(19) United States
(12) Patent Application Publication
(10) Pub. No.: US 2024/0386054 A1
(43) Pub. Date: Nov. 21, 2024

(54) SYSTEMS, APPARATUS, ARTICLES OF MANUFACTURE, AND METHODS FOR CROSS TRAINING AND COLLABORATIVE ARTIFICIAL INTELLIGENCE FOR PROACTIVE DATA MANAGEMENT AND ANALYTICS

(71) Applicant: Intel Corporation, Santa Clara, CA (US)

(72) Inventors: Rita WOUHAYBI, Portland, OR (US); Stanley T. MO, Portland, OR (US); Eve SCHOOLER, Portola Valley, CA (US); Christopher TIMMINS, Phoenix, AZ (US); Samudyatha C. KAIRA, Portland, OR (US); Greeshma PISHARODY, Portland, OR (US); Shane DEWING, Scottsdale, AZ (US); Hassnaa MOUSTAFA, San Jose, CA (US)

(21) Appl. No.: 18/571,142

(22) PCT Filed: Dec. 23, 2021
(86) PCT No.: PCT/US2021/065156

§ 371 Date: Dec. 15, 2023

Related U.S. Application Data
(60) Provisional application No. 63/248,312, filed on Sep. 24, 2021.

(51) Int. Cl. G06F 16/901; G06F 16/908; G06F 21/62

(52) U.S. Cl. CPC G06F 16/9024; G06F 16/908; G06F 21/6209

(57) ABSTRACT

Methods, apparatus, systems, and articles of manufacture are disclosed for proactive data management and analytics. An example apparatus includes at least one memory, instructions, and processor circuitry to at least one of execute or instantiate the instructions to identify nodes in a network environment, identify ones of the nodes as data subscribers, ingest data from data sources, execute a machine learning model on the data to generate an output, and perform an action based on the output.

### RELATED APPLICATION

This patent claims the benefit of U.S. Provisional Patent Application No. 63/248,312, which was filed on Sep. 24, 2021. U.S. Provisional Patent Application No. 63/248,312 is hereby incorporated herein by reference in its entirety. Priority to U.S. Provisional Patent Application No. 63/248,312 is hereby claimed.

### FIELD OF THE DISCLOSURE

This disclosure relates generally to data management and, more particularly, to systems, apparatus, articles of manufacture, and methods for cross training and collaborative Artificial Intelligence for proactive data management and analytics.

### BACKGROUND

Data management systems gather data and/or otherwise monitor many different complex activities and processes. The gathering of sufficient and relevant data to verify that a specific activity, tool, or task is performing as expected (or identifying a problem with the activity, tool, or task) can be intensive. As analytics efforts within data management systems increase, the need to quickly verify the state and/or sequence of complex actions or processes will increase as well.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 illustrates deployment of a virtual Edge configuration in an Edge computing system operated among multiple Edge nodes and multiple tenants.

FIG. 5 is a schematic diagram of an example infrastructure processing unit (IPU).

FIG. 6 is a block diagram of an example adaptive data management (ADM) system to implement adaptive data management in a network environment.

FIG. 7 is a flowchart representative of example machine readable instructions and/or example operations that may be executed and/or instantiated by processor circuitry to generate an example recommendation to integrate a hardware, software, and/or firmware feature in a semiconductor-based device (e.g., a silicon-based device).

FIG. 8 is an illustration of an example edge network environment including an example edge gateway and an example edge switch that may implement the example ADM system of FIG. 6 and/or otherwise as disclosed herein.

FIG. 9 is a flowchart representative of example machine readable instructions and/or example operations that may be executed and/or instantiated by processor circuitry to implement ADM as disclosed herein.

FIG. 10 is a flowchart representative of example machine readable instructions and/or example operations that may be executed and/or instantiated by processor circuitry to implement ADM as disclosed herein.

FIG. 11 is a block diagram of an example processing platform including processor circuitry structured to execute the example machine readable instructions and/or the example operations of FIGS. 7, 9, and/or 10 to implement the example ADM system of FIG. 6.

FIG. 12 is a block diagram of a first example adaptive data management (ADM) system for online learning and/or insights on data affinities and/or retention.

FIG. 13 is a block diagram of a second example ADM system for offline learning and/or insights on data affinities and/or retention.

FIG. 14 is a schematic illustration of a first example graph model and a second example graph model for depicting groups of related data and metadata connected linked via strength vectors.

FIG. 15 is a flowchart representative of example machine readable instructions and/or example operations that may be executed by example processor circuitry to implement the ADM system of FIGS. 12 and/or 13 to generate metadata for ingested and/or stored data, determine strength vector(s) for the ingested and/or stored data, and retain the ingested and/or stored data based on respective graph models.

FIG. 16 is a flowchart representative of example machine readable instructions and/or example operations that may be executed by example processor circuitry to implement the ADM system of FIGS. 12 and/or 13 to generate graph models similar to those illustrated in FIG. 14.

FIG. 17 is a flowchart representative of example machine readable instructions and/or example operations that may be executed by example processor circuitry to implement the ADM system of FIGS. 12 and/or 13 to ingest, analyze, and retain data ingested from online data source(s).

FIG. 18 is a flowchart representative of example machine readable instructions and/or example operations that may be executed by example processor circuitry to implement the ADM system of FIGS. 12 and/or 13 to execute continuous learning and/or prediction algorithms for retaining ingested data.

FIG. 19 is a flowchart representative of example machine readable instructions and/or example operations that may be executed by example processor circuitry to implement the ADM system of FIGS. 12 and/or 13 to analyze, update, and retain data stored in offline distributed datastore(s).

FIG. 20 is a flowchart representative of example machine readable instructions and/or example operations that may be executed by example processor circuitry to implement the ADM system of FIGS. 12 and/or 13 to execute continuous learning and/or prediction algorithms for retaining stored data.

FIG. 21 is a block diagram of an example processing platform including processor circuitry structured to execute the example machine readable instructions and/or the example operations of FIGS. 15-20 to implement the ADM system of FIGS. 12 and/or 13.

FIG. 22 is an illustration of an example network system including example confidence scoring circuitry implementing adaptive data confidence scoring among nodes.

FIG. 23 depicts a graph model representation of an example network system including the example data confidence scoring circuitry of FIG. 22 implementing adaptive data confidence scoring among nodes.

FIG. 24 is a block diagram of an example implementation of the data confidence scoring circuitry of FIGS. 22 and/or 23.

FIG. 25 is a block diagram of an example implementation of example data ingestion circuitry and example analytics manager circuitry of the data confidence scoring circuitry of FIG. 24.

FIG. 26 is a flowchart representative of example machine readable instructions and/or example operations that may be executed and/or instantiated by processor circuitry to implement adaptive data confidence scoring among multiple nodes.

FIG. 27 is a flowchart representative of example machine readable instructions and/or example operations that may be executed and/or instantiated by processor circuitry to determine a bad node.

FIG. 28 is a flowchart representative of example machine readable instructions and/or example operations that may be executed and/or instantiated by processor circuitry to implement a simulation of multiple nodes.

FIG. 29 is a flowchart representative of example machine readable instructions and/or example operations that may be executed and/or instantiated by processor circuitry to generate node information error correction values.

FIG. 30 is a flowchart representative of example machine readable instructions and/or example operations that may be executed and/or instantiated by processor circuitry to extrapolate node information for an error causation node and calculate a confidence level of the extrapolated node information.

FIG. 31 is a flowchart representative of example machine readable instructions and/or example operations that may be executed and/or instantiated by processor circuitry to implement a machine learning model associated with a group of nodes.

FIG. 32 is a flowchart representative of example machine readable instructions and/or example operations that may be executed and/or instantiated by processor circuitry to implement a rolling manifest of incoming node information.

FIG. 33 is a flowchart representative of example machine readable instructions and/or example operations that may be executed and/or instantiated by processor circuitry to implement a statistical feature data ingestion process.

FIG. 34 is a flowchart representative of example machine readable instructions and/or example operations that may be executed and/or instantiated by processor circuitry to determine an intermittent nature of a correlation error.

FIG. 35 is a flowchart representative of example machine readable instructions and/or example operations that may be executed and/or instantiated by processor circuitry to determine a cyclic nature of a correlation error.

FIG. 36 is a flowchart representative of example machine readable instructions and/or example operations that may be executed and/or instantiated by processor circuitry to identify a trend of the correlation error.

FIG. 37 is a flowchart representative of example machine readable instructions and/or example operations that may be executed and/or instantiated by processor circuitry to adjust cross-correlated weights of a machine learning model of a group of nodes.

FIG. 38 is a block diagram of an example processor platform structured to execute and/or instantiate the machine readable instructions and/or the operations of FIGS. 26-37 to implement the data confidence scoring circuitry of FIGS. 22, 23, and/or 24.

FIG. 39 is an illustration of an example environment including example contextual data translators for improved data management.

FIG. 40 is a block diagram of an example implementation of the contextual data translators of FIG. 39.

FIG. 41 is an illustration of example contextual data graph models.

FIG. 42 is an illustration of an example event chain.

FIG. 43 is an illustration of example implementations of the event chain of FIG. 42.

FIG. 44 is an illustration of an example workflow to achieve contextual data translation across different systems of an environment.

FIG. 45 is a flowchart representative of example machine readable instructions and/or example operations that may be executed and/or instantiated by processor circuitry to persist a contextual data graph model in a shared datastore to be accessible by a node.

FIG. 46 is a flowchart representative of example machine readable instructions and/or example operations that may be executed and/or instantiated by processor circuitry to determine a strength of association between a first data object and a second data object of a contextual data graph model.

FIG. 47 is a flowchart representative of example machine readable instructions and/or example operations that may be executed and/or instantiated by processor circuitry to update one(s) of contextual data graph models based on correlation(s).

FIG. 48 is a flowchart representative of example machine readable instructions and/or example operations that may be executed and/or instantiated by processor circuitry to provide updated contextual data graph models to at least one of node(s) or a shared datastore.

FIG. 49 is a flowchart representative of example machine readable instructions and/or example operations that may be executed and/or instantiated by processor circuitry to generate alert(s) to node(s) in an environment based on updated contextual data graph model(s).

FIG. 50 is a flowchart representative of example machine readable instructions and/or example operations that may be executed and/or instantiated by processor circuitry to update a contextual data graph model based on a machine learning output.

FIG. 51 is a flowchart representative of example machine readable instructions and/or example operations that may be executed and/or instantiated by processor circuitry to reconcile use(s) of application(s) and service(s) by first and second systems.

FIG. 52 is a flowchart representative of example machine readable instructions and/or example operations that may be executed and/or instantiated by processor circuitry to output results based on a search including at least one of a first data object or a second data object.

FIG. 53 is a block diagram of an example processing platform including processor circuitry structured to execute the example machine readable instructions and/or the example operations of FIGS. 45-52 to implement the example contextual data translator of FIGS. 39 and/or 40.

FIG. 54 is a block diagram of an example data routing management system including an example data routing manager to implement adaptive data routing in a network environment.

FIG. 55 is a block diagram of an example implementation of the data routing manager of FIG. 54.

FIG. 56 is an illustration of example data graphs to facilitate adaptive data routing in a network environment.

FIG. 57 depicts an example dataset including example metadata for adaptive data routing in a network environment.

FIG. 58 is a flowchart representative of example machine readable instructions and/or example operations that may be executed and/or instantiated by processor circuitry to route a message to user(s).

FIG. 59 is another flowchart representative of example machine readable instructions and/or example operations that may be executed and/or instantiated by processor circuitry to route a message to user(s).

FIG. 60 is a flowchart representative of example machine readable instructions and/or example operations that may be executed and/or instantiated by processor circuitry to present a message to user(s).

FIG. 61 is a flowchart representative of example machine readable instructions and/or example operations that may be executed and/or instantiated by processor circuitry to present a message to user(s) based on activity information associated with the user.

FIG. 62 is a flowchart representative of example machine readable instructions and/or example operations that may be executed and/or instantiated by processor circuitry to escalate presentation of a message to user(s).

FIG. 63 is a flowchart representative of example machine readable instructions and/or example operations that may be executed and/or instantiated by processor circuitry to augment a data object to present to a user based on metadata associated with the user.

FIG. 64 is a flowchart representative of example machine readable instructions and/or example operations that may be executed and/or instantiated by processor circuitry to adjust metadata associated with a user.

FIG. 65 is a flowchart representative of example machine readable instructions and/or example operations that may be executed and/or instantiated by processor circuitry to train and/or retrain a machine learning model.

FIG. 66 is a block diagram of an example processing platform including processor circuitry structured to execute the example machine readable instructions and/or the example operations of FIGS. 58-65 to implement the example data routing manager of FIGS. 54 and/or 55.

FIG. 67 is a block diagram of an example implementation of the processor circuitry of FIGS. 11, 21, 38, 53, and/or 66.

FIG. 68 is a block diagram of another example implementation of the processor circuitry of FIGS. 11, 21, 38, 53, and/or 66.

FIG. 69 is a block diagram of an example software distribution platform (e.g., one or more servers) to distribute software (e.g., software corresponding to the example machine readable instructions of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Network environments today have many different complex activities and processes, and the gathering of sufficient and relevant data to verify that a specific activity, tool, or task is performing as expected (or identifying a problem with the activity, tool, or task) can be intensive. As Edge analytics efforts increase, the need to quickly verify the state and/or sequence of complex actions or processes will increase as well. This will enable faster and more effective decisions and actions an organization can make in their complex environments.

Examples disclosed herein include systems, apparatus, articles of manufacture, and methods for cross training and collaborative Artificial Intelligence for proactive data management and analytics. In some disclosed examples, proactive and/or otherwise adaptive data management is implemented by an example proactive and/or otherwise adaptive data management system. Advantageously, an example proactive and/or otherwise adaptive data management and analytics system as disclosed herein is an improvement over conventional, static data management systems that may require constant adjustments and modifications to satisfy complex and diverse network workloads.

Examples disclosed herein include proactive and/or adaptive data retention in an automated and contextual manner as a part of proactive and/or otherwise adaptive data management for a network environment. Examples disclosed herein can implement proactive and/or adaptive data retention by considering offline retention mechanisms for stored data at rest. Examples disclosed herein can implement proactive and/or adaptive data retention by considering online retention mechanisms during data ingestion.

Data quality of retained data is important for the efficacy and/or the higher accuracy of the resulting insights of any data analytics platform. Examples disclosed herein include a peer-to-peer network of nodes and, through applying a consensus approach and cross-correlation to either correct a node's model or identify a rare outlier event to improve data quality of retained data, the data quality managed by the peer-to-peer network can be improved.

In some disclosed examples, once a data retention decision is reached, an autonomous hierarchical contextual translator can bridge the data and/or contextual gap between different parts of the network environment. Examples disclosed herein include a network-wide data dialect and contextual translator (e.g., a universal dictionary or white pages) that can be used to (1) dynamically translate and label the data from each discipline; (2) store the context-based data in such a manner to be shared across disciplines for network wide insights; and/or (3) identify the subset of the data that is needed for translation between interacting disciplines, when not all of the data may be relevant.

Once data is retained, analyzed, and/or translated, examples disclosed herein include presenting relevant information to a user. In some disclosed examples, presenting the relevant information to a user can be implemented by determining an optimum representation of data for the user through customization and creation of a network of subject matter experts and stakeholders. In some disclosed examples, the network of the subject matter experts and/or the stakeholders can be implemented by users whom the data could be sent for supervisory inputs, timeliness, addition of relevant information, and the like. In some disclosed examples, the data itself and/or associated metadata can provide guidance to whom or what (e.g., an application or service) the data should be provided based on the context and urgency of the data.

### Section A—Example Network Environments That May Implement the Examples Disclosed Herein

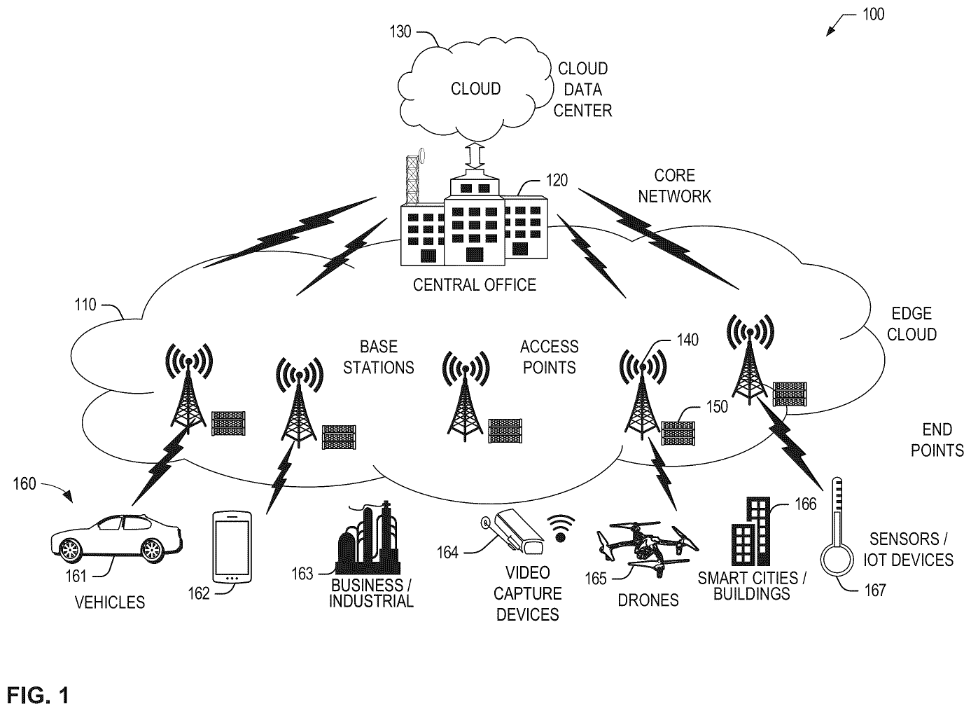

FIG. 1 is a block diagram 100 showing an overview of a configuration for Edge computing, which includes a layer of processing referred to in many of the following examples as an “Edge cloud”. For example, the block diagram 100 may implement an example adaptive data management system (also referred to herein as a smart data management system) as disclosed herein. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

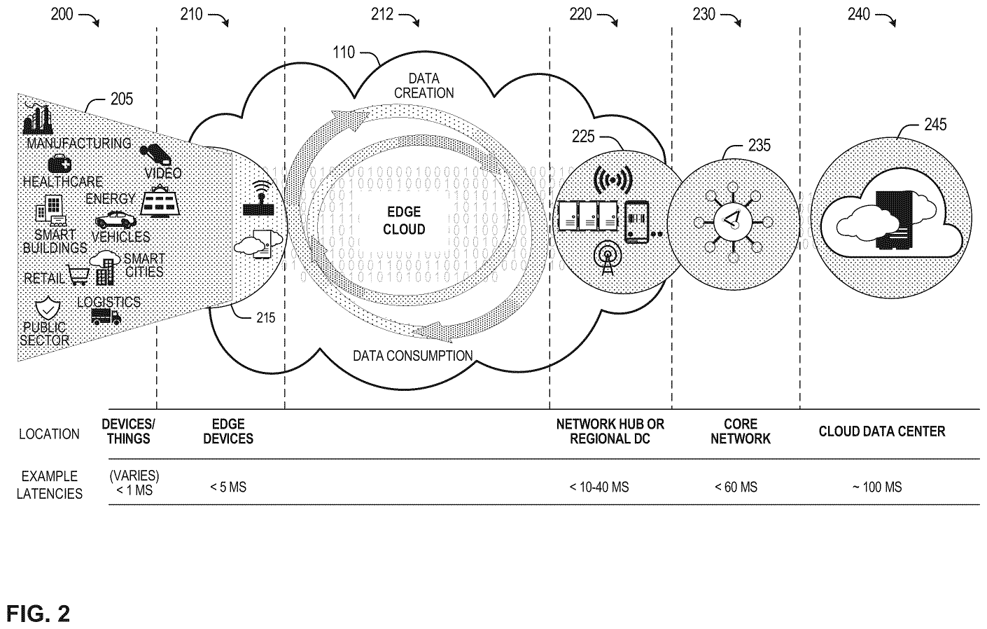

FIG. 2 illustrates operational layers among endpoints, an Edge cloud, and cloud computing environments. For example, FIG. 2 may implement an example adaptive data management system as disclosed herein. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance (e.g., distance between I/O interfaces such as PCIe or NICs) and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

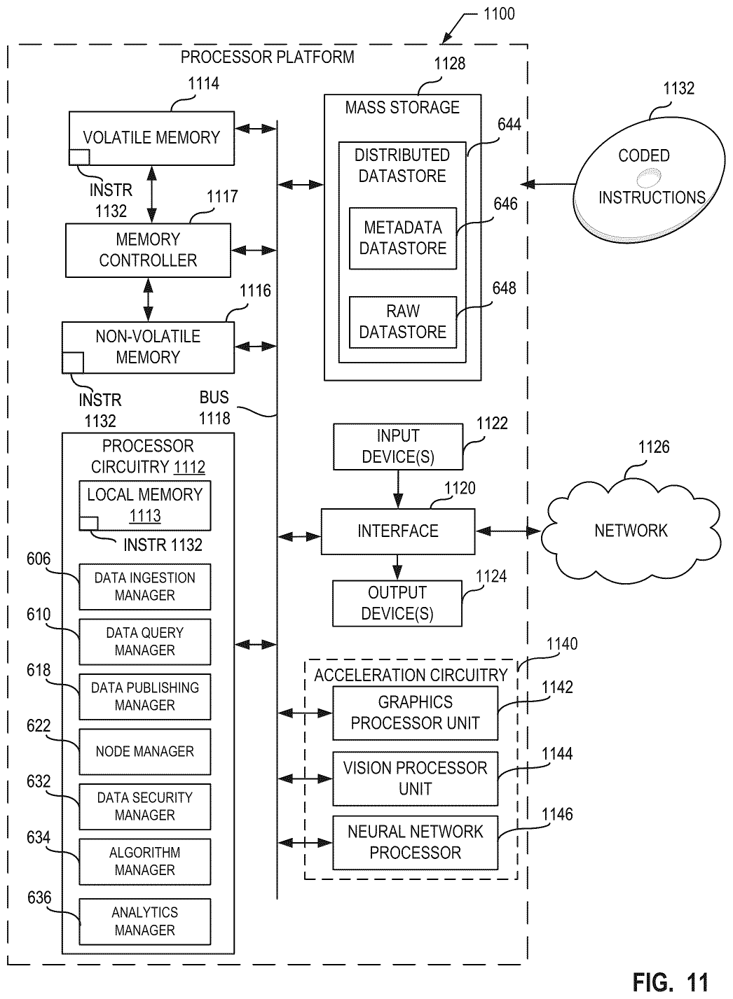

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing or electronic device is described in conjunction with FIGS. 11, 21, 38, 53, and/or 66. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines (VMs), one or more containers, etc. Such virtual computing environments provide an execution environment in which one or more applications and/or other software, code, or scripts may execute while being isolated from one or more other applications, software, code, or scripts.

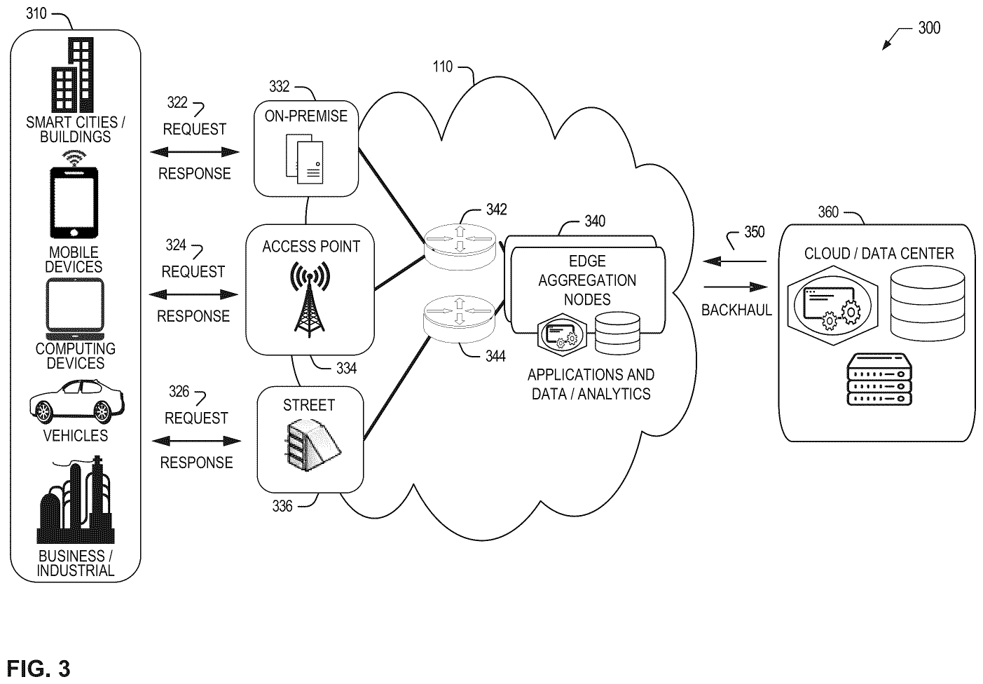

In FIG. 3, various client endpoints 310 (in the form of mobile devices, computers, autonomous vehicles, business computing equipment, industrial processing equipment) exchange requests and responses that are specific to the type of endpoint network aggregation. For example, FIG. 3 may implement an example adaptive data management system as disclosed herein. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

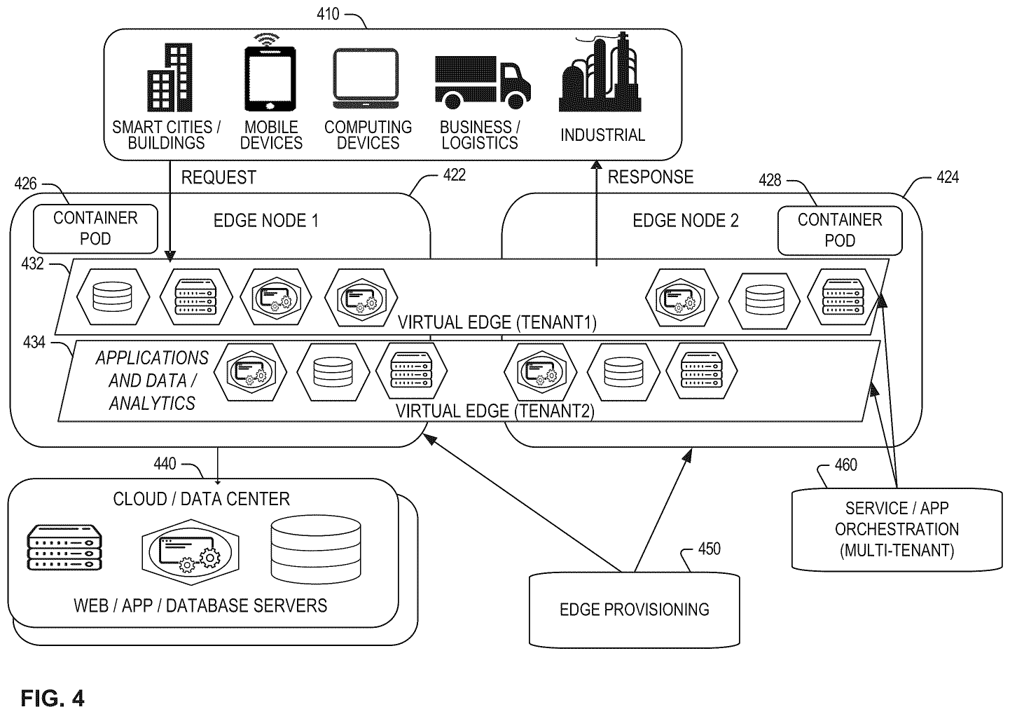

FIG. 4 illustrates deployment and orchestration for virtualized and container-based Edge configurations across an Edge computing system operated among multiple Edge nodes and multiple tenants (e.g., users, providers) which use such Edge nodes. For example, FIG. 4 may implement an example adaptive data management system as disclosed herein. Specifically, FIG. 4 depicts coordination of a first Edge node 422 and a second Edge node 424 in an Edge computing system 400, to fulfill requests and responses for various client endpoints 410 (e.g., smart cities/building systems, mobile devices, computing devices, business/logistics systems, industrial systems, etc.), which access various virtual Edge instances. Here, the virtual Edge instances 432, 434 provide Edge compute capabilities and processing in an Edge cloud, with access to a cloud/data center 440 for higher-latency requests for websites, applications, database servers, etc. However, the Edge cloud enables coordination of processing among multiple Edge nodes for multiple tenants or entities.

In the example of FIG. 4, these virtual Edge instances include: a first virtual Edge 432, offered to a first tenant (Tenant 1), which offers a first combination of Edge storage, computing, and services; and a second virtual Edge 434, offered to a second tenant (Tenant 2), which offers a second combination of Edge storage, computing, and services. The virtual Edge instances 432, 434 are distributed among the Edge nodes 422, 424, and may include scenarios in which a request and response are fulfilled from the same or different Edge nodes. The configuration of the Edge nodes 422, 424 to operate in a distributed yet coordinated fashion occurs based on Edge provisioning functions 450. The functionality of the Edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective Edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual Edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), GPU, interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, servlets, servers, or other computation abstraction that may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous Edge node. As part of migration of a container, a pod controller at a source Edge node may obtain a migration key from a target Edge node pod controller where the migration key is used to wrap the container-specific keys. When the container/pod is migrated to the target Edge node, the unwrapping key is exposed to the pod controller that then decrypts the wrapped keys. The keys may now be used to perform operations on container specific data. The migration functions may be gated by properly attested Edge nodes and pod managers (as described above).

In further examples, an Edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an Edge computing system may be configured to fulfill requests and responses for various client endpoints from multiple virtual Edge instances (and, from a cloud or remote data center). The use of these virtual Edge instances may support multiple tenants and multiple applications (e.g., augmented reality (AR)/virtual reality (VR), enterprise applications, content delivery, gaming, compute offload, etc.) simultaneously. Further, there may be multiple types of applications within the virtual Edge instances (e.g., normal applications; latency sensitive applications; latency-critical applications; user plane applications; networking applications; etc.). The virtual Edge instances may also be spanned across systems of multiple owners at different geographic locations (or, respective computing systems and resources which are co-owned or co-managed by multiple owners).

For instance, each Edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various Edge node resources (e.g., storage, compute, services, depicted with hexagons) provided for the respective Edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, the pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different Edge node that does satisfy it. Alternatively, the first pod may be allowed to execute and a different shared pod controller is installed and invoked prior to the second pod executing.

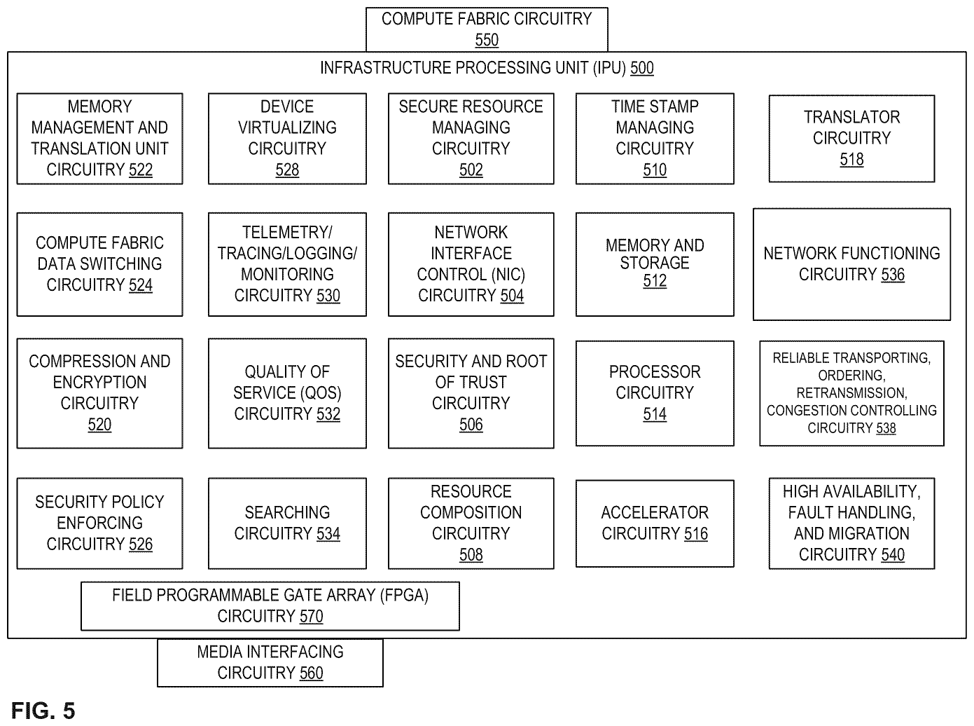

FIG. 5 depicts an example of an infrastructure processing unit (IPU) 500. In some examples, the IPU 500 can effectuate and/or otherwise facilitate proactive and/or adaptive data management and analytics as described herein. Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 5, the IPU 500 includes or otherwise accesses secure resource managing circuitry 502, network interface controller (NIC) circuitry 504, security and root of trust circuitry 506, resource composition circuitry 508, time stamp managing circuitry 510, memory and storage 512, processing circuitry 514, accelerator circuitry 516, and/or translator circuitry 518. Any number and/or combination of other structure(s) can be used such as but not limited to compression and encryption circuitry 520, memory management and translation unit circuitry 522, compute fabric data switching circuitry 524, security policy enforcing circuitry 526, device virtualizing circuitry 528, telemetry, tracing, logging and monitoring circuitry 530, quality of service circuitry 532, searching circuitry 534, network functioning circuitry (e.g., routing, firewall, load balancing, network address translating (NAT), etc.) 536, reliable transporting, ordering, retransmission, congestion controlling circuitry 538, and high availability, fault handling and migration circuitry 540 shown in FIG. 5. Different examples can use one or more structures (components) of the example IPU 500 together or separately. For example, compression and encryption circuitry 520 can be used as a separate service or chained as part of a data flow with vSwitch and packet encryption.

In some examples, the IPU 500 includes a field programmable gate array (FPGA) 570 structured to receive commands from an CPU, XPU, or application via an API and perform commands/tasks on behalf of the CPU, including workload management and offload or accelerator operations. The illustrated example of FIG. 5 may include any number of FPGAs configured and/or otherwise structured to perform any operations of any IPU described herein.

Example compute fabric circuitry 550 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel@ QuickPath Interconnect (QPI), Intel@ Ultra Path Interconnect (UPI), Intel@ On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 560 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 500, IPU 500 is a root of a system (e.g., rack of servers or data center) and manages compute resources (e.g., CPU, xPU, storage, memory, other IPUs, and so forth) in the IPU 500 and outside of the IPU 500. Different operations of an IPU are described below.

In some examples, the IPU 500 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 500 is selected to perform a workload, secure resource managing circuitry 502 offloads work to a CPU, xPU, or other device and the IPU 500 accelerates connectivity of distributed runtimes, reduce latency, CPU and increases reliability.

In some examples, secure resource managing circuitry 502 runs a service mesh to decide what resource is to execute workload, and provide for L7 (application layer) and remote procedure call (RPC) traffic to bypass kernel altogether so that a user space application can communicate directly with the example IPU 500 (e.g., the IPU 500 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 500 dynamically selects itself to run a given workload (e.g., microservice) within a composable infrastructure including an IPU, xPU, CPU, storage, memory, and other devices in a node.

In some examples, communications transit through media interfacing circuitry 560 of the example IPU 500 through a NIC/smartNIC (for cross node communications) or loopback back to a local service on the same host. Communications through the example media interfacing circuitry 560 of the example IPU 500 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 500 prioritizes its processing to minimize the stalling of the requesting application. In some examples, the IPU 500 schedules the prioritized message request issuing the event to execute a SQL query database and the example IPU constructs microservices that issue SQL queries and the queries are sent to the appropriate devices or services.

### Section B—Example Adaptive Data Management System

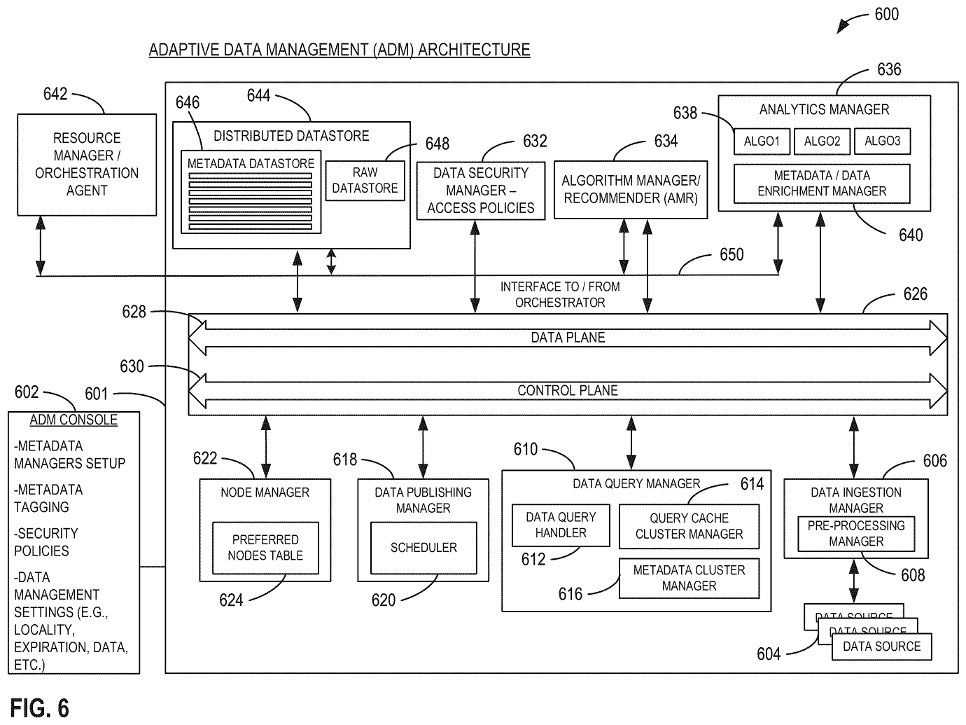

FIG. 6 is a block diagram of an example adaptive data management (ADM) system 600 to implement adaptive data management in a network environment. In some examples, the ADM system 600 can effectuate and/or otherwise implement proactive data management in the network environment. The ADM system 600 of FIG. 6 may be instantiated (e.g., creating an instance of, bring into being for any length of time, materialize, implement, etc.) by processor circuitry such as a CPU executing instructions. Additionally or alternatively, the ADM system 600 of FIG. 6 may be instantiated by an ASIC or an FPGA structured to perform operations corresponding to the instructions. It should be understood that some or all of the ADM system 600 of FIG. 6 may, thus, be instantiated at the same or different times. Some or all of the ADM system 600 of FIG. 6 may be instantiated, for example, in one or more threads executing concurrently on hardware and/or in series on hardware. Moreover, in some examples, some or all of the ADM system 600 of FIG. 6 may be implemented by one or more VMs and/or containers executing on the processor circuitry.

In some examples, the ADM system 600 is implemented using an example logical entity 601. For example, the logical entity 601 can be implemented using a client compute node, such as any type of endpoint component, device, appliance, or other thing capable of communicating as a producer or consumer of data. In some examples, the logical entity 601 can be implemented by, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a sensor, a personal video recorder, a headset (e.g., an augmented reality (AR) headset, a virtual reality (VR) headset, etc.) or other wearable device, or any other type of computing device. In some examples, the logical entity 601 can be implemented using one or more client compute nodes, one or more servers, one or more personal computers, etc., and/or any combination(s) thereof. For example, a first portion of the logical entity 601 can be implemented using a first client compute node and a second portion of the logical entity 601 can be implemented using a second client compute node. Any other combinations are contemplated.

In the illustrated example of FIG. 6, the ADM system 600 includes an example ADM console 602, example data sources 604, and an example data ingestion manager 606, which includes an example pre-processing manager 608. The ADM system 600 includes an example data query manager 610, which includes an example data query handler 612, an example query cache cluster manager 614, and an example metadata cluster manager 616. The ADM system 600 includes an example data publishing manager 618, which includes an example scheduler 620. The ADM system 600 includes an example node manager 622, which includes an example preferred nodes table 624. The ADM system 600 includes an example network plane 626, which includes an example data plane 628 and an example control plane 630. The ADM system 600 includes an example data security manager 632, an example algorithm manager and/or recommender (AMR) 634, and an example analytics manager 636, which includes example algorithms 638 (identified by ALGO1, ALGO2, ALGO3), and an example metadata/data enrichment manager 640. The ADM system 600 includes an example resource manager and/or orchestration agent 642. The ADM system 600 includes an example distributed datastore 644, which includes an example metadata datastore 646, and an example raw datastore 648.

In the illustrated example, the ADM system 600 includes the ADM console 102 to setup and/or otherwise configure portion(s) of the ADM system 600 (e.g., the data ingestion manager 606, the node manager 622, etc.). For example, the ADM console 602 can configure the metadata/data enrichment manager 640. In some examples, the ADM console 602 may effectuate and/or otherwise execute metadata tagging by adding, removing, and/or modifying metadata. In some examples, the ADM console 602 can enforce and/or otherwise implement security policies. For example, the ADM console 602 can add, remove, and/or modify access policies generated, managed, and/or otherwise handled by the data security manager 632. In some examples, the ADM console 602 can configure data management settings (e.g., locality, expiration date, etc., of data) associated with data that is generated, accessed, and/or stored by the ADM system 600. In some examples, the ADM console 602 can be implemented using one or more user experience (UX) and/or user interface (UI) (e.g., graphical user interface (GUI)) consoles, displays, interfaces, etc.

In the illustrated example, the ADM system 600 includes the data ingestion manager 606 to ingest, receive, and/or otherwise obtain data from one(s) of the data sources 604. For example, the data sources 604 can be implemented using any hardware, software, and/or firmware as described herein (e.g., hardware, software, and/or firmware of an autonomous guided vehicle (AGV), a server, an IoT device, an Edge appliance, etc.). In some examples, the data ingestion manager 606 includes the pre-processing manager 608 to pre-process data obtained from the data sources 604. For example, the data ingestion manager 606 can extract portion(s) of the data, convert portion(s) of the data from a first data format to a second data format, compress or decompress the data, decrypt or encrypt the data, etc., and/or any combination(s) thereof.

In the illustrated example, the ADM system 600 includes the data query manager 610 to queue and/or otherwise process data search requests from users and/or applications. For example, the data query handler 612 can queue and/or otherwise process the data search requests. In some examples, the data query handler 612 can generate and/or return results associated with the data search results to the requester (e.g., the requesting user, the requesting device, the requesting application/service, etc.). In some examples, the data query manager 610 can utilize the existence of metadata tables extracted from data files (e.g., media, alpha-numeric, spatial, etc., data files) that have been pre-generated by the metadata/data enrichment manager 640. In some examples, the data query manager 610 can be implemented using a search and match of topical terms to metadata tags. In some examples, the data query manager 610 can be implemented using a search and match of weighted topics and phrases with Boolean operations to perform complex contextual matches, prioritizations, and sequences of topics mapping.

In some examples, the data query manager 610 manages multiple metadata context resulting from metadata generating engines, sub-metadata tables specific to user/applications with unique context, permissions, etc. In some examples, the data query manager 610 can scan a metadata file (e.g., a metadata array, table, etc.), for primary search and recommendation of most appropriate data file links associated with portion(s) of the metadata file. For example, the data query manager 610 can include the metadata cluster manager 616 to scan the metadata file and/or return a number of excerpts (e.g., a user selectable number of excerpts, portions, etc.) for final selection and output. In some examples, the data query manager 610 can check selections for permission level appropriateness. For example, different departments, regions, etc., of an environment can have security and access control. In some examples, the data query manager 610 can cross-reference the selections with the security and access control to determine whether a requester has access to the selections. In some examples, the data query manager 610 can link a user/application to a returned and/or otherwise identified data source file. In some examples, the data query manager 610 and a metadata database (e.g., the metadata datastore 646) need not be co-resident.

In some examples, the data query manager 610 can include the query cache cluster manager 614 to execute and/or otherwise effectuate selective caching. For example, the query cache cluster manager 614 can activate and/or otherwise enable caching for frequently requested and/or accessed topics, most recently used search terms with user selected and preferred data source file links, data source file linkages that have a high correlation to one another (e.g., occurs frequently), etc., and/or any combination(s) thereof.

In some examples, the data query manager 610 facilitates capacity scaling for data and/or resource demand volume and for serving local organizations, personnel, teams, etc. For example, the data query manager 610 can launch and/or otherwise instantiate additional instances of the data query manager 610 near and/or otherwise proximate to demand sources (e.g., a department server, an individual personal computer, etc.) that may be associated with the data sources 604.

Advantageously, in some examples, a locality of the metadata datastore 646 to the data query manager 610 can reduce network traffic and latency to ensure that even if a file (e.g., a data file) is unavailable, the existence of the file may be confirmed. In some examples, the data query manager 610 can enable and/or otherwise effectuate synchronization with other components of the ADM system 600 more frequently for metadata (e.g., metadata files, tables, etc.) of the metadata datastore 646 that is/are accessed most frequently or undergo significant changes (e.g., usually another feature of frequent use or recent capture). In some examples, the data query manager 610 can achieve interactive and/or programmatic access to portion(s) of the ADM system 600.

In the illustrated example, the ADM system 600 includes the data publishing manager 618 to implement publish-subscribe messaging. For example, a subscriber (e.g., a data subscriber, a device subscriber, etc.) can coordinate with the scheduler 620 to subscribe to alerts, changes, updates, etc., of data of the metadata datastore 646, the raw datastore 648, and/or data generated by one(s) of the data sources 604. In some examples, the data publishing manager 618 can publish data of interest to the appropriate subscribers.

In the illustrated example, the ADM system 600 includes the node manager 622 to enable edge nodes to maintain lists (e.g., a friends list, a neighboring nodes list, a trusted or verified node list, etc.) on the network. In some examples, the list(s) can include(s) the preferred nodes table 624. For example, the preferred nodes table 624 can be implemented using a routing table in networking examples. In some examples, the node manager 622 can maintain the table/list/index as a dynamic and/or evolving table/list/index by considering previous interactions and/or transactions between neighboring nodes. For example, the node manager 622 can control the table/list/index to rate neighboring nodes based on the context of data requested, the frequency of data requested, the Quality-of-Service (QoS) of past interactions, etc., and/or any combination(s) thereof. In some examples, the table/list/index can exist in the distributed datastore 644, which may be quickly accessible upon a request from the data query manager 610.

In the illustrated example, the ADM system 600 includes the network plane 626 to facilitate the transmission, distribution, and/or otherwise propagation of data within a network environment. In some examples, the network plane 626 can be implemented by one or more networks. For example, the network plane 626 can be implemented by the Internet. However, the network plane 626 can be implemented using any suitable wired and/or wireless network(s) including, for example, one or more data buses, one or more Local Area Networks (LANs), one or more wireless LANs (WLANs), one or more cellular networks, one or more private networks, one or more public networks, one or more fiber networks, one or more satellite networks, one or more terrestrial networks, one or more non-terrestrial networks, etc., and/or any combination(s) thereof. In the illustrated example, component(s) of the ADM system 600 can provide, deliver, propagate, etc., data in the ADM system 600 by way of the data plane 628. In the illustrated example, component(s) of the ADM system 600 can provide, deliver, propagate, etc., controls, commands, directions, instructions, etc., in the ADM system 600 by way of the control plane 630.

In the illustrated example, the ADM system 600 includes the data security manager 632 to control (e.g., add, remove, modify, etc.) one(s) of the access policies. For example, the data security manager 632 can control the access policies rather than the node/platform level security components and/or a user who may be authenticated to access the network. In some examples, the data security manager 632 can be accessed through the ADM console 602.

In some examples, the data security manager 632 assigns initial security/access levels to data files, data streams, etc., based on user provided policy or explicit settings. In some examples, the data security manager 632 can facilitate autonomous control of access policies, where content may inherit security levels from other similar data files based on metadata, data topics, etc. In some examples, the data security manager 632 can ensure compatible security level data match for the user/application/service level security with appropriate data levels. In some examples, the data security manager 632 can define the scope of data availability (e.g., geographic, topical, personnel, security level, etc.). In some examples, the data security manager 632 can log audits for a query log (e.g., requests, copies, moves, successes/fails, reasons for the requests, successes, fails, etc., etc.) maintained by the data query manager 610. In some examples, the data security manager 632 can ensure data/metadata from high security areas are not copied/moved to lower-level security environments. In some examples, the data security manager 632 can enforce top secret level access to confidential areas or non-top secret level access to unsecured servers. In some examples, the data security manager 632 can monitor with the data query manager 610 the data request traffic for potential irregularities. In some examples, the data security manager 632 can implement and/or otherwise provide encryption services, keys as a service, etc., and/or any combination(s) thereof for improved security of the ADM system 600.

In the illustrated example, the ADM system 600 includes the AMR 634 to monitor the data on the data plane 628 and/or in the distributed datastore 644 (e.g., when invoked or triggered to run analytics) and/or upon a gap in the existing algorithms 638 of the analytics manager 636. In some examples, the AMR 634 can interface with the resource manager 642 by using an example interface 650. For example, the resource manager 642 can implement an orchestration agent that receives a request for new one(s) of the algorithms 638 to act on of data of interest. For example, if a node that was previously monitoring a video stream and now has some additional time series data, the AMR 634 can request the resource manager/orchestrator agent 642 for a new one of the algorithms 638 to update the analytics manager 636 to run insights on both modalities.

In some examples, the analytics manager 636 includes a metadata agent (e.g., a metadata agent that can be implemented by the metadata/data enrichment manager 640) that may request analytics to be executed by the AMR 634 for generating metadata from source streams/files. In some examples, the AMR 634 can instantiate one(s) of the algorithms 638 to generate the analytics. In some examples, the analytics may be generated by an Artificial Intelligence/Machine Learning (AI/ML) model (e.g., a neural network (NN)) for classification, neural natural language processing (NNLP) to parse documentation, etc., and/or any combination(s) thereof.

In some examples, in the data or user domain, an application or a direct user request may request an analytics container (e.g., an analytics container that may be instantiated and/or implemented by the analytics manager 636) with appropriate configuration(s) and optimization(s) for the requested task. In some examples, certain one(s) of the algorithms 638 or AI/ML models may be preferred over time as a function of accuracy and performance and priorities may be assigned to the one(s) of the algorithms 638 for utilization in the ADM system 600.

In some examples, the resource manager/orchestration agent 642 can orchestrate new one(s) of the algorithms 638 either from a centralized algorithm library based on example algorithm ratings, scores, etc., if available, or through a pointer or other reference to a local datastore (e.g., if available in a library) of the analytics manager 636 for faster access or the distributed datastore 644.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, one(s) of the algorithms 638 may be trained with data to recognize patterns and/or associations and follow such patterns and/or associations when processing input data such that other input(s) result in output(s) consistent with the recognized patterns and/or associations. In some examples, an association can be implemented using a data association. For example, the association may itself be data. For example, the association can be implemented using an address (e.g., a storage or memory address), a pointer, a reference, etc., or any other data connection or linkage that may be stored in a mass storage device, memory, etc.

Many different types of machine-learning models and/or machine-learning architectures exist. In some examples, the analytics manager 636 may generate one(s) of the algorithms 638 as neural network model(s). In some examples, the resource manager/orchestration agent 642 may obtain and/or generate one(s) of the algorithms 638. Using a neural network model enables the analytics manager 636 to execute AI/ML workload(s). In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the analytics manager 636 may compile and/or otherwise generate one(s) of the algorithm(s) 638 as lightweight machine-learning models.

In general, implementing an ML/AI system involves two phases, a learning/training phase and an inference phase. In the learning/training phase, a training algorithm is used to train the one(s) of the algorithms 638 to operate in accordance with patterns and/or associations based on, for example, training data. In general, the one(s) of the algorithms 638 include(s) internal parameters (e.g., indices, raw data, metadata, insights, models, weights, etc.) that guide how input data is transformed into output data, such as through a series of nodes and connections within the one(s) of the algorithms 638 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the analytics manager 636 may invoke supervised training to use inputs and corresponding expected (e.g., labeled) outputs to select parameters (e.g., by iterating over combinations of select parameters) for the one(s) of the algorithms 638 that reduce model error. As used herein, “labeling” refers to an expected output of the machine learning model (e.g., a classification, an expected output value, etc.). Alternatively, the analytics manager 636 may invoke unsupervised training (e.g., used in deep learning, a subset of machine learning, etc.) that involves inferring patterns from inputs to select parameters for the one(s) of the algorithms 638 (e.g., without the benefit of expected (e.g., labeled) outputs).

In some examples, the analytics manager 636 trains the one(s) of the algorithms 638 using unsupervised clustering of operating observables. For example, the operating observables may include data from the data sources 604, metadata in the metadata datastore 646, data in the raw datastore 648, etc., and/or combination(s) thereof. However, the analytics manager 636 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the analytics manager 636 may train the one(s) of the algorithms 638 until the level of error is no longer reducing. In some examples, the analytics manager 636 may train the one(s) of the algorithms 638 locally on the analytics manager 636 and/or remotely at an external computing system (e.g., on external computing device(s) in communication with the resource manager/orchestration agent 642) communicatively coupled to the analytics manager 636. In some examples, the analytics manager 636 trains the one(s) of the algorithms 638 using hyperparameters that control how the learning is performed (e.g., a learning rate, a number of layers to be used in the machine learning model, etc.). In some examples, the analytics manager 636 may use hyperparameters that control model performance and training speed such as the learning rate and regularization parameter(s). The analytics manager 636 may select such hyperparameters by, for example, trial and error to reach an optimal model performance. In some examples, the analytics manager 636 Bayesian hyperparameter optimization to determine an optimal and/or otherwise improved or more efficient network architecture to avoid model overfitting and improve the overall applicability of the one(s) of the algorithms 638. Alternatively, the analytics manager 636 may use any other type of optimization. In some examples, the analytics manager 636 may perform re-training. The analytics manager 636 may execute such re-training in response to override(s) by a user of the ADM system 600, a receipt of new training data, change(s) to node(s), change(s) observed and/or otherwise identified by node(s), etc.

In some examples, the analytics manager 636 facilitates the training of the one(s) of the algorithms 638 using training data. In some examples, the analytics manager 636 utilizes training data that originates from locally generated data, such as one(s) of the data from the data sources 604, metadata in the metadata datastore 646, data in the raw datastore 648, etc., and/or combination(s) thereof. In some examples, the analytics manager 636 utilizes training data that originates from externally generated data, such as data from the data sources 604, data from the resource manager/orchestration agent 642, etc., and/or combination(s) thereof. In some examples where supervised training is used, the analytics manager 636 may label the training data (e.g., label training data or portion(s) thereof with appropriate metadata). Labeling is applied to the training data by a user manually or by an automated data pre-processing system. In some examples, the analytics manager 636 may pre-process the training data. In some examples, the analytics manager 636 sub-divides the training data into a first portion of data for training the one(s) of the algorithms 638, and a second portion of data for validating the one(s) of the algorithms 638.

Once training is complete, the analytics manager 636 may deploy the one(s) of the algorithms 638 for use as an executable construct that processes an input and provides an output based on the network of nodes and connections defined in the one(s) of the algorithms 638. The analytics manager 636 may store the one(s) of the algorithms 638 in the analytics manager 636. In some examples, the analytics manager 636 may invoke the interface 650 to transmit the one(s) of the algorithms 638 to one(s) of the external computing systems in communication with the resource manager/orchestration agent 642. In some examples, in response to transmitting the one(s) of the algorithms 638 to the one(s) of the external computing systems, the one(s) of the external computing systems may execute the one(s) of the algorithms 638 to execute AI/ML workloads with at least one of improved efficiency or performance.

Once trained, the deployed one(s) of the algorithms 638 may be operated in an inference phase to process data. In the inference phase, data to be analyzed (e.g., live data) is input to the one(s) of the algorithms 638, and the one(s) of the algorithms 638 execute(s) to create an output. This inference phase can be thought of as the AI “thinking” to generate the output based on what it learned from the training (e.g., by executing the one(s) of the algorithms 638 to apply the learned patterns and/or associations to the live data). In some examples, input data undergoes pre-processing before being used as an input to the one(s) of the algorithms 638. Moreover, in some examples, the output data may undergo post-processing after it is generated by the one(s) of the algorithms 638 to transform the output into a useful result (e.g., a display of data, a detection and/or identification of an object, an instruction to be executed by a machine, etc.).

In some examples, output of the deployed one(s) of the algorithms 638 may be captured and provided as feedback. By analyzing the feedback, an accuracy of the deployed one(s) of the algorithm(s) 638 can be determined. If the feedback indicates that the accuracy of the deployed model is less than a threshold or other criterion, training of an updated model can be triggered using the feedback and an updated training data set, hyperparameters, etc., to generate an updated, deployed model.

In the illustrated example, the ADM system 600 includes the metadata/data enrichment manager 640 to schedule and/or execute metadata creation and/or post-processing routines intended to extract context and meaning from the source data stream/data files to enhance source data files to decrease noise and/or clarify/focus subjects or topics of interest. In some examples, the metadata/data enrichment manager 640 includes a metadata or enhancement request routine, an online metadata agent, and/or an offline metadata agent. In some examples, the metadata or enhancement request routine can be configured and/or otherwise instantiated to take inputs from a user or process/application to articulate the types of metadata/enhancement and determine what operations may be done in real time and what must be done offline based on a complexity of the request, type of data, available processing resources, priority/urgency of the operation, and the like. In some examples, the metadata/data enrichment manager 640 can enrich metadata by adding and/or otherwise including new metadata in response to ingesting data from an environment. In some examples, the metadata/data enrichment manager 640 can enrich metadata by removing and/or otherwise deleting portion(s) of the metadata that is/are determined to be irrelevant (or not as relevant as once determined) or not useful for determining output(s) with a high likelihood of accuracy, relevancy, etc., and/or any combination(s) thereof.

In some examples, the online metadata agent can access existing metadata or enhancement functionality within a node or launch a selected algorithm package to perform real time metadata/enhancement actions on the data stream and create a source-file linked metadata record that may be passed to the data query manager 610 for incorporation and synchronization with other authorized and/or relevant instances of the data query manager 610. In the example of source file enhancement, the original file may be archived and linked with appropriate metadata record while the modified file is returned to the requestor.

In some examples, the offline metadata agent can be implemented as the real time agent instantiated on the server/file storage that runs metadata/enhancement routines offline due to resource availability, complexity of operations, and/or lower priority setting. Subsequent behavior may be similar to the online metadata once post-processing has been completed.

In some examples, the metadata/data enrichment manager 640 evaluates metadata/enhancement requests and priority. In some examples, the metadata/data enrichment manager 640 can select appropriate operations for base metadata and enhancement operations. In some examples, the metadata/data enrichment manager 640 can invoke and/or otherwise provoke the AMR 634 to heuristically suggest proper algorithm(s) for advanced data operations and/or recommend algorithm combinations (e.g., algorithm recipes) from prior operations that may be preferred by different customers or observed to operate best on certain hardware.

In some examples, the metadata/data enrichment manager 640 can identify real-time operations from post-processed operations and confirm with the user allowing the user to modify. In some examples, the metadata/data enrichment manager 640 can launch modules (e.g., AI, NNLP, analytics, statistics, etc.) to generate metadata (e.g., generate association(s) of data portion(s) and metadata) and/or enhance existing data (e.g., hyper-resolution or false image enhancements) on local node or supporting compute platform(s). In some examples, the metadata/data enrichment manager 640 can manage archiving of sources, appending metadata records requested or provided by the data query manager 610 (with source links), etc. In some examples, a single instance of the metadata/data enrichment manager 640 can manage multiple metadata/enhancement operations.

In the illustrated example, the ADM system 600 includes the distributed datastore 644 to record data. For example, the distributed datastore 644 can include the metadata datastore 646 to record and/or otherwise store metadata. In some examples, the distributed datastore 644 can include the raw datastore 648 to record raw and/or otherwise unprocessed data. The distributed datastore 644 can be implemented by one or more volatile memories (e.g., a Synchronous Dynamic Random Access Memory (SDRAM), Dynamic Random Access Memory (DRAM), RAMBUS Dynamic Random Access Memory (RDRAM), etc.), one or more non-volatile memories (e.g., flash memory), and/or combination(s) thereof. The distributed datastore 644 may additionally or alternatively be implemented by one or more double data rate (DDR) memories, such as DDR, DDR2, DDR3, DDR4, DDR5, mobile DDR (mDDR), etc. The distributed datastore 644 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the distributed datastore 644 is illustrated as a single datastore, the distributed datastore 644 may be implemented by any number and/or type(s) of datastores. Furthermore, the data stored in the distributed datastore 644 may be in any data format such as, for example, binary data, comma delimited data, tab delimited data, structured query language (SQL) structures, etc.

In some examples, the metadata datastore 646, the raw datastore 648, and/or, more generally, the distributed datastore 644 may implement one or more databases. The term “database” as used herein means an organized body of related data, regardless of the manner in which the data or the organized body thereof is represented. For example, the organized body of related data may be in the form of one or more of a table, a map, a grid, a packet, a datagram, a frame, a model (e.g., an AI/ML model, a data graph model, etc.), a file, an e-mail, a message, a document, a report, a list or in any other form.

As used herein, data is information in any form that may be ingested, processed, interpreted and/or otherwise manipulated by processor circuitry to produce a result. The produced result may itself be data.

As used herein “threshold” is expressed as data such as a numerical value represented in any form, that may be used by processor circuitry as a reference for a comparison operation.

As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

While an example manner of implementing the ADM system 600 is illustrated in FIG. 6, one or more of the elements, processes, and/or devices illustrated in FIG. 6 may be combined, divided, re-arranged, omitted, eliminated, and/or implemented in any other way. Further, the logical entity 601, the ADM console 602, the data sources 604, the data ingestion manager 606, the pre-processing manager 608, the data query manager 610, the data query handler 612, the query cache cluster manager 614, the metadata cluster manager 616, the data publishing manager 618, the scheduler 620, the node manager 622, the preferred nodes table 624, the network plane 626, the data plane 628, the control plane 630, the data security manager 632, the AMR 634, the analytics manager 636, the algorithms 638, the metadata/data enrichment manager 640, the resource manager 642, the distributed datastore 644, the metadata datastore 646, the raw datastore 648, the interface 650, and/or, more generally, the ADM system 600 of FIG. 6, may be implemented by hardware alone or by hardware in combination with software and/or firmware. Thus, for example, any of the logical entity 601, the ADM console 602, the data sources 604, the data ingestion manager 606, the pre-processing manager 608, the data query manager 610, the data query handler 612, the query cache cluster manager 614, the metadata cluster manager 616, the data publishing manager 618, the scheduler 620, the node manager 622, the preferred nodes table 624, the network plane 626, the data plane 628, the control plane 630, the data security manager 632, the AMR 634, the analytics manager 636, the algorithms 638, the metadata/data enrichment manager 640, the resource manager 642, the distributed datastore 644, the metadata datastore 646, the raw datastore 648, the interface 650, and/or, more generally, the ADM system 600, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as Field Programmable Gate Arrays (FPGAs). Further still, the ADM system 600 of FIG. 6 may include one or more elements, processes, and/or devices in addition to, or instead of, those illustrated in FIG. 6, and/or may include more than one of any or all of the illustrated elements, processes and devices.

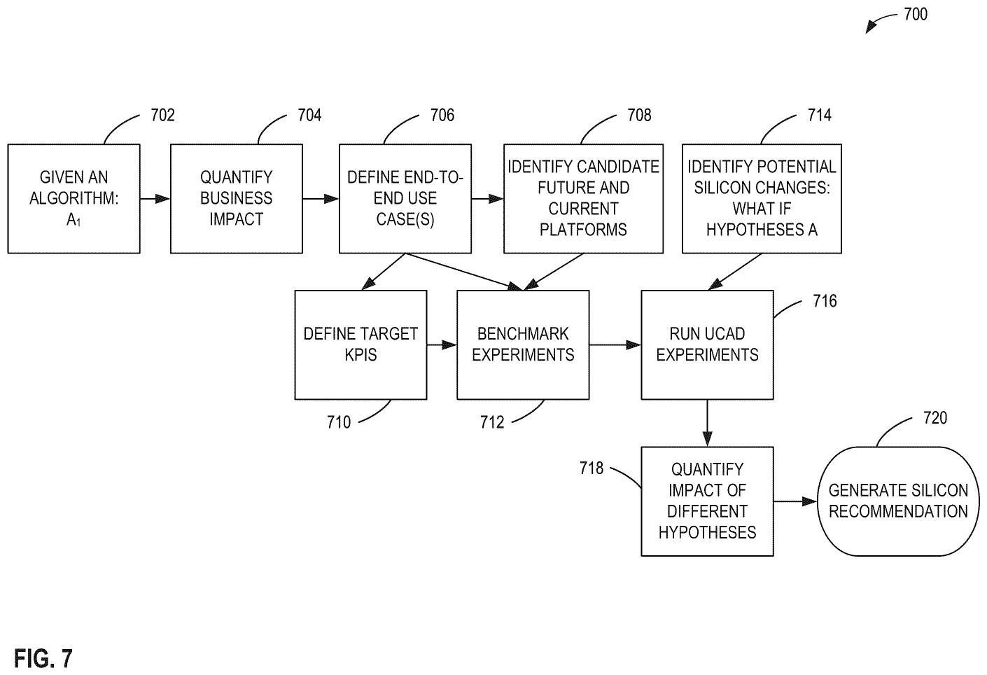

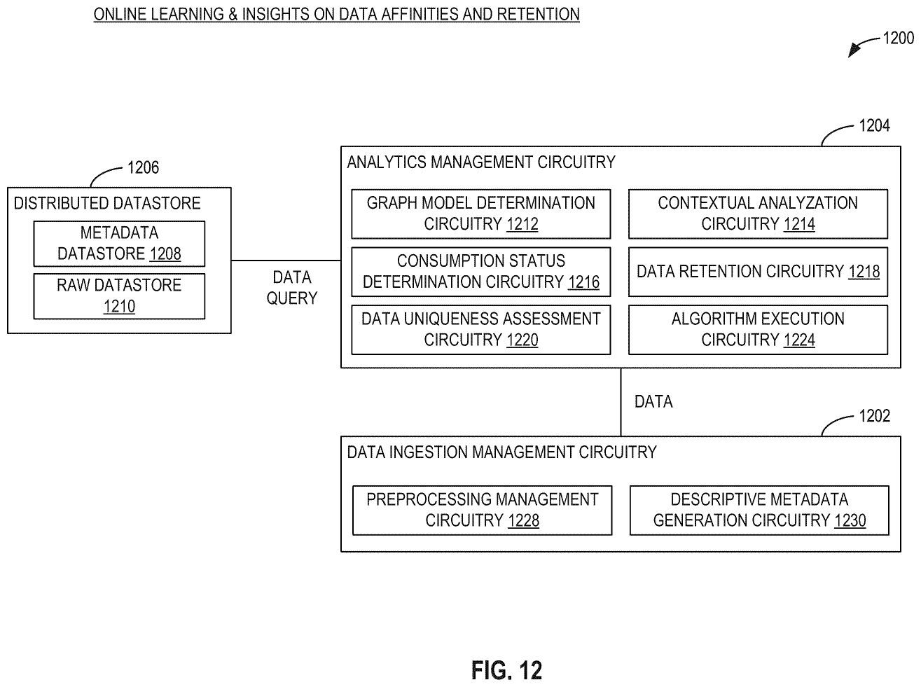

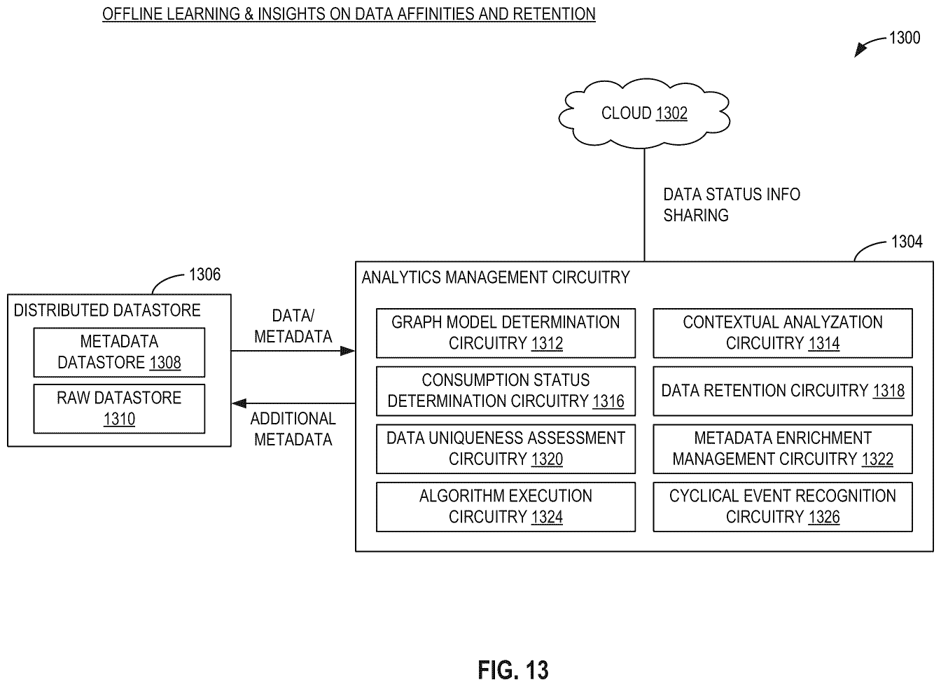

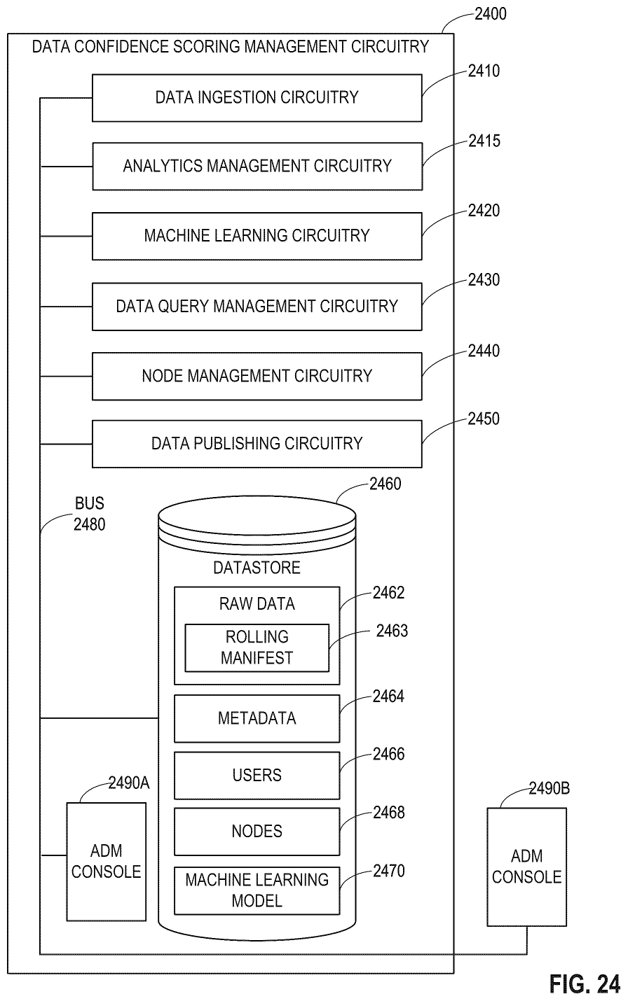

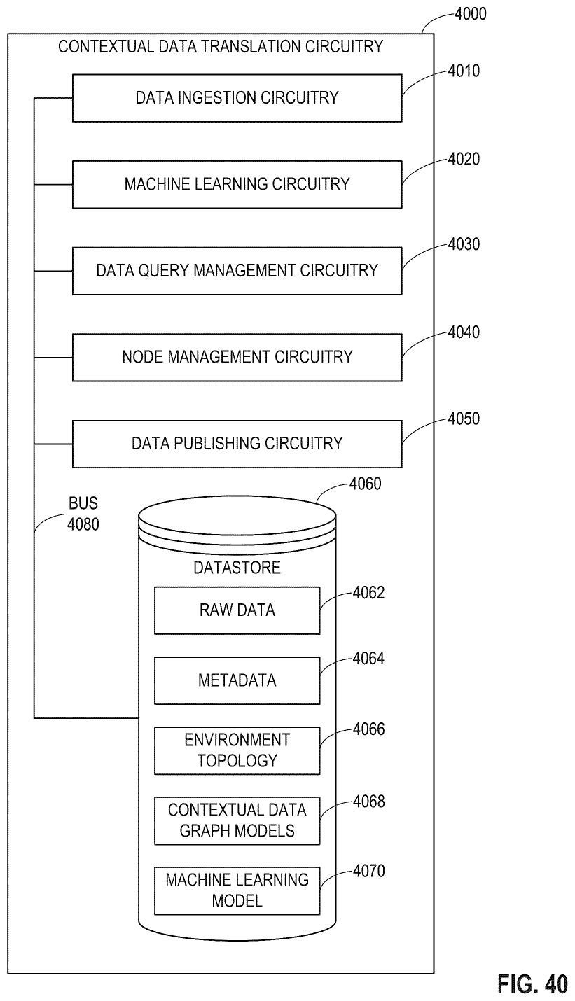

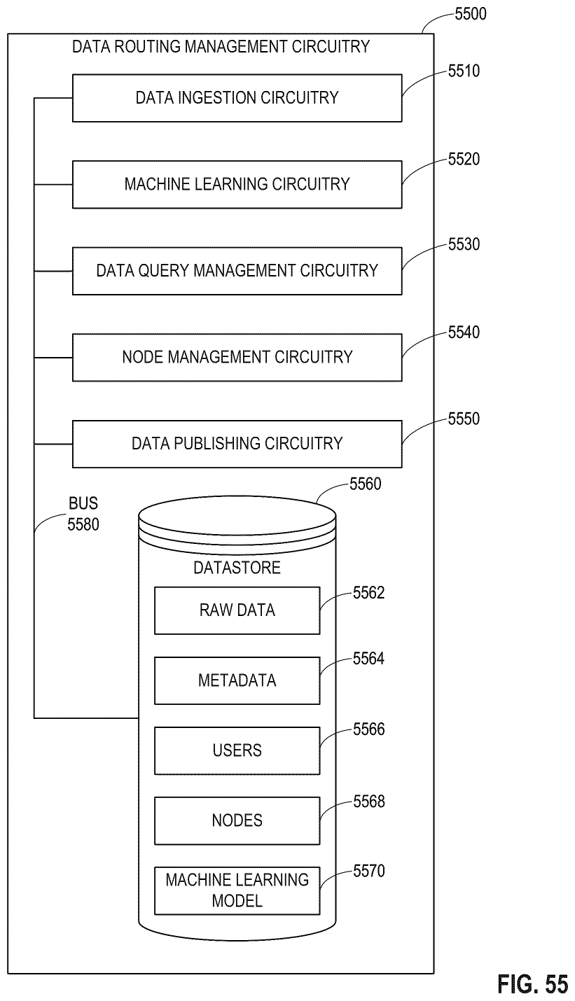

Flowcharts representative of example hardware logic circuitry, machine readable instructions, hardware implemented state machines, and/or any combination thereof for implementing the example ADM system 600 of FIG. 6, the first ADM system 210 of FIG. 12, the second ADM system 1300 of FIG. 13, the data value scoring circuitry 2400 of FIG. 24, the contextual data translation circuitry 4000 of FIG. 40, the data routing management circuitry 5500 of FIG. 55, and/or portion(s) thereof are shown in FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65. The machine readable instructions may be one or more executable programs or portion(s) of an executable program for execution by processor circuitry, such as the processor circuitry 1112, 2112, 3812, 5312, 6612 shown in the example processor platform(s) 1100, 2100, 3800, 5300, 6600 discussed below in connection with FIGS. 11, 21, 38, 53, 66. The program may be embodied in software stored on one or more non-transitory computer readable storage media such as a CD, a floppy disk, a hard disk drive (HDD), a solid-state drive (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65, many other methods of implementing the example ADM system 600 of FIG. 6, the first ADM system 210 of FIG. 12, the second ADM system 1300 of FIG. 13, the data value scoring circuitry 2400 of FIG. 24, the contextual data translation circuitry 4000 of FIG. 40, and/or the data routing management circuitry 5500 of FIG. 55 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 7 is a flowchart representative of example machine readable instructions and/or example operations 700 that may be executed and/or instantiated by processor circuitry to generate an example recommendation to integrate a hardware, software, and/or firmware feature in a semiconductor-based device (e.g., a silicon-based device). For example, the machine readable instructions and/or the operations 700 of FIG. 7 can be executed by the ADM system 600 of FIG. 6, or portion(s) thereof, or any other hardware, software, and/or firmware described herein.

The example machine readable instructions and/or the example operations 700 of FIG. 7 begin at block 702, at which a candidate algorithm (e.g., an AI/ML algorithm) is identified. At block 704, a business impact of the candidate algorithm may be quantified. At block 706, end-to-end use case(s) that may utilize the candidate algorithm are defined. At block 708, current and future candidate platforms that may be utilized for the end-to-end use case(s) may be identified. At block 710, target key performance indicators (KPIs) may be defined and technical benchmarking may be implemented at block 712. At block 714, potential changes to a semiconductor-based device may be identified and computer-aided design (e.g., CAD, UCAD, etc.) experiments may be conducted at block 716. At block 718, an impact of different hypotheses are quantified, which may result in generating a semiconductor-device based recommendation at block 720. For example, a recommendation to change (e.g., add, remove, and/or modify) hardware, software, and/or firmware associated with a semiconductor-based device may be generated at block 720. In some examples, the semiconductor-based device may be manufactured based on the recommendation. In some examples, the manufactured semiconductor-based device may execute and/or otherwise implement the candidate algorithm identified at block 702 using hardware, software, and/or firmware of the manufactured semiconductor-based device.

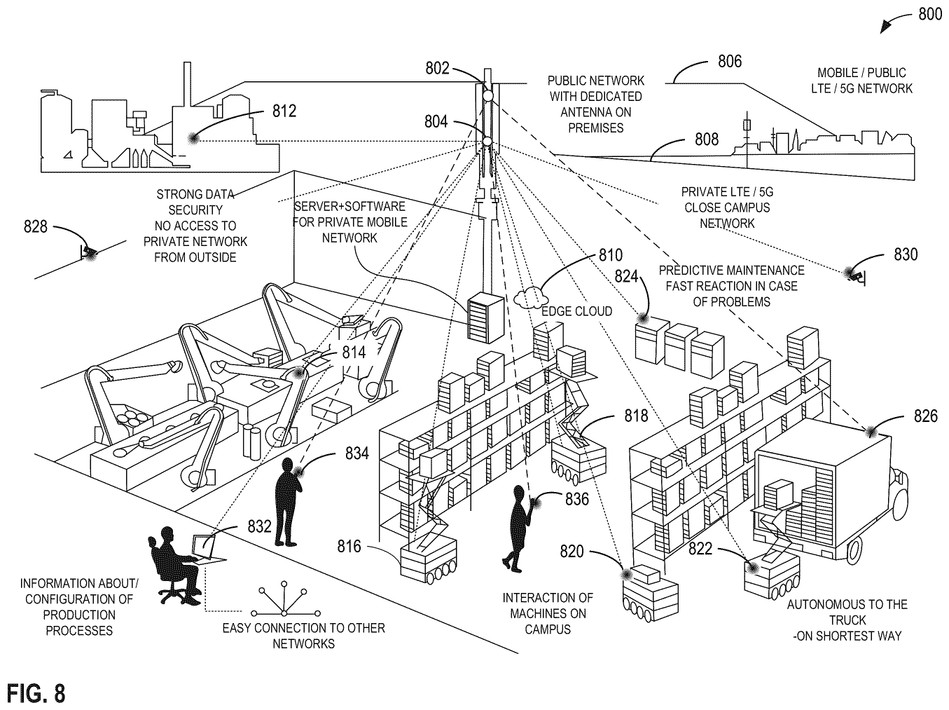

FIG. 8 is an illustration of an example edge network environment 800 including an example edge gateway 802 and an example edge switch 804 that may implement the ADM system 600 of FIG. 6 and/or otherwise as disclosed herein. In some examples, the edge gateway 802 and/or the edge switch 804 may implement resources of the edge devices layer 210 of FIG. 2. In some examples the edge gateway 802 and/or the edge switch 804 may implement the access point or base station 140 of FIG. 1, the local processing hub 150 of FIG. 1, and/or the nodes 215 of FIG. 2. For example, the edge gateway 802 and/or the edge switch 804 may implement the edge devices layer 210 of FIG. 2.

The edge network environment 800 of the illustrated example includes an example public network 806, an example private network 808, and an example edge cloud 810. In this example, the public network 806 may implement a telephone service provider (TSP) network (e.g., a Long-Term Evolution (LTE) network, a 5G network, a Telco network, etc.). For example, the public network 806 may implement the network access layer 220 of FIG. 2, the core network 230 of FIG. 2, and/or the cloud data center layer 240 of FIG. 2. In this example, the private network 808 may implement an enterprise network (e.g., a close campus network, a private LTE network, a private 5G network, etc.). For example, the private network 808 may implement the endpoint layer 200 of FIG. 2 and/or the edge devices layer 210 of FIG. 2. In some examples, the edge cloud 810 may be implemented by one or more hardware, software, and/or firmware resources. For example, the edge cloud 810 may be implemented by one or more computer servers. In this example, the edge cloud 810 may implement an enterprise edge cloud. For example, the edge cloud 810 may implement the edge cloud 110 of FIGS. 1, 2, and/or 3.

In the illustrated example of FIG. 8, the edge network environment 800 may implement a smart factory (e.g., a smart industrial factory), a process control environment, etc. For example, the edge network environment 800 may implement one(s) of the computational use cases 205 of FIG. 2, such as a manufacturing, smart building, logistics, vehicle, and/or video computational use cases.

The edge network environment 800 of the illustrated example includes an example process control system 812, example robots (e.g., collaborative robots, robot arms, etc.) 814, a first example industrial machine (e.g., an autonomous industrial machine) 816, a second example industrial machine 818, a third example industrial machine 820, a fourth example industrial machine 822, an example predictive maintenance system 824, an example vehicle (e.g., a truck, an autonomous truck, an autonomous vehicle, etc.) 826, a first example monitoring sensor 828, a second example monitoring sensor 830, and example endpoint devices 832, 834, 836. In some examples, the process control system 812 may include one or more industrial machines such as a silo, a smokestack, a conveyor belt, a mixer, a pump, etc., and/or a combination thereof. For example, the process control system 812 may implement the business and industrial equipment 163 of FIG. 1, the smart cities and building devices 166 of FIG. 1, etc.

In some examples, the robots 814 may implement hydraulic and/or electromechanical robots that may be configured to execute manufacturing tasks (e.g., lifting equipment, assembling components, etc.), industrial tasks, etc. For example, the robots 814 may implement the business and industrial equipment 163 of FIG. 1, the smart cities and building devices 166 of FIG. 1, etc. In some examples, the industrial machines 816, 818, 820, 822 are autonomous machines, such as AGVs, autonomous forklifts, scissor lifts, etc. For example, the industrial machines 816, 818, 820 may implement the business and industrial equipment 163 of FIG. 1, the drones 165 of FIG. 1, the smart cities and building devices 166 of FIG. 1, etc. In some examples, the predictive maintenance system 824 may implement one or more computing devices, servers, etc., that identify maintenance alerts, fault predictions, etc., associated with equipment of the edge network environment 800 based on sensor data (e.g., prognostic health data). For example, the predictive maintenance system 824 may implement the business and industrial equipment 163 of FIG. 1, the smart cities and building devices 166 of FIG. 1, the sensors and IoT devices 167 of FIG. 1, etc.

In some examples, the vehicle 826 may implement one of the autonomous vehicles 161 of FIG. 1. In some examples, the first monitoring sensor 828 and/or the second monitoring sensor 830 are video cameras. For example, the first monitoring sensor 828 and/or the second monitoring sensor 830 may implement the business and industrial equipment 163 of FIG. 1, the video capture devices 164 of FIG. 1, the smart cities and building devices 166 of FIG. 1, the sensors and IoT devices 167 of FIG. 1, etc. Alternatively, the first monitoring sensor 828 and/or the second monitoring sensor 830 may implement a thermal camera (e.g., an infrared camera), an air pollution sensor, a carbon dioxide sensor, a temperature sensor, a humidity sensor, an air pressure sensor, etc., or any other type of sensor.

In this example, the endpoint devices 832, 834, 836 include a first example endpoint device 832, a second example endpoint device 834, and a third example endpoint device 836. In some examples, one(s) of the endpoint devices 832, 834, 836 may implement consumer computing devices, user equipment, etc. For example, one or more of the endpoint devices 832, 834, 836 may implement the user equipment 162 of FIG. 1. In some examples, one or more of the endpoint devices 832, 834, 836 may be implemented by a smartphone, a tablet computer, a desktop computer, a laptop computer, a wearable device (e.g., a headset or headset display, an augmented reality (AR) headset, a smartwatch, smart glasses, etc.), etc.

In the illustrated example of FIG. 8, the edge gateway 802 may facilitate communication, data transfers, etc., between different networks, such as communication from a source service, a source appliance, etc., of the public network 806 to a target service, a target appliance, etc., of the private network 808. For example, the edge gateway 802 may receive a data stream including one or more data packets from a source (e.g., a data source), a producer (e.g., a data producer), etc. In some examples, the edge gateway 802 may receive the data stream from the vehicle 826, the second endpoint device 834, the third endpoint device 836, etc., to be transmitted to a target service, a target appliance, etc., which may be implemented by the cloud data center 130 of FIG. 1, the cloud data center 245 of FIG. 2, the cloud or data center 360 of FIG. 3, etc.

In some examples, the edge gateway 802 may facilitate communication, data transfers, etc., between a source service, a source appliance, etc., of the private network 808 to a target service, a target appliance, etc., of the public network 806. For example, the edge gateway 802 may receive a data stream including one or more data packets from a source (e.g., a data source), a producer (e.g., a data producer), etc., which may be implemented by the cloud data center 130 of FIG. 1, the cloud data center 245 of FIG. 2, the cloud or data center 360 of FIG. 3, etc. In some examples, the edge gateway 802 may receive the data stream from the cloud data center 130 of FIG. 1, the cloud data center 245 of FIG. 2, the cloud or data center 360 of FIG. 3, etc., to be transmitted to the vehicle 826, the second endpoint device 834, the third endpoint device 836, etc.

In the illustrated example of FIG. 8, the edge switch 804 may facilitate communication, data transfers, etc., between different sources and targets within a network, such as communication from a source service, a source appliance, etc., of the private network 808 to a target service, a target appliance, etc., of the private network 808. For example, the edge switch 804 may receive a data stream from the edge gateway 802, the edge cloud 810, the process control system 812, one(s) of the robots 814, one(s) of the industrial machines 816, 818, 820, 822, the predictive maintenance system 824 (or sensor(s) thereof), the first monitoring sensor 828, the second monitoring sensor 830, the first endpoint device 832, the second endpoint device 834, the third endpoint device 836, etc. In some examples, the edge switch 804 may transmit the data stream to a destination within the private network 808. For example, the edge switch 804 may transmit the data stream to at least one of the edge gateway 802, the edge cloud 810, the process control system 812, one(s) of the robots 814, one(s) of the industrial machines 816, 818, 820, 822, the predictive maintenance system 824 (or sensor(s) thereof), the vehicle 826, the first monitoring sensor 828, the second monitoring sensor 830, the first endpoint device 832, the second endpoint device 834, or the third endpoint device 836.

In some examples, the edge gateway 802 and/or the edge switch 804 may implement adaptive data management based on global observability at the edge, which may be implemented by the edge network environment 800 or portion(s) thereof. In some examples, the edge network environment 800 may implement a large number and/or different types of applications, such as machine vision applications implemented by the robots 814, autonomous driving applications implemented by the vehicle 826, etc. In some examples, the data generated by the private network 808 is relatively diverse because of the vast range of data sources, such as sensors, controllers, services, and/or user input that may be processed and analyzed to identify anomalies and trends in the data. For example, the edge gateway 802 and/or the edge switch 804 may facilitate the transmission of data including sensor data or measurements, video feeds, still images, predictive maintenance alerts or control commands, robotic control commands, etc., and/or a combination thereof.

In some examples, the edge gateway 802 and/or the edge switch 804 may transfer data to components of the ADM system 600 of FIG. 6 to execute one(s) of the algorithms 638 to implement ADM as disclosed herein. In some examples, the edge gateway 802 and/or the edge switch 804 may execute the one(s) of the algorithms 638 to implement ADM as disclosed herein. In some examples, there are a plurality of the edge gateways 802 and/or a plurality of the edge switches 804 in the edge network environment 800. The algorithms 638 may be executed in multiple places of the edge network environment 800 (e.g., by ones of the edge gateways 802, the edge switches 804, etc., or any other device(s)). In some examples, the different ones of the edge gateways 802, the edge switches 804, etc., may have more or less observability based on the data that they process and/or otherwise encounter. Accordingly, two different ones of the devices of FIG. 8 may develop, train, and/or otherwise generate different one(s) of the algorithms 638 based on the data processed by each of the different ones of the devices. For example, a first one of the edge switches 804 may observe 10% of the edge network environment 800 and a second one of the edge switches 804 may observe 90% of the edge network environment 800, which may become the basis for the differences in data outputs generated by the algorithms 638 executed by the first and second one of the devices. In some examples, the first one of the devices may transmit and/or otherwise propagate data outputs from its execution of the algorithms 638 to the second one of the devices. In some examples, the second one of the devices may transmit and/or otherwise propagate model outputs from its execution of the algorithms 638 to the first one of the devices for cross-training and/or cross-correlation of the algorithms 638.

In some examples, data generated by the private network 808 may be immense. In some examples, a data source, such as the process control system 812, one(s) of the robots 814, one(s) of the industrial machines 816, 818, 820, 822, the predictive maintenance system 824 (or sensor(s) thereof), the vehicle 826, the first monitoring sensor 828, the second monitoring sensor 830, the first endpoint device 832, the second endpoint device 834, and/or the third endpoint device 836, may have insufficient computing resources (e.g., one or more processors, one or more accelerators, one or more memories, one or more mass storage discs, etc.) to analyze the data generated by the data source. In some examples, the data source may be unable to identify redundant data, less important or less significant data, etc., due to insufficient computing resources and therefore may flood the private network 808 with a significant quantity of data at relatively short intervals. Advantageously, the edge gateway 802, the edge switch 804, and/or, more generally, the ADM system 600 of FIG. 6, may implement ADM as disclosed herein to process data based on at least one of a content and/or a context of the data.

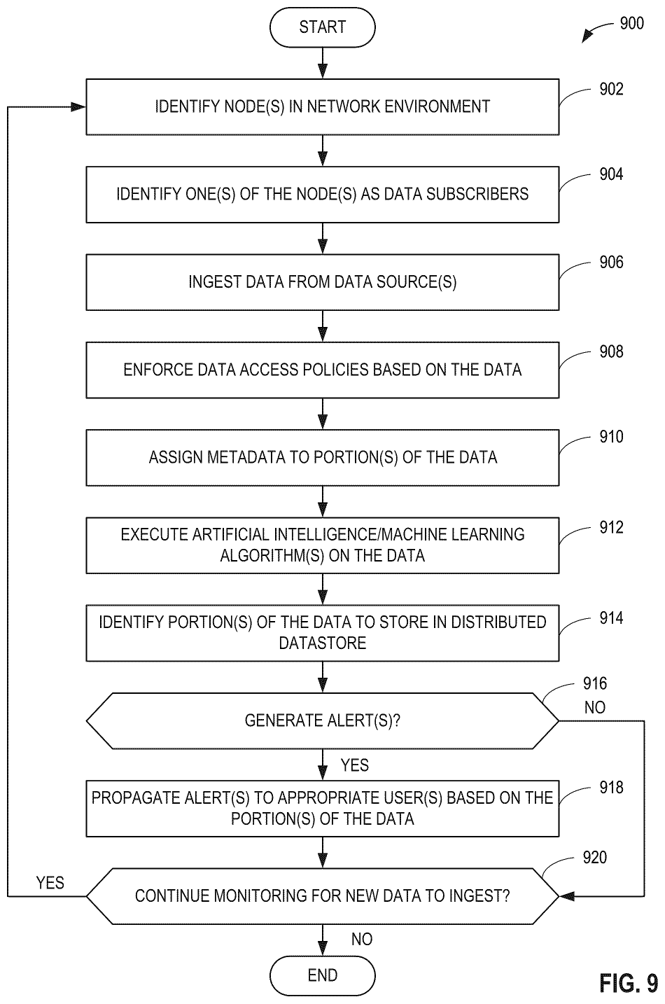

FIG. 9 is a flowchart representative of example machine readable instructions and/or example operations 900 that may be executed and/or instantiated by processor circuitry to implement ADM as disclosed herein. The example machine readable instructions and/or the example operations 900 of FIG. 9 begin at block 902, at which the ADM system 600 of FIG. 6 identifies node(s) in a network environment.

At block 904, the ADM system 600 identifies one(s) of the node(s) as data subscribers. For example, the node manager 622 can identify one or more nodes based on the preferred nodes table 624. In some examples, the data publishing manager 618 can identify one(s) of the one or more nodes as subscribing for data updates, alerts, indications, etc. In some examples, the data publishing manager 618 can consult the scheduler 620 to determine which one(s) of the one or more nodes are data subscribers.

At block 906, the ADM system 600 ingests data from data source(s). For example, the data ingestion manager 606 can obtain data from the data sources 604. In some examples, the pre-processing manager 608 can pre-process the ingested data.

At block 908, the ADM system 600 enforces data access policies based on the data. For example, the data security manager 632 can enforce the access policies. In some examples, the data security manager 632 can implement one or more security operations in connection with a data requester, data that is being requested, access to components of the ADM system 600, etc., and/or combination(s) thereof based on the access policies.

At block 910, the ADM system 600 assigns metadata to portion(s) of the data. For example, the metadata/data enrichment manager 640 can add, remove, and/or modify metadata associated with portion(s) of the data. In some examples, the metadata/data enrichment manager 640 can store the metadata in the metadata datastore 646.

At block 912, the ADM system 600 executes Artificial Intelligence/Machine-Learning algorithm(s) on the data. For example, the AMR 634 can identify one(s) of the algorithms 638 to apply to the data. In some examples, the analytics manager 636 can execute the identified one(s) of the algorithms 638 on the data, or portion(s) thereof, to implement data classification, clustering, etc., operation(s) to generate recommendations, identify action(s) to carry out, generate alert(s), etc., and/or combination(s) thereof.

At block 914, the ADM system 600 identifies portion(s) of the data to store in a distributed datastore. For example, the data ingestion manager 606 can identify portion(s) of the ingested data to be stored in the raw datastore 648 (e.g., record in cold storage, hot storage, etc.). In some examples, the data ingestion manager 606 can consult the data query manager 610 and/or the analytics manager 636 to determine whether portion(s) of the data is/are to be stored in the distributed datastore 644.

At block 916, the ADM system 600 determines whether to generate alert(s). For example, the AMR 634 can invoke the analytics manager 636 to execute one(s) of the algorithms 638 to determine whether an alert is to be generated. In some examples, the alert can be a predictive alert associated with an event yet to occur, an immediate alert associated with an imminent or ongoing event, etc., and/or combination(s) thereof.

If, at block 916, the ADM system 600 determines not to generate an alert, control proceeds to block 920 to determine whether to continue monitoring for new data to ingest, otherwise control proceeds to block 918 to propagate alert(s) to appropriate user(s) based on the portion(s) of the data. For example, the data publishing manager 618 can identify one or more users, one or more devices associated with the one or more users, etc., to which alert(s) is/are to be propagated, distributed, and/or otherwise provided to.

At block 920, the ADM system 600 determines whether to continue monitoring for new data to ingest. If, at block 920, the ADM system 600 determines to continue monitoring for new data to ingest, control returns to block 902, otherwise the example machine readable instructions and/or the operations 900 of FIG. 9 conclude.

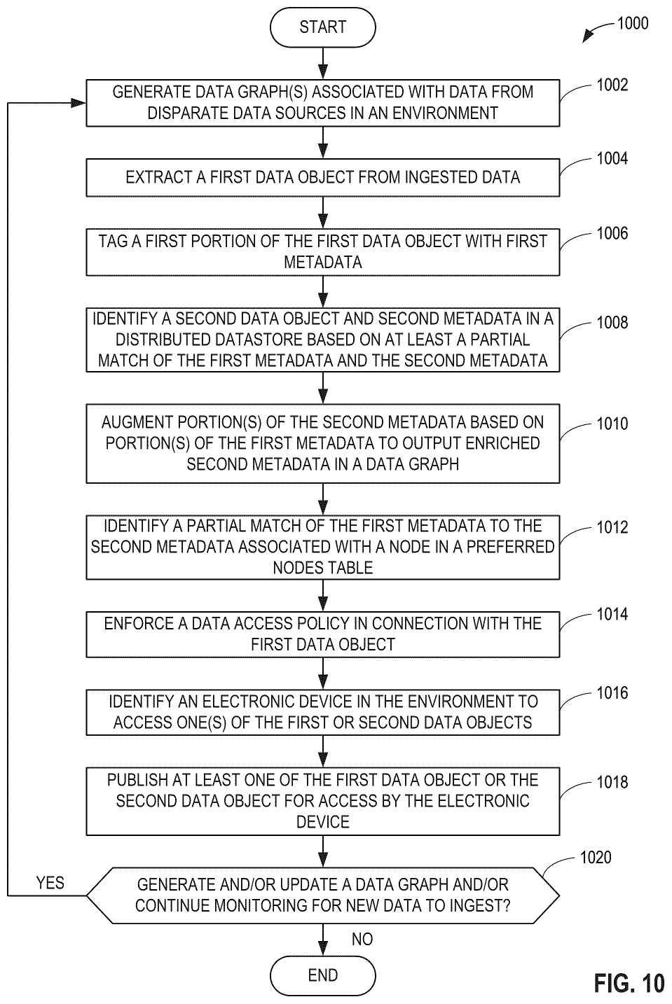

FIG. 10 is a flowchart representative of example machine readable instructions and/or example operations 1000 that may be executed and/or instantiated by processor circuitry to implement ADM as disclosed herein. The example machine readable instructions and/or the example operations 1000 of FIG. 10 begin at block 1002, at which the ADM system 600 of FIG. 6 generates data graph(s) associated with data from disparate data sources in an environment. For example, the analytics manager 636 can instantiate, invoke, etc., the one(s) of the algorithms 638 to generate a new data graph (e.g., a data graph model, a contextual data graph model, etc.) based on data (e.g., control data, sensor data, corporate and/or organizational data, etc., from one(s) of the data sources 604 of FIG. 6 that may be of different types) in an environment (e.g., the edge network environment 800 of FIG. 8) and/or identify an existing data graph based on the data as described herein. In some examples, the analytics manager 636 can instantiate, invoke, etc., one(s) of the algorithms 638 to identify one or more portions of the data to be stored in a datastore, such as the distributed datastore 644, as described herein. For example, the analytics manager 636 can determine to store the one or more portions of the data in hot storage, warm storage, or cold storage based on a data retention policy, which may be implemented using output(s) from the one(s) of the algorithms 638, as described herein. For example, the analytics manager 636 can use the one(s) of the algorithms 638 to predict at least one of an access frequency or a use frequency of the first data object by user(s) of the environment based on a data retention policy. In some examples, the analytics manager 636 can cause storage of the first data object in hot storage, warm storage, or cold storage based on the data retention policy.

In some examples, the analytics manager 636 obtains metadata from the metadata datastore 646 using the data plane 628 to be utilized in a generation of a data graph. The metadata can include one or more second portions of second metadata associated with a second data object and one or more third portions of third metadata associated with a third data object. In some examples, the third metadata includes one or more of the portion(s) of the second metadata. In some examples, the second metadata and the third metadata are associated with each other based on the portion(s) of the second metadata that are included in the second metadata and the third metadata. In some examples, the analytics manager 636 obtains the second data object from the raw datastore 648 using the data plane 628. In some examples, the analytics manager 636 generates a primary data graph node based on the second data object. For example, the second data object, or an identifier or reference to the second data object, can be the primary data graph node. In some examples, the analytics manager 636 generates a first strength vector to connect the primary data graph node to portion(s) of the second metadata. In some examples, the analytics manager 636 generates a second strength vector to connect the primary data graph node to portion(s) of the third metadata. In some examples, the analytics manager 636 generates the data graph based on at least one of the primary data graph node, the first strength vector, and the second strength vector. In some examples, the analytics manager 636 stores the data graph in the distributed datastore 644.

In some examples, the first data object includes a first lexical term and the second data object includes a second lexical term. In some examples, the analytics manager 636 is to, in response to a determination that a strength of a vector (e.g., the first strength vector, the second strength vector, etc.) in the data graph to connect a first portion of the first metadata to a second portion of the second metadata satisfies a threshold, generate an association of the first lexical term and the second lexical term. In some examples, the analytics manager 636 can cause storage of the association in the distributed datastore 644. For example, the association can be accessed by electronic devices in the environment or a different environment.

At block 1004, the ADM system 600 extracts a first data object from ingested data. For example, the data ingestion manager 606 can ingest data, which can include one or more data objects, from one(s) of the data sources 604 as described herein. In some examples, the data object can be a data file (e.g., a manufacturing report associated with a completion of an assembly, a supply chain purchase order, a spreadsheet, etc.), a sensor data object (e.g., data describing a controller that generated data, data representative of a sensor and a sensor measurement sensed by the sensor, etc.), etc., and/or any combination(s) thereof as described herein.

In some examples, the first data object is a first instance of the data object. In some examples, the data ingestion manager 606 and/or the data query manager 610 locate a second instance of the first data object in the raw datastore 648 of the distributed datastore 644. In some examples, the first instance has one or more first values and the second instance to have one or more second values. In some examples, the analytics manager 636 can determine whether a correlation error based on a comparison of the one or more first values and the one or more second values satisfies a threshold. In some examples, the analytics manager 636, in response to a determination that the correlation error satisfies the threshold, can apply an error correction value to the first instance to reduce the correlation error, and expire the second instance. For example, the raw datastore 648 can age, expire, and/or otherwise cause the second instance to be removed from the environment immediately or over a period of time.

At block 1006, the ADM system 600 tags a first portion of the first data object with first metadata. For example, the data ingestion manager 606 and/or the data query manager 610 can tag a portion of the first data object with first metadata based on an environment of the one(s) of the data sources 604 and/or a type of one(s) of the data sources 604 that generated the first data object as described herein.

At block 1008, the ADM system 600 identifies a second data object and second metadata in a distributed datastore based on at least a partial match of the first metadata and the second metadata. For example, the data query manager 610 and/or the analytics manager 636 can identify a match (e.g., a partial match, a complete match, a substantial match, etc.) of first portion(s) of the first metadata to second portion(s) of second metadata. In some examples, the metadata datastore 646 can store the second metadata and association(s) of the second metadata with a second data object. In some examples, the raw datastore 648 can store the second data object. In some examples, the first portion and the second portion may be coupled and/or otherwise graphically connected or linked in a data graph as described herein.

In some examples, the first strength vector has a vector length and an angle with respect to a reference axis. For example, the vector length can be representative of a strength of association between the one of the one or more second portions of the second metadata and the second data object. In some examples, the first angle can be representative of a first probability that a first event associated with the one of the one or more second portions of the second metadata is to precede or follow a second event associated with the second data object.

At block 1010, the ADM system 600 augments portion(s) of the second metadata based on portion(s) of the first metadata to output enriched second metadata in a data graph. For example, the analytics manager 636 can direct, instruct, and/or otherwise cause the metadata/data enrichment manager 640 to augment the second metadata by adding and/or otherwise connecting one(s) of the first portion(s) of the first metadata to one(s) of the second portion(s) of the second metadata in a data graph (e.g., a data graph including connection(s) to link the first metadata and the second metadata). In some examples, the metadata/data enrichment manager 640 can augment the second metadata by writing and/or otherwise including the one(s) of the first portion(s) of the first metadata into one or more data entries of the second metadata. In some examples, the metadata/data enrichment manger 640 can enrich the second metadata in response to execution of one or more machine learning models with the first data object, the second data object, the first metadata, and/or the second metadata as data input(s) to the one or more machine learning models. In some examples, the metadata/data enrichment manager 640 can enrich the second metadata by removing and/or otherwise deleting portion(s) of the first metadata from the second metadata. In some examples, the metadata/data enrichment manager 640 can enrich the second metadata by removing and/or otherwise deleting portion(s) of the second metadata that is/are determined to not be as relevant as once determined and/or observed, not useful for determining decisions, outputs, etc., and/or any combination(s) thereof. Advantageously, the metadata/data enrichment manager 640 can make subsequent queries for the first data object, the second data object, etc., more enriching and/or otherwise more relevant or useful to a data requester by identifying other data object(s) that have strong or substantially relevant association(s) to the first data object, the second data object, etc., by linking the one(s) of the first portion(s) of the first metadata to one(s) of the second portion(s) of the second metadata.

At block 1012, the ADM system 600 identifies a partial match of the first metadata to the second metadata associated with a node in a preferred nodes table. For example, the analytics manager 636 can identify a match, such as a partial match, of the first metadata to second metadata associated with a node, such as the first endpoint device 832, or a user associated thereof. In some examples, the analytics manager 636 can provide the identification of the node to the node manager 622. In some examples, the node manager 622 can search and/or query the preferred nodes table 624 to determine whether the node is included in the preferred nodes table 624.

At block 1014, the ADM system 600 enforces a data access policy in connection with the first data object. For example, the data security manager 632 can determine that the second metadata includes a description of, a pointer to, a reference to, etc., a data access policy as described herein. In some examples, the data security manager 632 can determine whether the node identified by the second metadata is allowed access to the first data object (and/or similar or other relevant data to the first data object) based on the data access policy as described herein. In response to a determination by the data security manager 632 that the node does not have access to the first data object based on the data access policy, the data security manager 632 can enforce the data access policy by denying the node access to the first data object. For example, the data security manager 632 can instruct the data query manager 610 to deny the node access to the first data object as described herein. In some examples, the data security manager 632 can direct the data publishing manager 618 to not publish the first data object for access by the node. In some examples, in response to a determination that the node has access to the first data object based on the data access policy, the data security manager 632 can enforce the data access policy causing the first data object to be published for access by the node. For example, the data security manager 632 can instruct the data query manager 610 to grant the node access to the first data object as described herein. In some examples, the data publishing manager 618 can publish the first data object for access by the node as described herein. For example, the data publishing manager 618 can encrypt the first data object using an encryption key that the node possesses as described herein.

At block 1016, the ADM system 600 identifies an electronic device in the environment to access one(s) of the first or second data objects. For example, the node manager 622 can search the metadata datastore 646 using the second metadata as search input(s) to identify one or more electronic devices as search output(s) or result(s). In some examples, the node manager 622 can search the preferred nodes table 624 using the second metadata as search input(s) to identify one or more electronic devices as search output(s) or result(s). For example, the node manager 622 can identify an electronic device, such as the first endpoint device 832, referenced by the second metadata.

At block 1018, the ADM system 600 publishes at least one of the first data object or a second data object for access by the electronic device. For example, the data publishing manager 618 can publish at least one of the first data object or the second data object for access by the first endpoint device 832.

In some examples, the analytics manager 636 can identify one or more nodes representative of logical entities in the environment based on the data graph. For example, the analytics manager 636 can identify the one or more nodes based on a relevancy score associated with the one or more nodes and the first data object. In some examples, the node manager 622 can determine whether the one or more nodes are included in the preferred nodes table 624. In some examples, the data publishing manager 618 can publish the first data object for access by the one or more nodes in response to a determination that the one or more nodes are included in the preferred nodes table 624. In some examples, a score can be implemented using data. For example, the score may itself be data. For example, the score can be implemented using a value (e.g., a binary value, an alphanumeric value, etc.) that may be stored in a mass storage device, memory, etc. In some examples, a score can be implemented using any type of mathematical representation. For example, a score can be a probability or likelihood having a value in a particular range, such as from 0 to 1 (or any other range of values). In some examples, a score can be a value from a distribution, such as a probability distribution, a normal distribution, a logarithmic distribution, etc., or any other type of distribution. In some examples, a score can be a mathematical representation such as a ratio, a proportion, a percentage, a fraction, etc., or any other type of mathematical representation to describe a relationship between two components, elements, etc.

At block 1020, the ADM system 600 determines whether to generate and/or update a data graph and/or continue monitoring for new data to ingest. For example, the data ingestion manager 606 can determine whether to continue monitoring for data (e.g., new data including one or more data objects) that is created, generated, and/or otherwise made available by the one(s) of the data sources 604 as described herein. In some examples, the analytics manager 636 can determine whether to generate a new data graph and/or update an existing data graph based on feedback data (e.g., a user acknowledging a relevancy of the first and/or second data object presented to the user, an event that occurred after a publishing of the first and/or second data object, etc., and/or any combination(s) thereof. If, at block 1020, the ADM system 600 determines to generate and/or update a data graph and/or continue monitoring for new data to ingest at block 1020, control returns to block 1002, otherwise the example machine readable instructions and/or the example operations 1000 of FIG. 10 conclude.

FIG. 11 is a block diagram of an example processor platform 1100 structured to execute and/or instantiate the machine readable instructions and/or the operations of FIGS. 7, 9, and/or 10 to implement the ADM system 600 of FIG. 6. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an IoT device, an IPU, or any other type of computing and/or electronic device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example data ingestion manager 606, the example data query manager 610, the example data publishing manager 618, the example node manager 622, the example data security manager 632, the example algorithm manager 634, and the example analytics manager 636.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. In some examples, the bus 1118 may implement the data plane 628, the control plane 630, and/or, more generally, the network plane 626, of FIG. 6. The volatile memory 1114 may be implemented by SDRAM, DRAM, RDRAM®, and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a USB interface, a Bluetooth® interface, an NFC interface, a PCI interface, and/or a PCIe interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 1128 implement the distributed datastore 644, which includes the example metadata datastore 646 and the example raw datastore 648 of FIG. 6.

The machine executable instructions 1132, which may be implemented by the machine readable instructions of FIGS. 7, 9, and/or 10, may be stored in the mass storage device 1128, in the volatile memory 1114, in the non-volatile memory 1116, and/or on a removable non-transitory computer readable storage medium such as a CD or DVD.

The processor platform 1100 of the illustrated example of FIG. 11 includes example acceleration circuitry 1140, which includes an example GPU 1142, an example vision processor unit (VPU) 1144, and an example neural network processor 1146. In this example, the GPU 1142, the VPU 1144, the neural network processor 1146, and/or, more generally, the acceleration circuitry 1140, are in communication with different hardware of the processor platform 1100, such as the volatile memory 1114, the non-volatile memory 1116, etc., via the bus 1118. In this example, the neural network processor 1146 may be implemented by one or more integrated circuits, logic circuits, microprocessors, GPUs, DSPs, or controllers from any desired family or manufacturer that can be used to execute an AI/ML model, such as a neural network. In some examples, one or more of the example data ingestion manager 606, the example data query manager 610, the example data publishing manager 618, the example node manager 622, the example data security manager 632, the example algorithm manager 634, and/or the example analytics manager 636 can be implemented in or with at least one of the GPU 1142, the VPU 1144, the neural network processor 1146, and/or, more generally, the acceleration circuitry 1140, instead of or in addition to the processor circuitry 1112.

Example methods, apparatus, systems, and articles of manufacture for proactive data management and analytics are disclosed herein. Further examples and combinations thereof include the following:

Example 1 includes a system for proactive data management, the system comprising a data ingestion manager to extract a first data object from ingested data, the ingested data to be generated by one or more data sources in an environment, the one or more data sources including at least one of autonomous equipment, a sensor, or a first electronic device associated with a first user, a data query manager to tag a first portion of the first data object with first metadata, the first metadata based on at least one of the environment or a type of a first one of the one or more data sources that generated the first data object, a distributed datastore to store a second data object and second metadata, the second data object linked to the second metadata in a data graph, an analytics manager to identify the second data object based on at least a partial match of the first metadata to the second metadata, and augment one or more second portions of the second metadata based on one or more first portions of the first metadata to output enriched second metadata in the data graph, a node manager to identify a second electronic device in the environment, the second electronic device represented by a node in a preferred nodes table, the node to be identified based on the enriched second metadata, and a data publishing manager to publish at least one of the first data object or the second data object for access by the second electronic device, the second electronic device associated with the first user or a second user in the environment.

In Example 2, the subject matter of Example 1 can optionally include that the analytics manager is to at least one of identify the second data object or enrich the second data object in response to execution of one or more machine learning models with the first data object as a data input to the one or more machine learning models.

In Example 3, the subject matter of Examples 1-2 can optionally include a data security manager to identify a data access policy corresponding to the second metadata, determine whether the second user has access to the first data object based on the data access policy, and in response to a determination that the second user does not have access to the first data object based on the data access policy, deny the second electronic device access to the first data object.

In Example 4, the subject matter of Examples 1-3 can optionally include that the data security manager is to, in response to a determination that the second user has access to the first data object based on the data access policy, permit the data publishing manager to publish the first data object for access by the second electronic device.

In Example 5, the subject matter of Examples 1-4 can optionally include that the distributed datastore includes a metadata datastore and a raw datastore, and the analytics manager is to obtain the second metadata and third metadata from the metadata datastore via a data plane, the third metadata including at least one of the one or more second portions of the second metadata, obtain the second data object from the raw datastore via the data plane, generate a primary data graph node based on the second data object, generate a first strength vector to connect the primary data graph node to the at least one of the one or more second portions of the second metadata, generate a second strength vector to connect the primary data graph node to one of one or more third portions of the third metadata, generate the data graph based on at least one of the primary data graph node, the first strength vector, and the second strength vector, and store the data graph in the distributed datastore.

In Example 6, the subject matter of Examples 1-5 can optionally include that the first strength vector has a vector length and an angle with respect to a reference axis, the vector length represented by a strength of association between the at least one of the one or more second portions of the second metadata and the second data object, the angle represented by a first probability that a first event associated with the at least one of the one or more second portions of the second metadata is to precede or follow a second event associated with the second data object.

In Example 7, the subject matter of Examples 1-6 can optionally include that the analytics manager is to instantiate a machine learning microservice to predict at least one of an access frequency or a use frequency of the first data object by at least one of the first user or the second user based on a data retention policy, and store the first data object in hot storage, warm storage, or cold storage based on the data retention policy.

In Example 8, the subject matter of Examples 1-7 can optionally include that the first data object is a first instance of the first data object with one or more first values, and the analytics manager is to locate a second instance of the first data object in a raw datastore of the distributed datastore, the second instance to have one or more second values, determine whether a correlation error based on a comparison of the one or more first values and the one or more second values satisfies a threshold, and in response to a determination that the correlation error satisfies the threshold apply an error correction value to the first instance to reduce the correlation error, and expire the second instance.

In Example 9, the subject matter of Examples 1-8 can optionally include that the environment is a first environment, the first data object includes a first lexical term, the second data object includes a second lexical term, and the analytics manager is to generate an association of the first lexical term and the second lexical term in response to a determination that a strength of a vector in the data graph satisfies a threshold, the vector to connect a first portion of the first metadata to a second portion of the second metadata, and store the association in the distributed datastore, the association to be accessible by the second electronic device in the first environment or a third electronic device in a second environment.

In Example 10, the subject matter of Examples 1-9 can optionally include that the analytics manager is to identify, based on the data graph, one or more nodes in the preferred nodes table, the one or more nodes to be represented by logical entities in the environment, the one or more nodes to be identified based on a relevancy score associated with the one or more nodes and the first data object, the node manager is to determine whether the one or more nodes are included in the preferred nodes table, and the data publishing manager is to publish the first data object for access by the one or more nodes in response to a determination that the one or more nodes are in the preferred nodes table.

Example 11 includes an apparatus comprising at least one memory, instructions, and processor circuitry to at least one of execute or instantiate the instructions to extract a first data object from ingested data, the ingested data to be generated by one or more data sources in an environment, the one or more data sources including at least one of autonomous equipment, a sensor, or a first electronic device associated with a first user, tag a first portion of the first data object with first metadata, the first metadata based on at least one of the environment or a type of a first one of the one or more data sources that generated the first data object, store a second data object and second metadata in a distributed datastore, the second data object linked to the second metadata in a data graph, identify the second data object based on at least a partial match of the first metadata to the second metadata, augment one or more second portions of the second metadata based on one or more first portions of the first metadata to output enriched second metadata in the data graph, identify a second electronic device in the environment, the second electronic device represented by a node in a preferred nodes table, the node to be identified based on the enriched second metadata, and publish at least one of the first data object or the second data object for access by the second electronic device, the second electronic device associated with the first user or a second user in the environment.

In Example 12, the subject matter of Example 11 can optionally include that the processor circuitry is to at least one of execute or instantiate the instructions to at least one of identify the second data object or enrich the second data object in response to execution of one or more machine learning models with the first data object as a data input to the one or more machine learning models.

In Example 13, the subject matter of Examples 11-12 can optionally include that the processor circuitry is to at least one of execute or instantiate the instructions to identify a data access policy corresponding to the second metadata, determine whether the second user has access to the first data object based on the data access policy, and in response to a determination that the second user does not have access to the first data object based on the data access policy, deny the second electronic device access to the first data object.

In Example 14, the subject matter of Examples 11-13 can optionally include that the processor circuitry is to at least one of execute or instantiate the instructions to, in response to a determination that the second user has access to the first data object based on the data access policy, permit the publish of the first data object for access by the second electronic device.

In Example 15, the subject matter of Examples 11-14 can optionally include that the distributed datastore includes a metadata datastore and a raw datastore, and the processor circuitry is to at least one of execute or instantiate the instructions to obtain the second metadata and third metadata from the metadata datastore via a data plane, the third metadata including at least one of the one or more second portions of the second metadata, obtain the second data object from the raw datastore via the data plane, generate a primary data graph node based on the second data object, generate a first strength vector to connect the primary data graph node to the at least one of the one or more second portions of the second metadata, generate a second strength vector to connect the primary data graph node to one of one or more third portions of the third metadata, generate the data graph based on at least one of the primary data graph node, the first strength vector, and the second strength vector, and store the data graph in the distributed datastore.

In Example 16, the subject matter of Examples 11-15 can optionally include that the first strength vector has a vector length and an angle with respect to a reference axis, the vector length represented by a strength of association between the at least one of the one or more second portions of the second metadata and the second data object, the angle represented by a first probability that a first event associated with the at least one of the one or more second portions of the second metadata is to precede or follow a second event associated with the second data object.

In Example 17, the subject matter of Examples 11-16 can optionally include that the processor circuitry is to at least one of execute or instantiate the instructions to predict at least one of an access frequency or a use frequency of the first data object by at least one of the first user or the second user based on a data retention policy, and store the first data object in hot storage, warm storage, or cold storage based on the data retention policy.

In Example 18, the subject matter of Examples 11-17 can optionally include that the first data object is a first instance of the first data object with one or more first values, and the processor circuitry is to at least one of execute or instantiate the instructions to locate a second instance of the first data object in a raw datastore of the distributed datastore, the second instance to have one or more second values, determine whether a correlation error based on a comparison of the one or more first values and the one or more second values satisfies a threshold, and in response to a determination that the correlation error satisfies the threshold apply an error correction value to the first instance to reduce the correlation error, and expire the second instance.

In Example 19, the subject matter of Examples 11-18 can optionally include that the environment is a first environment, the first data object includes a first lexical term, the second data object includes a second lexical term, and the processor circuitry is to at least one of execute or instantiate the instructions to generate an association of the first lexical term and the second lexical term in response to a determination that a strength of a vector in the data graph satisfies a threshold, the vector to connect a first portion of the first metadata to a second portion of the second metadata, and store the association in the distributed datastore, the association to be accessible by the second electronic device in the first environment or a third electronic device in a second environment.

In Example 20, the subject matter of Examples 11-19 can optionally include that the processor circuitry is to at least one of execute or instantiate the instructions to identify, based on the data graph, one or more nodes in the preferred nodes table, the one or more nodes to be represented by logical entities in the environment, the one or more nodes to be identified based on a relevancy score associated with the one or more nodes and the first data object, determine whether the one or more nodes are included in the preferred nodes table, and publish the first data object for access by the one or more nodes in response to a determination that the one or more nodes are in the preferred nodes table.

Example 21 includes at least one computer readable storage medium comprising instructions that, when executed, cause processor circuitry to at least extract a first data object from ingested data, the ingested data to be generated by one or more data sources in an environment, the one or more data sources including at least one of autonomous equipment, a sensor, or a first electronic device associated with a first user, tag a first portion of the first data object with first metadata, the first metadata based on at least one of the environment or a type of a first one of the one or more data sources that generated the first data object, store a second data object and second metadata in a distributed datastore, the second data object linked to the second metadata in a data graph, identify the second data object based on at least a partial match of the first metadata to the second metadata, augment one or more second portions of the second metadata based on one or more first portions of the first metadata to output enriched second metadata in the data graph, identify a second electronic device in the environment, the second electronic device represented by a node in a preferred nodes table, the node to be identified based on the enriched second metadata, and publish at least one of the first data object or the second data object for access by the second electronic device, the second electronic device associated with the first user or a second user in the environment.

In Example 22, the subject matter of Example 21 can optionally include that the instructions, when executed, cause the processor circuitry to at least one of identify the second data object or enrich the second data object in response to execution of one or more machine learning models with the first data object as a data input to the one or more machine learning models.

In Example 23, the subject matter of Examples 21-22 can optionally include that the instructions, when executed, cause the processor circuitry to identify a data access policy corresponding to the second metadata, determine whether the second user has access to the first data object based on the data access policy, and in response to a determination that the second user does not have access to the first data object based on the data access policy, deny the second electronic device access to the first data object.

In Example 24, the subject matter of Examples 21-23 can optionally include that the instructions, when executed, cause the processor circuitry to, in response to a determination that the second user has access to the first data object based on the data access policy, permit the publish of the first data object for access by the second electronic device.

In Example 25, the subject matter of Examples 21-24 can optionally include that the distributed datastore includes a metadata datastore and a raw datastore, and the instructions, when executed, cause the processor circuitry to obtain the second metadata and third metadata from the metadata datastore via a data plane, the third metadata including at least one of the one or more second portions of the second metadata, obtain the second data object from the raw datastore via the data plane, generate a primary data graph node based on the second data object, generate a first strength vector to connect the primary data graph node to the at least one of the one or more second portions of the second metadata, generate a second strength vector to connect the primary data graph node to one of one or more third portions of the third metadata, generate the data graph based on at least one of the primary data graph node, the first strength vector, and the second strength vector, and store the data graph in the distributed datastore.

In Example 26, the subject matter of Examples 21-25 can optionally include that the first strength vector has a vector length and an angle with respect to a reference axis, the vector length represented by a strength of association between the at least one of the one or more second portions of the second metadata and the second data object, the angle represented by a first probability that a first event associated with the at least one of the one or more second portions of the second metadata is to precede or follow a second event associated with the second data object.

In Example 27, the subject matter of Examples 21-26 can optionally include that the instructions, when executed, cause the processor circuitry to predict at least one of an access frequency or a use frequency of the first data object by at least one of the first user or the second user based on a data retention policy, and store the first data object in hot storage, warm storage, or cold storage based on the data retention policy.

In Example 28, the subject matter of Examples 21-27 can optionally include that the first data object is a first instance of the first data object with one or more first values, and the instructions, when executed, cause the processor circuitry to locate a second instance of the first data object in a raw datastore of the distributed datastore, the second instance to have one or more second values, determine whether a correlation error based on a comparison of the one or more first values and the one or more second values satisfies a threshold, and in response to a determination that the correlation error satisfies the threshold apply an error correction value to the first instance to reduce the correlation error, and expire the second instance.

In Example 29, the subject matter of Examples 21-28 can optionally include that the environment is a first environment, the first data object includes a first lexical term, the second data object includes a second lexical term, and the instructions, when executed, cause the processor circuitry to generate an association of the first lexical term and the second lexical term in response to a determination that a strength of a vector in the data graph satisfies a threshold, the vector to connect a first portion of the first metadata to a second portion of the second metadata, and store the association in the distributed datastore, the association to be accessible by the second electronic device in the first environment or a third electronic device in a second environment.

In Example 30, the subject matter of Examples 21-29 can optionally include that the instructions, when executed, cause the processor circuitry to identify, based on the data graph, one or more nodes in the preferred nodes table, the one or more nodes to be represented by logical entities in the environment, the one or more nodes to be identified based on a relevancy score associated with the one or more nodes and the first data object, determine whether the one or more nodes are included in the preferred nodes table, and publish the first data object for access by the one or more nodes in response to a determination that the one or more nodes are in the preferred nodes table.

Example 31 includes a method comprising extracting a first data object from ingested data, the ingested data to be generated by one or more data sources in an environment, the one or more data sources including at least one of autonomous equipment, a sensor, or a first electronic device associated with a first user, tagging a first portion of the first data object with first metadata, the first metadata based on at least one of the environment or a type of a first one of the one or more data sources that generated the first data object, storing a second data object and second metadata in a distributed datastore, the second data object linked to the second metadata in a data graph, identifying the second data object based on at least a partial match of the first metadata to the second metadata, augmenting one or more second portions of the second metadata based on one or more first portions of the first metadata to output enriched second metadata in the data graph, identifying a second electronic device in the environment, the second electronic device represented by a node in a preferred nodes table, the node to be identified based on the enriched second metadata, and publishing at least one of the first data object or the second data object for access by the second electronic device, the second electronic device associated with the first user or a second user in the environment.

In Example 32, the subject matter of Example 31 can optionally include that the identifying of the second data object or the enriching of the second data object is in response to executing one or more machine learning models with the first data object as a data input to the one or more machine learning models.

In Example 33, the subject matter of Examples 31-32 can optionally include identifying a data access policy corresponding to the second metadata, determining whether the second user has access to the first data object based on the data access policy, and in response to determining that the second user does not have access to the first data object based on the data access policy, denying the second electronic device access to the first data object.

In Example 34, the subject matter of Examples 31-33 can optionally include, in response to determining that the second user has access to the first data object based on the data access policy, permitting the publishing of the first data object for access by the second electronic device.

In Example 35, the subject matter of Examples 31-34 can optionally include that the distributed datastore includes a metadata datastore and a raw datastore, and further include obtaining the second metadata and third metadata from the metadata datastore via a data plane, the third metadata including at least one of the one or more second portions of the second metadata, obtaining the second data object from the raw datastore via the data plane, generating a primary data graph node based on the second data object, generating a first strength vector to connect the primary data graph node to the at least one of the one or more second portions of the second metadata, generating a second strength vector to connect the primary data graph node to one of one or more third portions of the third metadata, generating the data graph based on at least one of the primary data graph node, the first strength vector, and the second strength vector, and storing the data graph in the distributed datastore.

In Example 36, the subject matter of Examples 31-35 can optionally include that the first strength vector has a vector length and an angle with respect to a reference axis, the vector length represented by a strength of association between the at least one of the one or more second portions of the second metadata and the second data object, the angle represented by a first probability that a first event associated with the at least one of the one or more second portions of the second metadata is to precede or follow a second event associated with the second data object.

In Example 37, the subject matter of Examples 31-36 can optionally include predicting at least one of an access frequency or a use frequency of the first data object by at least one of the first user or the second user based on a data retention policy, and storing the first data object in hot storage, warm storage, or cold storage based on the data retention policy.

In Example 38, the subject matter of Examples 31-37 can optionally include that the first data object is a first instance of the first data object with one or more first values, and further include locating a second instance of the first data object in a raw datastore of the distributed datastore, the second instance to have one or more second values, determining whether a correlation error based on a comparison of the one or more first values and the one or more second values satisfies a threshold, and in response to determining that the correlation error satisfies the threshold applying an error correction value to the first instance to reduce the correlation error, and expiring the second instance.

In Example 39, the subject matter of Examples 31-38 can optionally include that the environment is a first environment, the first data object includes a first lexical term, the second data object includes a second lexical term, and further include generating an association of the first lexical term and the second lexical term in response to a determination that a strength of a vector in the data graph satisfies a threshold, the vector to connect a first portion of the first metadata to a second portion of the second metadata, and storing the association in the distributed datastore, the association to be accessible by the second electronic device in the first environment or a third electronic device in a second environment.

In Example 40, the subject matter of Examples 31-39 can optionally include identifying, based on the data graph, one or more nodes in the preferred nodes table, the one or more nodes to be represented by logical entities in the environment, the one or more nodes to be identified based on a relevancy score associated with the one or more nodes and the first data object, determining whether the one or more nodes are included in the preferred nodes table, and publishing the first data object for access by the one or more nodes in response to a determination that the one or more nodes are in the preferred nodes table.

Example 41 is edge server processor circuitry to perform the method of any of Examples 31-40.

Example 42 is edge cloud processor circuitry to perform the method of any of Examples 31-40.

Example 43 is edge node processor circuitry to perform the method of any of Examples 31-40.

Example 44 is edge gateway processor circuitry to perform the method of any of Examples 31-40.

Example 45 is edge switch circuitry to perform the method of any of Examples 31-40.

Example 46 is an XPU to perform the method of any of Examples 31-40.

Example 47 is an Infrastructure Processing Unit to perform the method of any of Examples 31-40.

Example 48 is an apparatus comprising at least one of acceleration circuitry, one or more graphics processor units, one or more vision processor units, Artificial Intelligence processor circuitry, machine learning processor circuitry, neural network processor circuitry, one or more digital signal processors, one or more general purpose processors, or network interface circuitry to perform the method of any of Examples 31-40.

Example 49 is at least one computer readable medium comprising instructions to perform the method of any of Examples 31-40.

### Section C—Systems, Apparatus, Articles of Manufacture, and Methods for Adaptive and/or Proactive Data Retention

Data retention is a big cost (e.g., economic cost, computational cost, resource cost (e.g., hardware, software, and/or firmware costs), etc.) and overhead for any platform (whether in the Cloud or at the Edge). Data retention policies are mainly present for some categories of applications (e.g., medical records, government related matters, etc.) and there is not enough attention for data retention management for IoT applications. Advantageously, the example proactive data management analytics system and/or the adaptive data management (ADM) system as disclosed herein (e.g., the ADM system 600 of FIG. 6) may implement smart data retention in an automated and contextual way for improved data management.

Smart data retention as disclosed herein considers offline retention decision happening for stored data at rest, and online retention decision happening during data ingestion. In some examples, to improve adaptive, proactive, and/or otherwise smart data retention, the data itself may have specific metadata (e.g., descriptive metadata) to provide information helping the cost-efficient decision. Also, data transformation may take place (e.g., sub-sampling, data summarization on-demand, etc.) to be able to characterize the data.

Example factors considered for smart data retention include consumption status, retention cost, and uniqueness. For consumption status, the ADM system may continuously learn the consumption status of the stored data through learning how frequently the data is requested/used, and prediction of its possible usage, data validity and lifetime—making best use of cold, warm, and hot storage from the standpoint of accessibility and locality to teams most likely to access this data based on trends and analysis of usage patterns and nominal traffic on the network during critical events (e.g., product launch, tax time, quarterly assessment, etc.). For retention cost, the ADM system may continuously check the cost of retaining the data. The cost may be calculated/learned considering the storage needs, the power consumption by the storage, and/or the I/O needed to transmit the data upon request. The cost may be compared with the platform resources budget to determine a decision on retaining or migrating or deleting the data. For uniqueness of the data as compared to other datasets on the network, the ADM system may determine that the more unique, the higher the retention. For example, when the ADM system determines that similarity exists, this similarity may be used to compress the data. In some examples, the ADM system may consider contextual compression and cyclical location caching.

In some examples, smart data retention may be implemented by one or more Artificial Intelligence/Machine Learning (AI/ML) algorithms, models, etc., of the ADM system that look at (e.g., constantly look at) data streams and set value of usage in the future (e.g., “maybe more use in the future than now”) and/or value too (e.g., outlier data). In some examples, the ADM system may implement smart data retention by identifying cyclical events (e.g., patterns) in data usage, such as financial milestones, which can be recurring in nature or where events tied to one another may create a chain that “pulls” data and adjacent data from warm to hot and from cold to warm, respectively. In some examples, the ADM system may implement a usage model of the data by invoking one or more AI/ML algorithms, models, etc.

In some examples, the ADM system may implement adaptive, proactive, and/or otherwise smart data retention by predicting and/or otherwise determining within a specific likelihood how much the ADM system anticipates that this data is to be used in the future. In some examples, the ADM system may identify data affinities/adjacencies for related data relationships. In some examples, the ADM system may implement smart data retention by predicting/computing where the data can be used (e.g., a decision to cache data of interest) and appropriate caching location and availability level over time. In some examples in which heavy use is identified, the ADM system may, for high traffic applications, create one or more mirror servers to increase data accessibility and frequency, temporarily, to support increased transactions. In examples disclosed herein, “frequency” refers to either a rate at which data is used and/or requested or a number of instances at which data is stored in distributed datastore(s), storage device(s), memory, etc. For example, data (e.g., documents, spreadsheets, pixel data comprising an image, etc.) may have a storage frequency of “three locations” and a use frequency of “read from memory once a month”.

FIG. 12 is a block diagram of an example ADM system 1200 to execute continuous machine learning algorithms to ingest, analyze, and retain data and/or metadata. The ADM system 1200 of FIG. 12, or portion(s) thereof, may be instantiated (e.g., creating an instance of, bring into being for any length of time, materialize, implement, etc.) by processor circuitry such as a central processing unit executing instructions. Additionally or alternatively, the ADM system 1200 of FIG. 12 may be instantiated (e.g., creating an instance of, bring into being for any length of time, materialize, implement, etc.) by an ASIC or an FPGA structured to perform operations corresponding to the instructions. It should be understood that some or all of the ADM system 1200 of FIG. 12 may, thus, be instantiated at the same or different times. Some or all of the ADM system 1200 may be instantiated, for example, in one or more threads executing concurrently on hardware and/or in series on hardware. Moreover, in some examples, some or all of the ADM system 1200 of FIG. 12 may be implemented by one or more virtual machines and/or containers executing on the microprocessor.

The illustrated example of FIG. 12 depicts the example ADM system 1200 including example data ingestion management circuitry 1202, example analytics management circuitry 1204, and an example distributed datastore 1206. In some examples, the ADM system 1200 may be implemented by the ADM system 600 of FIG. 6, or portion(s) thereof. In some examples, the data ingestion management circuitry 1202 may be implemented by the data ingestion manager 606 of FIG. 6. In some examples, the analytics management circuitry 1204 may be implemented by the analytics manager 636 of FIG. 6. In some examples, the distributed datastore 1206 may be implemented by the distributed datastore 644 of FIG. 6.

The example data ingestion management circuitry 1202 of FIG. 12 may obtain first data from a data source (e.g., one(s) of the data sources 604 of FIG. 6) and provide the first data to the analytics management circuitry 1204. The example analytics management circuitry 1204 of FIG. 12 may provide the first data to the distributed datastore 1206 for storage. In some examples, the analytics management circuitry 1204 of FIG. 12 may obtain second data and/or queries (e.g., previously received queries associated with the first data, current or instant received queries associated with the first data, etc.) from the distributed datastore 1206, more specifically, from the metadata datastore 1208 and/or the raw datastore 1210. In some examples, the analytics management circuitry 1204 may execute and/or otherwise implement online learning and insights on data affinities and/or retention based on at least one of the first data, the second data, or the queries. In some examples, the first data and/or the second data can be sensor data, medical records, financial records, video frame images, corporate documents, etc. The content type and the content description of the first data and/or the second data are specific to the business, company, and/or the type of organization to which the first data and/or the second data belongs. In some examples, the content type and the content description are included in the metadata of the first data and the second data.

The example analytics management circuitry 1204 illustrated in FIG. 12 includes example graph model determination circuitry 1212, example contextual analyzation circuitry 1214, example consumption status determination circuitry 1216, example data retention circuitry 1218, example data uniqueness assessment circuitry 1220, or algorithm execution circuitry 1224. In some examples, at least one of the graph model determination circuitry 1212, the contextual analyzation circuitry 1214, the consumption status determination circuitry 1216, the data retention circuitry 1218, the data uniqueness assessment circuitry 1220, or the algorithm execution circuitry 1224 may be instantiated and/or otherwise invoked to implement online learning and insights on data affinities and/or retention. In some examples, the analytics management circuitry 1204 receives ingested data from the data ingestion management circuitry 1202. The example data ingestion management circuitry 1202 illustrated in FIG. 12 includes example preprocessing management circuitry 1228. In some examples, the data ingestion management circuitry 1202 may include the preprocessing management circuitry 1228 to preprocess the ingested data such that the analytics management circuitry 1204 may appropriately analyze, process, and/or manipulate the ingested data. The example data ingestion management circuitry 1202 illustrated in FIG. 12 may also include example descriptive metadata generation circuitry 1230 to write and/or assign metadata descriptors/headers to the ingested data. In some examples, the data source(s) (e.g., data source(s) 604) generate(s) the metadata for the ingested data prior to sending the data to the data ingestion management circuitry 1202.

In some examples, the descriptive metadata generation circuitry 1230 analyzes the contents of the ingested data to determine what descriptors and/or headers appropriately represent the ingested data. The example descriptive metadata generation circuitry 1230 can select several data blocks that include appropriately representative information. In some examples, the metadata descriptors/headers include a data validity block that defines the validity time of the ingested data. Further description of validity time in reference to the examples disclosed herein are explained in greater detail below. In some examples, the metadata descriptors/headers include a content type block that defines a category of data to which the ingested data belongs. For example, the ingested data may be pixel data of a captured image and the content type block may include phrases such as “image”, “pixels”, “video frame”, etc. to distinguish that the ingested data includes an image. In some examples, the metadata descriptors/headers include a content description block that defines a description of data included in the ingested data. For example, if the ingested data is pixel data of a captured image, the content description block may include phrases such as “street”, “car”, “face”, etc. to specify the types of settings, objects, subjects, etc. that the ingested data includes. In some examples, the metadata descriptors/headers include a resource allocation block that defines the memory size of the ingested data. For example, the resource allocation block may specify that the ingested data contains one Gigabyte (Gb) of pixel data.

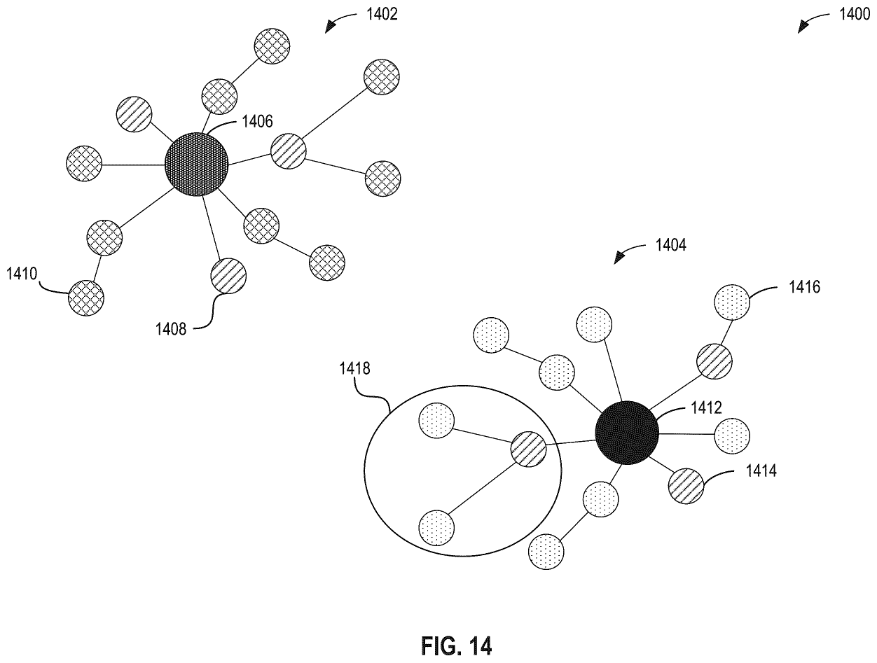

The example analytics management circuitry 1204 receives the ingested data to be analyzed from the data ingestion management circuitry 1202. In some examples, the graph model determination circuitry 1212 of the analytics management circuitry 1204 can generate a new graph model associated with the ingested data. In other examples, the graph model determination circuitry 1212 queries the distributed datastore 1206 to modify an existing graph model to include the ingested data. In some examples, the graph model can be implemented using group(s) or grouping(s) of data that is/are related to one(s) of each other via similarities in metadata descriptions. The data in the graph model is correlated to other data via a vector (e.g., a strength vector) that identifies the keywords, phrases, objects in images, sensor data, etc. that the metadata (and by extension, the data) have in common. In some examples, the graph model determination circuitry 1212 receives the ingested data and determines the strength vector for the ingested data relative to the new or existing graph model with which the ingested data is associated. Further descriptions of the graph model(s) and the strength vector(s) are discussed below in reference to the illustrated example of FIG. 14.

In some examples, the contextual analyzation circuitry 1214 can contextually compress the graph model based on similarities between the ingested data and associated data in the graph model that the contextual analyzation circuitry 1214 identifies. In examples disclosed herein, to “contextually compress” data and/or groups of data (e.g., data in a graph model) can be to combine two or more data that match and/or share common portion(s) of content. For example, to contextually compress a first data file and a second data file is to generate a third data file. The example third data file occupies more memory/storage space than the first data file or the second data file individually but occupies less memory/storage space than the first data file and the second data file together. In examples disclosed herein, to “contextually compress” data and/or groups of data (e.g., data in a graph model) can also be to remove data that is the same as or substantially similar to other data. The example contextual analyzation circuitry 1214 can determine what data identicalities (or substantial similarities) exist between the ingested data and the graph model and/or between different data nodes in the graph model. The data can be wholly similar to one another or partially similar. In some examples, if a first data node (e.g., the ingested data) is partially similar to a second data node (e.g., some other data node) in the graph model, then the contextual analyzation circuitry 1214 can contextually compress the first node and the second node and output a third data node. The example third data node includes the common and distinct data and/or metadata of the first data node and the second data node. In some examples, if the first data node (e.g., the ingested data) is wholly similar to the second data node (e.g., some other data node) in the graph model, then the contextual analyzation circuitry 1214 can discard the first node or the second node.

In some examples, the consumption status determination circuitry 1216 can query the distributed datastore 1206 to generate a consumption status of the graph model related to the ingested data to factor into a retention decision for the metadata, the ingested data, and/or the graph model. For example, the example consumption status determination circuitry 1216 can determine how frequently various Edge nodes in the Edge network (e.g., the Edge cloud 110) use and/or request data in the graph model. The example consumption status determination circuitry 1216 defines a use frequency in the consumption status to determine where to store data within the graph model, such that if the graph model is used at a rate that satisfies a hot storage parameter, then that would support a decision to store a portion (e.g., some or all) of the graph model and/or the ingested data in hot storage (e.g., cached memory, dynamic random access memory (DRAM), etc.) where it is more easily accessible to relevant Edge nodes. In examples disclosed herein, “use frequency” refers to a rate at which data is requested from, read from, written to, and/or manipulated in storage. For example, the use frequency may indicate that data is updated in storage weekly. The example use frequently is to be included in metadata associated with the data such that a consumption status data block and/or a use frequency data block in the metadata indicates the how often the data is “used” and in what way the data is “used”.

The example consumption status determination circuitry 1216 can identify a consumption form (e.g., raw data or compressed data) of the used/requested data of the graph model. For example, the consumption status determination circuitry 1216 can determine that one or more Edge nodes often use first data from the graph node in a raw form as a training set to perform AI/ML learning algorithms. The example consumption status determination circuitry 1216 may determine that the consumption status in the metadata of the first data is to be set to a raw data consumption form. Therefore, the analytics management circuitry 1204 can store the example ingested data related to the graph model as raw data in the distributed datastore 1206 if the metadata of the graph model indicates a raw data consumption form.

The example consumption status determination circuitry 1216 can identify the validity time of the ingested data and/or the graph model to factor into the consumption status. The validity time of data (e.g., ingested data) in the graph model can be a part of the metadata and can indicate how long the data is still valid (e.g., accurate, relevant, supported, etc.) before the data is to be updated. For example, the validity time can be implemented using the time period during with the data, the ingested data, and/or the graph model are valid in reality.

By way of example, the ingested data may be an image of an intersection captured at some point in the midday to contribute to a traffic monitoring system that informs applications and/or users of current traffic statuses, including at the intersection. A later image of the same intersection may be taken at rush hour and added to the image database for that intersection, at which point the previously-captured image may be updated as invalid because it no longer applies to the current traffic status. The example consumption status determination circuitry 1216 generates the validity time aspect of the consumption status such that retention decisions, storage location decisions, modification decisions, etc. with regard to the metadata, the ingested data, and/or the graph model can be made.

In some examples, the data retention circuitry 1218 of the analytics management circuitry 1204 illustrated in FIG. 12 can quantify and/or otherwise determine the retention cost of the ingested data and/or the graph model to factor into the retention decision of the ingested data. The example retention cost includes the storage space taken up, the power consumed for storage, and the power consumed to transmit the ingested data upon request after storage. In examples disclosed herein, the term “retention cost” refers to an aggregation of total power a device (e.g., an Edge node, an Edge device, an Edge aggregation node, an access point, an Edge data center, etc.) uses to store, send, and/or receive data (e.g., raw data and/or metadata) and a total storage space the data occupies on the device. In some examples, the retention cost includes one or more values (e.g., total power consumption, total storage space occupied, etc.) represented in a vector, a matrix, a table, etc. The analytics management circuitry 1204 uses the one or more values, dimensions, etc. of the retention cost relative to an acceptable retention expenditure (e.g., retention cost threshold) to determine if/how ingested data is to be retained.

In some examples, the analytics management circuitry 1204 can implement algorithms (e.g., the algorithms 638 of FIG. 6) to continuously learn a retention cost threshold/parameter for various forms of storage (e.g., hot storage, warm storage, cold storage, etc.). In some examples, the analytics management circuitry 1204 can compare the determined retention cost relative to a predetermined retention cost parameter. For example, the data retention circuitry 1218 can determine that the power used to store the ingested data in random access memory (RAM) may be higher that the hot storage location parameter. In such an example, the data retention circuitry 1218 may also determine that the power used to store the ingested data in a solid-state drive (SSD) (or any other type of storage device or disc) on the same Edge node satisfies the warm storage location parameter. The data retention circuitry 1218 can make similar example quantifications relative to the storage space consumption and the input/output transmission power consumption. The example data retention circuitry 1218 factors the example determinations into the decision on whether to retain the ingested data in hot storage, warm storage, and/or cold storage or whether to discard the ingested data.

In some examples, the data uniqueness assessment circuitry 1220 of the analytics management circuitry 1204 illustrated in FIG. 12 can assess the uniqueness of the ingested data compared to other data in the distributed datastore 1206 and/or the related graph model. In examples disclosed herein, the “uniqueness” of a particular dataset and/or data point can be measured in terms of a score, ratio, percentage, etc. relative to other dataset(s) and/or data point(s) in the distributed datastore 1206 and/or elsewhere in the Edge network (e.g., the Edge cloud 110). For example, if a first dataset and a second dataset are the same (e.g., are fully matching), and if the uniqueness was measured as a percentage, then the uniqueness of the first dataset would be zero percent. In some examples, if the first dataset and the second dataset are partially matching (e.g., they share 50 percent of the same data), then the uniqueness of the first dataset relative to the second dataset would reflect the amount of data that matches between the first dataset and the second dataset (e.g., a uniqueness of 50 percent).

The example data uniqueness assessment circuitry 1220 can query the distributed datastore 1206 to perform a search on the example metadata datastore 1208 based on the metadata of the ingested data. In some examples, for a quicker return, the example data uniqueness assessment circuitry 1220 may search the metadata of the graph model with which the ingested data is associated. In some examples, for a more thorough assessment, the example data uniqueness assessment circuitry 1220 may query the metadata datastore 1208 on a first Edge node receiving the ingested, a network of second Edge nodes in direct communication with the first Edge node, and/or the Edge computing network (e.g., the Edge cloud 110) that includes the first Edge node, the second Edge nodes, and further Edge nodes/databases. In some examples, the data uniqueness assessment circuitry 1220 determines the uniqueness of the ingested data relative to the raw datastore 1210, to perform a more comprehensive search compared to the metadata search.

In some examples, the data uniqueness assessment circuitry 1220 determines that the ingested data is similar to already existing data in the distributed datastore 1206 and/or the graph model. In some examples, the ingested data may be similar to existing data to a point that retaining the ingested data would be redundant. For example, if the ingested data is a first image of an intersection for traffic monitoring applications, the first image may be demonstrably unchanged from a second image of the intersection that was captured previous to the first image. The example analytics management circuitry 1204 may determine that the first image is redundant (e.g., the first image has a uniqueness score of zero, a zero percent uniqueness, and/or a 1:1 ratio between the first image and the second image) and discard (rather than stores) the ingested data (e.g., the first image). In other examples, the ingested may be similar to existing data to a point that the existing data is to be updated to reflect the ingested data. For example, the ingested data may be a first spreadsheet of sales in January of a particular year, but a second spreadsheet of sales in January of the particular year may already exist with one cell containing different information. In such an example, if uniqueness is measured as a percentage difference between two datasets, then the uniqueness of the first spreadsheet relative to the second spreadsheet would be slightly (e.g., one to two percent) higher than zero percent. In the same example, the uniqueness of the first spreadsheet may be above a threshold for discarding the ingested data (e.g., above zero percent) but below a threshold for retaining as a separate dataset (e.g., below five percent). In such an example, the analytics management circuitry 1204 may update (e.g., replace or by replacement) the second spreadsheet with the first spreadsheet (the ingested data) based on the uniqueness (e.g., the percent difference) of the first spreadsheet relative to the second spreadsheet.

The above-mentioned example operations of the analytics management circuitry 1204 may be implemented an/or instantiated by logic and/or machine-readable instructions stored in the example distributed datastore 1206. In some examples the algorithm execution circuitry 1224 executes example AI/ML algorithms and/or models (e.g., the algorithms 640 of FIG. 6) to predict usage models based on input(s) the consumption status determination circuitry 1216, the data retention circuitry 1218, and the data uniqueness assessment circuitry 1220 generate. The AI/ML algorithms that the algorithm execution circuitry 1224 execute and/or instantiate can learn (e.g., continuously learn, iteratively learn, etc.) how to accurately store and/or retain the ingested data and/or the graph model such that the ingested data and/or the graph model are readily available and/or properly preserved based on how users of the Edge network use/request the data.

In some examples, the algorithm execution circuitry 1224 determines that the ingested data and/or the graph model may satisfy various storage (e.g., hot, warm, or cold storage) parameters based on the consumption status, retention cost, and the uniqueness of the ingested data and/or the graph model. In some examples, the algorithm execution circuitry 1224 outputs a usage model based on the consumption status, retention cost, and the uniqueness of the ingested data and/or the graph model. The example usage model can include results that indicate whether the ingested data and/or the graph model satisfy various hot storage parameters, warm storage parameters, and/or cold storage parameters. In some examples, if the example algorithm execution circuitry 1224 predicts that the ingested data and/or the graph model is to satisfy enough hot storage parameters (e.g., above a hot storage threshold), then the algorithm execution circuitry 1224 is to predict that the ingested data and/or the graph model satisfy a hot storage policy. In some examples, hot storage parameters, warm storage parameters, and/or cold storage parameters are based on tables, matrices, or otherwise tabulated data including rows of ingested and/or stored data and columns of the consumption status, the retention cost, the data uniqueness, the data coverage, and/or the cyclical events of the ingested data and/or the stored data. The example hot storage parameters, warm storage parameters, and/or cold storage parameters can be satisfied if a particular number of columns satisfy particular values or if a particular number of column include terms, categories, strings, etc. that correlate to a particular storage level (e.g., hot storage, warm storage, cold storage, etc.). For example, if the consumption status determination circuitry 1216 determines that first ingested data is to be used twice a week based on the use frequency of the graph data with the first ingested data, then the hot storage policy for consumption status and/or use frequency may be satisfied. In another example if the consumption status determination circuitry 1216 determines that second ingested data is to be used once a week based on the use frequency of the graph data with the second ingested data, then the warm storage policy for consumption status and/or use frequency is said to be satisfied. In some examples, certain combinations, patterns, permutations, etc. of satisfied parameters dictate whether a hot storage policy, a warm storage policy, or a cold storage policy are satisfied.

In some examples, the example algorithm execution circuitry 1224 can send a signal to the data retention circuitry 1218 to store the ingested data and/or a portion (e.g., some or all) of the graph model in hot storage (e.g., cached memory, DRAM, etc.). In some examples, the algorithm execution circuitry 1224 determines that the ingested data and/or the graph model do not satisfy the hot storage policy, the warm storage policy, or the cold storage policy. In some examples, the algorithm execution circuitry 1224 sends a command to the data retention circuitry 1218 to discard the ingested data and/or the portion (e.g., some or all) of the graph model.

FIG. 13 is a block diagram of an example ADM system 1300 to execute continuous machine learning algorithms to share, analyze, and retain stored data and/or metadata. The ADM system 1300 of FIG. 13 may be instantiated (e.g., creating an instance of, bring into being for any length of time, materialize, implement, etc.) by processor circuitry such as a central processing unit executing instructions. Additionally or alternatively, the ADM system 1300 of FIG. 13 may be instantiated (e.g., creating an instance of, bring into being for any length of time, materialize, implement, etc.) by an ASIC or an FPGA structured to perform operations corresponding to the instructions. It should be understood that some or all of the ADM system 1300 of FIG. 13 may, thus, be instantiated at the same or different times. Some or all of the ADM system 1300 may be instantiated, for example, in one or more threads executing concurrently on hardware and/or in series on hardware. Moreover, in some examples, some or all of the ADM system 1300 of FIG. 13 may be implemented by one or more virtual machines and/or containers executing on the microprocessor.

The illustrated example of FIG. 13 depicts the example ADM system 1300 including an example cloud network 1302 (e.g., the Edge cloud 110), example analytics management circuitry 1304, and an example distributed datastore 1306. In some examples, the ADM system 1300 may be implemented by the ADM system 600 of FIG. 6. In some examples, the analytics management circuitry 1304 may be implemented by the analytics manager 636 of FIG. 6. In some examples, the distributed datastore 1306 may be implemented by the distributed datastore 644 of FIG. 6. In some examples, the ADM system 1300, the analytics management circuitry 1304, and/or the distributed datastore 1306 of FIG. 13 are the same as the ADM system 1200, analytics management circuitry 1204, and/or the distributed datastore 1206 of FIG. 12, respectively.

In some examples, the analytics management circuitry 1304 of FIG. 13 obtains first data from Edge node(s) (e.g., one(s) of the Internet of Things (IoT) device(s) 310, Access Point(s) 334, Edge Aggregation Node(s) 340 etc.) via the cloud 1302. The example analytics management circuitry 1304 of FIG. 13 may provide the first data to the distributed datastore 1306 for storage. The example distributed datastore 1306 includes example metadata datastore 1308 and example raw datastore 1310. In some examples, the analytics management circuitry 1304 obtains second data (e.g., raw data and/or metadata) from the distributed datastore 1306 to analyze, retain, and/or share with other Edge nodes via the cloud 1302. In some examples, the analytics management circuitry 1304 may execute and/or otherwise implement online learning and insights on data affinities and/or retention based on at least one of the first data and/or the second data. The example analytics management circuitry 1304 can generate additional metadata of the first and/or the second data based on the online learning and the insights executed. In some examples, the analytics management circuitry 1304 stores the additional metadata in the metadata datastore 1308 and shares the additional and/or otherwise updated metadata with other Edge node(s) via the cloud 1302.

The example analytics management circuitry 1304 illustrated in FIG. 13 includes example graph model determination circuitry 1312, example contextual analyzation circuitry 1314, example consumption status circuitry 1316, example data retention circuitry 1318, example data uniqueness assessment circuitry 1320, example metadata/data enrichment management circuitry 1322, example algorithm execution circuitry 1324, and example cyclical event recognition circuitry 1326. In some examples, the analytics management circuitry 1304 includes the graph model determination circuitry 1312, the contextual analyzation circuitry 1314, the consumption status circuitry 1316, the data retention circuitry 1318, the data uniqueness assessment circuitry 1320, the metadata/data enrichment management circuitry 1322, the algorithm execution circuitry 1324, and the cyclical event recognition circuitry 1326 to implement online learning and insights on data affinities and/or retention. In some examples, the analytics management circuitry 1304 receives stored data from the cloud 1302 (e.g., Edge cloud 110) to perform offline learning, predictions, insights, analyses, etc. to make retention decisions on the stored data and/or a graph model associated with the stored data.

The example analytics management circuitry 1304 receives the stored data to be analyzed from the cloud 1302 and/or the distributed datastore 1306. In some examples, the graph model determination circuitry 1312 of the analytics management circuitry 1304 can generate a new graph model associated with the stored data. In other examples, the graph model determination circuitry 1312 queries the distributed datastore 1306 to determine a graph model with which to associate the stored data or to read an existing graph model that already includes the stored data. The graph model is a group of data that are related via similarities in metadata descriptions. The data in the graph model are correlated to one another via a strength vector that identifies the keywords, phrases, objects in images, sensor data, etc. that the metadata (and by extension, the data) have in common. Further descriptions of the graph model(s) and the strength vector(s) are discussed below in reference to FIG. 14.

In some examples, the contextual analyzation circuitry 1314 can contextually compress the graph model based on similarities between the stored data and associated data in the graph model that the contextual analyzation circuitry 1314 identifies. The example contextual analyzation circuitry 1314 can determine what data identicalities exist between the stored data and the graph model and/or between different data nodes in the graph model. The data can be wholly similar to one another or partially similar. In some examples, if a first data node (e.g., the stored data) is partially similar to a second data node (e.g., some other data node) in the graph model, then the contextual analyzation circuitry 1314 can combine the first node and the second node such that the output is a third data node that includes the common and distinct data and/or metadata of the first data node and the second data node. In some examples, if the first data node (e.g., the stored data) is wholly similar to the second data node (e.g., some other data node) in the graph model, then the contextual analyzation circuitry 1314 can discard the first node or the second node.

In some examples, the consumption status determination circuitry 1316 can query the distributed datastore 1306 to generate a consumption status of the graph model related to the stored data to factor into a retention decision for the metadata, the stored data, and/or the graph model. For example, the example consumption status determination circuitry 1316 can determine how frequently various Edge nodes in the Edge network (e.g., Edge cloud 110) use and/or request data in the graph model. The frequency of use defined in the consumption status can help determine where to move (e.g., store, promote, relegate, redirect, etc.) data within the graph model, such that if the graph model is used at a rate that satisfies a hot storage parameter, then that would support a decision to store a portion (e.g., some or all) of the graph model and/or the stored data in hot storage (e.g., cached memory, dynamic random access memory (DRAM), etc.) where it is more easily accessible to relevant Edge nodes.

The example consumption status determination circuitry 1316 can also identify a consumption form (e.g., raw data or compressed data) of the used/requested data of the graph model. For example, the consumption status determination circuitry 1316 can determine that one or more Edge nodes often use data from the graph node in a raw form as a training set to perform AI/ML learning algorithms. In some examples, the consumption status determination circuitry 1316 may determine that the consumption status be set to a raw data form. Therefore, the analytics management circuitry 1304 may store the example stored data related to the graph model as raw data in the distributed datastore 1306.

The example consumption status determination circuitry 1316 can also identify the validity time of the stored data and/or the graph model to factor into the consumption status. The validity time of data (e.g., stored data) in the graph model can be a part of the metadata and can indicate how long the data is still valid (e.g., accurate, relevant, supported, etc.) before the data is to be updated. In other words, the validity time is the time period during with the data, the stored data, and/or the graph model are valid in reality. For example, the stored data may be an image of an intersection captured at some point in the midday to contribute to a traffic monitoring system that informs applications and/or users of current traffic statuses, including at the intersection. A later image of the same intersection may be taken at rush hour and added to the image database for that intersection, at which point the previously-captured image may be updated as invalid because it no longer applies to the current traffic status. The example consumption status determination circuitry 1312 generates the validity time aspect of the consumption status such that retention decisions, storage location decisions, modification decisions, etc. with regard to the metadata, the stored data, and/or the graph model can be made.

The example consumption status determination circuitry 1316 can also detect a data coverage of the stored data and/or the graph model. In some examples, the data coverage is an indication of the usage of the stored data and/or portion(s) (e.g., some or all) of the graph model across user(s) and/or application(s) in an Edge network. For example, the data coverage of financial reports (e.g., profit/loss statements, balance sheets, cash-flow statements, etc.) may include a first data location (e.g., Edge node(s), server(s), data center(s), etc.) that the financial department of a company primarily uses. In some examples, when stored data is pulled from the cloud 1302 and/or the distributed datastore 1306 for predictions, learning, insight, analysis, etc. it may be determined that the stored data belongs to the category of financial reports. In some examples, if the stored data is currently stored on a second data location (e.g., Edge node(s), server(s), data center(s), etc.) and/or is a part of a graph model that the financial department does not use, then the determined data coverage of the stored data may contribute to a retention decision to move the stored data from the second data location to the first data location.

In some examples, the data retention circuitry 1318 of the analytics management circuitry 1304 illustrated in FIG. 13 can quantify the retention cost of the stored data and/or the graph model to factor into the retention decision of the stored data. The example retention cost includes the storage space taken up, the power consumed for storage, and the power consumed to transmit the stored data upon request after retention (e.g., relegation, promotion, demotion, etc.). In some examples, the retention cost includes one or more values (e.g., total power consumption, total storage space occupied, etc.) represented in a vector, a matrix, a table, etc. The analytics management circuitry 1204 uses the one or more values, dimensions, etc. of the retention cost relative to an acceptable retention expenditure (e.g., retention cost threshold) to determine if/how ingested data is to be retained.

In some examples, the analytics management circuitry 1304 can implement algorithms (e.g., algorithms 638) to continuously learn a retention cost threshold/parameter for various forms of storage (e.g., hot storage, warm storage, cold storage, etc.). In other examples, the analytics management circuitry 1304 can compare the determined retention cost relative to a predetermined retention cost parameter. For example, the data retention circuitry 1318 may determine that the power used to store (e.g., move) the store data in random access memory (RAM) may be higher that the hot storage location parameter. In such an example, the data retention circuitry 1318 may also determine that the power used to store the stored data in an SSD on the same Edge node satisfies the warm storage location parameter. The data retention circuitry 1318 can make similar example quantifications relative to the storage space consumption and the input/output transmission power consumption. These example determinations can factor into the decision on whether to retain the stored data in hot storage, warm storage, and/or cold storage or to discard the stored data.

In some examples, the data uniqueness assessment circuitry 1320 of the analytics management circuitry 1304 illustrated in FIG. 13 can assess the uniqueness of the stored data compared to other data in the distributed datastore 1306 and/or the related graph model. The example data uniqueness assessment circuitry 1320 can query the distributed datastore 1306 to perform a search on the example metadata datastore 1308 based on the metadata of the stored data. For a quicker return, the example data uniqueness assessment circuitry 1320 may search the metadata of the graph model with which the stored data is associated. For a more thorough assessment, the example data uniqueness assessment circuitry 1320 may query the metadata datastore 1308 on a first Edge node receiving the ingested, a network of second Edge nodes in direct communication with the first Edge node, and/or the Edge computing network (e.g., the Edge cloud 110) that includes the first Edge node, the second Edge nodes, and further Edge nodes/databases. In some examples, the data uniqueness assessment circuitry 1320 determines the uniqueness of the stored data relative to the raw datastore 1310, to perform a more comprehensive search compared to the metadata search.

In some examples, the data uniqueness assessment circuitry 1320 determines that the stored data is similar to already existing data in the distributed datastore 1306 and/or the graph model. In some examples, the stored data may be similar to existing data to a point that retaining the ingested data would be redundant. For example, if the stored data is an image of an intersection for traffic monitoring applications, the image may be demonstrably unchanged from a previous image of the intersection. The example analytics management circuitry 1304 may determine that the image is redundant and discard (rather than retain) the stored data. In other examples, the stored data may be similar to existing data to a point that the existing data is to be updated to reflect the stored data. For example, the stored data may be a spreadsheet of sales in January of a particular year, but another spreadsheet of sales in January of the same year may already exist with one cell containing different information. In such an example, the analytics management circuitry 1304 may update (e.g., replace) the existing data with the stored data.

In some examples, the cyclical event recognition circuitry 1326 can implement logic, machine-readable instructions, and/or AI/ML algorithms to recognize, predict, and/or continually learn to recognize/predict cyclical (e.g. recurring, periodic, bi-annual, quarterly, etc.) events (e.g., product launches, tax audits, assessments, etc.) an Edge network user (e.g., companies, organizations, etc.) experience. In some examples, the cyclical event recognition circuitry 1326 observes users requesting and/or using stored data and/or graph models saved in the distributed datastore 1306. In some examples, the cyclical event recognition circuitry 1326 monitors the cloud 1302 to determine (e.g., recognize, assess, observe, etc.) if certain graph models are used/requested regularly and/or with elevated frequency during same time periods each year, month, quarter, etc.

In some examples, the cyclical event recognition circuitry 1326 can predict whether repeating events will occur after a distinct number of observations are recognized (e.g., monitored, determined, assessed, etc.). For example, at the end of a first quarter of a company's fiscal year, a financial group of the company calls data from a graph model for analysis and/or manipulation. At the end of a second quarter, the financial group uses the same graph model data for similar and/or same operations. Towards the end of the third quarter, the cyclical event recognition circuitry 1326 may predict that the financial group will want to use the graph model data. In some examples, the cyclical event recognition circuitry 1326 may output a result to the data retention circuitry 1318, a usage model, and/or the algorithm execution circuitry 1324 that influences a retention decision that moves the stored data and/or the graph model to an Edge node, the distributed datastore 1306, or some other storage/processing location that is closer to the computational location of the financial group. In other words, the stored data and/or graph model is/are moved to hot storage relative to the computing node of the financial group prior to the occurrence of the cyclical event(s) so that time is not spent retrieving useful data from distant (e.g.. remote, inaccessible, inactive, etc.) storage locations.

The above-mentioned example operations of the analytics management circuitry 1304 may be implemented an/or instantiated by logic and/or machine-readable instructions stored in the example distributed datastore 1306. In some examples the algorithm execution circuitry 1324 executes example AI/ML algorithms and/or models (e.g., algorithms 640 of FIG. 6) to predict usage models based on input(s) the contextual analyzation circuitry 1314, the consumption status determination circuitry 1316, the data retention circuitry 1318, the data uniqueness assessment circuitry 1320, and the cyclical event recognition circuitry 1326 generate. The AI/ML algorithms that the algorithm execution circuitry 1324 execute can continuously learn how to accurately move (e.g., promote and/or demote) and/or retain the stored data and/or the graph model such that the stored data and/or the graph model are readily available and/or properly preserved based on how users of the Edge network use/request the data.

In examples disclosed herein, to “promote” means to move or otherwise store raw data, metadata, and/or a portion (e.g., some or all) of a graph model to a storage location (e.g., RAM, memory cache, SSD, etc.) and/or an Edge node (e.g., IoT device 310, Access Point 332, Edge Aggregation Node 340, Cloud/Data Center 360, etc.) that is closer to the data and/or graph model usage point (e.g., Edge node, server, memory, etc. that uses/requests the data and/or the graph model). For example, to “promote” stored data based on a graph model prediction and/or a usage model output is to move the stored data from cold storage to warm storage. In examples disclosed herein, to “demote” means to move or otherwise store raw data, metadata, and/or a portion (e.g., some or all) of a graph model to a storage location (e.g., RAM, memory cache, SSD, etc.) and/or an Edge node (e.g., IoT device 310, Access Point 332, Edge Aggregation Node 340, Cloud/Data Center 360, etc.) that is further from the data and/or graph model usage point (e.g., Edge node, server, memory, etc. that uses/requests the data and/or the graph model). For example, to “demote” stored data based on a graph model prediction and/or a usage model output is to move the stored data from hot storage to cold storage.

In some examples, the algorithm execution circuitry 1324 determines that the stored data and/or the graph model may satisfy various storage (e.g., hot, warm, or cold storage) parameters based on the consumption status, retention cost, the uniqueness, and the cyclical events of the stored data and/or the graph model. In some examples, the algorithm execution circuitry 1324 outputs a usage model based on the consumption status, retention cost, the uniqueness, and the cyclical events of the stored data and/or the graph model. The example usage model includes results that indicate whether the stored data and/or the graph model satisfy various hot storage parameters, warm storage parameters, and/or cold storage parameters. If the example algorithm execution circuitry 1324 predicts that the stored data and/or the graph model is to satisfy enough hot storage parameters (e.g., above a hot storage threshold), then the algorithm execution circuitry 1324 is to predict that the stored data and/or the graph model satisfy a hot storage policy. In some examples, the example algorithm execution circuitry 1324 can send a signal to the data retention circuitry 1318 to move (e.g., promote, demote, or laterally transfer) the stored data and/or a portion (e.g., some or all) of the graph model to hot storage (e.g., cached memory, DRAM, etc.). In some examples, the algorithm execution circuitry 1324 determines that the stored data and/or the graph model do not satisfy the hot storage policy, the warm storage policy, or the cold storage policy. In some examples, the algorithm execution circuitry 1324 sends a command to the data retention circuitry 1318 to remove the stored data and/or the portion (e.g., some or all) of the graph model from storage (e.g., the distributed datastore 1306).

In some examples, the metadata is no longer relevant as a result of relegating the stored data to another level of storage. For example, depending on the new or existing graph model with which the stored data is associated after relegation, the strength vector of the stored data may have changed. Further descriptions of strength vectors and graph models are explained below in relation to FIG. 14. In some examples, the metadata/data enrichment management circuitry 1322 of the analytics management circuitry 1304 modifies the metadata of the stored data based on the retention decision, storage relegation (e.g. promotion, demotion, lateral transference, etc.), and/or graph model prediction. For example, the graph model determination circuitry 1312 may determine that the stored data has a weaker correlation with an adjacent (e.g. connected) node in a graph model compared to the last time the analytics management circuitry 1304 performed its offline learning, predictions, and/or insights on the stored data. In such an example, the metadata/data enrichment management circuitry 1322 may modify the strength vector (e.g., reduce the weight from high to low, 5 to 2, etc.) that connects the stored data and the adjacent node such that it reflects the weakened correlation the stored data has with the graph model and/or the adjacent node.

FIG. 14 is a schematic illustration 1400 of a first example graph model 1402 and a second example graph model 1404 for depicting groups of related raw data (e.g., ingested data, stored data, etc.) and metadata connected linked via strength vectors. In some examples, the first graph model 1402 and/or the second graph model 1404 is/are contextual data graph model(s). The first graph model 1402 includes a first example major node 1406, a first example adjacent node 1408, and a second example adjacent node 1410. The second graph model 1404 includes a second example major node 1412, a third example adjacent node 1414, a fourth example adjacent node 1416, and an example adjacent node grouping 1418. The patterns (e.g., solid, dotted, striped, hashed, etc.) of the various major nodes and adjacent nodes illustrated in FIG. 14 depict the various descriptors (e.g., keywords) of the metadata associated with raw data, ingested data, stored data, etc. stored in the distributed datastore 1206, 1306 of FIGS. 12 and 13. The example adjacent nodes illustrated in FIG. 14 represent the metadata associated with the ingested data, stored data, raw data etc. stored in the distributed datastore 1206, 1306 of FIGS. 12 and 13. Additionally or alternatively, the graph models 1402, 1404 of metadata descriptors illustrated in FIG. 14 can represent raw data, ingested data, stored data, etc. stored in other memory or other storage devices in the cloud 1302 (e.g., Edge cloud 110) of FIG. 13.

The lines connecting the major nodes 1406, 1412 to the adjacent nodes or the adjacent nodes to each other represent the strength vector between the two nodes. The example strength vector is of a single dimension and/or multiple dimensions and includes descriptors (e.g., keywords, similarity ratings (e.g., 1 through 5 with 1 being relatively not similar and 5 being substantially similar and/or identical, low/medium/high, etc.), characters, strings, numerical values, etc.) that represent how strongly the metadata of the raw data, ingested data, stored data, etc. match. The length of the strength vector(s) shown in the example schematic illustration 1400 of FIG. 14 symbolize the level of commonality, similarity, association, etc. two connected nodes share with one another. In other words, the strength vector length depicts the correlation between two connected nodes based on how frequently descriptors (e.g., keywords, terms, numerical values, data types, data categories, etc.) appear in both connected nodes. For example, the metadata of the first adjacent node 1408 has fewer matching data (e.g., descriptors, data blocks, etc.) with the metadata of the first major node 1406 than the metadata of the third adjacent node 1414 has with the second major node 1412. In some examples, the graph model determination circuitry 1212, 1312 can determine the number of matching metadata (e.g., metadata descriptors) that exists between adjacent nodes. The example graph model determination 1212, 1312 creates the strength vector based on the amount of metadata descriptors that match (e.g., fully matching, partially matching, and/or not matching) between the adjacent nodes. The example graph models disclosed herein (e.g., the first graph model 1402 and/or the second graph model 1404) are formed and/or predicted based on the metadata descriptions (e.g., the metadata descriptors) because parsing through the contents of the raw data to find similarities would consume much more processing resources, memory bandwidth, and compute time than parsing through the metadata.

In some examples, the first major node 1406 and the second major node 1412 have the same metadata descriptors. In some examples, the weighting of (e.g., length of the strength vectors between) the adjacent nodes (e.g., the first adjacent node 1408, the third adjacent node 1414, etc.) provide context and associated metadata descriptors. The example provided context of the graph model is tailored to a particular department and/or discipline within a company, an organization, a group, etc. For example, the first major node 1406 and the second major node 1412 may both include metadata that describe the associated raw data as belonging to the design engineering department of a bicycle company. In the same example, the first adjacent node 1408 and the third adjacent node 1414 may both include metadata that describe the raw data as belonging to the gear design segment of the design engineering department. However, since the strength vector connecting the second major node 1412 to the third adjacent node 1414 is shorter than the strength vector connecting the first major node 1406 and the first adjacent node 1408, it can be inferred that the second graph model 1404 has a stronger association with the gear design segment of the design engineering department than does the first graph model 1402.

In some examples, the first major node 1406 and the second major node 1412 have different metadata descriptors but are connected to adjacent nodes with similar metadata. In some examples, there is an implication that the first major node 1406 and the second major node 1412 have the same contextual definition. A user and/or operator can establish the example contextual definitions prescriptively depending on the metadata associations in the graph model(s). Additionally or alternatively, the analytics management circuitry 1204, 1304 can perform predictions/operations/insights on the graph model to determine the contextual definitions based on events, task, and/or objects in common among adjacent nodes. In some examples, graph model nodes are grouped together such as grouping 1418 of the second graph model 1404. Example groupings of nodes reinforce the contextual definition(s), descriptor(s), subject area(s), etc. of the major node (e.g., the second major node 1412).

In examples disclosed herein, the term “to associate” is defined as to correlate, link, couple, and/or connect two or more datasets, data points, raw data, metadata, etc. in the form of the strength vector based on similarities between the two or more datasets, data points, raw data, metadata, etc. For example, if a first metadata set has a sufficient number of same terms (e.g., over half of the total number of terms) as a second metadata set, then the strength vector is said to associate the first metadata and the second metadata. For example, if first raw data that the first metadata describes gets copied into storage on a different Edge node, then the strength vector that associates the first metadata and the second metadata indicates to the analytics management circuitry 1204, 1304 that second raw data is also to be copied into the same storage on the same Edge node as the first raw data.

In some examples, a dataset, data point, raw data, metadata, etc. are associated with the factors the analytics management circuitry 1204, 1304 determines as inputs to executed algorithms (e.g., algorithms 638 of FIG. 6). For example, if the cyclical event recognition circuitry 1326 recognizes a cyclical trend of cyclical events (e.g., a recurring usage (e.g., file opening, reading, manipulating, etc.) every month) of a raw dataset, then the cyclical trend is associated with the raw dataset. The cyclical trend can be represented in the form of data block (e.g., a cyclical trend metadata block that includes a time (e.g., “monthly”, “30 days”, etc.) and an action (e.g., “read from”, “write new”, “remove data”, “manipulate existing”, etc.)) included in metadata of the raw dataset. Therefore, if the metadata of the raw data is analyzed for a retention decision, the cyclical trend associated with the metadata/raw data is factored into the analysis, prediction, learning, and/or retention decision.

In examples disclosed herein, the term “association” refers to a correlation, linkage, coupling, and/or connection between two or more datasets, data points, raw data, metadata, etc. In some examples, the strength vector associating two adjacent nodes of a graph model can represent and/or define the association between the two adjacent nodes. In some examples, the analytics management circuitry 1204, 1304 determines factor(s) (e.g., uniqueness, retention cost, cyclical event, etc.) of ingested data and/or stored data, and the factor(s) are associated with the ingested data and/or the stored data for which the factor(s) were determined. For example, if first stored data (with associated first metadata) is found to have a uniqueness relative to second stored data (e.g., 1:2 ratio or 50 percent uniqueness), then the uniqueness associated with the first stored data is written into the first metadata (along with a storage location and/or an identifier of the stored data with which the uniqueness of the first data is compared (e.g., the second stored data)).

In some examples, the graph model determination circuitry 1212, 1312 of FIGS. 12 and 13 receive a stream of first metadata and/or first raw data and a stream of second metadata and/or second raw data to generate a first graph model (e.g., the first graph model 1402 or the second graph model 1404) and a second graph model (e.g., the first graph model 1402 or the second graph model 1404). The example contextual analyzation circuitry 1214, 1314 of FIGS. 12 and 13 can contextually compress the first metadata and/or the second metadata that have correlating metadata and/or raw data content. In some examples, the contextual analyzation circuitry 1214, 1314 of FIGS. 12 and 13 perform context and variance calculations on the adjacent node(s) of the first graph model and/or the second graph model (e.g., the first graph model 1402 and/or the second graph model 1404) to contextually compress (e.g., further reduce the number of nodes in) the graph model(s). The example graph model determination circuitry 1212, 1312 can convert the representative graph model(s) into first index table(s). The first index table(s) of the graph model representation(s) tabulate the raw data and/or the metadata that are depicted in the graph model(s). The example graph model determination circuitry 1212, 1312 can also generate second index table(s) including correlation factors between the first graph model and the second graph model. The analytics management circuitry 1204, 1304 can use the first index table(s) and/or the second index table(s) to execute learning, predictions, insights, operations, etc. on the ingested data, stored data, raw data, metadata, etc. that retain, move, modify, and/or discard the data being analyzed.

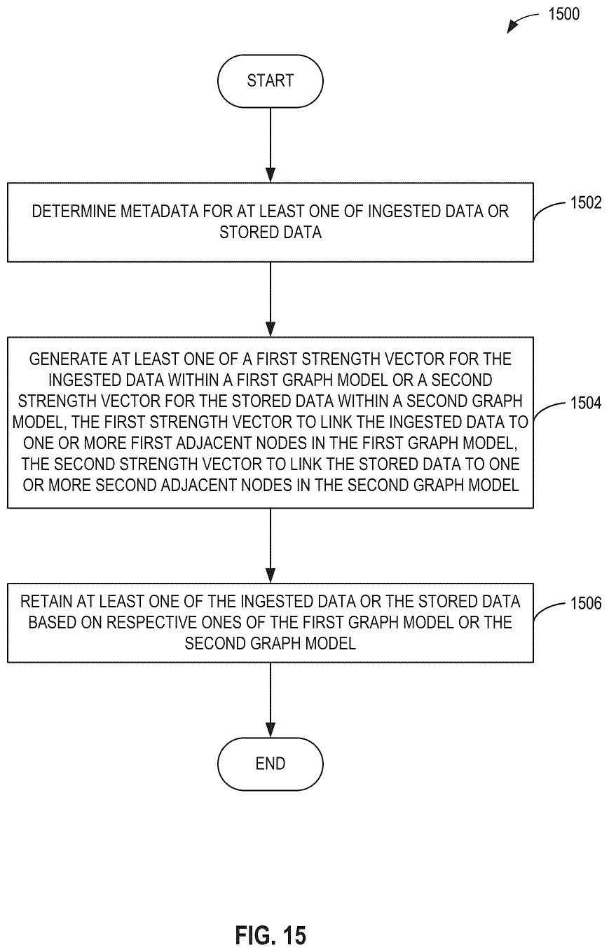

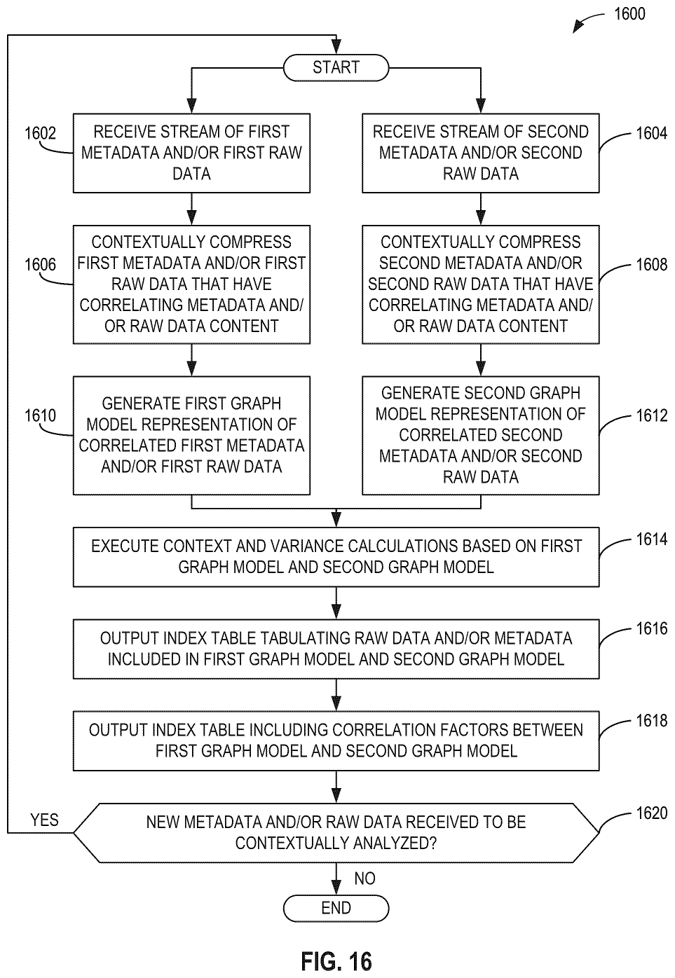

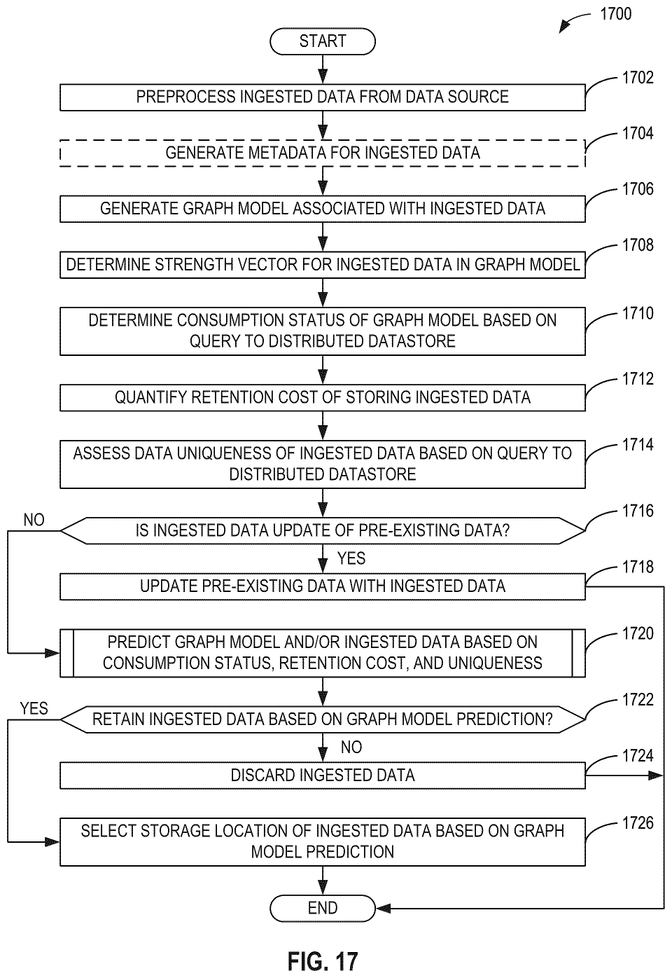

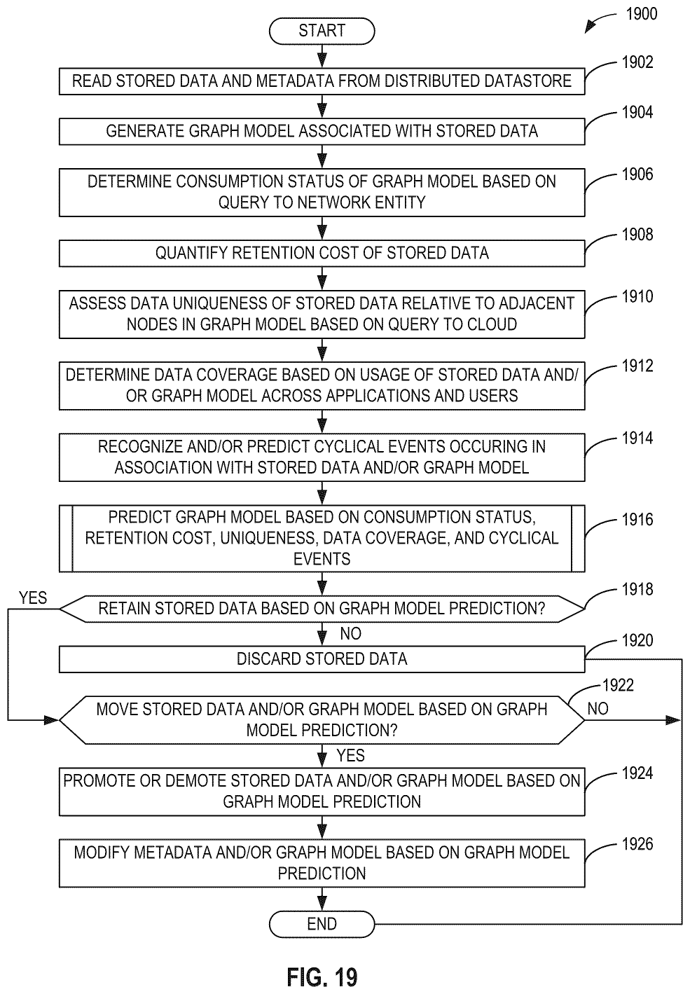

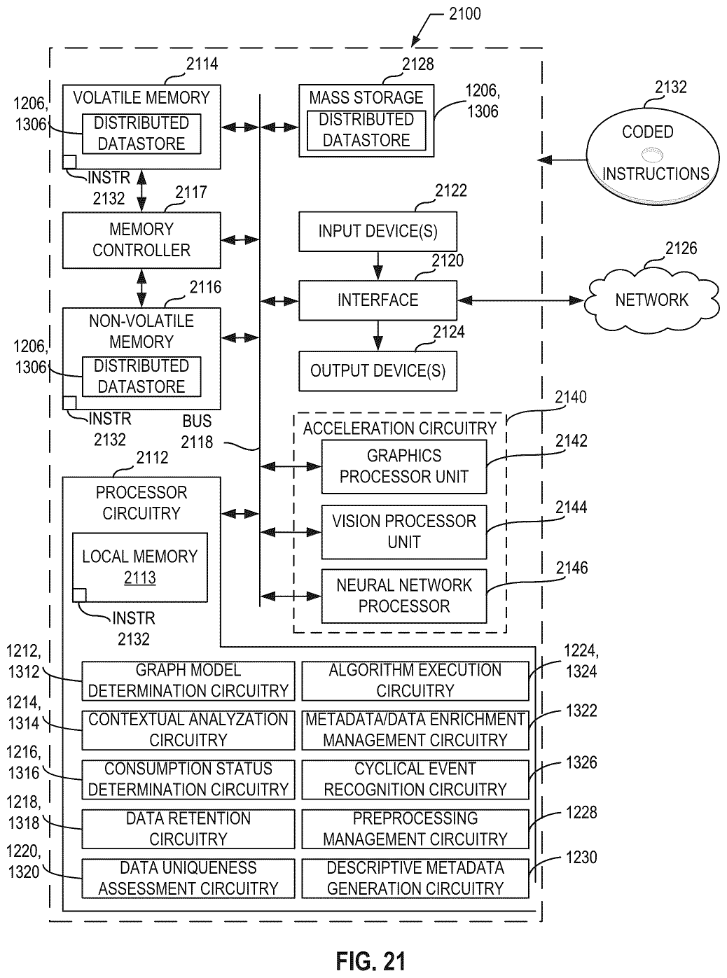

In some examples, the ADM systems 1200, 1300 include means for determining a graph model of metadata describing correlated raw data. For example, the means for determining may be implemented by the graph model determination circuitry 1212, 1312. In some examples, the graph model determination circuitry 1212, 1312 may be instantiated by processor circuitry such as the example processor circuitry 2112 of FIG. 21 executing machine executable instructions such as that implemented by at least blocks 1504 of FIGS. 15, 1602, 1604, 1610, 1612, 1616, 1618, and 1620 of FIGS. 16, 1706 and 1708 of FIG. 17, and 1902 and 1904 of FIG. 19. Additionally or alternatively, the graph model determination circuitry 1212, 1312 may be instantiated by any other combination of hardware, software, and/or firmware. For example, the graph model determination circuitry 1212, 1312 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for contextually analyzing and/or compressing raw data and/or metadata in a graph model. For example, the means for contextually analyzing and/or compressing may be implemented by the contextual analyzation circuitry 1214, 1314. In some examples, the contextual analyzation circuitry 1214, 1314 may be instantiated by processor circuitry such as the example processor circuitry 2112 of FIG. 21 executing machine executable instructions such as that implemented by at least blocks 1606, 1608, and 1614 of FIGS. 16 and 1716 and 1718 of FIG. 17. Additionally or alternatively, the contextual analyzation circuitry 1214, 1314 may be instantiated by any other combination of hardware, software, and/or firmware. For example, the contextual analyzation circuitry 1214, 1314 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for determining a consumption status for ingested data, stored data, and/or a graph model. For example, the means for determining may be implemented by the consumption status determination circuitry 1216, 1316. In some examples, the consumption status determination circuitry 1216, 1316 may be instantiated by processor circuitry such as the example processor circuitry 2112 of FIG. 21 executing machine executable instructions such as that implemented by at least blocks 1710 of FIGS. 17 and 1906 and 1912 of FIG. 19. Additionally or alternatively, the consumption status determination circuitry 1216, 1316 may be instantiated by any other combination of hardware, software, and/or firmware. For example, the consumption status determination circuitry 1216, 1316 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for determining a retention cost and/or a storage location for ingested data, stored data, and/or a graph model. For example, the means for determining may be implemented by the data retention circuitry 1218, 1318. In some examples, the data retention circuitry 1218, 1318 may be instantiated by processor circuitry such as the example processor circuitry 2112 of FIG. 21 executing machine executable instructions such as that implemented by at least blocks 1506 of FIGS. 15, 1712 and 1722-26 of FIG. 17, and 1908 and 1918-24 of FIG. 19. Additionally or alternatively, the data retention circuitry 1218, 1318 may be instantiated by any other combination of hardware, software, and/or firmware. For example, the data retention circuitry 1218, 1318 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for determining a data uniqueness for ingested data, stored data, and/or a graph model. For example, the means for determining may be implemented by the data uniqueness assessment circuitry 1220, 1320. In some examples, the data uniqueness assessment circuitry 1220, 1320 may be instantiated by processor circuitry such as the example processor circuitry 2112 of FIG. 21 executing machine executable instructions such as that implemented by at least blocks 1714 of FIG. 17 and 1910 of FIG. 19. Additionally or alternatively, the data uniqueness assessment circuitry 1220, 1320 may be instantiated by any other combination of hardware, software, and/or firmware. For example, the data uniqueness assessment circuitry 1220, 1320 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

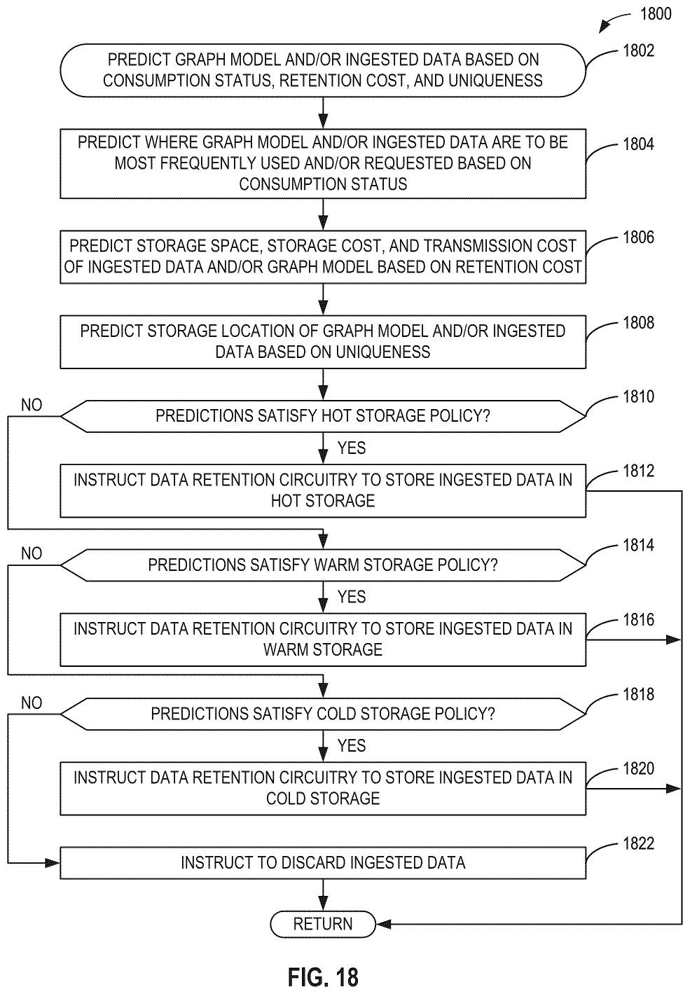

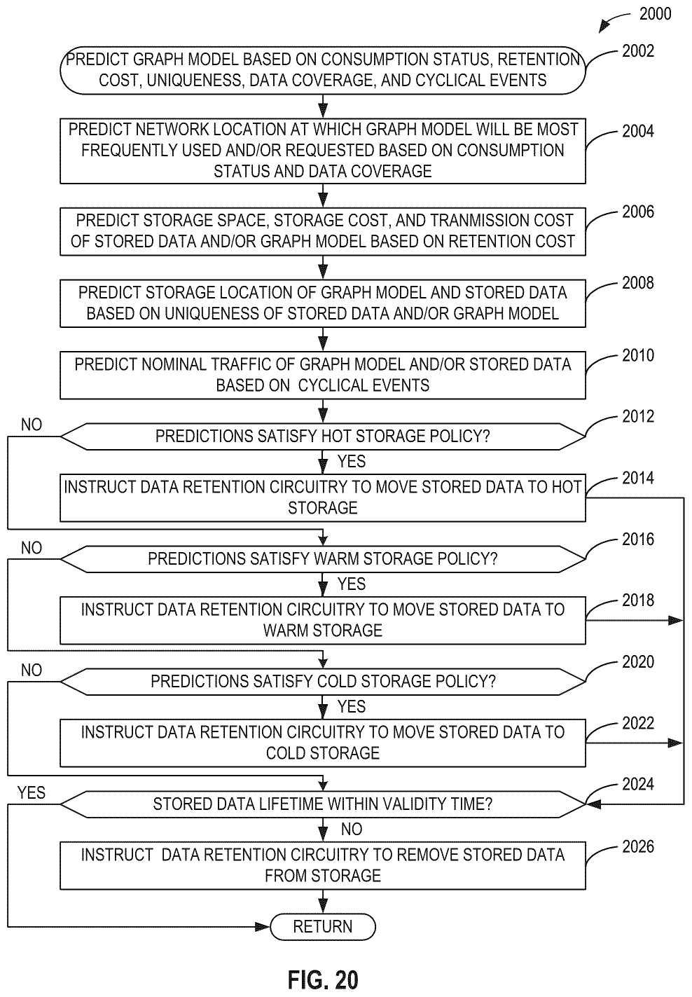

In some examples, the ADM systems 1200, 1300 include means for executing graph model prediction algorithms for ingested data, stored data, and/or graph model(s) based on a consumption status, a retention cost, a uniqueness, a data coverage, and cyclical event(s). For example, the means for executing may be implemented by the algorithm execution circuitry 1224, 1324. In some examples, the algorithm execution circuitry 1224, 1324 may be instantiated by processor circuitry such as the example processor circuitry 2112 of FIG. 21 executing machine executable instructions such as that implemented by at least blocks 1720 of FIG. 17, 1802-22 of FIG. 18, 1916 of FIG. 19, and 2002-26 of FIG. 20. Additionally or alternatively, the algorithm execution circuitry 1224, 1324 may be instantiated by any other combination of hardware, software, and/or firmware. For example, the algorithm execution circuitry 1224, 1324 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for modifying metadata and/or graph model(s) based on the output(s) of the executed graph model prediction algorithms. For example, the means for executing may be implemented by the metadata/data enrichment circuitry 1322. In some examples, the metadata/data enrichment circuitry 1322 may be instantiated by processor circuitry such as the example processor circuitry 2112 of FIG. 21 executing machine executable instructions such as that implemented by at least block 1926 of FIG. 19. Additionally or alternatively, the metadata/data enrichment circuitry 1322 may be instantiated by any other combination of hardware, software, and/or firmware. For example, the metadata/data enrichment circuitry 1322 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for recognizing cyclical events involving metadata, graph model(s), ingested data, and/or stored data. For example, the means for recognizing may be implemented by the cyclical event recognition circuitry 1326. In some examples, the cyclical event recognition circuitry 1326 may be instantiated by processor circuitry such as the example processor circuitry 2112 of FIG. 21 executing machine executable instructions such as that implemented by at least block 1914 of FIG. 19. Additionally or alternatively, the cyclical event recognition circuitry 1326 may be instantiated by any other combination of hardware, software, and/or firmware. For example, the cyclical event recognition circuitry 1326 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for preprocessing ingested data received from data source(s). For example, the means for preprocessing may be implemented by the preprocessing management circuitry 1228. In some examples, the preprocessing management circuitry 1228 may be instantiated by processor circuitry such as the example processor circuitry 2112 of FIG. 21 executing machine executable instructions such as that implemented by at least block 1702 of FIG. 17. Additionally or alternatively, the preprocessing management circuitry 1228 may be instantiated by any other combination of hardware, software, and/or firmware. For example, the preprocessing management circuitry 1228 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the ADM systems 1200, 1300 include means for generating metadata associated with ingested data received from data source(s). For example, the means for generating may be implemented by the descriptive metadata generation circuitry 1230. In some examples, the descriptive metadata generation circuitry 1230 may be instantiated by processor circuitry such as the example processor circuitry 2112 of FIG. 21 executing machine executable instructions such as that implemented by at least blocks 1502 of FIG. 15 and 1702 of FIG. 17. Additionally or alternatively, the descriptive metadata generation circuitry 1230 may be instantiated by any other combination of hardware, software, and/or firmware. For example, the descriptive metadata generation circuitry 1230 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the ADM systems 1200, 1300 of FIGS. 12 and 13 are illustrated in FIGS. 12 and 13, one or more of the elements, processes, and/or devices illustrated in FIGS. 12 and 13 may be combined, divided, re-arranged, omitted, eliminated, and/or implemented in any other way. Further, the example graph model determination circuitry 1212, 1312, the example contextual analyzation circuitry 1214, 1314, the example data retention circuitry 1218, 1318, the example data uniqueness assessment circuitry 1220, 1320, the example algorithm execution circuitry 1224, 1324, the example metadata/data enrichment circuitry 1322, the example cyclical event recognition circuitry 1326, the example preprocessing management circuitry 1228, the example descriptive metadata generation circuitry 1230, and/or, more generally, the example ADM systems 1200, 1300 of FIGS. 12 and 13, may be implemented by hardware alone or by hardware in combination with software and/or firmware. Thus, for example, any of the example graph model determination circuitry 1212, 1312, the example contextual analyzation circuitry 1214, 1314, the example data retention circuitry 1218, 1318, the example data uniqueness assessment circuitry 1220, 1320, the example algorithm execution circuitry 1224, 1324, the example metadata/data enrichment circuitry 1322, the example cyclical event recognition circuitry 1326, the example preprocessing management circuitry 1228, the example descriptive metadata generation circuitry 1230, and/or, more generally, the example ADM systems 1200, 1300, could be implemented by processor circuitry, analog circuit(s), digital circuit(s), logic circuit(s), programmable processor(s), programmable microcontroller(s), GPU(s), digital signal processor(s) (DSP(s)), ASIC(s), programmable logic device(s) (PLD(s)), and/or field programmable logic device(s) (FPLD(s)) such as Field Programmable Gate Arrays (FPGAs). Further still, the example ADM systems 1200, 1300 of FIGS. 12 and 13 may include one or more elements, processes, and/or devices in addition to, or instead of, those illustrated in FIGS. 12 and 13, and/or may include more than one of any or all of the illustrated elements, processes and devices.

Flowcharts representative of example hardware logic circuitry, machine readable instructions, hardware implemented state machines, and/or any combination thereof for implementing the first example ADM system 1200, the second example ADM system 1300, and/or portion(s) thereof are shown in FIGS. 15-20. The machine readable instructions may be one or more executable programs or portion(s) of an executable program for execution by processor circuitry, such as the processor circuitry 2112 shown in the example processor platform 2100 discussed below in connection with FIG. 21. The program may be embodied in software stored on one or more non-transitory computer readable storage media such as a compact disk (CD), a floppy disk, a hard disk drive (HDD), an SSD, a digital versatile disk (DVD), a Blu-ray disk, a volatile memory (e.g., RAM of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 15-20, many other methods of implementing the first example ADM system 1200, the second example ADM system 1300, and/or portion(s) thereof alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 15-20 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 15 is a flowchart representative of example machine readable instructions and/or example operations 1500 that may be executed and/or instantiated by processor circuitry to generate strength vector(s) for graph model(s) based on determined metadata, and to make retention decisions based on the generated graph model. The machine readable instructions and/or the operations 1500 of FIG. 15 begin at block 1502, at which the ADM systems 1200, 1300 determine metadata for at least one of ingested data and/or stored data. For example, the descriptive metadata generation circuitry 1230 can analyze raw data received from data source(s) (e.g., data source(s) 604) and generate metadata that include multiple descriptors and/or headers (e.g., keywords, terms, numerical values, validity time, content type, content description, strength vector(s), resource needs, etc.) used to contextually compress and/or associate various raw data into graph model representations.

At block 1504, the ADM systems 1200, 1300 generate a first strength vector for the ingested data associated with a first graph model and a second strength vector for the stored data associated with a second graph model. For example, the graph model determination circuitry 1212, 1312 analyzes various graph model metadata compositions to find a match with the metadata of the ingested data and the stored data. The graph model determination circuitry 1212, 1312 can determine which adjacent nodes and/or major node(s) of the first graph model and/or the second graph model are most similar to the ingested data and/or stored data and create connections in the form of the first strength vector and/or the second strength vector between two or more adjacent nodes.

At block 1506, the ADM systems 1200, 1300 retain at least one of the ingested data and/or the stored data based on the first strength vector, the second strength vector, the first graph model, the second graph model, graph model predictions, learning, and/or insights. For example, the data retention circuitry 1218 of ADM system 1200 can move, store, and/or discard ingested data and associated metadata based on retention decisions gathered from executed algorithm(s) (e.g., algorithm(s) 638). The data retention circuitry 1318 of ADM system 1300 can move, promote, demote, laterally transfer, and/or discard stored data based on retention decisions gathered from executed algorithm(s) (e.g., algorithm(s) 638). The data retention circuitry 1218, 1318 can retain and/or move the ingested data and/or the stored data to or from hot storage, warm storage, or cold storage based on the data usage prediction outputs from the executed algorithms.

FIG. 16 is a flowchart representative of example machine readable instructions and/or example operations 1600 that may be executed and/or instantiated by processor circuitry to generate graph model(s) and index tables based on correlations between metadata of various raw data (e.g., ingested data and/or stored data). The machine readable instructions and/or the operations 1600 of FIG. 16 begin at block 1602 at which the ADM systems 1200, 1300 receive streams of first metadata and first raw data. Simultaneously or at a sufficiently similar time at block 1604, the ADM systems 1200, 1300 receive streams of second metadata, and/or second raw data. For example, the graph model determination circuitry 1212, 1312 collect the various metadata, raw data, ingested data, and/or stored data from the cloud 1302, the distributed datastore(s) 1206, 1306, and/or the data ingestion management circuitry 1202 as a basis for analyzing and determining the composition of a first graph model and a second graph model. The first graph model and the second graph model include depictions of correlated raw data based on similarities between the metadata associated with the raw data.

At block 1606, the ADM systems 1200, 1300 contextually compress the first metadata and/or the first raw data that connect to an extent that is above a first correlation threshold. Simultaneously or at a sufficiently similar time at block 1608, the ADM systems 1200, 1300 contextually compress the second metadata and/or the second raw data that connect to an extent that is above a second correlation threshold. For example, the contextual analyzation circuitry 1214, 1314 compare similarities between the stream of first metadata and/or the stream of first raw data and combine and/or remove data that are sufficiently similar to one another. The contextual analyzation circuitry 1214, 1314 amalgamates and/or discards metadata and/or raw data to eliminate data redundancies, reduce storage space, reduce memory bandwidth, increase compute times, and decrease the size(s) of the graph model(s).

At block 1610, the ADM systems 1200, 1300 generate the first graph model based on the correlated and contextually compressed first metadata and/or first raw data. Simultaneously or at a sufficiently similar time at block 1612, the ADM systems 1200, 1300 generate the second graph model based on the correlated and contextually compressed second metadata and/or second raw data. For example, the graph model determination circuitry 1212, 1312 determine a first major node including first metadata that describe a first summation of the first graph model contents. The graph model determination circuitry 1212, 1312 also determines a second major node including second metadata that describe a second summation of the second graph model contents. The graph model determination circuitry 1212, 1312 can generate strength vectors for the various incoming streams of metadata and raw data before or after the contextual compression stages at blocks 1606 and 1608. The graph model determination circuitry 1212, 1312 can associate (e.g., connect) adjacent nodes based on similarities with the strength vectors of the adjacent nodes to form the first graph model representation and the second graph model representation.

At block 1614, the ADM systems 1200, 1300 execute context and variance calculations based on the generated first graph model and the generated second graph model. For example, the contextual analyzation circuitry 1214, 1314 can determine which adjacent nodes of the first graph model and/or the second graph model can be further compressed (e.g., contextually compressed). The contextual analyzation circuitry 1214, 1314 contextually compresses the first graph model and the second graph model following the generation stages to further eliminate any redundancies that may be more prevalent in the perspective of metadata and/or raw data assembled in the form of graph model(s).

At block 1616, the ADM systems 1200, 1300 output first index table(s) tabulating raw data and/or metadata included in the first graph model and/or the second graph model. For examples, the graph model determination circuitry 1212, 1312 can generate first lookup table(s) that points to raw data and/or metadata the first graph model and/or the second graph model represent. If example hardware, software, firmware, etc. pull data from storage, the data/metadata associated with (e.g., in the same graph model as) the raw data is readily available in the first index table stored in the same and/or nearby storage location for quick access.

At block 1618, the ADM systems 1200, 1300 output a second index table including correlating factors between the first graph model and the second graph model. For example, the graph model determination circuitry 1212, 1312 can generate the second index table (e.g., lookup table) including indicators that direct users, operators, requesters, etc. to a third index table that is related to the first index table. While the first index table points to other data within the same graph model, the second index table points to other data within a relatively similar graph model. The data retention circuitry 1218, 1318 and/or algorithm execution circuitry 1224, 1324 can use the correlation factors in the second index table to make retention decisions by moving index tables (e.g., the first index table or the third index table) closer together in storage based on the correlation factors in some other index table (e.g., the second index table).

At block 1620, the ADM systems 1200, 1300 determine if new streams of metadata and/or raw data are received. For example, the graph model determination circuitry 1212, 1312 detects if the cloud 1302, the distributed datastore 1206, 1306, the data ingestion management circuitry 1202, etc. send new streams of raw data and/or metadata to the graph model determination circuitry 1212, 1312 for generating graph model representations. If new metadata and/or raw data are received, then process 1600 proceeds to blocks 1602 and 1604 where the graph model determination circuitry 1212, 1312 receive the transmitted streams of first metadata, first raw data, second metadata, and/or second raw data. If no new metadata and/or raw data are received, then process 1600 ends.

FIG. 17 is a flowchart representative of example machine readable instructions and/or example operations 1700 that may be executed and/or instantiated by processor circuitry to predict usage models and generate retention decisions based on a consumption status, a retention cost, and a data uniqueness of the ingested data and/or the graph model(s) associated with the ingested data. The machine readable instructions and/or the operations 1700 of FIG. 17 begin at block 1702 at which the ADM system 1200 preprocesses ingested data received from data source(s) (e.g., data source(s) 604). For example, the preprocessing management circuitry 1228 can clean, select instances of, normalize, encode, transform, extract features of, etc. the ingested data such that it is more efficient for the analytics management circuitry 1204 to analyze and/or retain the ingested data as well as associate the ingested data with new and/or existed graph model(s).

At block 1704, the ADM system 1200 can optionally generate metadata for the ingested data that the preprocessing management circuitry 1228 preprocesses and/or that the data ingestion management circuitry 1202 receives. For example, the descriptive metadata generation circuitry 1230 can detect and/or determine features (e.g., data validity, content type, content description, strength vector, resource needs, keywords, terms, etc.) of the ingested data and generate descriptors and/or headers of the ingested based on the detected features. Additionally or alternatively, the data source(s) (e.g., data source(s) 604) from which the data ingestion management circuitry 1202 receives the ingested data can generate the descriptive metadata and remove block 1704 from process 1700.

At block 1706, the ADM system 1200 determines the graph model associated with the ingested data. For example, the graph model determination circuitry 1212 can correlate the ingested data with an existing graph model based on the metadata of the ingested data and the index table of the existing graph model. Additionally or alternatively, the graph model determination circuitry 1212 can generate a new graph model and a new index table correlating to the metadata of the ingested data as shown by process 1600 of FIG. 16.

At block 1708, the ADM system 1200 determines the strength vector(s) of the ingested data in the correlated graph model. For example, the graph model determination circuitry 1212 determines with which adjacent nodes in the graph model does the ingested data most closely correlate. Based on that determination, the graph model determination circuitry 1212 can generate the strength vector (e.g., a weighted value of 1 to 5, low/medium/high, weak to strong, etc.) connecting the ingested data to the adjacent node(s). The strength vector indicates how closely the ingested data relates to the adjacent node(s).

At block 1710, the ADM system 1200 determines the consumption status of the graph model based on a query to the distributed datastore 1206. For example the consumption status determination circuitry 1216 queries the distributed datastore 1206 to return a result indicating where (e.g., at what Edge nodes, memory locations, etc.) the graph model associated with the ingested data is most often used/requested, how often the graph model is used/requested, where the different nodes of the graph model are stored, the consumption form (e.g., raw and/or compressed) of the graph model nodes, how long the graph model is used before the nodes therein are invalid, etc. The consumption status determination circuitry 1216 can output a result (e.g., tabulated result) that indicates the various consumption status factors of the graph model with which the ingested data is associated.

At block 1712, the ADM system 1200 quantifies the retention cost of storing the ingested data. For example, the data retention circuitry 1218 can determine the storage space the ingested data is to take up, the power consumed to store the ingested data, the power consumed to transmit (e.g., input and output) the ingested data upon storage, etc. The data retention circuitry 1218 can determine a result that includes the retention cost factors of the ingested data and that contributes to the graph model prediction and/or the ingested data retention decision.

At block 1714, the ADM system 1200 assesses the data uniqueness of the ingested data based on a query to the distributed datastore 1206. For example, the data uniqueness assessment circuitry 1220 can compare the ingested data to nodes in the associated graph model to determine if the ingested data has raw data and/or metadata in common with other data nodes in the graph model. For example, the ingested data may be a first image that is relatively unchanged from a second image previously generated. The uniqueness of the ingested data can factor into the graph model prediction and/or the retention decision for the ingested data.

At block 1716, the ADM system 1200 determines if the ingested data is an update of pre-existing data. For example, the contextual analyzation circuitry 1214 can analyze the uniqueness of the ingested data assessed in block 1714 to determine if the ingested data is substantially similar to data that is already associated with the graph model. The contextual analyzation circuitry 1214 can determine if the ingested data wholly or partially includes the same content as data in the graph model and/or the index table associated with the graph model.

At block 1718, the ADM system 1200 updates (e.g., replaces) the pre-existing data with the ingested data if the uniqueness of the ingested data is below a certain threshold. For example, the contextual analyzation circuitry 1214 may determine that the ingested data is an update to previously store data and that the two data are substantially similar to the point that to retain both would be redundant. In such an example, the contextual analyzation circuitry 1214 updates the pre-existing data with the ingested data. In response to the contextual analyzation circuitry 1214 updating the pre-existing data with the ingested data, the process 1700 ends.

At block 1720, the ADM system 1200 predicts the graph model and/or the ingested data based on the consumption status, the retention cost, and the data uniqueness of the ingested data if the contextual analyzation circuitry 1214 determines that the ingested data is not an update of the pre-existing data. For example, if the ingested data is unique enough, the algorithm execution circuitry 1224 executes algorithm(s) (e.g., algorithm(s) 638) to determine where and/or how to retain the ingested data and/or associated graph model based on the factors that the analytics management circuitry 1204 previously determined. Further description of subprocess 1720 are described below regarding process 1800 of FIG. 18.

At block 1722, the ADM system 1200 determines if the ingested data is to be retained based on the predictions the algorithm execution circuitry 1224 output at block 1720. For example, if the algorithm execution circuitry 1224 determines that the consumption status, the retention cost, and/or the uniqueness do not satisfy the hot storage policies, the warm storage policies, or the cold storage policies, then the algorithm execution circuitry 1224 outputs instructions to discard the ingested data.

At block 1724, the ADM system 1200 discards the ingested data if the output of block 1722 reflect such a decision. For example, if the algorithm execution circuitry 1224 gives instructions to discard the ingested data, the data retention circuitry 1218 discards (e.g., does not retain) the ingested data. Following the completion of block 1724, the process 1700 ends.

At block 1726, the ADM system 1200 selects a storage location for the ingested data based on the graph model prediction that the algorithm execution circuitry 1224 outputs. For example, if the algorithm execution circuitry 1224 gives instructions to store the ingested data in hot storage, then the data retention circuitry 1218 determines where to best store the ingested data relative to the graph model storage location. In such an example, the data retention circuitry 1218 may determine that the ingested data is to be stored in cache memory on the same Edge node where the graph model is stored. Following the completion of block 1726, the process 1700 ends.

FIG. 18 is a flowchart representative of example machine readable instructions and/or example operations 1800 that may be executed and/or instantiated by processor circuitry to predict graph model and/or ingested data retention decisions based on a consumption status, a retention cost, and a data uniqueness of the ingested data and/or the graph model(s) associated with the ingested data. The machine readable instructions and/or the operations 1800 of FIG. 18 can be executed and/or instantiated by processor circuitry to implement block 1720 of FIG. 17. The machine readable instructions and/or the operations 1800 of FIG. 18 begin at block 1802 at which the ADM system 1200 signals to the algorithm execution circuitry 1224 that the subprocess, operation, and/or function for predicting the graph model and/or the ingested data has begun. For example, the algorithm execution circuitry 1224 can request the consumption status from the consumption status determination circuitry 1216.

At block 1804, the ADM system 1200 predicts where the graph model and/or the ingested data are to be most frequently used and/or requested based on the consumption status. For example, the algorithm execution circuitry 1224 executes AI/ML algorithms to predict and/or continuously learn where the ingested data and/or the graph model are to be most frequently used/requested based on the consumption status. The algorithm execution circuitry 1224 can select the storage location that makes more frequently used/requested data easily accessible and makes less frequently used/requested data take up less storage space, memory bandwidth, retention cost, etc. closer to the Edge.

At block 1806, the ADM system 1200 predicts the storage space, storage power consumption cost, and the transmission power consumption cost of the ingested data and/or the graph model based on the quantified retention cost. For example, the algorithm execution circuitry 1224 executes AI/ML algorithms to predict and/or continuously learn how much overhead the ingested data and/or the graph model is to consume based on the consumption status of the ingested data and/or the graph model and the retention cost of the ingested data and/or the graph model. For example, based on the consumption status of the ingested data, it may or may not be worthwhile to store the ingested data in hot storage where the retention cost would be higher than it would be to store the ingested data in cold storage.

At block 1808, the ADM system 1200 predicts the storage location of the graph model and/or the ingested data based on the uniqueness of the ingested data. For example, the algorithm execution circuitry 1224 executes AI/ML algorithms to predict and/or continuously learn where to store the ingested data such that it is substantially unique relative to other raw data and/or metadata at the same storage location. If the ingested data is stored in a location where other stored data and/or graph model(s) are similar to a certain degree, then it would be more efficient to store the ingested data in a different storage level (e.g., hot storage, warm storage, cold storage, etc.) or in a different storage location (e.g., on a different Edge node). At block 1810, the ADM system 1200 determines if the predictions satisfy a hot storage policy of the ingested data graph model and/or ADM system 1200. For example, the algorithm execution circuitry 1224 accumulates the predictions made at blocks 1804, 1806, and 1808 to determine if the individual predictions satisfy hot storage parameters for each of the consumption status, the retention cost, and/or the data uniqueness.

At block 1812, the ADM system 1200 gives instructions to store the ingested data in hot storage (e.g., cached memory, RAM, volatile memory, etc.). For example, if the algorithm execution circuitry 1224 determines that the predictions made at block 1810 satisfy enough hot storage parameters to satisfy the hot storage policy, then the algorithm execution circuitry 1224 outputs instructions to store the ingested data in hot storage. Following completion of block 1812, the process 1800 returns to block 1722 where the ADM system 1200 determines if the ingested data is to be retained based on the graph model prediction.

At block 1814, the ADM system 1200 determines if the predictions satisfy a warm storage policy of the ingested data graph model and/or ADM system 1200. For example, if the predictions do not satisfy the hot storage policy, then the algorithm execution circuitry 1224 accumulates the predictions made at blocks 1804, 1806, and 1808 to determine if the individual predictions satisfy warm storage parameters for each of the consumption status, the retention cost, and/or the data uniqueness.

At block 1816, the ADM system 1200 gives instructions to store the ingested data in warm storage (e.g., non-volatile memory, SSD, etc.). For example, if the algorithm execution circuitry 1224 determines that the predictions made at block 1814 satisfy enough warm storage parameters to satisfy the warm storage policy, then the algorithm execution circuitry 1224 outputs instructions to store the ingested data in warm storage. Following completion of block 1816, the process 1800 returns to block 1722 where the ADM system 1200 determines if the ingested data is to be retained based on the graph model prediction.

At block 1818, the ADM system 1200 determines if the predictions satisfy a cold storage policy of the ingested data graph model and/or ADM system 1200. For example, if the predictions do not satisfy the warm storage policy, then the algorithm execution circuitry 1224 accumulates the predictions made at blocks 1804, 1806, and 1808 to determine if the individual predictions satisfy cold storage parameters for each of the consumption status, the retention cost, and/or the data uniqueness.

At block 1820, the ADM system 1200 gives instructions to store the ingested data in cold storage (e.g., Edge aggregation node, central cloud/data center, etc.). For example, if the algorithm execution circuitry 1224 determines that the predictions made at block 1818 satisfy enough cold storage parameters to satisfy the cold storage policy, then the algorithm execution circuitry 1224 outputs instructions to store the ingested data in cold storage. Following completion of block 1820, the process 1800 returns to block 1722 where the ADM system 1200 determines if the ingested data is to be retained based on the graph model prediction.

At block 1822, the ADM system 1200 gives instructions to discard the ingested data. For example, if the predictions accumulated and analyzed at blocks 1810, 1814, and 1818 do not satisfy the hot storage policy, the warm storage policy, nor the cold storage policy, respectively, then the algorithm execution circuitry 1224 predicts that the ingested data is not to be consumed frequently enough, is to have too high of a retention cost, and/or is not unique enough to retain and/or to store along with the graph model with the ingested data. Following completion of block 1822, the process 1800 returns to block 1722 where the ADM system 1200 determines if the ingested data is to be retained based on the graph model prediction.

FIG. 19 is a flowchart representative of example machine readable instructions and/or example operations 1900 that may be executed and/or instantiated by processor circuitry to predict usage models and generate retention decisions based on a consumption status, a retention cost, a data uniqueness, a data coverage, and a cyclical event reoccurrence of the stored data and/or the graph model(s) associated with the stored data. The machine readable instructions and/or the operations 1800 of FIG. 18 begin at block 1802 at which the ADM system 1300 preprocesses stored data received from the cloud network 1302 (e.g., Edge cloud 110). For example, the graph model determination circuitry 1312 can retrieve stored data from the cloud 1302 and/or the distributed datastore 1306 for analysis and/or graph model determination/association.

At block 1904, the ADM system 1300 determines the graph model associated with the stored data. For example, the graph model determination circuitry 1312 can correlate the stored data with an existing graph model based on the metadata of the stored data and the index table of the existing graph model. Additionally or alternatively, the graph model determination circuitry 1312 can generate a new graph model and a new index table correlating to the metadata of the stored data as shown by process 1600 of FIG. 16.

At block 1906, the ADM system 1300 determines the consumption status of the graph model based on a query to the cloud 1302. For example the consumption status determination circuitry 1316 queries the cloud 1302 and/or the distributed datastore 1306 to return a result indicating where (e.g., at what Edge nodes, memory locations, etc.) the graph model associated with the stored data is most often used/requested, how often the graph model is used/requested, where the different nodes of the graph model are stored, the consumption form (e.g., raw and/or compressed) of the graph model nodes, how long the graph model is used before the nodes therein are invalid, etc. The consumption status determination circuitry 1316 can output a result (e.g., tabulated result) that indicates the various consumption status factors of the graph model with which the stored data is associated.

At block 1908, the ADM system 1300 quantifies the retention cost of storing the stored data. For example, the data retention circuitry 1318 can determine the storage space the stored data is to take up, the power consumed to store the stored data, the power consumed to transmit (e.g., input and output) the stored data, etc. The data retention circuitry 1318 can determine a result that includes the retention cost factors of the stored data and that contributes to the graph model prediction and/or the stored data retention decision.

At block 1910, the ADM system 1300 assesses the data uniqueness of the stored data based on a query to the cloud 1302. For example, the data uniqueness assessment circuitry 1320 can compare the stored data to nodes in the associated graph model to determine if the stored data has raw data and/or metadata in common with other data nodes in the graph model. For example, the stored data may be a first image that is relatively unchanged from a second image previously generated. The uniqueness of the stored data can factor into the graph model prediction and/or the retention decision for the stored data.

At block 1912, the ADM system 1300 determines the data coverage of the stored data and/or the graph model based on the usage of the stored data and/or the graph model across applications and users in the Edge network. For example, the consumption status determination circuitry 1316 can determine where (e.g., at which Edge nodes, access points, IoT devices, etc.) the stored data and/or the graph model is/are stored, used, and/or requested. The data coverage can contribute to where the stored data is best retained based on where the stored data is most frequently accessed.

At block 1914, the ADM system 1300 recognizes and/or predicts cyclical events that occur in association with the stored data and/or the graph model. For example, the cyclical event recognition circuitry 1326 identifies recurring events (e.g., product launches, tax times, quarterly filings, etc.) that occur as a pattern and involve the stored data and/or the graph model. If the cyclical event recognition circuitry 1326 determines that first stored data is used more often at the end of the year than second stored data, then the cyclical event determination may contribute to a retention decision to relegate the first stored data to hot storage at the end of the year while a similar retention decision may not be made for the second stored data.

At block 1916, the ADM system 1300 predicts the graph model and/or the stored data based on the consumption status, the retention cost, the data uniqueness, the data coverage, and the cyclical events of the stored data. For example, if the stored data is consumed at a higher-than-average rate, the algorithm execution circuitry 1324 executes algorithm(s) (e.g., algorithm(s) 638) to determine where and/or how to retain the stored data and/or associated graph model based on the factors that the analytics management circuitry 1304 previously determined. Further description of subprocess 1916 are described below regarding process 2000 of FIG. 20.

At block 1918, the ADM system 1300 determines if the stored data is to be retained based on the predictions the algorithm execution circuitry 1324 output at block 1916. For example, if the algorithm execution circuitry 1324 determines that the consumption status, the retention cost, the uniqueness, the data coverage, and/or the cyclical events do not satisfy the hot storage policies, the warm storage policies, or the cold storage policies, then the algorithm execution circuitry 1324 outputs instructions to discard the stored data.

At block 1920, the ADM system 1300 discards the stored data if the output of block 1918 reflects such a decision. For example, if the algorithm execution circuitry 1324 gives instructions to discard the stored data, the data retention circuitry 1318 discards (e.g., does not relegate or retain) the stored data. Following the completion of block 1920, the process 1900 ends.

At block 1922, the ADM system 1300 determines if instructions were given to relegate the stored data and/or the graph model based on the graph model prediction. For example, the data retention circuitry 1318 determines if the algorithm execution circuitry 1324 output instructions to move (e.g., relegate) the stored data to hot storage, warm storage, or cold storage. If the algorithm execution circuitry 1324 did not give instructions to move or remove the stored data, then process 1900 ends.

At block 1924, the ADM system 1300 promotes or demotes the stored data and/or the graph model based on the graph model prediction that the algorithm execution circuitry 1324 outputs. For example, if the algorithm execution circuitry 1324 gives instructions to move the stored data from warm storage to hot storage, then the data retention circuitry 1318 promotes the stored data from its current storage location to a storage location (e.g., memory) that is more volatile and/or more easily accessible relative to the warm storage location. In such an example, the data retention circuitry 1318 may determine that the stored data is to be stored in cache memory on the same Edge node where the graph model is stored.

At block 1926, the ADM system 1300 modifies the metadata of the store data and/or the graph model based on the graph model prediction. For example, the metadata/data enrichment circuitry 1322 adds, removes, and/or changes descriptions in the metadata to reflect changes in the storage location, content, and/or associations of the stored data and/or the graph model Following the completion of block 1926, the process 1900 ends.

FIG. 20 is a flowchart representative of example machine readable instructions and/or example operations 2000 that may be executed and/or instantiated by processor circuitry to predict graph model and/or stored data retention decisions based on the consumption status, the retention cost, the data uniqueness, the data coverage, and/or the cyclical events of the stored data and/or the graph model(s) associated with the stored data. The machine readable instructions and/or the operations 2000 of FIG. 20 can be executed and/or instantiated by processor circuitry to implement block 1916 of FIG. 19. The machine readable instructions and/or the operations 2000 of FIG. 20 begin at block 2002 at which the ADM system 1300 signals to the algorithm execution circuitry 1324 that the subprocess, operation, and/or function for predicting the graph model and/or the stored data has begun. For example, the algorithm execution circuitry 1324 can request the consumption status and the data coverage of the stored data and/or the graph model from the consumption status determination circuitry 1316.

At block 2004, the ADM system 1300 predicts where the graph model and/or the stored data are to be most frequently used and/or requested based on the consumption status and the data coverage. For example, the algorithm execution circuitry 1324 executes AI/ML algorithms to predict and/or continuously learn where the stored data and/or the graph model are to be most frequently used/requested based on the consumption status and the data coverage. The algorithm execution circuitry 1324 can select the storage location that makes more frequently used/requested data easily accessible and makes less frequently used/requested data take up less storage space, memory bandwidth, retention cost, etc. in data storage locations that are closer to the Edge.

At block 2006, the ADM system 1300 predicts the storage space, storage power consumption cost, and the transmission power consumption cost of the stored data and/or the graph model based on the quantified retention cost. For example, the algorithm execution circuitry 1324 executes AI/ML algorithms to predict and/or continuously learn how much overhead the stored data and/or the graph model is to consume based on the consumption status of the stored data and/or the graph model and the retention cost of the stored data and/or the graph model. For example, based on the consumption status of the stored data, it may or may not be worthwhile to store the stored data in hot storage where the retention cost would be higher than it would be to store the stored data in cold storage.

At block 2008, the ADM system 1300 predicts the storage location of the graph model and/or the stored data based on the uniqueness of the stored data. For example, the algorithm execution circuitry 1324 executes AI/ML algorithms to predict and/or continuously learn where to store the stored data such that it is substantially unique relative to other raw data and/or metadata at the same storage location. If the stored data is stored in a location where other stored data and/or graph model(s) are similar to a certain degree, then it would be more efficient to store the stored data in a different storage level (e.g., hot storage, warm storage, cold storage, etc.) or in a different storage location (e.g., on a different Edge node).

At block 2010, the ADM system 1300 predicts the nominal traffic of the graph model and/or the stored data based on cyclical events. For example, the algorithm execution circuitry 1324 executes AI/ML algorithms to predict and/or continuously learn where to store the stored data such that the stored data is readily available to users, operators, applications, etc. that frequently use and/or request the stored data at recurring time periods. For example, financial data in cold storage may be pulled to hot storage at the end of a fiscal year such that a financial department can quickly call the financial data.

At block 2012, the ADM system 1300 determines if the predictions satisfy a hot storage policy of the stored data graph model and/or ADM system 1300. For example, the algorithm execution circuitry 1324 accumulates the predictions made at blocks 2004, 2006, 2008, and 2010 to determine if the individual predictions satisfy hot storage parameters for each of the consumption status, the retention cost, the data uniqueness, the data coverage, and/or the cyclical events.

At block 2014, the ADM system 1300 gives instructions to store the stored data in hot storage (e.g., cached memory, RAM, volatile memory, etc.). For example, if the algorithm execution circuitry 1324 determines that the predictions made at block 2012 satisfy enough hot storage parameters to satisfy the hot storage policy, then the algorithm execution circuitry 1324 outputs instructions to store the stored data in hot storage. Following completion of block 2014, the process 2000 returns to block 1918 where the ADM system 1300 determines if the stored data is to be retained based on the graph model prediction.

At block 2016, the ADM system 1300 determines if the predictions satisfy a warm storage policy of the stored data graph model and/or ADM system 1300. For example, if the predictions do not satisfy the hot storage policy, then the algorithm execution circuitry 1324 accumulates the predictions made at blocks 2004, 2006, 2008, and 2010 to determine if the individual predictions satisfy warm storage parameters for each of the consumption status, the retention cost, the data uniqueness, the data coverage, and/or the cyclical events.

At block 2018, the ADM system 1300 gives instructions to store the stored data in warm storage (e.g., non-volatile memory, SSD, etc.). For example, if the algorithm execution circuitry 1324 determines that the predictions made at block 2016 satisfy enough warm storage parameters to satisfy the warm storage policy, then the algorithm execution circuitry 1324 outputs instructions to store the stored data in warm storage. Following completion of block 2018, the process 2000 returns to block 1918 where the ADM system 1300 determines if the stored data is to be retained based on the graph model prediction.

At block 2020, the ADM system 1300 determines if the predictions satisfy a cold storage policy of the stored data graph model and/or ADM system 1300. For example, if the predictions do not satisfy the warm storage policy, then the algorithm execution circuitry 1324 accumulates the predictions made at blocks 2004, 2006, 2008, and 2010 to determine if the individual predictions satisfy cold storage parameters for each of the consumption status, the retention cost, the data uniqueness, the data coverage, and/or the cyclical events.

At block 2022, the ADM system 1300 gives instructions to store the stored data in cold storage (e.g., Edge aggregation node, central cloud/data center, etc.). For example, if the algorithm execution circuitry 1324 determines that the predictions made at block 2020 satisfy enough cold storage parameters to satisfy the cold storage policy, then the algorithm execution circuitry 1324 outputs instructions to store the stored data in cold storage. Following completion of block 2020, the process 2000 returns to block 1918 where the ADM system 1300 determines if the stored data is to be retained based on the graph model prediction.

At block 2024, the ADM system 1300 determines if the lifetime of the stored data is within a validity time of the stored data. For example, if the predictions accumulated and analyzed at blocks 2012, 2016, and 2020 do not satisfy the hot storage policy, the warm storage policy, nor the cold storage policy, respectively, then the algorithm execution circuitry 1324 determines if the stored data is still valid (e.g., has not been rendered unusable due to an update). If the algorithm execution circuitry 1324 determines that the stored data is still valid, then no instructions regarding retention of the stored data are generated, and process 2000 returns to block 1918 where the ADM system 1300 determines if the stored data is to be retained based on the graph model prediction.

At block 2026, the ADM system 200 gives instructions to remove the stored data from storage. For example, if the algorithm execution circuitry 1324 determines that the stored data does not satisfy the hot storage policy, the warm storage policy, nor the cold storage policy, and if the algorithm execution circuitry 1324 determines that the lifetime of the stored data is not within the validity time, then the algorithm execution circuitry 1324 generates instructions to discard the stored data. The instructions are returned to the data retention circuitry 1318, which removes the stored data from memory. Following completion of block 2026, the process 2000 returns to block 1918 where the ADM system 1300 determines if the stored data is to be retained based on the graph model prediction.

FIG. 21 is a block diagram of an example processor platform 2100 structured to execute and/or instantiate the machine readable instructions and/or the operations of FIGS. 15-20 to implement the example ADM systems 1200, 1300 of FIGS. 12 and 13. The processor platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2100 of the illustrated example includes processor circuitry 2112. The processor circuitry 2112 of the illustrated example is hardware. For example, the processor circuitry 2112 can be implemented by one or more integrated circuits, logic circuits, FPGAs, microprocessors, CPUs, GPUs, DSPs, and/or microcontrollers from any desired family or manufacturer. The processor circuitry 2112 may be implemented by one or more semiconductor based (e.g., silicon based) devices. In this example, the processor circuitry 2112 implements the example graph model determination circuitry 1212, 1312, the example contextual analyzation circuitry 1214, 1314, the example data retention circuitry 1218, 1318, the example data uniqueness assessment circuitry 1220, 1320, the example algorithm execution circuitry 1224, 1324, the example metadata/data enrichment circuitry 1322, the example cyclical event recognition circuitry 1326, the example preprocessing management circuitry 1228, and/or the example descriptive metadata generation circuitry 1230.

The processor circuitry 2112 of the illustrated example includes a local memory 2113 (e.g., a cache, registers, etc.). The processor circuitry 2112 of the illustrated example is in communication with a main memory including a volatile memory 2114 and a non-volatile memory 2116 by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117.

The processor platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2122 are connected to the interface circuitry 2120. The input device(s) 2122 permit(s) a user to enter data and/or commands into the processor circuitry 2112. The input device(s) 2122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2124 are also connected to the interface circuitry 2120 of the illustrated example. The output device(s) 2124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2100 of the illustrated example also includes one or more mass storage devices 2128 to store software and/or data. Examples of such mass storage devices 2128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 2132, which may be implemented by the machine readable instructions of FIGS. 15-20, may be stored in the mass storage device 2128, in the volatile memory 2114, in the non-volatile memory 2116, and/or on a removable non-transitory computer readable storage medium such as a CD or DVD.

The processor platform 2100 of the illustrated example of FIG. 21 includes example acceleration circuitry 2140, which includes an example GPU 2142, an example vision processing unit (VPU) 2144, and an example neural network processor 2146. In this example, the GPU 2142, the VPU 2144, the neural network processor 2146, and/or, more generally, the acceleration circuitry 2140, are in communication with different hardware of the processor platform 2100, such as the volatile memory 2114, the non-volatile memory 2116, etc., via the bus 2118. In this example, the neural network processor 2146 may be implemented by one or more integrated circuits, logic circuits, microprocessors, GPUs, DSPs, or controllers from any desired family or manufacturer that can be used to execute an AI/ML model. In some examples, one or more of the example graph model determination circuitry 1212, 1312, the example contextual analyzation circuitry 1214, 1314, the example consumption status determination circuitry 1216, 1316, the example data retention circuitry 1218, 1318, the example data uniqueness assessment circuitry 1220, 1222, the example algorithm execution circuitry 1224, 1324, the example metadata/data enrichment circuitry 1322, the example cyclical event recognition circuitry 1326, the example preprocessing management circuitry 1228, and/or the example descriptive metadata generation circuitry 1230 can be implemented in or with at least one of the GPU 2142, the VPU 2144, the neural network processor 2146, and/or, more generally, the acceleration circuitry 2140, instead of or in addition to the processor circuitry 2112 and/or the interface circuitry 2120.

From the foregoing, it will be appreciated that example systems, methods, apparatus, and articles of manufacture have been disclosed that predict retention decisions of for the graph model, the ingested data, and/or the stored data based on the consumption status, the retention cost, the uniqueness, the data coverage, and/or the cyclical events of the graph model, the ingested data, and/or the stored data. Disclosed systems, methods, apparatus, and articles of manufacture improve the efficiency of using a computing device by retaining, relegating, or otherwise moving the graph model, the stored data, and/or the ingested data to at least one of hot storage, warm storage, or cold storage such that the retained data is either in a more easily accessible storage location (e.g., hotter storage) than the previous storage location or consumes a lesser storage cost (e.g., colder storage) than the previous storage location. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to perform continuous learning, predictions, insights, and adaptive data retention are disclosed herein. Further examples and combinations thereof include the following:

Example 50 includes an apparatus for data retention, the apparatus comprising interface circuitry to at least one of store ingested data or access stored data, and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate descriptive metadata generation circuitry to determine metadata for at least one of the ingested data or the stored data, graph model determination circuitry to generate at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model, and data retention circuitry to retain at least one of the ingested data or the stored data based on respective ones of the first graph model or the second graph model.

In Example 51, the subject matter of Example 50 can optionally include that the graph model determination circuitry is to generate the first graph model including the first adjacent nodes and the second graph model including the second adjacent nodes, wherein the first adjacent nodes represent metadata associated with the ingested data and the second adjacent nodes represent metadata associated with the stored data.

In Example 52, the subject matter of Examples 50-51 can optionally include that the descriptive metadata generation circuitry is to associate one or more data blocks with the metadata, the data blocks including at least one of a data validity block, a content type block, a content description block, or a resource allocation block.

In Example 53, the subject matter of Examples 50-52 can optionally include that the graph model determination circuitry is to connect the ingested data to the first adjacent nodes within the first graph model based on a first portion of metadata of the ingested data matching a second portion of metadata of the first adjacent nodes, and connect the stored data to the second adjacent nodes within the second graph model based on a third portion of metadata of the stored data matching a fourth portion of metadata of the second adjacent nodes.

In Example 54, the subject matter of Examples 50-53 can optionally include that data retention circuitry is to determine a consumption status of the stored data, the consumption status including at least one of a frequency of use of the stored data, a consumption form of the stored data in use, or a validity time of the stored data, calculate a retention cost of the stored data, the retention cost representative of a quantification of at least one of storage space used to store the stored data, first power consumption to store the stored data, or second power consumption to at least one of write or read the stored data, and retain the stored data in response to at least one of the consumption status or the retention cost satisfying a first threshold.

In Example 55, the subject matter of Examples 50-54 can optionally include that the processor circuitry is to perform at least one of the first operations, the second operations, or the third operations to instantiate algorithm execution circuitry to predict a frequency at which the stored data is to be used based on at least one of the consumption status, the validity time, or a data coverage of the first adjacent nodes in the first graph model, and select a storage retention for the stored data based on at least one of the consumption status, the validity time, the data coverage, or a contextual data association, the storage retention including a promotion or a demotion of the stored data, the promotion to cause the stored data to have a first level of accessibility, the demotion to cause the stored data to have a second level of accessibility, the second level of accessibility to be less than the first level of accessibility.

In Example 56, the subject matter of Examples 50-55 can optionally include that the graph model determination circuitry is to create one or more copies of the first graph model or the second graph model in one or more Edge nodes, the one or more Edge nodes to use the first graph model or the second graph model based on at least one of the consumption status, the validity time, or the data coverage of the first graph model of the second graph model.

In Example 57, the subject matter of Examples 50-56 can optionally include that wherein the processor circuitry is to perform at least one of the first operations, the second operations, or the third operations to instantiate data uniqueness assessment circuitry to assess a first uniqueness of the stored data, the first uniqueness including a first comparison of one or more characteristics similar to the stored data and the second adjacent nodes, and cyclical event recognition circuitry to associate a cyclical trend of critical events with at least one of a first pattern of use of the stored data, a second pattern of use of the second adjacent nodes, first nominal traffic of the stored data, or second nominal traffic of the second adjacent nodes, the data retention circuitry to retain the stored data in response to at least one of the first uniqueness or the cyclical trend satisfying a second threshold.

In Example 58, the subject matter of Examples 50-57 can optionally include that the data retention circuitry is to determine whether the ingested data is to be stored based on a second uniqueness of the ingested data, the second uniqueness including a second comparison of one or more characteristics similar to the ingested data and the first adjacent nodes, and in response to the second uniqueness satisfying a third threshold, select a storage location for the ingested data based on the storage location of the first adjacent nodes in the first graph model relative to where the ingested data was ingested, the storage location to be at least one of a hot storage, a warm storage, or a cold storage.

In Example 59, the subject matter of Examples 50-58 can optionally include that the descriptive metadata generation circuitry is to update the metadata stored in a distributed datastore based on at least one of singular usage, block usage, or sequential usage of at least one of the stored data, the first adjacent nodes, or the second adjacent nodes.

Example 60 includes an apparatus comprising at least one memory, instructions in the apparatus, and processor circuitry to execute the instructions to create metadata for at least one of ingested data or stored data, generate at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model, and store at least one of the ingested data or the stored data based on respective ones of the first graph model or the second graph model.

In Example 61, the subject matter of Example 60 can optionally include that the processor circuitry is to generate the first graph model including the first adjacent nodes and the second graph model including the second adjacent nodes, wherein the first adjacent nodes represent metadata associated with the ingested data and the second adjacent nodes represent metadata associated with the stored data.

In Example 62, the subject matter of Examples 60-61 can optionally include that the processor circuitry is to describe one or more data blocks with the metadata, the data blocks including at least one of a data validity block, a content type block, a content description block, or a resource allocation block.

In Example 63, the subject matter of Examples 60-62 can optionally include that the processor circuitry is to correlate the ingested data to the first adjacent nodes within the first graph model based on a first portion of metadata of the ingested data matching a second portion of metadata of the first adjacent nodes, and correlate the stored data to the second adjacent nodes within the second graph model based on a third portion of metadata of the stored data matching a fourth portion of metadata of the second adjacent nodes.

In Example 64, the subject matter of Examples 60-63 can optionally include that the processor circuitry is to determine a consumption status of the stored data, the consumption status including at least one of a frequency of use of the stored data, a consumption form of the stored data in use, or a validity time of the stored data, calculate a retention cost of the stored data, the retention cost representative of a quantification of at least one of storage space used to store the stored data, first power consumption to store the stored data, or second power consumption to at least one of write or read the stored data, and retain the stored data in response to at least one of the consumption status or the retention cost satisfying a first threshold.

In Example 65, the subject matter of Examples 60-64 can optionally include that the processor circuitry is to predict a frequency at which the stored data is to be used based on at least one of the consumption status, the validity time, or a data coverage of the first adjacent nodes in the first graph model, and select a storage retention for the stored data based on at least one of the consumption status, the validity time, the data coverage, or a contextual data association, the storage retention including a promotion or a demotion of the stored data, the promotion to cause the stored data to have a first level of accessibility, the demotion to cause the stored data to have a second level of accessibility, the second level of accessibility to be less than the first level of accessibility.

In Example 66, the subject matter of Examples 60-65 can optionally include that the processor circuitry is to generate one or more copies of the first graph model or the second graph model in one or more Edge nodes, the one or more Edge nodes to use the first graph model or the second graph model based on at least one of the consumption status, the validity time, or the data coverage of the first graph model of the second graph model.

In Example 67, the subject matter of Examples 60-66 can optionally include that the processor circuitry is to assess a first uniqueness of the stored data, the first uniqueness including a first comparison of one or more characteristics similar to the stored data and the second adjacent nodes, and associate a cyclical trend of critical events with at least one of a first pattern of use of the stored data, a second pattern of use of the second adjacent nodes, first nominal traffic of the stored data, or second nominal traffic of the second adjacent nodes, the processor circuitry to move the stored data in response to at least one of the first uniqueness or the cyclical trend satisfying a second threshold.

In Example 68, the subject matter of Examples 60-67 can optionally include that processor circuitry is to determine whether the ingested data is to be stored based on a second uniqueness of the ingested data, the second uniqueness including a second comparison of one or more characteristics similar to the ingested data and the first adjacent nodes, and in response to the second uniqueness satisfying a third threshold, select a storage location for the ingested data based on the storage location of the first adjacent nodes in the first graph model relative to where the ingested data was ingested, the storage location to be at least one of a hot storage, a warm storage, or a cold storage.

In Example 69, the subject matter of Examples 60-68 can optionally include that the processor circuitry is to modify the metadata stored in a distributed datastore based on at least one of singular usage, block usage, or sequential usage of at least one of the stored data, the first adjacent nodes, or the second adjacent nodes.

Example 70 includes an apparatus comprising means for determining metadata for at least one of ingested data or stored data, means for generating at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model, means for retaining at least one of the ingested data or the stored data based on respective ones of the first graph model or the second graph model.

In Example 71, the subject matter of Example 70 can optionally include that the means for generating is to generate the first graph model including the first adjacent nodes and the second graph model including the second adjacent nodes, wherein the first adjacent nodes represent metadata associated with the ingested data and the second adjacent nodes represent metadata associated with the stored data.

In Example 72, the subject matter of Examples 70-71 can optionally include that the means for determining is to associate one or more data blocks with the metadata, the data blocks including at least one of a data validity block, a content type block, a content description block, or a resource allocation block.

In Example 73, the subject matter of Examples 70-72 can optionally include that the means for generating is to connect the ingested data to the first adjacent nodes within the first graph model based on a first portion of metadata of the ingested data matching a second portion of metadata of the first adjacent nodes, and connect the stored data to the second adjacent nodes within the second graph model based on a third portion of metadata of the stored data matching a fourth portion of metadata of the second adjacent nodes.

In Example 74, the subject matter of Examples 70-73 can optionally include means for defining a consumption status of the stored data, the consumption status including at least one of a frequency of use of the stored data, a consumption form of the stored data in use, or a validity time of the stored data, means for quantifying a retention cost of the stored data, the retention cost representative of a quantification of at least one of storage space used to store the stored data, first power consumption to store the stored data, or second power consumption to at least one of write or read the stored data, and wherein the means for retaining is to relocate the stored data in response to at least one of the consumption status or the retention cost satisfying a first threshold.

In Example 75, the subject matter of Examples 70-74 can optionally include means for predicting a frequency at which the stored data is to be used based on at least one of the consumption status, the validity time, or a data coverage of the first adjacent nodes in the first graph model, wherein the means for predicting is to select a storage retention for the stored data based on at least one of the consumption status, the validity time, the data coverage, or a contextual data association, the storage retention including a promotion or a demotion of the stored data, the promotion to cause the stored data to have a first level of accessibility, the demotion to cause the stored data to have a second level of accessibility, the second level of accessibility to be less than the first level of accessibility.

In Example 76, the subject matter of Examples 70-75 can optionally include that the means for generating is to create one or more copies of the first graph model or the second graph model in one or more Edge nodes, the one or more Edge nodes to use the first graph model or the second graph model based on at least one of the consumption status, the validity time, or the data coverage of the first graph model of the second graph model.

In Example 77, the subject matter of Examples 70-76 can optionally include means for assessing a first uniqueness of the stored data, the first uniqueness including a first comparison of one or more characteristics similar to the stored data and the second adjacent nodes, and means for associating a cyclical trend of critical events with at least one of a first pattern of use of the stored data, a second pattern of use of the second adjacent nodes, first nominal traffic of the stored data, or second nominal traffic of the second adjacent nodes, wherein the means for retaining is to move the stored data in response to at least one of the first uniqueness or the cyclical trend satisfying a second threshold.

In Example 78, the subject matter of Examples 70-77 can optionally include that the means for retaining is to determine whether the ingested data is to be stored based on a second uniqueness of the ingested data, the second uniqueness including a second comparison of one or more characteristics similar to the ingested data and the first adjacent nodes, and in response to the second uniqueness satisfying a third threshold, select a storage location for the ingested data based on the storage location of the first adjacent nodes in the first graph model relative to where the ingested data was ingested, the storage location to be at least one of a hot storage, a warm storage, or a cold storage.

In Example 79, the subject matter of Examples 70-78 can optionally include that the means for determining is to update the metadata stored in a distributed datastore based on at least one of singular usage, block usage, or sequential usage of at least one of the stored data, the first adjacent nodes, or the second adjacent nodes.

Example 80 includes at least one computer readable medium comprising instructions that, when executed, cause processor circuitry to at least generate metadata for at least one of ingested data or stored data, determine at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model, and store at least one of the ingested data or the stored data based on respective ones of the first graph model or the second graph model.

In Example 81, the subject matter of Example 80 can optionally include that the instructions, when executed, cause the processor circuitry to determine the first graph model including the first adjacent nodes and the second graph model including the second adjacent nodes, wherein the first adjacent nodes represent metadata associated with the ingested data and the second adjacent nodes represent metadata associated with the stored data.

In Example 82, the subject matter of Examples 80-81 can optionally include that the instructions, when executed, cause the processor circuitry to associate one or more data blocks with the metadata, the data blocks including at least one of a data validity block, a content type block, a content description block, or a resource allocation block.

In Example 83, the subject matter of Examples 80-82 can optionally include that the instructions, when executed, cause the processor circuitry to connect the ingested data to the first adjacent nodes within the first graph model based on a first portion of metadata of the ingested data matching a second portion of metadata of the first adjacent nodes, and connect the stored data to the second adjacent nodes within the second graph model based on a third portion of metadata of the stored data matching a fourth portion of metadata of the second adjacent nodes.

In Example 84, the subject matter of Examples 80-83 can optionally include that the instructions, when executed, cause the processor circuitry to determine a consumption status of the stored data, the consumption status including at least one of a frequency of use of the stored data, a consumption form of the stored data in use, or a validity time of the stored data, calculate a retention cost of the stored data, the retention cost representative of a quantification of at least one of storage space used to store the stored data, first power consumption to store the stored data, or second power consumption to at least one of write or read the stored data, and retain the stored data in response to at least one of the consumption status or the retention cost satisfying a first threshold.

In Example 85, the subject matter of Examples 80-84 can optionally include that the instructions, when executed, cause the processor circuitry to predict a frequency at which the stored data is to be used based on at least one of the consumption status, the validity time, or a data coverage of the first adjacent nodes in the first graph model, and select a storage retention for the stored data based on at least one of the consumption status, the validity time, the data coverage, or a contextual data association, the storage retention including a promotion or a demotion of the stored data, the promotion to cause the stored data to have a first level of accessibility, the demotion to cause the stored data to have a second level of accessibility, the second level of accessibility to be less than the first level of accessibility.

In Example 86, the subject matter of Examples 80-85 can optionally include that the instructions, when executed, cause the processor circuitry to create one or more copies of the first graph model or the second graph model in one or more Edge nodes, the one or more Edge nodes to use the first graph model or the second graph model based on at least one of the consumption status, the validity time, or the data coverage of the first graph model of the second graph model.

In Example 87, the subject matter of Examples 80-86 can optionally include that the instructions, when executed, cause the processor circuitry to assess a first uniqueness of the stored data, the first uniqueness including a first comparison of one or more characteristics similar to the stored data and the second adjacent nodes, and associate a cyclical trend of critical events with at least one of a first pattern of use of the stored data, a second pattern of use of the second adjacent nodes, first nominal traffic of the stored data, or second nominal traffic of the second adjacent nodes, wherein the instructions, when executed, further cause the processor circuitry to retain the stored data in response to at least one of the first uniqueness or the cyclical trend satisfying a second threshold.

In Example 88, the subject matter of Examples 80-87 can optionally include that the instructions, when executed, cause the processor circuitry to determine whether the ingested data is to be stored based on a second uniqueness of the ingested data, the second uniqueness including a second comparison of one or more characteristics similar to the ingested data and the first adjacent nodes, and in response to the second uniqueness satisfying a third threshold, select a storage location for the ingested data based on the storage location of the first adjacent nodes in the first graph model relative to where the ingested data was ingested, the storage location to be at least one of a hot storage, a warm storage, or a cold storage.

In Example 89, the subject matter of Examples 80-88 can optionally include that the instructions, when executed, cause the processor circuitry to update the metadata stored in a distributed datastore based on at least one of singular usage, block usage, or sequential usage of at least one of the stored data, the first adjacent nodes, or the second adjacent nodes.

Example 90 includes a method comprising determining metadata for at least one of ingested data or stored data, generating at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model, retaining at least one of the ingested data or the stored data based on respective ones of the first graph model or the second graph model.

In Example 91, the subject matter of Example 90 can optionally include that the generating of the at least one strength vector includes generating the first graph model including the first adjacent nodes and the second graph model including the second adjacent nodes, wherein the first adjacent nodes represent metadata associated with the ingested data and the second adjacent nodes represent metadata associated with the stored data.

In Example 92, the subject matter of Examples 90-91 can optionally include that the determining of the metadata includes associating one or more data blocks with the metadata, the data blocks including at least one of a data validity block, a content type block, a content description block, or a resource allocation block.

In Example 93, the subject matter of Examples 90-92 can optionally include that linking the ingested data to the first adjacent nodes within the first graph model based on a first portion of metadata of the ingested data matching a second portion of metadata of the first adjacent nodes, and linking the stored data to the second adjacent nodes within the second graph model based on a third portion of metadata of the stored data matching a fourth portion of metadata of the second adjacent nodes.

In Example 94, the subject matter of Examples 90-93 can optionally include that determining a consumption status of the stored data, the consumption status including at least one of a frequency of use of the stored data, a consumption form of the stored data in use, or a validity time of the stored data, calculating a retention cost of the stored data, the retention cost representative of a quantification of at least one of storage space used to store the stored data, first power consumption to store the stored data, or second power consumption to at least one of write or read the stored data, and retaining the stored data in response to at least one of the consumption status or the retention cost satisfying a first threshold.

In Example 95, the subject matter of Examples 90-94 can optionally include that the retaining of the stored data includes predicting a frequency at which the stored data is to be used based on at least one of the consumption status, the validity time, or a data coverage of the first adjacent nodes in the first graph model, selecting a storage relegation for the stored data based on at least one of the consumption status, the validity time, the data coverage, or a contextual data association, the storage relegation including a promotion or a demotion of the stored data, the promotion to cause the stored data to have a first level of accessibility, the demotion to cause the stored data to have a second level of accessibility, the second level of accessibility to be less than the first level of accessibility, and example 96 includes the method of example 90, further including creating one or more copies of the first graph model or the second graph model in one or more Edge nodes, the one or more Edge nodes to use the first graph model or the second graph model based on at least one of the consumption status, the validity time, or the data coverage of the first graph model of the second graph model.

In Example 97, the subject matter of Examples 90-96 can optionally include that assessing a first uniqueness of the stored data, the first uniqueness including a first comparison of one or more characteristics similar to the stored data and the second adjacent nodes, and associating a cyclical trend of critical events with at least one of a first pattern of use of the stored data, a second pattern of use of the second adjacent nodes, first nominal traffic of the stored data, or second nominal traffic of the second adjacent nodes, including retaining of the stored data in response to at least one of the first uniqueness or the cyclical trend satisfying a second threshold.

In Example 98, the subject matter of Examples 90-97 can optionally include that the retaining of the ingested data includes determining whether the ingested data is to be stored based on a second uniqueness of the ingested data, the second uniqueness including a second comparison of one or more characteristics similar to the ingested data and the first adjacent nodes, and in response to the second uniqueness satisfying a third threshold, selecting a storage location for the ingested data based on the storage location of the first adjacent nodes in the first graph model relative to where the ingested data was ingested, the storage location to be at least one of a hot storage, a warm storage, or a cold storage.

In Example 99, the subject matter of Examples 90-98 can optionally include that the determining of the metadata includes updating the metadata stored in a distributed datastore based on at least one of singular usage, block usage, or sequential usage of at least one of the stored data, the first adjacent nodes, or the second adjacent nodes.

### Section D—Systems, Apparatus, Articles of Manufacture, and Methods to Implement Adaptive Data Value Scoring Among Multiple Nodes

The volume of data created worldwide expands at an ever increasing rate. Edge networks have proliferated in the last decade and serve many purposes, one of which is to allow better collection, computation, and handling of data at the edge. A popular implementation of an edge network is a “smart” sensor network. Sensor networks made up of sensors across many sensor types (e.g., image, audio, temperature, etc.) generate massive amounts of data. Sensors are ubiquitous in many environments and can be grouped together to form groups of sensors to serve a common purpose. Sensors commonly are integrated into compute nodes (e.g., nodes, platforms) that have processing power and storage to provide computation and analysis of sensor data in real-time. Groups of nodes with sensors to sense the same or similar environmental content (e.g., node peer groups) provide platforms for next generation data gathering. Data quality is a key for the efficacy of any data analytics platform. Yet, in some node deployment scenarios, some nodes may repeatedly provide non-contextual or outdated data because of deployment location, lack of data, configuration setup, not enough peers, dated algorithms, etc. In other scenarios, some nodes may experience rare events or outliers that could define the outcome of an entire process. Artificial intelligence, through the use of machine learning and neural networks, may be deployed with sensor network nodes to provide models for data type classification. However, such prior deployments do not focus on data quality.

Examples disclosed herein can provide an infrastructure based on the ADM system 600 of FIG. 6 to implement a peer-to-peer network of nodes augmented with artificial intelligence to apply a consensus approach and cross-correlation of sensor data to correct node models and/or identify rare outlier events. For example, a data confidence scoring manager can determine if a group of nodes (e.g., a team of nodes, a set of nodes, a peer-to-peer family of nodes, etc.) are correlated regarding the data (e.g., information, sensor information, sensor data, etc.) they generate (e.g., create, produce, etc.). In some examples, the data confidence scoring manager can obtain data from a group of nodes, calculate a correlation value among the data, and compare the correlation value to a threshold value to determine if an error is detected.

In some examples, the data confidence scoring manager can implement a machine learning model to determine a predicted output data for a given node in the group of nodes when the output data of other nodes adjacent to the given node are known. In some examples, the data confidence scoring manager can adjust a set of weights (e.g., strength of connection weights and biases, etc.) in the machine learning model associated with the nodes. In some examples, the weights are associated with each vector connecting between each pair of adjacent nodes in a graph of nodes representing the model, and adjusting the weights will adjust the relationship of adjacent nodes in the model.

In some examples, the data confidence scoring manager can determine whether to adjust the weights between the adjacent nodes in the machine learning model in response to determining that the correlation value has a detected correlation error. In some examples, the data confidence scoring manager can determine, through an analysis of the data from the nodes and the correlation error, a cause of the correlation error, which can include the data confidence scoring manager generating a correlation error causation ranked node list that can be sorted to show the node(s) at the top of the list as generating the data causing the correlation error.

In some examples, the data confidence scoring manager can generate a set of error correction values to be applied to the node data from the group of nodes. The data confidence scoring manager can generate the example error correction values through a determination of a set of differential values between the data produced from each given node, with the data that would be expected to be produced using the machine learning model. In some examples, the data confidence scoring manager can apply the error correction values to the node data to recreate the expected output.

In some examples, the data confidence scoring manager can run a simulation of the group of nodes with the error correction values applied to the node data output from the nodes to generate simulated error corrected data. In some examples, the data confidence scoring manager can direct the simulated error corrected node data to a second group of nodes (e.g., autonomous nodes) to determine whether the simulated error corrected node data modifies the output of the second group of nodes, which allows a determination whether the error corrected data can be applied to the actual model for use or if the node(s) that are exhibiting data issues should be disabled (e.g., brought offline, etc.) for maintenance and/or replacement.

In some examples, the data confidence scoring manager can corroborate data from the group of nodes other than the identified node(s) that are exhibiting data issues. In some examples, through the use of the machine learning model, the data confidence scoring manager can extrapolate data for the identified node(s) exhibiting data issues by using the corroborating data from the remaining nodes in the group of nodes that are not exhibiting data issues. In some examples, the data confidence scoring manager can replace the data being output from the identified node(s) with data issues with the extrapolated data for those node(s). In some examples, once the extrapolated data has replaced the output data from the identified node(s) with the data issues, those identified node(s) can be disabled.

In some examples, the data confidence scoring manager can ingest data obtained from the group of nodes and manage the storage (e.g., cause the storage) of the obtained data in a rolling manifest (e.g., a data buffer). In some examples, the data confidence scoring manager can manage the storage of one or more data snapshots of data obtained from the group of nodes at particular times. In some examples, the data confidence scoring manager can calculate statistical features from the data snapshots stored in the rolling manifest. For example, the statistical features can include the mean, median, mode, standard deviation, min, max, correlation values, and any number of other statistical features that are generated from one or more of the data snapshots. In some examples, the data confidence scoring manager can compare the statistical feature(s) to threshold values of the statistical features. In some examples, when one or more statistical features surpass a threshold value (e.g., go below a low threshold, go above a high threshold, etc.) the data confidence scoring manager can initiate one or more error correction processes. In some examples, the error correction processes include the data confidence scoring manager to send a request to adjust the weights of the machine learning model, the data confidence scoring manager to generate error correction values to be applied to the node data output, or to extrapolate node data to replace the node data from the node(s) that are having issues with their data. In some examples, the data confidence scoring manager can identify a trend of the correlation error or one or more other statistical features by comparing statistical features from different data snapshots to determine if the statistical feature(s) are increasing or decreasing over time.

In some examples, the data confidence scoring manager can determine if a correlation error detected from a group of nodes is intermittent. In some examples, the data confidence scoring manager can initiate error event handling and an error event log in response to the correlation error from the group of nodes being intermittent. In some examples, the error event handling and/or the error event log can be implemented for a period of time to check for long term cycles that are infrequent but present. In some examples, the data confidence scoring manager can determine if the intermittent correlation error has a cyclic nature (repeats every certain amount of time). In some examples, the data confidence scoring manager can apply the error correction values to the node data during one or more windows of time during each cycle of the intermittent correlation error in response to the intermittent correlation error being cyclic.

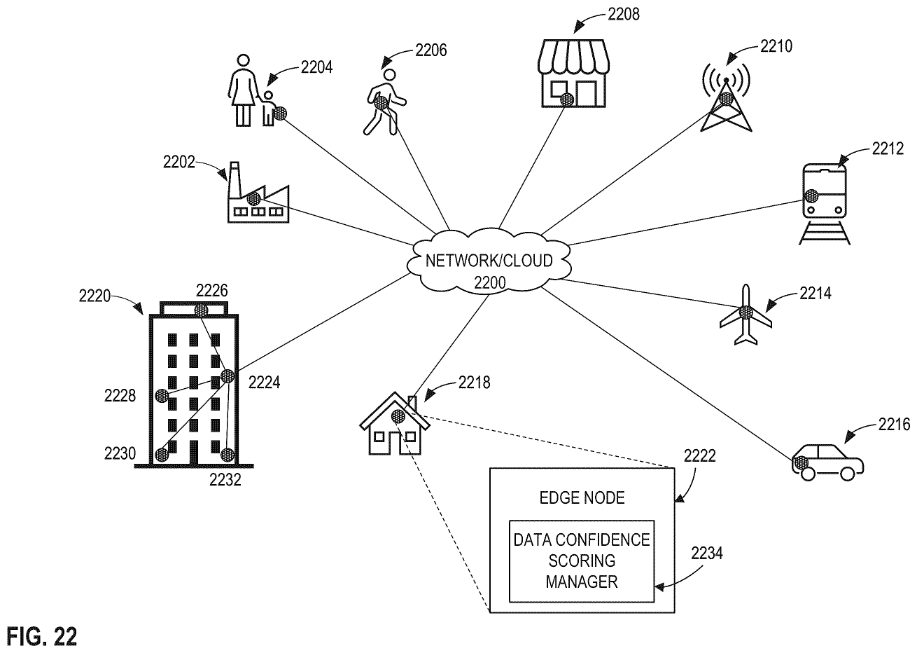

Turning to the figures, the illustrated example of FIG. 22 is an illustration of an example network system including example data confidence scoring circuitry implementing adaptive data confidence scoring among nodes. In the illustrated example in FIG. 22, edge nodes are present and shown contextually in a series of example usages as part of a network (e.g., cloud) 2200 of connected edge nodes (also referred to simply as nodes). In some examples, edge nodes may be devices and/or integrated into devices as complex as server computers, cell phones, and transportation vehicles or as simple as a smart sensor. As illustrated in FIG. 22, example edge nodes may be implemented in manufacturing plants/factories 2202, as wearable devices for adults and children 2204, as mobile computing devices such as cellular phones and laptops carried by people 2206, in retail establishments/stores 2208, on cellular and other electromagnetic signal transmission towers 2210, in commuter and freight trains 2212, in commercial airplanes 2214, in automobiles and trucks and transportation infrastructure systems (e.g., stoplights) 2216, in residential homes 2218, in office buildings 2220, or in/around any other form factor that could potentially house, carry, and/or integrate an edge node.

A single edge node, such as edge node 2222 (expanded in visual size from its location in 2218 for illustrative purposes) may have any one of any number of form factors, from microscopic sensor systems to large factory floor jumbo nodes. Each edge node illustrated in the example network system in FIG. 22 may communicate with some or all of the other edge nodes illustrated (and not illustrated), with any wireless or wired protocol capable of transmitting packets of data between the edge nodes pictured that are coupled for wireless and/or wired transmission of data in a communicative way (i.e., communicatively coupled). In some examples, a given contextual edge node location may have additional number of local edge nodes. For example, office building 2220 includes edge nodes 2224, 2226, 2228, 2230, and 2232 on, in, or around its premises. In some examples one edge node in a single locational context may serve as a major edge node and the remaining nodes local edge nodes are minor nodes. For example, edge node 2224 may serve as a major edge node communicating with other remote edge nodes across network/cloud 2200 and have the job of being a communication intermediary between other local edge nodes (e.g., 2226, 2228, 2230, and 2232) and/or as an intermediary between local edge nodes and remote edge nodes (e.g., 2202, 2204, etc.). In some examples, the other local edge nodes (e.g., 2226, 2228, 2230, and 2232) may be considered adjacent edge nodes to major edge node 2224 and/or adjacent edge nodes to each other. In some examples, edge nodes considered local to each other (e.g., 2224, 2226, 2228, 2230, and 2232) are referred to as a team of nodes, a group of nodes, or a set of nodes. In some examples, edge nodes that are part of a group/team of nodes do not need to be physically local to each other to be considered a group. In some examples, edge nodes that are physically local to each other may be considered as part of a group of nodes for one or more reasons, such as locality of data collection to allow for data correlation, such as local edge nodes that participate in a sensor network.

In the illustrated example in FIG. 22, one or more of the connected edge nodes that are part of a network/cloud 2200 of connected edge nodes, such as edge node 2222, include example data confidence scoring manager 2234. The data confidence scoring manager 2234 includes at least logic capable of operating within an adaptive data confidence scoring network of edge nodes. The adaptive data confidence scoring utilizes algorithms (including training algorithms, processes, techniques, etc.) that compute at least a correlation score per edge node against data/information (e.g., node information) from multiple other local edge nodes in a local group of edge nodes (i.e., nodes).

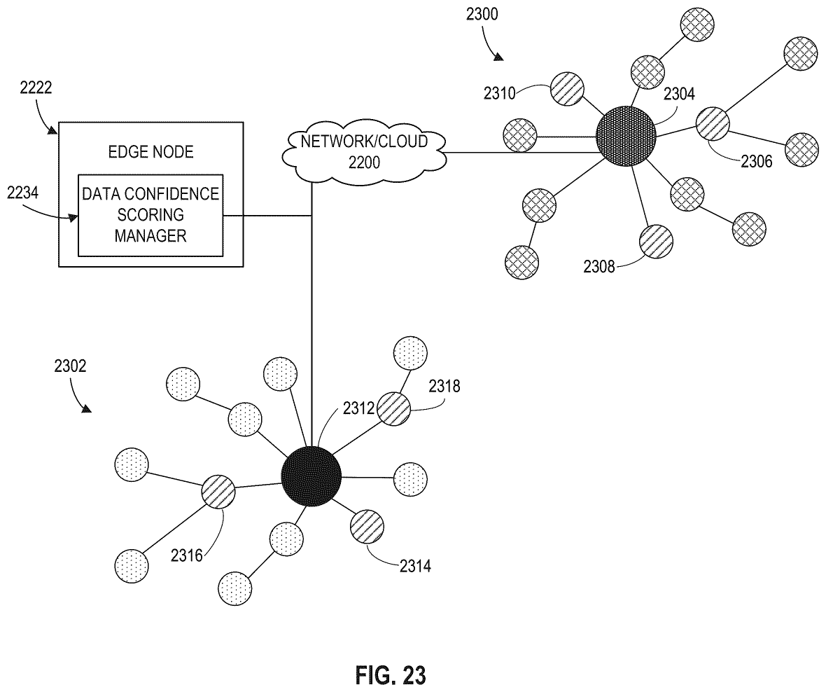

FIG. 23 depicts a graph model representation of an example network system including the example data confidence scoring circuitry of FIG. 22 implementing adaptive data confidence scoring among nodes. In the illustrated example in FIG. 23, two groups of nodes are communicatively coupled to the network/cloud 2200 including a first group 2300 and a second group 2302. The example network/cloud 2200 may have any number of additional nodes communicatively coupled, including example edge node 2222 (i.e., node 2222). Example node 2222 includes data confidence scoring manager 2234. In some examples, some or all of the nodes in the first node group 2300 and the second node group 2302 also have a partial or full copy or instance of the data confidence scoring manager 2234. The example first group 2300 includes a major node 2304 and the example second group 2302 includes a major node 2312. In some examples, the major nodes 2304 and 2312 are the intermediary nodes that provide communication relays from other nodes in the first group 2300 and the second group 2302 to the network/cloud 2200. In other examples, some or all nodes in the first group 2300 and the second group 2302 can communicate directly across the network/cloud 2200.

In some examples, a machine learning model (e.g., 2470 in FIG. 24 below) is executed and/or instantiated to provide functions (e.g., terms, which, in some examples, may include an activation function, similar to the nodes of a neural network) associated with each node and/or each node's relationship with adjacent nodes (e.g., connection weights). For example, the machine learning model 2470 representing all of the nodes in the first group 2300 could be trained where every node in the first group 2300 has a term that corresponds to the generation of data (e.g., node information) from that node and, additionally, each node in the first group 2300 has a weight associated with each of that node's adjacent neighbor nodes (e.g., each vector line in FIG. 23 connecting two circles representing two nodes would have a designated weight). The weights, along with the terms, provide a generated best guess from the machine learning model 2470 about what node information will produce from a first node when an adjacent second node produces a specific value of its own node data. Thus, the machine learning model 2470 creates a node information prediction mechanism among nodes based on the node information known to be produced. For example, strength of connection weights (represented as vectors/lines between two adjacent nodes) may range anywhere from 0-1 (with 1 being a highest strength of connection and 0 being a lowest strength of connection). Using this strength of connection weight range, two adjacent nodes 2304 and 2310 with a strength of connection vector 2320 measure the ambient temperature in two different locations of a small classroom and are highly correlated to each other, thus, a vector connecting node A and B may have a strength of connection weight of 0.99. In another example, a “strength of connection” may include both a strength of connection weight and a strength of connection bias and may range into a positive and negative number range to any rational number. In this example, the strength of connection weight and the strength of connection bias may be used similarly to the weights and biases associated with links between two nodes of a neural network. In this example, two adjacent nodes 2304 and 2310 with a strength of connection vector 2320 measure the ambient temperature in a room and have a medium correlation to each other, thus, a vector connecting node A and B may have a strength of connection weight of 1.37 and a strength of connection bias of −0.19.

In some examples, it should be considered herein that an association between a first datum and a second datum can be implemented using data. For example, the association can be a reference, a pointer, etc., that connects, links, and/or otherwise relates the first datum and the second datum.

As the machine learning model 2470 predicts output data per node, each of the nodes in the example first group 2300 has actual output data as well. The node information correlation value may be high, medium, or among the nodes of the example first group 2300. In some examples, logic within the data confidence scoring manager 2234 calculates a correlation value among a group of nodes. In some examples, an expectation a group of nodes, with a data confidence scoring manager 2234 per node (e.g., edge node 2222), have been deployed with similar training algorithms in a similar operating environment (e.g., in a same local area with strong correlation among the nodes in the group), there may be an expectation that similar data patterns will come from multiple nodes within the group. In some examples, the output node information can also produce a covariance value. Advantageously, the data confidence scoring manager 2234 can calculate and/or otherwise determine covariance values among the group of nodes, which may be a key statistical feature to be utilized in algorithms and techniques described herein. In some examples, both the correlation and covariance statistical features are utilized in calculations.

In some examples, in response to the data confidence scoring manager 2234 determining that the nodes within the first group 2300 have highly correlated data, the data confidence scoring manager 2234 can determine that, if an alert is generated due to an anomalistic data change, the data confidence scoring manager 2234 can propagate the alert across the nodes in the group (e.g., if data dramatically changes for one node, it should dramatically change in a correlated manner for other nodes). Thus, if data dramatically changes for one node and a corresponding change is not seen among other local nodes in the group that have highly correlated data, the data confidence scoring manager 2234 may detect a data issue with the node that displays the data change. In some examples, a high correlation score between a set of peer nodes for a given piece of data indicates outliers (e.g., data anomalies received from a single node) would not exist. In other examples, a low to medium correlation score between a set of peer nodes indicates either A) a true outlier event happened at a node in the group, or B) a node has a faulty data stream or a fault in the node is imminent.

In some examples, a data confidence score that measures correlation is calculated as a utility function, which can be implemented using Equation (1) below:

U(Data T0, Data T1)=Max [(features Data T0*Var), features Data T1*Var)]

### Equation 1. Example Data Confidence Score Utility Function

In the example of Equation (1) above, the example data confidence score utility function includes: (1) a utility function U with inputs of data at time 0 (T0) and data at time 1 (T1); and (2) a utility maximization function (Max) that calculates a preferred maximum utility of the input data by inputting a set of features of the data T0 and a set of features of the data T1 to see which set provides more utility. In some examples, data features may include one or more statistical features of the data, such as standard deviation, mean, variance, min, and max, among many other possible statistical features. In some examples, the data input can include a Var factor to multiply by, which, in different examples, can be a validity time (e.g., a length of time required to capture valid data) or a coverage of data (e.g., a specific population of nodes from which the data is drawn), or a combination of both validity time and coverage of data.

In some examples, the data confidence score can also be referred to and/or otherwise implemented by a data value score, a data integrity score, or a data quality score.

FIG. 24 is a block diagram of an example implementation of the data confidence scoring circuitry of FIGS. 22 and/or 23. In some examples, the data confidence scoring management circuitry 2400 of FIG. 24 can implement the data confidence scoring manager 2234 of FIGS. 22 and 23 and/or all or portion(s) of the ADM system 600 of FIG. 6. The data confidence scoring circuitry 2400 of FIG. 24 may be instantiated (e.g., creating an instance of, bring into being for any length of time, materialize, implement, etc.) by processor circuitry such as a central processing unit executing instructions. Additionally or alternatively, the data confidence scoring circuitry 2400 of FIG. 24 may be instantiated (e.g., creating an instance of, bring into being for any length of time, materialize, implement, etc.) by an ASIC or an FPGA structured to perform operations corresponding to the instructions. It should be understood that some or all of the data confidence scoring circuitry 2400 of FIG. 24 may, thus, be instantiated at the same or different times. Some or all of the data confidence scoring circuitry 2400 may be instantiated, for example, in one or more threads executing concurrently on hardware and/or in series on hardware. Moreover, in some examples, some or all of the data confidence scoring circuitry 2400 of FIG. 24 may be implemented by one or more virtual machines and/or containers executing on the microprocessor.

The data confidence scoring circuitry 2400 of the illustrated example includes example data ingestion circuitry 2410, example analytics management circuitry 2415, example machine learning circuitry 2420, example data query management circuitry 2430, example node management circuitry 2440, example data publishing circuitry 2450, an example datastore 2460, and an example bus 2480. The datastore 2460 of the illustrated example includes example raw data 2462, example rolling manifest 2463, example metadata 2464, example users 2466, example nodes 2468, an example machine learning model 2470, and one or more example ADM consoles such as ADM console 2490A located in the data confidence scoring circuitry 2400 and ADM console 2490B located in a location discrete from the data confidence scoring circuitry 2400. In the illustrated example, the data ingestion circuitry 2410, the analytics management circuitry 2415, the machine learning circuitry 2420, the data query management circuitry 2430, the node management circuitry 2440, the data publishing circuitry 2450, the example datastore 2460, and the example ADM consoles 2490A and 2490B are in communication with one(s) of each other by way of the bus 2480. In some examples, the data ingestion circuitry 2410 can receive data/commands from the ADM console 2490B and the data publishing circuitry 2450 can publish/transmit data to the ADM console 2490B using communication via the bus 2480. In some examples, the bus 2480 can be implemented using at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 2480 can be implemented by any other type of computing or electrical bus. In some examples, the bus 2480 can implement the data plane 628, the control plane 630, and/or, more generally, the network plane 626 of FIG. 6, or portion(s) thereof.

The data confidence scoring circuitry 2400 of the illustrated example includes the data ingestion circuitry 2410 to obtain data (e.g., node information), determine whether new data is received and/or otherwise ready to be ingested, etc. In some examples, the data ingestion circuitry 2410 can implement the data ingestion manager 606 of FIG. 6, or portion(s) thereof.

In some examples, the data ingestion circuitry 2410 can obtain (e.g., receive) and/or otherwise ingest sensor and/or location data. For example, the data ingestion circuitry 2410 can receive video data from a video camera, a beacon signal from a radio frequency identification device (RFID) terminal, a use of login credentials at an electronic terminal (e.g., a laptop computer, a desktop computer, a control station, etc.), etc. In some such examples, the data ingestion circuitry 2410 can determine whether a location of a user changed based on the ingested sensor and/or location data. For example, the data ingestion circuitry 2410 can obtain a first sensor data (e.g., node information) that determines a temperature in a first location at a first time and obtain a second sensor data (e.g., node information) that determines a temperature in the first location at a second time.

The data confidence scoring circuitry 2400 of the illustrated example includes the machine learning circuitry 2420 to execute a machine learning model (e.g., the machine learning model 2470) to generate output(s) (e.g., model output(s)), which can include an AI watch dog that monitors the sensors for outliers and trains the machine learning model 2470 to self-correct the model when outlier node information is determined to be replaced. In some examples, the machine learning circuitry 2420 can implement the algorithms 638, and/or, more generally, the analytics manager 636 of FIG. 6, or portion(s) thereof. In some examples, the machine learning circuitry 2420 generates machine learning output(s) based on machine learning input(s). In some examples, the machine learning circuitry 2420 instantiates an AI/ML microservice to instantiate and/or execute the machine learning model 2470. In some examples, the AI/ML microservice can be implemented using one or more VMs, one or more containers, and/or any combination(s) thereof.

In some examples, the machine learning circuitry 2420 generates the machine learning model 2470 based on data associated with an environment, such as the network/cloud 2200 and the corresponding system of nodes illustrated in FIG. 22 and/or FIG. 23. In some examples, the machine learning circuitry 2420 executes the machine learning model 2470 to generate data graphs (e.g., data graph models, contextual data graph models, etc.) corresponding to respective portions of the environment. In some examples, the machine learning circuitry 2420 executes the machine learning model 2470 to identify suspected outlier nodes, error causation nodes, and groups of nodes to simulate node information input and output. In some examples, the machine learning circuitry 2420 causes storage of the machine learning model 2470. In some examples, the machine learning circuitry 2420 also adjusts at least one cross-correlated weight from a series of cross-correlated weights at least node of the group of nodes. In some examples, the machine learning circuitry 2420 is to cause storage of the machine learning model 2470. For example, to “cause storage” may be implemented by communicating with a storage controller and the storage controller actually performs the functions of the storage routine, but the machine learning circuitry 2420 is to cause storage because the instruction to store originated at the machine learning circuitry 2420.

In some examples, the machine learning model 2470 updates metadata associated with response(s) and/or non-response(s) by user(s) to data traffic (e.g., one or more messages). In some examples, the machine learning model 2470 updates metadata associated with cause(s) of action(s) and effect(s) of the action(s) based on the data traffic. In some examples, the machine learning model 2470 updates at least one of the data graphs or the hotspots based on a routing of the data traffic. In some examples, the machine learning model 2470 identifies a stratification of nodes, including major nodes and adjacent nodes based on the routing of the data traffic, the correlation of the node information across nodes within a group of nodes and across groups of nodes. In some examples, the machine learning model 2470 retrains the machine learning model 2470 based on at least one of the update(s) or other data, which can include node information, node weights, cross-node strength of connection, etc.

In some examples, an ADM console may be present in or around the data confidence scoring circuitry 2400 as the ADM console 2490A and/or the ADM console 2490B. In one or more situations during the operation of the data confidence scoring circuitry 2400 there are one or more consoles to prompt users for input and/or feedback.

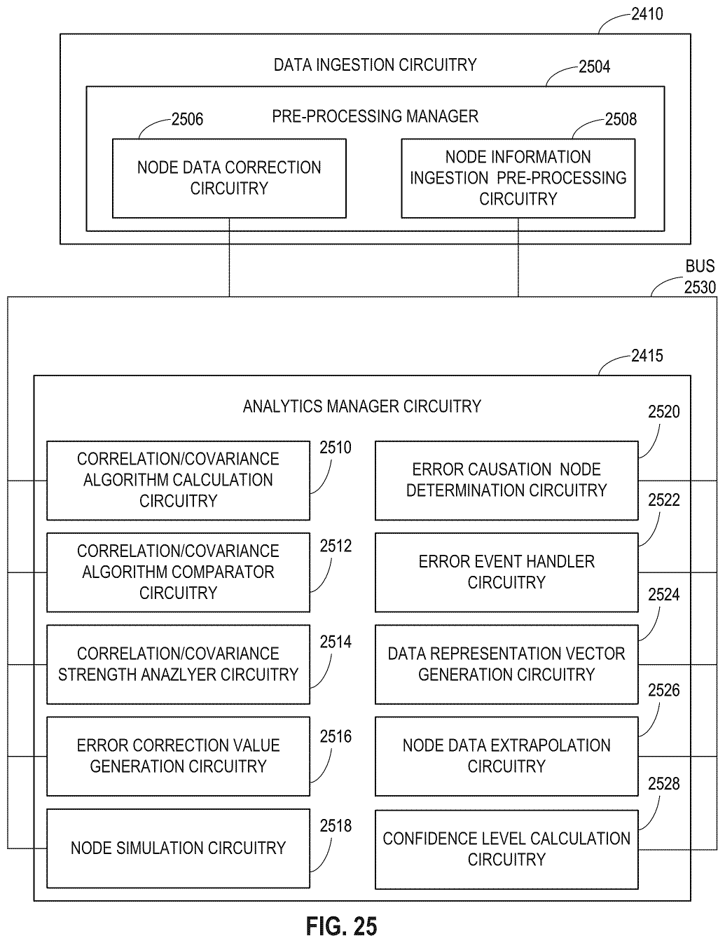

FIG. 25 is a block diagram of an example implementation of example data ingestion circuitry and example analytics manager circuitry of the data confidence scoring circuitry of FIG. 24. In the description in connection with the illustrated example of FIG. 25, the functionality of each block shown will be described. The flowcharts from page 26-37 will provide more context and specific interaction among the blocks of FIG. 25. The example data ingestion circuitry 2410 includes example pre-processing management circuitry 2504. In some examples, the machine learning circuitry 2420 instantiates an AI/ML microservice to instantiate and/or execute the data ingestion circuitry 2410. In some examples, the AI/ML microservice can be implemented using one or more VMs, one or more containers, and/or any combination(s) thereof. In the illustrated example in FIG. 25, the pre-processing management circuitry 2504 includes an example node data correction circuitry 2506 and an example node information ingestion pre-processing circuitry 2508.

The example node data correction circuitry 2506 applies node information error correction values to node information to reduce correlation errors. In some examples, the node information error correction values are supplied by the example error correction value generation circuitry 2516. In some examples, the machine learning circuitry 2420 instantiates an AI/ML microservice to instantiate and/or execute the node data correction circuitry 2506. In some examples, the AI/ML microservice can be implemented using one or more VMs, one or more containers, and/or any combination(s) thereof.

The example node information ingestion pre-processing circuitry 2508 has several functions related to node information ingestion. First, the example node information ingestion pre-processing circuitry 2508 initiates a rolling manifest, which is a data buffer of the most recent items of data (e.g., node information) that have arrived from the group of nodes. Then, the example node information ingestion pre-processing circuitry 2508 can cause the node information to be stored in the rolling manifest. The rolling manifest is utilized to extract statistical features from the node information, such as mean, min, max, standard deviation, etc. The example node information ingestion pre-processing circuitry 2508 also functions as an extraction mechanism of a statistical feature from data snapshots that are moments in time of the node information input from the group of nodes. Next, the example node information ingestion pre-processing circuitry 2508 compares the statistical feature to a threshold value which allows a statistical feature of the data snapshots to determine whether a machine learning model 2470 is sufficiently accurate or if one or more weights in the machine learning model 2470 should be modified to accurately portray the node information input from the group of nodes. The example node information ingestion pre-processing circuitry 2508 can then request modification to the machine learning model 2470 if that seems appropriate based on the statistical feature threshold value. In some examples, the machine learning circuitry 2420 instantiates an AI/ML microservice to instantiate and/or execute the node information ingestion pre-processing circuitry 2508. In some examples, the AI/ML microservice can be implemented using one or more VMs, one or more containers, and/or any combination(s) thereof.

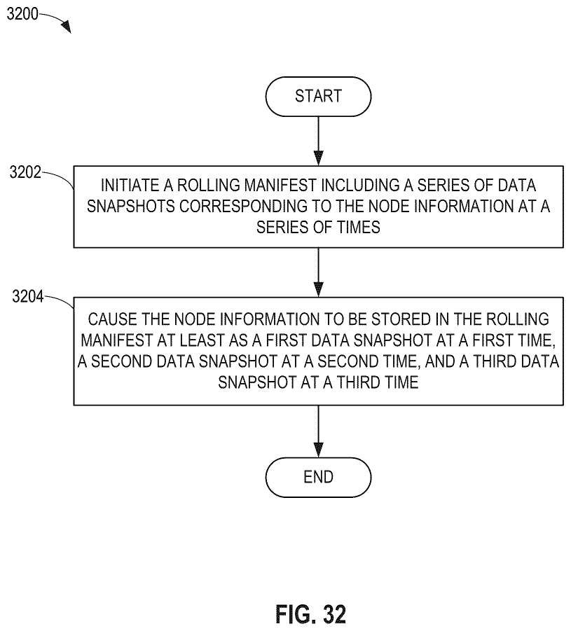

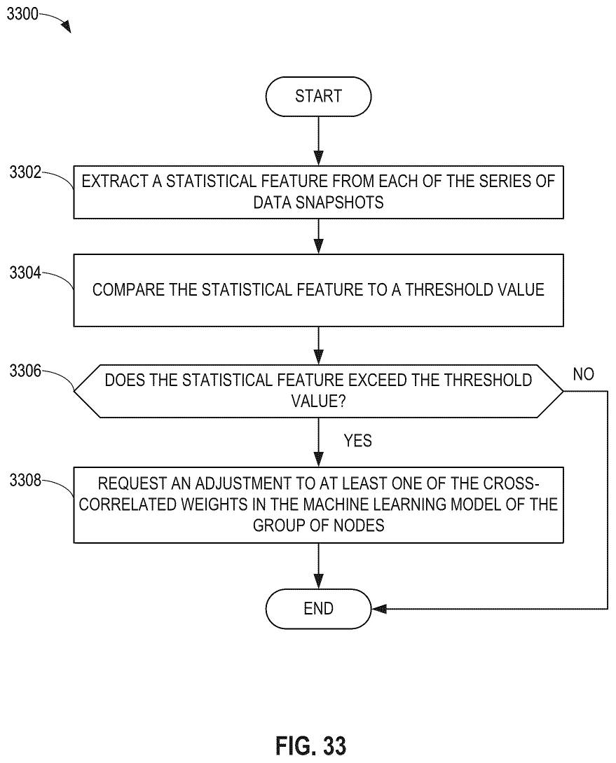

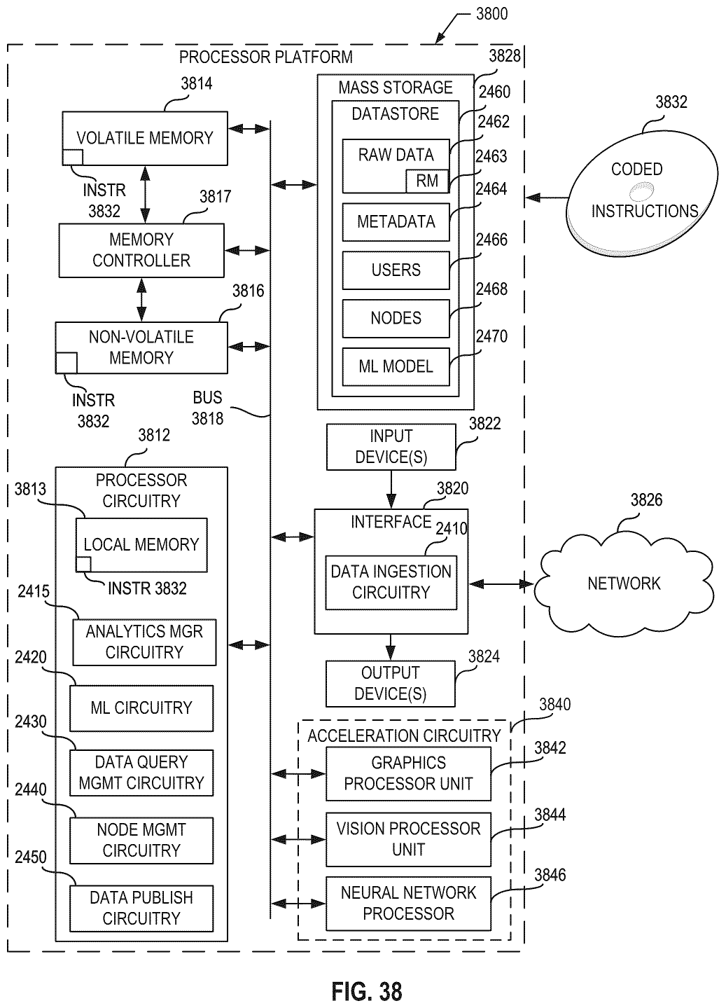

In some examples, the data confidence scoring management circuitry 2500 includes means for initiating a rolling manifest including a series of data snapshots corresponding to the node information at a series of times. In some examples, the data confidence scoring management circuitry 2500 includes means for causing the node information to be stored in the rolling manifest at least at a first data snapshot at a first time, a second data snapshot at a second time, and a third data snapshot at a third time. In some examples, the data confidence scoring management circuitry 2500 includes means for extracting a statistical feature from each of the series of data snapshots. In some examples, the data confidence scoring management circuitry 2500 includes means for comparing the statistical feature to a threshold value. In some examples, the data confidence scoring management circuitry 2500 includes means for determining if the statistical feature exceeds the threshold value. In some examples, the data confidence scoring management circuitry 2500 includes means for requesting an adjustment to at least one of the cross-correlated weights in the machine learning model of the group of nodes. For example, the means for initiating and causing, as discussed in the description related to FIG. 32, and the means for extracting, comprising, determining, and requesting, as discussed in the description related to FIG. 33, may be implemented by the node information ingestion pre-processing circuitry 2508. In some examples, the node information ingestion pre-processing circuitry 2508 may be implemented by machine executable instructions such as that implemented by at least blocks 3202, 3204, 3302, 3304, 3306, and 3308, executed by processor circuitry, which may be implemented by the example processor circuitry 3812 of FIG. 38. In other examples, the node information ingestion pre-processing circuitry 2508 is implemented by other hardware logic circuitry, hardware implemented state machines, and/or any other combination of hardware, software, and/or firmware. For example, the node information ingestion pre-processing circuitry 2508 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

In the illustrated example in FIG. 25, an example implementation of the analytics management circuitry 2415 of FIG. 24 is shown. The example analytics management circuitry 2415 was described at a higher level of detail in the discussion related to FIG. 24. The example analytics management circuitry 2415 includes an example correlation/covariance algorithm calculation circuitry 2510, an example correlation/covariance algorithm comparator circuitry 2512, an example correlation/covariance strength analyzer circuitry 2514, an example error correction value generation circuitry 2516, an example node simulation circuitry 2518, an example error causation node determination circuitry 2520, an example long-term error event handler circuitry 2522, an example data representation vector generation circuitry 2524, an example node data extrapolation circuitry 2526, and a confidence level calculation circuitry 2528. The Although most of the calculations described utilize correlation as the key statistical feature, that was simply utilized for ease of explanation. In other examples, the covariance may be utilized as the key statistical feature. In yet other examples, a third statistical feature is utilized, or a combination of more than one statistical feature. In some examples, the machine learning circuitry 2420 instantiates an AI/ML microservice to instantiate and/or execute the analytics management circuitry 2415. In some examples, the AI/ML microservice can be implemented using one or more VMs, one or more containers, and/or any combination(s) thereof.

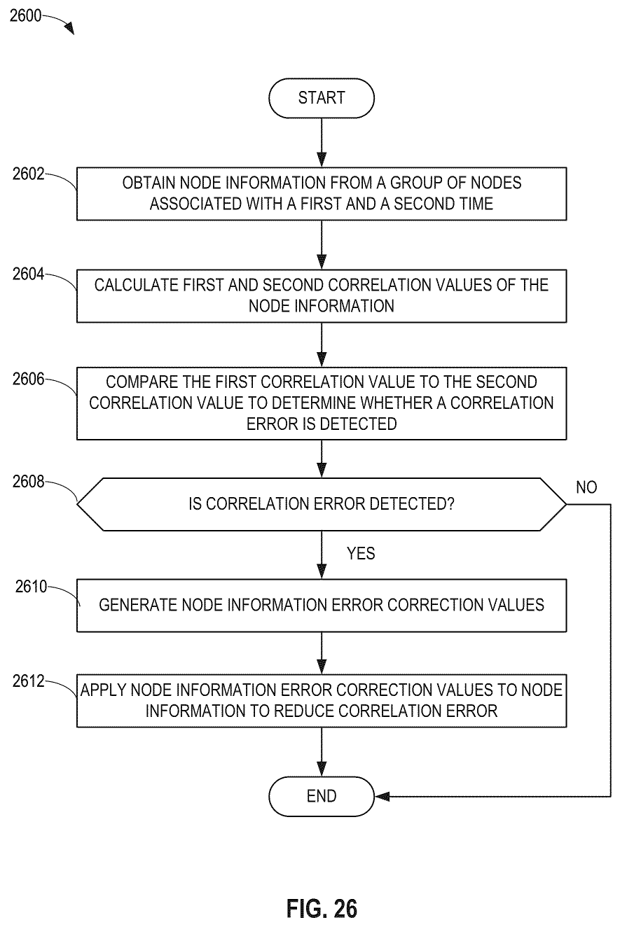

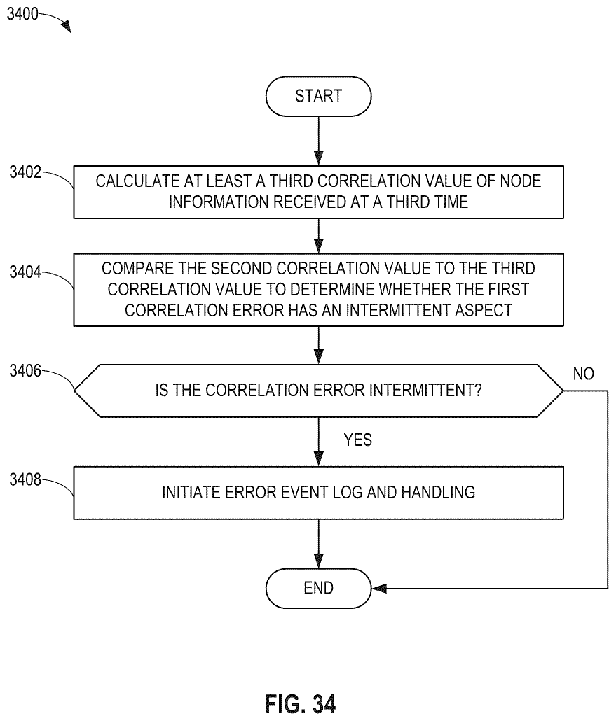

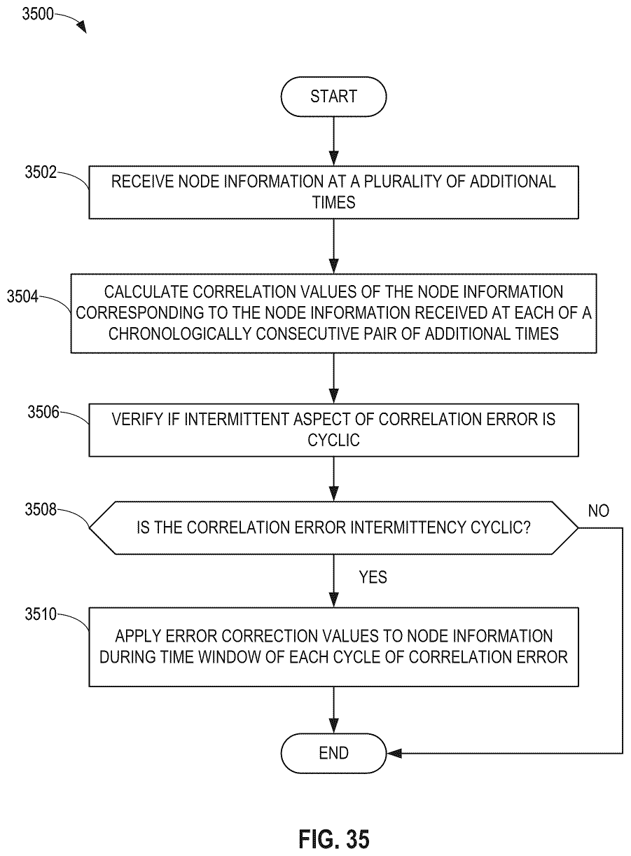

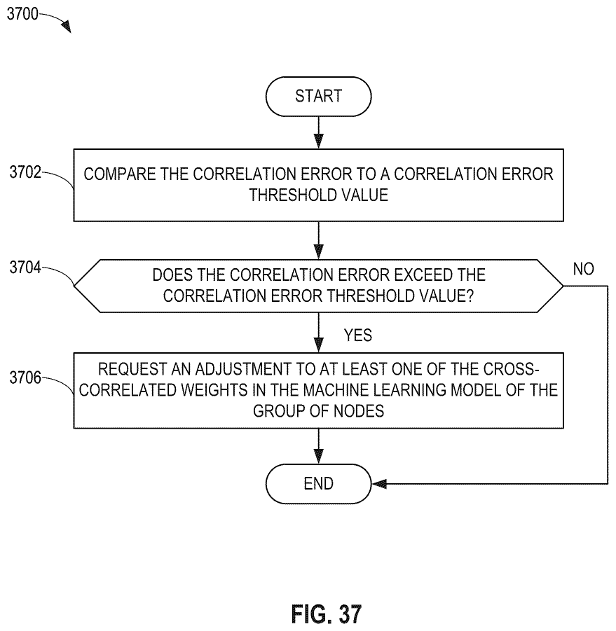

In some examples, the data confidence scoring management circuitry 2500 includes means for determining if a correlation error is detected. In some examples, the data confidence scoring management circuitry 2500 includes means for determining if a correlation error is intermittent. In some examples, the data confidence scoring management circuitry 2500 includes means for determining if the correlation error intermittency is cyclic. In some examples, the data confidence scoring management circuitry 2500 includes means for determining if the correlation error exceeds the correlation error threshold value. In some examples, the data confidence scoring management circuitry 2500 includes sub-circuitry for specific tasks (shown as the blocks within the data confidence scoring management circuitry 2500 in FIG. 25 and described below). For example, the means for determining, as discussed in the description related to FIG. 26, the means for determining, as discussed in the description related to FIG. 34, the means for determining, as discussed in the description related to FIG. 35, and the means for determining, as discussed in the description related to FIG. 37, may be implemented by the analytics management circuitry 2415. In some examples, the analytics management circuitry 2415 may be implemented by machine executable instructions such as that implemented by at least blocks 2608, 3406, 3508, and 3704, executed by processor circuitry, which may be implemented by the example processor circuitry 3812 of FIG. 38. In other examples, the analytics management circuitry 2415 is implemented by other hardware logic circuitry, hardware implemented state machines, and/or any other combination of hardware, software, and/or firmware. For example, the analytics management circuitry 2415 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example correlation/covariance algorithm calculation circuitry 2510 calculates node/information correlation (or covariance or other key statistical features) with node information obtained from the group of nodes. In some examples, individual data snapshots of node information are used as single points of reference. In other examples, a series of data snapshots, each with the correlation or covariance are used to create a running trendline. The example correlation/covariance algorithm calculation circuitry 2510 produces correlation values and that number or those numbers are then passed over to the example correlation/covariance algorithm comparator circuitry 2512 for comparison. In some examples, the correlation/covariance algorithm calculation circuitry 2510 calculates additional correlation values of node information obtained during attempts to determine if the correlation error was intermittent (i.e., not permanent) and/or cyclic. In some examples, the machine learning circuitry 2420 instantiates an AI/ML microservice to instantiate and/or execute the correlation/covariance algorithm calculation circuitry 2510. In some examples, the AI/ML microservice can be implemented using one or more VMs, one or more containers, and/or any combination(s) thereof.

In some examples, the data confidence scoring management circuitry 2500 includes means for calculating the first and second correlation values of the node information obtained at the first and second times. In some examples, the data confidence scoring management circuitry 2500 includes means for calculating at least a third correlation value of node information obtained at a third time. In some examples, the data confidence scoring management circuitry 2500 includes means for calculating correlation values of the node information corresponding to the node information of the obtained at each of a chronologically consecutive pair of additional times. For example, the means for calculating may be implemented by the correlation/covariance algorithm calculation circuitry 2510. In some examples, the correlation/covariance algorithm calculation circuitry 2510 may be implemented by machine executable instructions such as that implemented by at least blocks 2604, 3402, 3504, and 3702, executed by processor circuitry, which may be implemented by the example processor circuitry 3812 of FIG. 38. In other examples, the correlation/covariance algorithm calculation circuitry 2510 is implemented by other hardware logic circuitry, hardware implemented state machines, and/or any other combination of hardware, software, and/or firmware. For example, the correlation/covariance algorithm calculation circuitry 2510 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example correlation/covariance algorithm comparator circuitry 2512 compares the node/information correlation (or covariance or other key statistical features) values received from the example correlation/covariance algorithm calculation circuitry 2510. The example correlation/covariance algorithm comparator circuitry 2512 compares the node/information correlation value (single data point) or values (multiple data points for a trendline) and has the capacity to determine if the correlation/covariance/etc. is high, medium, or low (or any other granularity level used for determination). In some examples, the correlation/covariance algorithm comparator circuitry 2512 compares additional correlation values of node information obtained during attempts to determine if the correlation error was intermittent (i.e., not permanent) and/or cyclic. In some examples, the actual determination (intermittent and/or cyclic) is made by logic within the larger encompassing analytics manager circuitry 2315. In some examples, the machine learning circuitry 2420 instantiates an AI/ML microservice to instantiate and/or execute the correlation/covariance algorithm comparator circuitry 2512. In some examples, the AI/ML microservice can be implemented using one or more VMs, one or more containers, and/or any combination(s) thereof.

In some examples, the data confidence scoring management circuitry 2500 includes means for comparing a first correlation value to a second correlation value to determine whether a correlation error is detected. In some examples, the data confidence scoring management circuitry 2500 includes means for comparing a second correlation value to a third correlation value to determine whether a first correlation error has an intermittent aspect. In some examples, the data confidence scoring management circuitry 2500 includes means for verifying if an intermittent aspect of a correlation error is cyclic. For example, the means for comparing may be implemented by the correlation/covariance algorithm comparator circuitry 2512. In some examples, the correlation/covariance algorithm comparator circuitry 2512 may be implemented by machine executable instructions such as that implemented by at least blocks 2606, 3404, and 3506, executed by processor circuitry, which may be implemented by the example processor circuitry 3812 of FIG. 38. In other examples, the correlation/covariance algorithm comparator circuitry 2512 is implemented by other hardware logic circuitry, hardware implemented state machines, and/or any other combination of hardware, software, and/or firmware. For example, the correlation/covariance algorithm comparator circuitry 2512 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example correlation/covariance strength analyzer circuitry 2514 determines the “outcome correlation strength” between a correlation error and a causation event of the correlation error. For example, the higher the correlation of an input value into a node with the notable output, the higher the outcome correlation strength, where an outcome correlation strength of 1.0 shows a direct causation link. In some examples, a low outcome correlation strength does not show a causal link from the initial event to the correlation error, a medium outcome correlation strength shows a moderate cause-and-effect where the event may have been a partial cause, but there is not a full causation link in every circumstance, a high outcome correlation strength (e.g., a 1.0) shows a direct or close to direct cause-and-effect link (e.g., if the event takes place, the effect happens as a result of the event). In some examples, the machine learning circuitry 2420 instantiates an AI/ML microservice to instantiate and/or execute the correlation/covariance strength analyzer circuitry 2514. In some examples, the AI/ML microservice can be implemented using one or more VMs, one or more containers, and/or any combination(s) thereof.

In some examples, the data confidence scoring management circuitry 2500 includes means for determining an outcome correlation strength between a correlation error and a causation event of the correlation error. For example, the means for determining an outcome correlation strength may be implemented by the correlation/covariance strength analyzer circuitry 2514. In some examples, the correlation/covariance strength analyzer circuitry 2514 may be implemented by machine executable instructions such as that implemented by at least block 2904, executed by processor circuitry, which may be implemented by the example processor circuitry 3812 of FIG. 38. In other examples, the correlation/covariance strength analyzer circuitry 2514 is implemented by other hardware logic circuitry, hardware implemented state machines, and/or any other combination of hardware, software, and/or firmware. For example, the correlation/covariance strength analyzer circuitry 2514 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example error correction value generation circuitry 2516 generates node information error correction values that are utilized to modify the data coming from a node that is causing correlation errors among a group of nodes. The generated node information error correction values are then provided to the example node data correction circuitry 2506 for application to correct the node information to value(s) predicted by the machine learning model. In some examples, the machine learning circuitry 2420 instantiates an AI/ML microservice to instantiate and/or execute the error correction value generation circuitry 2516. In some examples, the AI/ML microservice can be implemented using one or more VMs, one or more containers, and/or any combination(s) thereof.

In some examples, the data confidence scoring management circuitry 2500 includes means for generating node information error correction values. For example, the means for generating may be implemented by the error correction value generation circuitry 2516. In some examples, the error correction value generation circuitry 2516 may be implemented by machine executable instructions such as that implemented by at least block 2610, executed by processor circuitry, which may be implemented by the example processor circuitry 3812 of FIG. 38. In other examples, the error correction value generation circuitry 2516 is implemented by other hardware logic circuitry, hardware implemented state machines, and/or any other combination of hardware, software, and/or firmware. For example, the error correction value generation circuitry 2516 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example node simulation circuitry 2518 simulates one or more nodes for testing purposes. When the example node data correction circuitry 2506 applies generated node information error correction values to node information input from one or more nodes in the group of nodes, it is initially not known whether the correction that takes place will adversely affect any downstream nodes receiving the corrected outputs. Thus, in some examples, the example node simulation circuitry 2518 simulates a first group of nodes to create artificial outputs that map/mimic what the error corrected node results may resemble. In response to creating the artificial outputs, the example node simulation circuitry 2518 causes a second group of nodes (e.g., autonomous downstream nodes) to receive the simulated, error corrected, node information. The example node simulation circuitry 2518 can check/verify whether the second group of nodes have had their output modified from before the simulation in comparison to the simulation. If the node simulation circuitry 2518 detects that the output has been modified during the simulation, then the node simulation circuitry 2518 can determine that the error corrected node information changed downstream outputs, and in many examples, the process stops after the node management circuitry 240 disables the error causation node (to wait for maintenance/replacement). In some examples, the machine learning circuitry 2420 instantiates an AI/ML microservice to instantiate and/or execute the node simulation circuitry 2518. In some examples, the AI/ML microservice can be implemented using one or more VMs, one or more containers, and/or any combination(s) thereof.

In some examples, the data confidence scoring management circuitry 2500 includes means for simulating a first group of nodes with node error correction values applied to generate simulated error corrected node information. In some examples, the data confidence scoring management circuitry 2500 includes means for causing a second group of autonomous nodes to receive the simulated, error corrected, node information. In some examples, the data confidence scoring management circuitry 2500 includes means for verifying if an output of the second group of autonomous nodes is modified by the simulated error corrected node information. In some examples, the data confidence scoring management circuitry 2500 includes means for determining if the output of the second group of autonomous nodes is modified. For example, the means for simulating may be implemented by the node simulation circuitry 2518. In some examples, the node simulation circuitry 2518 may be implemented by machine executable instructions such as that implemented by at least blocks 2802, 2804, 2806, and 2808, executed by processor circuitry, which may be implemented by the example processor circuitry 3812 of FIG. 38. In other examples, the node simulation circuitry 2518 is implemented by other hardware logic circuitry, hardware implemented state machines, and/or any other combination of hardware, software, and/or firmware. For example, the node simulation circuitry 2518 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example error causation node determination circuitry 2520 analyzes a correlation error (from a group of nodes against obtained node information. The example error causation node determination circuitry 2520 then generates a ranked list of nodes that contribute to the correlation error. Once the list has been generated, the example error causation node determination circuitry 2520 sorts the list from highest to lowest contribution. The node at the beginning of the list outputs data that has the greatest contribution to the correlation error. Thus, in some examples, the list provides an identification of error causation nodes. In some examples, an “error causation node” defines a node that causes a correlation error among a group of nodes. In some examples, the machine learning circuitry 2420 instantiates an AI/ML microservice to instantiate and/or execute the error causation node determination circuitry 2520. In some examples, the AI/ML microservice can be implemented using one or more VMs, one or more containers, and/or any combination(s) thereof.

In some examples, the data confidence scoring management circuitry 2500 includes means for analyzing at least a correlation error against obtained node information to generate a correlation error causation ranked node list. In some examples, the data confidence scoring management circuitry 2500 includes means for identifying a highest ranked node in the correlation error causation ranked node list as error causation node. For example, the means for analyzing may be implemented by the error causation node determination circuitry 2520. In some examples, the error causation node determination circuitry 2520 may be implemented by machine executable instructions such as that implemented by at least block 2702 and 2704, executed by processor circuitry, which may be implemented by the example processor circuitry 3812 of FIG. 38. In other examples, the error causation node determination circuitry 2520 is implemented by other hardware logic circuitry, hardware implemented state machines, and/or any other combination of hardware, software, and/or firmware. For example, the error causation node determination circuitry 2520 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example long-term error event handler circuitry 2522 initiates event log and handling. In some examples, when a correlation error is found to be intermittent (i.e., not continuous), the analytics management circuitry 2415 engages a long-term event log and handling process to allow the continuous tracking of node information. In some examples, the machine learning circuitry 2420 instantiates an AI/ML microservice to instantiate and/or execute the long-term error event handler circuitry 2522. In some examples, the AI/ML microservice can be implemented using one or more VMs, one or more containers, and/or any combination(s) thereof.

The example data representation vector generation circuitry 2524 generates a data representation vector. The example data representation vector output of at least a set of data adjacencies and a connection strength between the error causation node and a plurality of nodes other than the error causation node. In some examples, the data representation vector generation circuitry 2524 includes, executes, and/or otherwise implements logic that creates the vectors shown in the graphs (e.g., the vector lines between each of the nodes in FIG. 23, such as vector 2320) in FIG. 23. In some examples, the machine learning circuitry 2420 instantiates an AI/ML microservice to instantiate and/or execute the data representation vector generation circuitry 2524. In some examples, the AI/ML microservice can be implemented using one or more VMs, one or more containers, and/or any combination(s) thereof.

In some examples, the data confidence scoring management circuitry 2500 includes means for generating a data representation vector output of at least a set of data adjacencies and a connection strength between a error causation node and a plurality of nodes other than the error causation node. For example, the means for generating a data representation vector output may be implemented by the data representation vector generation circuitry 2524. In some examples, the data representation vector generation circuitry 2524 may be implemented by machine executable instructions such as that implemented by at least block 2902, executed by processor circuitry, which may be implemented by the example processor circuitry 3812 of FIG. 38. In other examples, the data representation vector generation circuitry 2524 is implemented by other hardware logic circuitry, hardware implemented state machines, and/or any other combination of hardware, software, and/or firmware. For example, the data representation vector generation circuitry 2524 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example node data extrapolation circuitry 2526 generates node information error correction values based on one or more of the data representation vector output, the outcome correlation strength, or the correlation value into a consolidated final output to extrapolate peer and/or adjacent nodes' data into the node with the results identified as at least partially causing the correlation error. Additionally, the example node data extrapolation circuitry 2526 corroborates node information from several nodes in the group of nodes that are not the error causation node to extrapolate node information for the error causation node (instead of using the actual output of the error causation node). In some examples, the machine learning circuitry 2420 instantiates an AI/ML microservice to instantiate and/or execute the node data extrapolation circuitry 2526. In some examples, the AI/ML microservice can be implemented using one or more VMs, one or more containers, and/or any combination(s) thereof.

In some examples, the data confidence scoring management circuitry 2500 includes means for generating node information error correction values of at least the data representation vector output, the outcome correlation strength, or the correlation value into a consolidated final output value. For example, the means for generating node information error correction values may be implemented by the node data extrapolation circuitry 2526. In some examples, the node data extrapolation circuitry 2526 may be implemented by machine executable instructions such as that implemented by at least block 3002, executed by processor circuitry, which may be implemented by the example processor circuitry 3812 of FIG. 38. In other examples, the node data extrapolation circuitry 2526 is implemented by other hardware logic circuitry, hardware implemented state machines, and/or any other combination of hardware, software, and/or firmware. For example, the node data extrapolation circuitry 2526 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

The example confidence level calculation circuitry 2528 calculates a confidence level of the extrapolated node information that was created by the example node data extrapolation circuitry 2526. In some examples, the machine learning circuitry 2420 instantiates an AI/ML microservice to instantiate and/or execute the confidence level calculation circuitry 2528. In some examples, the AI/ML microservice can be implemented using one or more VMs, one or more containers, and/or any combination(s) thereof.

In some examples, the data confidence scoring management circuitry 2500 includes means for calculating a confidence level value of the extrapolated node information for the error causation node. For example, the means for calculating a confidence level may be implemented by confidence level calculation circuitry 2528. In some examples, the confidence level calculation circuitry 2528 may be implemented by machine executable instructions such as that implemented by at least block 3004, executed by processor circuitry, which may be implemented by the example processor circuitry 3812 of FIG. 38. In other examples, the confidence level calculation circuitry 2528 is implemented by other hardware logic circuitry, hardware implemented state machines, and/or any other combination of hardware, software, and/or firmware. For example, the confidence level calculation circuitry 2528 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

In the illustrated example in FIG. 25, the example node data correction circuitry 2506 and the example node information ingestion pre-processing circuitry 2508 (and by extension the example pre-processing management circuitry 2504 and the data ingestion circuitry 2410), and the example correlation/covariance algorithm calculation circuitry 2510, the example correlation/covariance algorithm comparator circuitry 2512, the example correlation/covariance strength analyzer circuitry 2514, the example error correction value generation circuitry 2516, the example node simulation circuitry 2518, the example error causation node determination circuitry 2520, the example long-term error event handler circuitry 2522, the example data representation vector generation circuitry 2524, the example node data extrapolation circuitry 2526, and the confidence level calculation circuitry 2528 (and by extension the example analytics management circuitry 2415) are all communicatively coupled to bus 2530. In some examples, bus 2530 may be a wired or wireless bus and use any communication protocol that is understood by each of the coupled devices.

In some examples, the data confidence scoring management circuitry 2500 includes means for calculating the first and second correlation values of the node information obtained at the first and second times. For example, the means for calculating may be implemented by the correlation/covariance algorithm calculation circuitry 2510. In some examples, the correlation/covariance algorithm calculation circuitry 2410 may be implemented by machine executable instructions such as that implemented by at least blocks 2604, 3404, 3504, and 3702, executed by processor circuitry, which may be implemented by the example processor circuitry 3812 of FIG. 38. In other examples, the correlation/covariance algorithm calculation circuitry 2510 is implemented by other hardware logic circuitry, hardware implemented state machines, and/or any other combination of hardware, software, and/or firmware. For example, the correlation/covariance algorithm calculation circuitry 2510 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware, but other structures are likewise appropriate.

Flowcharts representative of example hardware logic circuitry, machine readable instructions, hardware implemented state machines, and/or any combination thereof for implementing the data confidence scoring manager 2234 of FIGS. 22, 23, and/or 24 are shown in FIGS. 26-37. The machine readable instructions may be one or more executable programs or portion(s) of an executable program for execution by processor circuitry, such as the processor circuitry 3812 shown in the example processor platform 3800 discussed below in connection with FIG. 38. The program may be embodied in software stored on one or more non-transitory computer readable storage media such as a CD, a floppy disk, a hard disk drive (HDD), a solid-state drive (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 26-37, many other methods of implementing the example data confidence scoring manager 2234 of FIGS. 22, 23, and/or 24 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 26 is a flowchart representative of example machine readable instructions and/or example operations that may be executed and/or instantiated by processor circuitry to implement adaptive data confidence scoring among multiple nodes.

The machine readable instructions and/or operations 2600 of FIG. 26 are described in connection with the example data ingestion circuitry 2410 (FIG. 24), the example node information ingestion pre-processing circuitry 2508, and the example analytics management circuitry 2415 (FIG. 24) and, more specifically, the example correlation/covariance algorithm calculation circuitry 2510 (FIG. 25), the example correlation/covariance algorithm comparator circuitry 2512 (FIG. 25), the example error correction value generation circuitry 2516 (FIG. 25), and the example node data correction circuitry 2506 (FIG. 25).

In the illustrated example of FIG. 26, the machine readable instructions and/or the operations 2600 of FIG. 26 begin at block 2602, at which the example data ingestion circuitry 2410 obtains node information (e.g., node data) from a group of nodes at a first time and at a second time. In some examples, this process is run in the background of a system. Thus, in some examples, node information (e.g., sensor data and/or telemetry data) generated from nodes within the group of nodes (e.g., sensor data and/or telemetry data) are processed through their normal routines and this information is passed to the user or application/service. In different examples, the sensor data includes any number of the following types of data: visual data, audio data, temperature data, pressure data, velocity data, acceleration data, or location data, or any other known type of sensor data. In different examples, the telemetry data includes any number of the following types of data: an IP address, an IP port, a media access control (MAC) address, a processor utilization percentage, a memory usage percentage, or a power consumption amount, or any other known type of telemetry data.

In addition to the normal routines, in some examples, the data ingestion circuitry 2410 processes node information and then stores the node information (e.g., to cause a storage controller or other storage logic to store) in a rolling manifest (the example rolling manifest is discussed below in detail with regard to FIG. 32.

In some examples, the data ingestion circuitry 2410 obtains (e.g., receives) the node information at a single time/occurrence. In other examples, the data ingestion circuitry 2410 obtains the node information at multiple times. A single n instant correlation value from a single receipt of node information provide ample information about whether the node information is correlated, but receiving the same node information at multiple times (e.g., at least two times) provides an added view into the change of the correlation value of the group of nodes. For example, tracking the change in the correlation value over multiple times can illustrate an anomalous spike, a degradation of a node over time, among other valuable insights. In some examples, the data ingestion circuitry 2410 may utilize a countdown timer to receive the value of the node each time the timer reaches zero.

At block 2604, the example correlation/covariance algorithm calculation circuitry 2510 calculates at least a first correlation value associated with the node information obtained at the first time and a second correlation value associated with the node information obtained at the second time. In some examples, the correlation/covariance algorithm calculation circuitry 2510 calculates the correlation value among the nodes in the group of nodes using the utility function (e.g., Equation 1 as described above). In other examples, the correlation/covariance algorithm calculation circuitry 2510 calculates the correlation among the node information obtained at the data ingestion circuitry 2410 from each of the nodes in the group of nodes through another correlation value calculation method. In some examples, the correlation/covariance algorithm calculation circuitry 2510 uses data pooling and hierarchical data consolidation to link node information from multiple nodes or archival data sources based on enumerated or automated correlation factors.

At block 2606, the example correlation/covariance algorithm comparator circuitry 2512 compares the first correlation value and the second correlation value to determine whether a correlation error is detected. In some examples, when there are two or more correlation values that have been calculated, the correlation/covariance algorithm comparator circuitry 2512 compares the multiple correlation values to identify a trend. In other examples, where there is only one correlation value that has been calculated. The example correlation/covariance algorithm comparator circuitry 2512 can determine a snapshot of the correlation value at a given single time, which will still provide basic information about whether the correlation among the nodes of a group of nodes is high (with no outliers) or medium/low (with one or more outliers). In some examples, the example correlation/covariance algorithm comparator circuitry 2512 can determine a correlation error based on a minimum threshold value of correlation for each correlation value calculated. For example, if a single correlation value is calculated at 0.9, that may be considered a very high degree of correlation among the nodes of the group of nodes producing/generating the node information. Thus, if an example minimum threshold for a “high degree” of correlation (e.g., strong correlation) is a correlation value of 0.7, then the example correlation/covariance algorithm comparator circuitry 2512 determines that a 0.9 calculated correlation value has a strong correlation and it is assumed no outlier nodes with anomalous data are present at the time the node information was generated resulting in the 0.9 correlation value.

In the alternative, if an example single correlation value comes back at 0.2, that may be considered a very low degree of correlation among the nodes of the group of nodes producing/generating the node information. Therefore, if the example minimum threshold for a high degree of correlation is a correlation value of 0.7, then the example correlation/covariance algorithm comparator circuitry 2512 determines that a 0.2 calculated correlation value has a low degree correlation and one or more outlier nodes with anomalous data are present at the time the node information was generated resulting in the 0.2 correlation value. In some examples, a low correlation value is defined to be a correlation error and a high correlation value is defined to not be a correlation error.

In some examples, node information correlation is mapped over time for convergence and/or divergence in data alignment. Therefore, in some examples, a correlation error may also occur if a correlation value trend over time moves the correlation value of the group of nodes towards a convergence in data alignment (i.e., high correlation) or a divergence in data alignment (i.e., low correlation). For example, if the correlation/covariance algorithm calculation circuitry 2510 calculates a first correlation value of the node information at time 1 of 0.9, and then the correlation/covariance algorithm calculation circuitry 2510 calculates a second correlation value of the node information at time 2 of 0.6, this may also be considered a correlation error, since the correlation value has decreased by 0.3 between the two times. In some examples, the correlation/covariance algorithm calculation circuitry 2510 tracks a trendline and utilizes the trendline to generate correlation errors. In some examples, real-time data selection results from users and/or applications also may identify the same or a similar trend. Additionally, in some examples, the analytics management circuitry 2415 may distinguish between data not used because of relevance vs formatting—the correlation values are generated in the utilization phase and provide a weighting to the data correlation engine for user preference. The analytics management circuitry 2415 can identify a node integrity issue by combining information from data alignment tracking with the real-time input.

At block 2608, the example correlation/covariance algorithm comparator circuitry 2512 then determines the result of the block 2606 comparison. If it is determined that a correlation error is not detected, then the example machine readable instructions and/or the example operations 2600 of FIG. 26 conclude.

Otherwise, if it is determined that a correlation error is detected, then at block 2610, in response to the detection/determination of the correlation error, the example error correction value generation circuitry 2516 generates node information error correction values. In some examples, the generation of node information error correction values can be combined with node information to provide a data value score (e.g., correlation value) for each node in the group of nodes. The value score can remain live in the rolling manifest data structure and regularly updated based on the scoring over an observation time. In some examples, this allows for continuous closed loop improvements in data correction and error detection within and across node groups.

When an example node has a low calculated correlation value after receiving high correlation value marks for a previous long observation time, this may trigger a flag for predictive maintenance for the example node. For example, an error may have occurred with the node's platform regarding the environment condition that caused the abrupt change in scoring.

In an alternative, when an example node has a high calculated correlation value after receiving low correlation value marks for a previous long observation time, this may trigger a flag to further examine the node. In some examples, one of two possibilities are likely in this scenario: A) a corner case node data happens and creates a real anomaly situation, or B) defective data either from the node in question or from an upstream node affecting the node in question has led to the change in the correlation value.

In some examples, the generation of node information error correction values is one (#1 response) of three possible responses when a correlation error is detected. In some examples, alternative solutions to address the correlation error include #2 response) Adjust weights/terms in the machine learning model 2470 to correct a node's model to ensure better alignment of models across nodes. E.g., where the group of nodes are all considered peer nodes and each node in the group has a machine learning model 2470 with output that should align with the machine learning models of the other nodes. #3 response) Acknowledge the occurrence of a rare or intermittent (outlier) event. The outlier event and its impact on the rest of the processes can then be surfaced to higher level applications. In some examples, the uniqueness and degree of the outlier event is quantified. Over time, the analytics management circuitry 2415 may rank outlier events based on severity, correlated with other events which will be used to predict outliers. In some examples, the analytics management circuitry 2415 may generate a course of actions to correct and avoid the outlier event.

Returning to FIG. 26, at block 2612, the example node data correction circuitry 2506 applies the node information error correction values to the node information to reduce the correlation error and at this point the process ends.

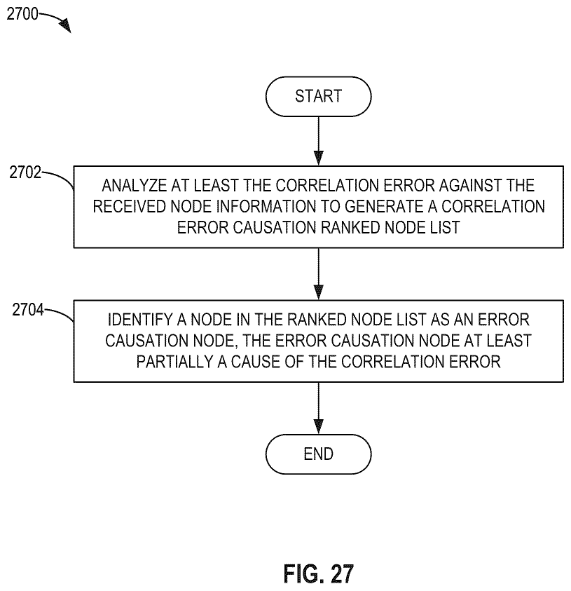

FIG. 27 is a flowchart representative of example machine readable instructions and/or example operations that may be executed and/or instantiated by processor circuitry to determine an error causation node.

The machine readable instructions and/or operations 2700 of FIG. 27 are described in connection with the example analytics management circuitry 2415 (FIG. 24) and, more specifically, the example error causation node determination circuitry 2520 (FIG. 25).

In the illustrated example of FIG. 27, the example machine readable instructions and/or the example operations 2700 of FIG. 27 begin at block 2702, at which the example error causation node determination circuitry 2520 analyzes at least the correlation error against the obtained node information to generate a correlation error causation ranked node list of the group of nodes. In some examples, the group of nodes has more than one outlier node causing a correlation error, but for efficiency purposes, the example error causation node determination circuitry 2520 may respond to nodes individually in the order of the seriousness of the correlation error. Therefore, the example error causation node determination circuitry 2520 generates a causation ranked node list. In some examples the example error causation node determination circuitry 2520 causes the list to be stored in the rolling manifest and will continuously update the list as new calculated correlation values are obtained and sorted.

Then, at block 2704, the example error causation node determination circuitry 2520 identifies a highest ranked node in the correlation error causation ranked node list as an error causation node from the group of nodes. The example error causation node determination circuitry 2520, in the process of ranking the node list for causation of the correlation values/errors, has continuous access to the list. Therefore, the node at the top of the correlation error causation ranked node list is identifiable by the example error causation node determination circuitry 2520 as the highest ranked node. At this point the process ends.

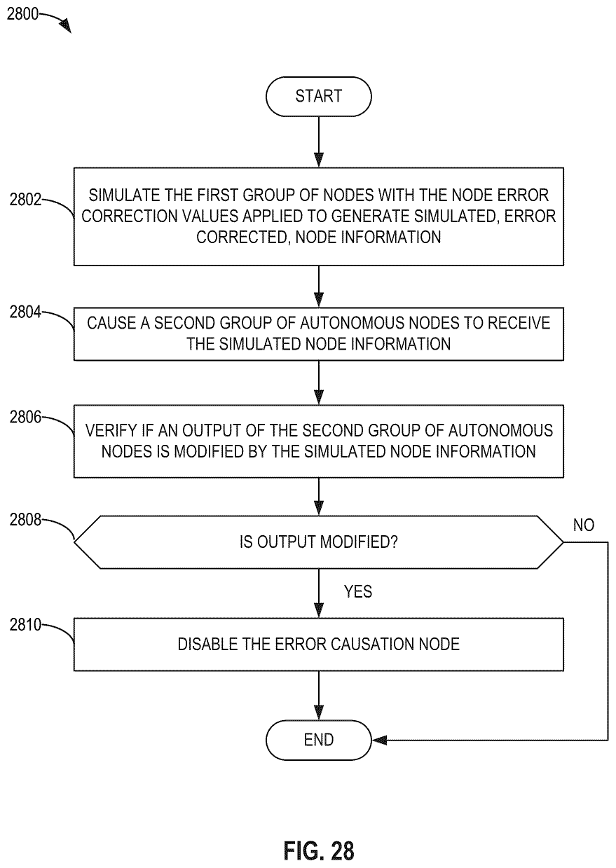

FIG. 28 is a flowchart representative of example machine readable instructions and/or example operations that may be executed and/or instantiated by processor circuitry to implement a simulation of multiple nodes.

The machine readable instructions and/or operations of FIG. 28 are described in connection with the example analytics management circuitry 2415 (FIG. 24) and the example node management circuitry 2440 (FIG. 24) and, more specifically, the example node simulator circuitry 2518 (FIG. 25).

In the illustrated example of FIG. 28, the example machine readable instructions and/or the example operations 2800 of FIG. 28 begin at block 2802, at which the example node simulator circuitry 2518 simulates with a machine learning model 2470 the first group of nodes with the node information error correction values applied to generate simulated error corrected node information. In some examples, correlation errors (e.g., correlation divergence) in one or more nodes in the group of nodes triggers the group of nodes to have one or more autonomous checkpoints for platform/sensors/data. The example node simulator circuitry 2518 runs a simulation using simulated versions of the group of nodes to test correlation value correction with the error causation node to address the local issue. Assuming the local simulation test completes successfully, then the example node simulator circuitry 2518 simulates local node error correction with downstream autonomous nodes to identify if there is a negative impact on the downstream nodes.

Thus, at block 2804, the example node simulator circuitry 2518 causes a second group of autonomous nodes to receive the simulated error corrected node information. The example downstream autonomous nodes are being tested at this stage to see if there is any negative impact, which may come in the form of the autonomous nodes having modified output.

At block 2806, the example node simulator circuitry 2518 verifies whether an output of the second group of nodes is modified by the simulated error corrected node information. And, at block 2808, the example node simulator circuitry 2518 determines the result of the verification process.

If the example node simulator circuitry 2518 determines that the output is not modified, the example machine readable instructions and/or the example operations 2800 of FIG. 28 conclude. In some examples, this result takes place in the event that the autonomous nodes are not affected by the simulated output of the local node(s) in the group of nodes with the error correction modification(s). In some examples, the simulated group of nodes provides the correlation error corrections to align the correlations. If there is no effect, then the example node simulator circuitry 2518 determines the error correction can take place without further repercussions.

If it is determined that the output is modified, then at block 2810, the example node management circuitry 2440 disables the error causation node. In some examples, when the error causation node is disabled, a user of the system/node is alerted that a node is causing a correlation error and correction of the correlation error is not feasible because the correction causes further discrepancies downstream. In response to disabling the first error causation node at block 2810, the example machine readable instructions and/or the example operations 2800 of FIG. 28 conclude.

In other examples, the node simulator circuitry 2518 performs as a process simulation manager. The example node simulator circuitry 2518 represents discrete process blocks as proxy for each operating group of nodes. In some examples, the process simulation manager is a neural network that detects patterns. This form of neural network is designed to detect changes in the process which adversely impact the output of the group of nodes at the process point (e.g., an output layer) prior to going to the next group of nodes (e.g., input). In some examples, the example process simulation manager operates continuously using the correlated data to retrain the neural network for optimization to a nominal environment for the group of nodes.

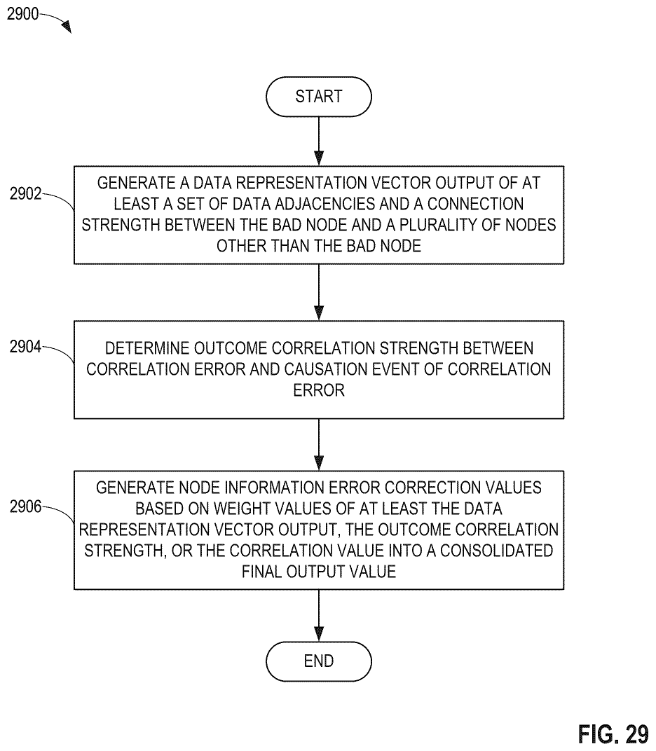

FIG. 29 is a flowchart representative of example machine readable instructions and/or example operations that may be executed and/or instantiated by processor circuitry to generate node information error correction values.

The machine readable instructions and/or operations of FIG. 29 are described in connection with the example analytics management circuitry 2415 (FIG. 24) and, more specifically, the example data representation vector generation circuitry 2524 (FIG. 25), the example correlation/covariance strength analyzer circuitry 2514 (FIG. 25), and the example node data extrapolation circuitry 2526 (FIG. 25).

In some examples, there are a variety of major data categories that are obtained as node information from the group of nodes. To represent the node information obtained from the group of nodes, in some examples, it is desirable to establish a ground truth metric for each major data category being analyzed. Additionally, multi-node corroboration takes place for computation or extrapolation using best available sensor information to compare with the data in question to draw a confidence level (or a reasonable doubt value). The machine learning model 2470 may include a neural network with a series of nodes with weights represented by vectors between the adjacent nodes, per layer. In some examples, the analytics management circuitry 2415 builds the neural network (or another form of a multi-node graph) to enable the machine learning model 2470 to help compute and extrapolate the best available node information to replace the node information from the identified error causation node.

In the illustrated example of FIG. 29, the example machine readable instructions and/or the example operations 2900 of FIG. 29 begin at block 2902, at which, for each of the first and second correlation values of the node information, the example data representation vector generation circuitry 2524 generates a data representation vector output of at least a set of data adjacencies and a connection strength between the error causation node and a plurality of nodes other than the error causation node in the group of nodes. For example, a set of data adjacencies are the nodes that are locally adjacent (direct output and/or input to/from) nodes (e.g., nodes 2306, 2308, and 2310 are three locally adjacent nodes to node 2304 in FIG. 2). Additionally, in some examples, a connection strength (i.e., strength of connection) represents how close (and correlated) nodes are spaced (e.g., how long the vector line is between two nodes in the data representation graph in FIG. 2). For example, the shorter the vector line between nodes, the more correlated the adjacent nodes.

At block 2904, the example correlation/covariance strength analyzer circuitry 2514 determines an outcome correlation strength between the correlation error and at least one causation event of the correlation error. In some examples, a cause and effect event correlation is determined (e.g., the higher the correlated cause, the greater the effect in magnitude and/or the more precise the timing of the resulting effect).

Then, at block 2906, the example node data extrapolation circuitry 2526 generates the node information error correction values based on weight values of at least one of the data representation vector output, the outcome correlation strength, or the first or second correlation value of the node information into a consolidated final output value. In some examples, the example node data extrapolation circuitry 2526 takes one or more of those inputs and weights and consolidates the related outputs for a given node in the neural network. Once all inputs have been entered and utilized, the example node data extrapolation circuitry 2526 generates a final output value, which is the extrapolated node information for the error causation node, and the example machine readable instructions and/or the example operations 2900 of FIG. 29 conclude. The example extrapolated node information may be in the form of a weighted node information output value (e.g., weighted output data) or it may be an array of values correlating to multiple data, sensor, and event inputs in a more complex model.

In some examples, machine learning models from multiple nodes, such as machine learning model 2470, are utilized to cross-correlate and correct a node's model (e.g., error causation node's model) through a consensus approach, which may evaluate and adjust weights or actualization values in the classification layers of the machine learning model 2470 (e.g., an artificial neural network) to better align multiple machine learning models with each other.

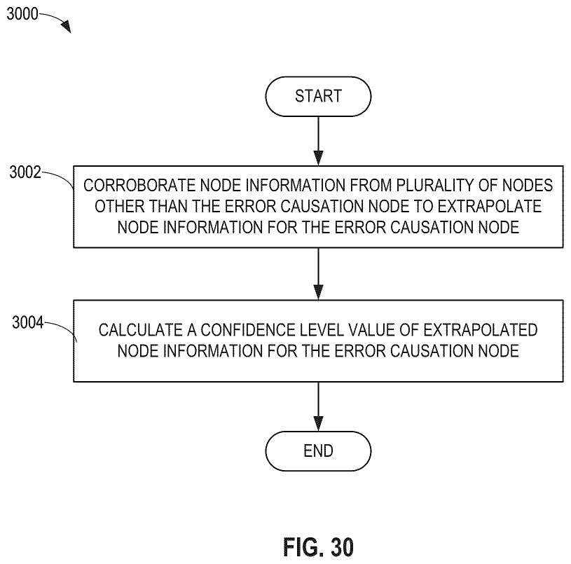

FIG. 30 is a flowchart representative of example machine readable instructions and/or example operations that may be executed and/or instantiated by processor circuitry to extrapolate node information for an error causation node and calculate a confidence level of the extrapolated node information.

The machine readable instructions and/or operations of FIG. 30 are described in connection with the example analytics management circuitry 2415 (FIG. 24) and, more specifically, the example node data extrapolation circuitry 2526 (FIG. 25) and the example confidence level calculation circuitry 2528 (FIG. 25).

In the illustrated example of FIG. 30, the example machine readable instructions and/or the example operations 3000 of FIG. 30 begin at block 3002, at which, the example node data extrapolation circuitry 2526 corroborates node information from the plurality of nodes other than the error causation node in the group of nodes to at least extrapolate node information for the error causation node. In some examples, the corroboration of node information from a plurality of nodes is the process described above in regarding to FIG. 8.

Then, at block 3004, the example confidence level calculation circuitry 2528 calculates a confidence level value of the extrapolated node information for the error causation node. In some examples, the resulting output value(s) from the multi-node corroboration in FIG. 8 are then utilized as empirical data through the calculations (i.e., the output value(s) can be substituted for lack of real-world observations of what was being output from the error causation node. As a follow up to assure data quality, the values can then be cross-checked through various other sensor inputs and other nodes to verify the generated data in question is legitimately accurate. In some examples, the confidence level calculation circuitry 2528 calculates how high a confidence level is in the data, or, alternatively, calculates how much of a reasonable doubt there is in the replacement extrapolated data, and the example machine readable instructions and/or the example operations 3000 of FIG. 30 conclude.

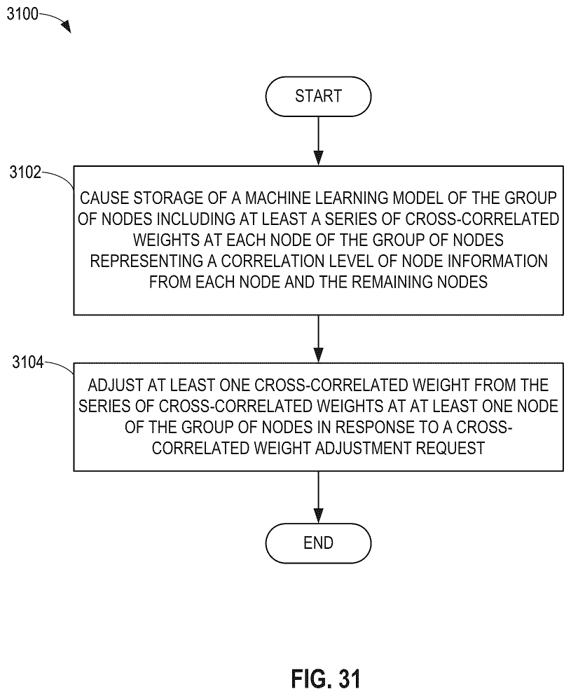

FIG. 31 is a flowchart representative of example machine readable instructions and/or example operations that may be executed and/or instantiated by processor circuitry to implement a machine learning model 2470 associated with a group of nodes.

The machine readable instructions and/or operations of FIG. 31 are described in connection with the example machine learning circuitry 2410 of FIG. 24.

As discussed earlier in reference to the schematic illustration in FIG. 24 and the flowcharts in FIGS. 26, 28, and 29, the system utilizes an example machine learning model 2470 for a number of tasks. The example machine learning model 2470 requires a process flow to be able to be implemented. Thus, in FIG. 31, the example machine learning circuitry 2410 manages the machine learning model 2470 by initiating it and then manipulating through requests.

In the illustrated example of FIG. 31, the example machine readable instructions and/or the example operations 3100 of FIG. 31 begin at block 3102, at which, the example machine learning circuitry 2410 causes storage of a machine learning model 2470 of the group of nodes, the machine learning model 2470 including at least a series of cross-correlated weights at each node of the group of nodes representing a correlation level of node information from each node of the group of nodes to the node information from the remaining nodes of the group of nodes.

Then, at block 3104, the example machine learning circuitry 2410 adjusts at least one cross-correlated weight from the series of cross-correlated weights at least at one node of the group of nodes in response to a cross-correlated weight adjustment request, and the example machine readable instructions and/or the example operations 3100 of FIG. 31 conclude.

FIG. 32 is a flowchart representative of example machine readable instructions and/or example operations that may be executed and/or instantiated by processor circuitry to implement a rolling manifest of incoming node information.

The machine readable instructions and/or operations of FIG. 32 are described in connection with the example data ingestion circuitry 2415 (FIG. 24), the example pre-processing management circuitry 2504 (FIG. 25), and, more specifically, the example node information ingestion pre-processing circuitry 2508 (FIG. 25).

In the illustrated example of FIG. 32, the example machine readable instructions and/or the example operations 3200 of FIG. 32 begin at block 3202, at which, the example node information ingestion pre-processing circuitry 2508 initiates a rolling manifest 2463, the rolling manifest 2463 to include a copy of the node information as a series of data snapshots corresponding to the node information at a series of times. In some examples, a rolling manifest 2463 is a storage buffer that keeps a rolling window of obtained node information. In some examples the length of the window of time the rolling manifest keeps the node information is dynamic and/or varies depending on factors such as a frequency of data snapshots, a priority level of the node information, and/or any one or more other reasons. In some examples, each amount of data (e.g., node information) stored in the rolling manifest has an expiration time and once the time expires the data associated with the expiration time is discarded, removed, etc. and the storage locations are recycled for new incoming data. In some examples, a specific manifest covering a certain window of time is saved for long term storage for future use/calculations. In some examples, there are multiple rolling manifests existing at once serving one or more purposes. In some examples, each given active rolling manifest is utilized to process and analyze statistical features at certain times. For example, the rolling manifest 2463 may include a 10 minute window of node information received from the nodes. E.g., a statistical feature (e.g., a mean of a type of data) can be calculated across the entire 10-minute window of node information.

Next, at block 3204, the example node information ingestion pre-processing circuitry 2508 causes the node information to be stored in the rolling manifest 2463 at least as a first data snapshot at a first time, as a second data snapshot at a second time, and as a third data snapshot at a third time, and the example machine readable instructions and/or the example operations 3200 of FIG. 32 conclude. In other examples, the rolling manifest 2463 may store less or more than data snapshots. In some examples, each data snapshot includes the set of data information from all of the nodes in the group of nodes. The node information (e.g., data) for each node may be one piece of data or multiple pieces of data, depending on the complexities of the node inputs and outputs. In some examples, the rolling manifest 2463 also stores one or more statistical features corresponding to the data. For example, the rolling manifest might include a series of data snapshots over the past 10 minutes of the node information from the group of nodes. A statistical feature corresponding to the series of data snapshots might be a standard deviation of a category of data from the group of nodes, represented in the data snapshots throughout the rolling window. Other statistical features include min, max, mode, median, and/or any other statistical feature known. The standard deviation may be stored with the rolling manifest 2463 for localized access to the statistical features of the data in the rolling manifest 2463.

In some examples, the analytics management circuitry 2415 checks for duplicate or aged correlation errors stored in the rolling manifest 2463 to determine if one or more correlation errors are irrelevant or redundant. In some examples, irrelevant or redundant errors are removed from the rolling manifest 2463 when found to provide more accurate correlation error data.

FIG. 33 is a flowchart representative of example machine readable instructions and/or example operations that may be executed and/or instantiated by processor circuitry to implement a statistical feature data ingestion process.

The machine readable instructions and/or operations of FIG. 32 are described in connection with the example data ingestion circuitry 2415 (FIG. 24), the example pre-processing management circuitry 2504 (FIG. 25), and, more specifically, the example node information ingestion pre-processing circuitry 2508 (FIG. 25).

In some examples, when implementing a rolling manifest 2463, the data in the immediate window of time can provide useful information similar to counters of data that are compared against threshold values. For example, returning to the standard deviation statistical feature, the data ingestion circuitry 2410 may keep track of a rolling standard deviation of the node information and if the rolling standard deviation ever exceeds a threshold value, the presence of this high level standard deviation could be a red flag that something is wrong with the input node information from the group of nodes.

In the illustrated example of FIG. 33, the example machine readable instructions and/or the example operations 3300 of FIG. 33 begin at block 3302, at which, the example node information ingestion pre-processing circuitry 2508 extracts a statistical feature from each of the series of data snapshots. As discussed above in reference to FIG. 32, in some examples, one or more statistical features are to be extracted. In some examples, the node information ingestion pre-processing circuitry 2508 extracts a statistical feature from an individual data snapshot, which may be a single time or a small window of time. In other examples, the node information ingestion pre-processing circuitry 2508 extracts a statistical feature from the combination of data snapshots stored in the rolling manifest 2463.

Next, at block 3304, the example node information ingestion pre-processing circuitry 2508 compares the statistical feature to a threshold value. In some examples, the example node information ingestion pre-processing circuitry 2508 keeps a small buffer in the rolling manifest that stores all statistical feature threshold values. In other examples, the example node information ingestion pre-processing circuitry 2508 accesses a series of registers, a location in the datastore 2460 designated to store the statistical feature windows, or in any accessible storage location. In some examples, the example node information ingestion pre-processing circuitry 2508 utilizes more than one threshold value for a statistical feature. For example, there may be a minimum threshold value and a maximum threshold value, which would provide a 3 segment decision tree of options for what to do when a statistical feature passes one of a series of threshold values in either direction. The example node information ingestion pre-processing circuitry 2508 may have a unique process to put in place for each one of many thresholds passed.

Next, at block 3306, the example node information ingestion pre-processing circuitry 2508 determines if the result of the comparison at block 3304 found that the statistical feature exceeded the threshold value. If the threshold value was not exceeded, then the example machine readable instructions and/or the example operations 3300 of FIG. 33 conclude.

Otherwise, if the threshold value was exceeded (or in one alternative, if the threshold value was a minimum and the statistical feature fell under the threshold value), then, at block 3308, the example node information ingestion pre-processing circuitry 2508, in response to the statistical feature exceeding the threshold value, requests an adjustment to at least one of the cross-correlated weights in the machine learning model 2470 of the group of nodes, and the example machine readable instructions and/or the example operations 3300 of FIG. 33 conclude. In some examples, the request for the adjustment is sent to the machine learning circuitry 2410. The process performed when a request for an adjustment is received is described in the discussion of FIG. 31.

FIG. 34 is a flowchart representative of example machine readable instructions and/or example operations that may be executed and/or instantiated by processor circuitry to determine an intermittent nature of a correlation error.

The machine readable instructions and/or operations of FIG. 34 are described in connection with the example analytics management circuitry 2415 (FIG. 24) and, more specifically, the example correlation/covariance algorithm calculation circuitry 2510 (FIG. 25), the example correlation/covariance algorithm comparator circuitry 2512 (FIG. 25), and the example long-term error event handler circuitry 2522 (FIG. 25).

In some situations, a correlation error can occur for a period of time due to a data outlier and then the correlation error may go away because the data outlier is no longer present. Scenarios exist where there is a correlation error and then it goes away permanently. In other situations, the correlation error may fade in and out due to some recurring cause. In these situations, determining the correlation error is intermittent is beneficial.

In the illustrated example of FIG. 34, the example machine readable instructions and/or the example operations 3400 of FIG. 34 begin at block 3402, at which, the example correlation/covariance algorithm calculation circuitry 2510 calculates at least a third correlation value of the node information received at a third time. In some examples, with a series of correlation values available in the rolling manifest 2463, a series of correlation errors may be detectable.

At block 3404, the example correlation/covariance algorithm comparator circuitry 2512 compares the second correlation value and the third correlation value to determine whether the first correlation error has an intermittent aspect.

At block 3406, the example correlation/covariance algorithm comparator circuitry 2512 determines if the correlation error is intermittent based on the comparison at block 3404. In some examples, when a correlation error changes between being present and not present, the example correlation/covariance algorithm comparator circuitry 2512 keeps track of the presence of the correlation error. Thus, when a correlation error is no longer present (after a period of time when it was present, the example correlation/covariance algorithm comparator circuitry 2512 determines that the correlation error is present. If it is determined at block 3406 that the correlation error is not intermittent, then the example machine readable instructions and/or the example operations 3400 of FIG. 34 conclude.

Otherwise, if it is determined at block 3406 that the correlation error is intermittent, then, in response to a determination that the first correlation error has an intermittent aspect, the example long-term error event handler circuitry 2522 initiates an error event log for the node information, and the example machine readable instructions and/or the example operations 3400 of FIG. 34 conclude. For example, the correlation error is present at time A, and then at time B, the correlation error is not present. In that scenario, the example correlation/covariance algorithm comparator circuitry 2512 confirms the intermittency of the correlation error.

FIG. 35 is a flowchart representative of example machine readable instructions and/or example operations that may be executed and/or instantiated by processor circuitry to determine a cyclic nature of a correlation error.

The machine readable instructions and/or operations of FIG. 35 are described in connection with the example data ingestion circuitry 2410 (FIG. 24) and the example analytics management circuitry 2415 (FIG. 24) and, more specifically, the example node data correction circuitry 2506 (FIG. 25), the example correlation/covariance algorithm calculation circuitry 2510 (FIG. 25), the example correlation/covariance algorithm comparator circuitry 2512 (FIG. 25), and the example node data correction circuitry 2506 (FIG. 25).

In some examples, once the intermittent nature of a correlation error is confirmed, the analytics management circuitry 2415 implements a process to determine if the intermittent nature of the correlation error, discussed above in regard to FIG. 34, is repeatable/cyclic. In some examples, at least blocks 3502 and 3504 are implemented as at least part of the process put into place as a result of the example long-term error event handler circuitry 2522 initiating an error event log for the node information at block 3406 in FIG. 34. In some examples, the long-term error event handler circuitry 2522 causes the data ingestion circuitry 2410 and the analytics management circuitry 2415 to implement at least blocks 3502 and 3504, respectively.

In the illustrated example of FIG. 35, the example machine readable instructions and/or the example operations 3500 of FIG. 35 begin at block 3502, at which, the example data ingestion circuitry 2410 receives the node information at a plurality of additional time values. In some examples, the node information is received at any rate the group of nodes report out the node information. The long-term error event handler circuitry 2522 may designate a buffer in the rolling window or elsewhere to make room for the storage of the node information received in block 3502.

Then, at block 3504, the example correlation/covariance algorithm calculation circuitry 2510 calculates a plurality of additional correlation values corresponding to the node information received at each of a chronologically consecutive pair of the plurality of additional time values. As described above, in regard to the description of FIG. 26, there are multiple implementation options for calculating the correlation values. In the process described in FIG. 35, the correlation values are calculated for chronologically consecutive pairs of time. For example, if a node publishes/outputs/sends its node information out once per second. Then the correlation values calculated would be at time X and time X+1 second. This would provide the possibility of a trend of the correlation value of the node information from the group of nodes. But alternatively, each node information received, could be used for calculating a correlation value separately, which could be used to determine a correlation error. The buffer utilized to store a chronological history of the correlation error of a node from the group of nodes may be larger due to the amount of data to be stored for cyclical intermittency verification purposes. In some examples, the buffer may be present in the rolling manifest 2463. In other examples, the buffer may be present elsewhere in the datastore 2460 or in another storage location in the system.

Next, at block 3506, the example correlation/covariance algorithm comparator circuitry 2512 verifies whether the intermittent aspect of the correlation error is cyclic based on an inspection of the plurality of the additional correlation values. In some examples, verification includes seeing a regularly repeatable correlation error that is present and gone at different times. In some examples, the frequency schedule of the intermittent aspect of the correlation error, if one exists, is stored in the buffer (e.g., in the rolling manifest 2463).

At block 3508, the example analytics management circuitry 2415 determines the result of the verification process. If it is determined that the intermittency is not cyclic, then the example machine readable instructions and/or the example operations 3500 of FIG. 35 conclude.

If it is determined that the intermittency is cyclic, then at block 3510, the example node data correction circuitry 2506, in response to a second determination that the intermittent aspect of the correlation error is cyclic, applies the node error correction values to the node information during a time window of each cycle of the correlation error, and the example machine readable instructions and/or the example operations 3500 of FIG. 35 conclude. Thus, the analytics management circuitry 2415 can utilize the buffer keeping track of the chronological history of the correlation error to set up a repeatable timer to apply node error correction values each time the timer expires (i.e., to coincide with the cyclical intermittency of the error causation node outputting error causation node information.

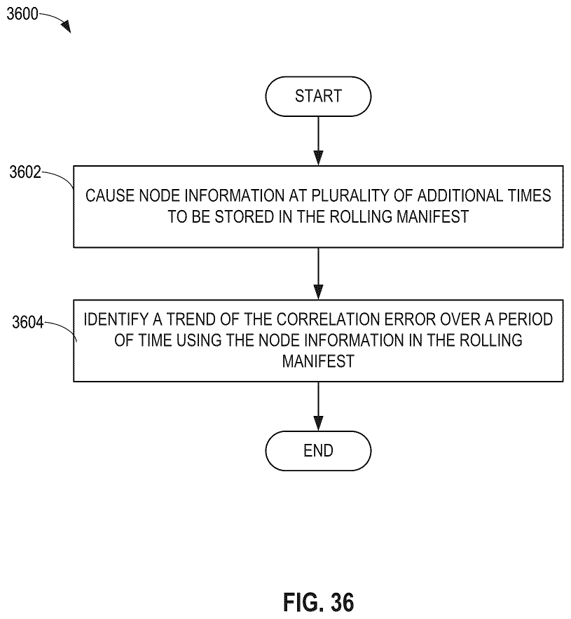

FIG. 36 is a flowchart representative of example machine readable instructions and/or example operations that may be executed and/or instantiated by processor circuitry to identify a trend of the correlation error.

The machine readable instructions and/or operations of FIG. 36 are described in connection with the example data ingestion circuitry 2410 (FIG. 24), the example analytics management circuitry 2415 (FIG. 24), the example pre-processing management circuitry 2504 (FIG. 25), and, more specifically, the example node information ingestion pre-processing circuitry 2508 (FIG. 25), and the example long-term error event handler circuitry 2522 (FIG. 25).

In some examples, node information correlation is mapped over time for convergence and/or divergence in data alignment. Therefore, in some examples, a correlation error may also occur if a correlation value trend over time moves the correlation value of the group of nodes towards a convergence in data alignment (i.e., high correlation) or a divergence in data alignment (i.e., low correlation).

In the illustrated example of FIG. 36, the example machine readable instructions and/or the example operations 3600 of FIG. 36 begin at block 3602, at which, the example node information ingestion pre-processing circuitry 2508 causes the node information at the plurality of additional time values to be stored at least in the rolling manifest.

Then, at block 3604, the example long-term error event handler circuitry 2522 identifies a trend of the correlation error over a period of time using the node information in the rolling manifest, and the example machine readable instructions and/or the example operations 3600 of FIG. 36 conclude.

FIG. 37 is a flowchart representative of example machine readable instructions and/or example operations that may be executed and/or instantiated by processor circuitry to adjust cross-correlated weights of a machine learning model 2470 of a group of nodes.

The machine readable instructions and/or operations of FIG. 37 are described in connection with the example analytics management circuitry 2415 (FIG. 24), and, more specifically, the example correlation/covariance algorithm comparator circuitry 2512 (FIG. 25).

In the illustrated example of FIG. 37, the example machine readable instructions and/or the example operations 3700 of FIG. 37 begin at block 3702, at which, the example correlation/covariance algorithm comparator circuitry 2512 compares the correlation error to a correlation error threshold value.

Next, at block 3704, the example correlation/covariance algorithm comparator circuitry 2512 determines if the correlation error exceeds a correlation error threshold value. If the correlation error does not exceed the correlation error threshold value, then the example machine readable instructions and/or the example operations 3700 of FIG. 37 conclude.

Otherwise, if the correlation error does exceed the correlation error threshold value, then, in block 3706, in response to the correlation error exceeding the correlation error threshold value, the example analytics management circuitry 2415 requests an adjustment to at least one of the cross-correlated weights in the machine learning model 2470 of the group of nodes, and the example machine readable instructions and/or the example operations 3700 of FIG. 37 conclude. In some examples, the request for the adjustment is sent to the machine learning circuitry 2410. The process performed when a request for an adjustment is received is described in the discussion of FIG. 31.

FIG. 38 is a block diagram of an example processor platform structured to execute and/or instantiate the machine readable instructions and/or the operations of FIGS. 26-37 to implement the data confidence scoring circuitry of FIGS. 22, 23, and/or 24. The processor platform 3800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 3800 of the illustrated example includes processor circuitry 3812. The processor circuitry 3812 of the illustrated example is hardware. For example, the processor circuitry 3812 can be implemented by one or more integrated circuits, logic circuits, FPGAs, microprocessors, CPUs, GPUs, DSPs, and/or microcontrollers from any desired family or manufacturer. The processor circuitry 3812 may be implemented by one or more semiconductor based (e.g., silicon based) devices. In this example, the processor circuitry 3812 implements the example machine learning circuitry 2420 (identified by ML CIRCUITRY), the example data query management circuitry 2430 (identified by DATA QUERY MGMT CIRCUITRY), the example node management circuitry 2440 (identified by NODE MGMT CIRCUITRY), and the example data publishing circuitry 2450 (identified by DATA PUBLISH CIRCUITRY) of FIG. 24.

The processor circuitry 3812 of the illustrated example includes a local memory 3813 (e.g., a cache, registers, etc.). The processor circuitry 3812 of the illustrated example is in communication with a main memory including a volatile memory 3814 and a non-volatile memory 3816 by a bus 3818. In some examples, the bus 3818 implements the bus 2480 of FIG. 24. The volatile memory 3814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3816 may be implemented by flash memory and/or any other desired type of memory device. Access to the main memory 3814, 3816 of the illustrated example is controlled by a memory controller 3817.

The processor platform 3800 of the illustrated example also includes interface circuitry 3820. The interface circuitry 3820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In this example, the interface circuitry 3820 implements the example data ingestion circuitry 2410 of FIG. 24.

In the illustrated example, one or more input devices 3822 are connected to the interface circuitry 3820. The input device(s) 3822 permit(s) a user to enter data and/or commands into the processor circuitry 3812. The input device(s) 3822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 3824 are also connected to the interface circuitry 3820 of the illustrated example. The output device(s) 3824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3820 of the illustrated example, thus, typically includes a graphics driver card, a graphics driver chip, and/or graphics processor circuitry such as a GPU.

The interface circuitry 3820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 3800 of the illustrated example also includes one or more mass storage devices 3828 to store software and/or data. Examples of such mass storage devices 3828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 3828 implement the example datastore 2460, the example raw data 2462, the example metadata 2464, the example users 2466, the example nodes 2468, and the example machine learning model 2470 (identified by ML MODEL) of FIG. 24.

The machine executable instructions 3832, which may be implemented by the machine readable instructions of FIGS. 26-37, may be stored in the mass storage device 3828, in the volatile memory 3814, in the non-volatile memory 3816, and/or on a removable non-transitory computer readable storage medium such as a CD or DVD.

The processor platform 3800 of the illustrated example of FIG. 3838 includes example acceleration circuitry 3840, which includes an example GPU 3842, an example vision processing unit (VPU) 3844, and an example neural network processor 3846. In this example, the GPU 3842, the VPU 3844, the neural network processor 3846, and/or, more generally, the acceleration circuitry 3840, are in communication with different hardware of the processor platform 3800, such as the volatile memory 3814, the non-volatile memory 3816, etc., via the bus 3818. In this example, the neural network processor 3846 may be implemented by one or more integrated circuits, logic circuits, microprocessors, GPUs, DSPs, or controllers from any desired family or manufacturer that can be used to execute an AI/ML model, such as a neural network, which may be implemented by the machine learning model 2470. In some examples, one or more of the example data ingestion circuitry 2410, the example machine learning circuitry 2420, the example data query management circuitry 2430, the example node management circuitry 2440, and/or the example data publishing circuitry 2450 can be implemented in or with at least one of the GPU 3842, the VPU 3844, the neural network processor 3846, and/or, more generally, the acceleration circuitry 3840, instead of or in addition to the processor circuitry 3812.

From the foregoing, it will be appreciated that example systems, methods, apparatus, and articles of manufacture have been disclosed for adaptive data confidence scoring among multiple nodes. Disclosed systems, methods, apparatus, and articles of manufacture achieve and/or otherwise implement improved data quality in sensor networks and improve the efficiency of sensor networks by validating the accuracy and need for individual nodes in the networks. Disclosed systems, methods, apparatus, and articles of manufacture improve the efficiency of using a computing device by implementing examples disclosed herein. Disclosed systems, methods, apparatus, and articles of manufacture are accordingly directed to one or more improvement(s) in the operation of a machine such as a computer or other electronic and/or mechanical device.

Example systems, apparatus, articles of manufacture, and methods for implementing adaptive data confidence scoring among multiple nodes are disclosed herein. Further examples and combinations thereof include the following:

Example 100 includes a method, including receiving node information from a group of nodes at least at a first time and at a second time, calculating at least a first correlation value associated with the node information received at the first time and a second correlation value associated with the node information received at the second time, comparing the first correlation value and the second correlation value to determine whether a correlation error is detected, in response to a detection of the correlation error, generating node information error correction values, and applying the node information error correction values to the node information to reduce the correlation error.

In Example 101, the subject matter of Example 100 can optionally include analyzing at least the correlation error against the node information to generate a ranked node list of the group of nodes, the ranked node list including one or more nodes from the group of nodes associated with a causation of the correlation error, and identifying at least one of the one or more nodes in the ranked node list as an error causation node from the group of nodes.

In Example 102, the subject matter of Examples 100-101 can optionally include, wherein the group of nodes is a first group of nodes, and further including simulating, with a machine learning model, the first group of nodes to generate an output of simulated node information, wherein the simulated node information includes the error correction values, send the simulated node information to a second group of nodes, verifying whether an output of the second group of nodes is modified by the simulated node information, and, in response to a verification that the output of the second group of nodes is modified, disabling the error causation node.

In Example 103, the subject matter of Examples 100-102 can optionally include, for each of the first and second correlation values of the node information, generating a data representation vector output of at least a set of data adjacencies and a connection strength between the error causation node and a plurality of nodes other than the error causation node in the group of nodes, and determining an outcome correlation strength between the correlation error and at least one causation event of the correlation error, and generating the node information error correction values based on weight values of at least one of the data representation vector output, the outcome correlation strength, or the first or second correlation value of the node information into a consolidated final output value.

In Example 104, the subject matter of Examples 100-103 can optionally include corroborating node information from the plurality of nodes other than the error causation node in the group of nodes to at least extrapolate node information for the error causation node, and calculating a confidence level value of the extrapolated node information for the error causation node.

In Example 105, the subject matter of Examples 100-104 can optionally include causing storage of a machine learning model of the group of nodes, the machine learning model including at least a series of cross-correlated weights at each node of the group of nodes representing a correlation level of node information from each node of the group of nodes to the node information from the remaining nodes of the group of nodes, and adjusting at least one cross-correlated weight from the series of cross-correlated weights for at least one node of the group of nodes in response to a cross-correlated weight adjustment request.

In Example 106, the subject matter of Examples 100-105 can optionally include initiating a rolling manifest, the rolling manifest to include a copy of the node information as a series of data snapshots corresponding to the node information at a series of times, and cause the node information to be stored in the rolling manifest at least as a first data snapshot at a first time, as a second data snapshot at a second time, and as a third data snapshot at a third time.

In Example 107, the subject matter of Examples 100-106 can optionally include extracting a statistical feature from each of the series of data snapshots, comparing the statistical feature to a threshold value, and in response to the statistical feature exceeding the threshold value, requesting an adjustment to at least one of the cross-correlated weights in the machine learning model of the group of nodes.

In Example 108, the subject matter of Examples 100-107 can optionally include, wherein the correlation error is a first correlation error, calculating at least a third correlation value of the node information received at a third time, comparing the second correlation value and the third correlation value to determine whether the first correlation error has an intermittent aspect, in response to a determination that the first correlation error has an intermittent aspect, initiating an error event log for the node information.

In Example 109, the subject matter of Examples 100-108 can optionally include, wherein the determination is a first determination, receiving the node information at a plurality of additional time values, calculating a plurality of additional correlation values corresponding to the node information received at each of a chronologically consecutive pair of the plurality of additional time values, verifying whether the intermittent aspect of the correlation error is cyclic based on an inspection of the plurality of the additional correlation values, and in response to a second determination that the intermittent aspect of the correlation error is cyclic, applying the node error correction values to the node information during a time window of each cycle of the correlation error.

In Example 110, the subject matter of Examples 100-109 can optionally include causing the node information at the plurality of additional time values to be stored at least in the rolling manifest, and identifying a trend of the correlation error over a period of time using the node information in the rolling manifest.

In Example 111, the subject matter of Examples 100-110 can optionally include comparing the correlation error to a correlation error threshold value, and in response to the correlation error exceeding the correlation error threshold value, requesting an adjustment to at least one of the cross-correlated weights in the machine learning model of the group of nodes.

In Example 112, the subject matter of Examples 100-111 can optionally include, wherein the node information includes at least one of sensor data or telemetry data, wherein the sensor data includes at least one of visual data, audio data, temperature data, pressure data, velocity data, acceleration data, or location data, and wherein the telemetry data including at least one of an internet protocol (IP) address, an IP port, a media access control (MAC) address, a processor utilization percentage, a memory usage percentage, or a power consumption amount.

Example 113 is an apparatus including at least one memory, instructions in the apparatus, and processor circuitry to execute and/or instantiate the instructions to perform the method of any of Examples 100-112.

Example 114 is edge server processor circuitry to perform the method of any of Examples 100-112.

Example 115 is edge cloud processor circuitry to perform the method of any of Examples 100-112.

Example 116 is edge node processor circuitry to perform the method of any of Examples 100-112.

Example 117 is edge gateway processor circuitry to perform the method of any of Examples 100-112.

Example 118 is edge switch circuitry to perform the method of any of Examples 100-112.

Example 119 is an XPU to perform the method of any of Examples 100-112.

Example 120 is an apparatus comprising at least one of acceleration circuitry, one or more graphics processor units, one or more vision processor units, Artificial Intelligence processor circuitry, Machine-Learning processor circuitry, neural network processor circuitry, one or more digital signal processors, one or more general purpose processors, or network interface circuitry to perform the method of any of Examples 100-112.

Example 121 is at least one computer readable medium comprising instructions to perform the method of any of Examples 100-112.

### Section E—Systems, Apparatus, Articles of Manufacture, and Methods for Contextual Translation of Data for Improved Data Management

Some network environments (e.g., factories, warehouses, commercial and/or industrial buildings, etc., having network connectivity) maintain multiple siloed data platforms for different units/disciplines in the facility supporting various suboperations. For example, a vehicle manufacturer may silo a first data platform for manufacturing a vehicle body in white paint, a second data platform for painting the vehicle body to a different color, a third data platform for final vehicle assembly, a fourth data platform for quality check, etc.

In some examples, each data platform may have a data manager that looks for patterns and contextual data impacting the operation of that specific discipline on the floor. However, each discipline, as one element of an entire process, may impact multiple other disciplines and data managers. In some examples, the issue may be compounded when there is no single data representation across the factory floor providing context on data usage, terminology, and/or chain of connections between disciplines.

In some examples, a data platform for a particular discipline (e.g., welding) may include a data manager that consumes data from controllers from different vendors, manufacturers, etc., monitoring the discipline. The data manager may provide the data to a translator to analyze the data from the different controllers for the particular discipline. However, a translation gap may occur when analyzing data from controllers monitoring different disciplines (e.g., soldering, screw driving, assembly, etc.). The translation gap may prevent the gathering of network environment wide (e.g., factory-wide, company or organization-wide, etc.) dependencies, operational insights, and the like.

Examples disclosed herein include a hierarchical, scalable, autonomous data dialect and/or contextual translator to bridge the data/context gap between different parts of a network environment (e.g., the factory floor of a factory, across different factories, etc.). Examples disclosed herein include contextual data translation to break down data silos (e.g., commercial, industrial, residential, etc., data silos) to enable data insights. Advantageously, the data insights may result from data management systems cross training and learning from one another based on contextual data translation.

Examples disclosed herein include an example contextual data translator that may track information usage associated with related departments, processes, operations, etc. In some disclosed examples, the contextual data translator can track the information usage by collecting sensor data and identifying process events (e.g., linkage(s) of events to one another that are monitored by applications/services) to create a contextual map (e.g., a contextual data map, a contextual data graph model, etc.) of data and/or terminology. In some disclosed examples, the contextual translator can enhance a dataset, which can be implemented by the contextual map, by capturing and creating associations between the dataset and local process events. In some disclosed examples, the contextual data translator can identify events that come just before or after a data access, process or query, etc., to establish a nominal “event chain.” Advantageously, in some disclosed examples, the contextual data translator can utilize the event chain to improve data customization and/or to achieve a deeper understanding of the contextual data/terminology to actual real-world activity.

In some disclosed examples, the data manager, the contextual data translator, and/or other components of systems described herein may be algorithm based (e.g., implemented by software and/or firmware executed and/or instantiated by processor circuitry) in the design of machine-to-machine engagements. For example, the contextual data translator can determine, detect, and/or otherwise identify correlations (e.g., contextual correlations) of actions, definitions, events, processes, operations, workflows, etc., based on the machine perspective versus a human perspective.

In some examples, a correlation can be implemented using any type of mathematical representation. For example, a correlation can be a probability or likelihood having a value in a particular range, such as from 0 to 1 (or any other range of values). In some examples, a correlation can be a value from a distribution, such as a probability distribution, a normal distribution, a Gaussian distribution, a logarithmic distribution, etc., or any other type of distribution. In some examples, a correlation can be implemented using one or more distributions. In some examples, a correlation can be a mathematical representation such as a ratio, a proportion, a percentage, a fraction, etc., or any other type of mathematical representation to describe a relationship between two components, elements, etc.

In some disclosed examples, the contextual data translator can create such a contextual/event-chained dataset for each discipline/department within an environment (e.g., a factory, a corporate office, etc.) and potentially for sub-units within departments where significant disparity is identified. In some disclosed examples, the contextual data translator can cache local contextual datasets and data together where analytics may be performed to weigh the strength of various contextual data graph node combinations between datasets being correlated. In some disclosed examples, the contextual data translator can weight the strength of the various contextual data graph node combinations over extended periods of time to gain additional insights based on event chaining from one dataset that may influence and/or impact other dataset(s).

In some disclosed examples, the contextual data translator can move the contextual/events trained dataset to a “white pages” server, which may enable shared access to the contextually correlated datasets. The white pages server may correspond to an “allow pages” or “primary pages” server that may implement a universal dictionary to facilitate contextual data translation. For example, the white pages server may store entries of first metadata that can be queried for, accessed, and/or retrieved to identify associated second metadata. In some disclosed examples, the contextual data translator can look up the first metadata to identify related second metadata and thereby translate first data associated with the first metadata to second data associated with the second metadata. In some disclosed examples, the contextual data translator can deliver, push, transmit, etc., the datasets, event chains, and/or context/graph models (e.g., contextual data graph models) to other parts of the environment. For example, the contextual data translator can propagate the datasets, event chains, and/or context/graph models to other node(s) of the environment to provide improved insights and correlation of cross-operations data and a manner to quickly bootstrap information and data services operations to improve scalability.

In some disclosed examples, the contextual data translator can deploy models (e.g., AI/ML models) and contextual data graphs between different data managers in an environment to allow each data manager to understand the vocabulary (e.g., lexical terms) of other processes, personnel, teams, etc., that may be requesting data. The contextual data translator can effectuate the understanding of relationship(s) between different data/information sources and importance(s) of data and adjacent datasets when viewed from an end-to-end process standpoint.

Examples disclosed herein may implement data management cross training to implement contextual translation of data for improved data management. In some disclosed examples, the contextual data translator can ingest, translate, and tag data (e.g., tag by appending metadata to the data, generating an association of the data and metadata, etc.) from a node corresponding to a particular discipline. The example contextual data translator can identify a subset of the ingested data that is needed for translation between interacting disciplines, when not all of the data may be relevant or needed for the translation. Advantageously, the example contextual data translator may learn (e.g., iteratively learn, continuously learn, etc.) based on and/or in response to events like new system additions, new insights from different disciplines, new alerts in one discipline that can translate to issues in other disciplines, etc., and/or any combination(s) thereof. The example contextual data translator can generate a context-based dataset including one or more contextual data graph models based on the tagged data. The example contextual data translator can store the context-based dataset in a shared datastore that may be shared across nodes from different disciplines to achieve environment-wide insights.

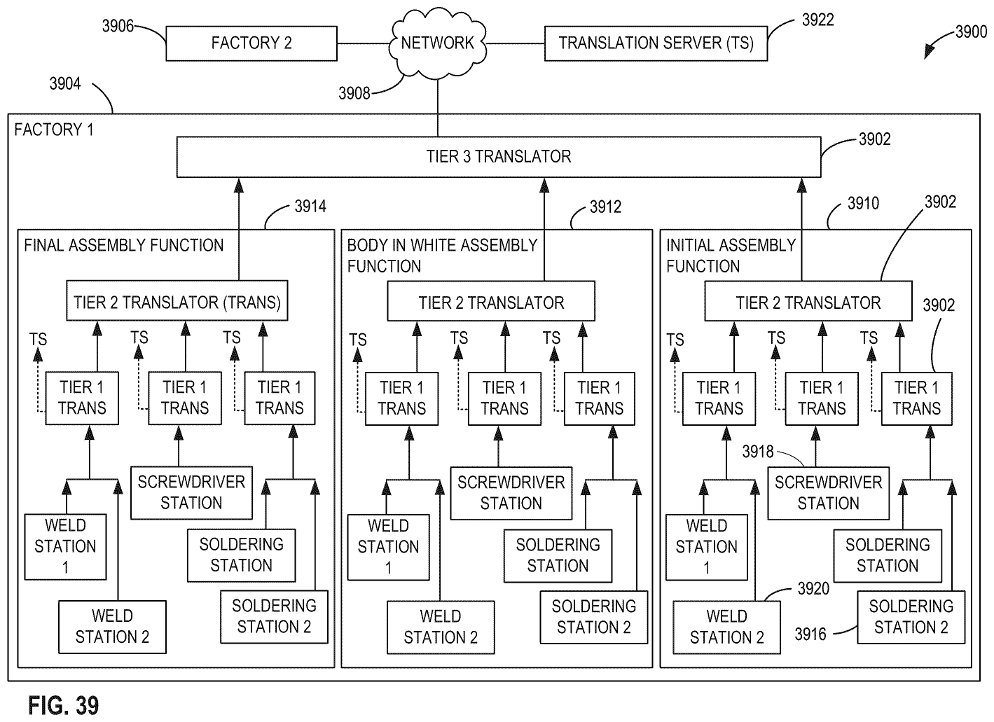

FIG. 39 is an illustration of an example environment 3900 including example contextual data translators 3902 for improved data management. The environment 3900 of the illustrated example is implemented with a first example factory (identified by FACTORY 1) 3904 and a second example factory (identified by FACTORY 2) 3906. The first factory 3904 and the second factory 3906 are coupled (e.g., communicatively coupled) to each other by way of an example network 3908. For example, the first factory 3904 and the second factory 3906 can implement a network environment because the first factory 3904 and the second factory 3906 are connected to a network, such as the network 3908.

In some examples, the network 3908 can be implemented by one or more networks. For example, the network 3908 can be implemented by the Internet. However, the network 3908 can be implemented using any suitable wired and/or wireless network(s) including, for example, one or more data buses, one or more LANs, one or more WLANs, one or more cellular networks, one or more private networks, one or more public networks, one or more fiber networks, one or more satellite networks, one or more terrestrial networks, one or more non-terrestrial networks, etc., and/or any combination(s) thereof.

The first factory 3904 includes first example functions 3910, 3912, 3914 including a first example function 3910, a second example function 3912, and a third example function 3914. The first function 3910 is an initial assembly function. For example, the first function 3910 can be implemented with an initial assembly of a product such as a vehicle. The second function 3912 is a body in white assembly function. For example, the second function 3912 can be implemented with painting a body of the product in a particular color (white). The third function 3914 is a final assembly function. For example, the third function 3914 can be implemented with a final assembly of the product (e.g., by installing a windshield on the vehicle, programming an electronic control unit (ECU) of the vehicle, etc.). Any other functions of the environment 3900 and/or any other types of the environment 3900 are contemplated.

The first function 3910 includes example disciplines 3916, 3918, 3920 including a first example discipline 3916, a second example discipline 3918, and a third example discipline 3920. The first discipline 3916 is a soldering discipline that is implemented with soldering stations and/or associated hardware, software, and/or firmware to control and/or monitor the soldering stations. For example, the first discipline 3916 can be implemented using processor circuitry (e.g., a client compute node, an appliance, a CPU, a PLC or other type of controller, etc.) that controls and/or monitors the soldering stations. The second discipline 3918 is a screwdriver discipline that is implemented with screwdriver stations and/or associated hardware, software, and/or firmware to control and/or monitor the screwdriver stations. For example, the second discipline 3918 can be implemented using processor circuitry (e.g., a client compute node, an appliance, a CPU, a PLC or other type of controller, etc.) that controls and/or monitors the screwdriver stations. The third discipline 3920 is a welding discipline that is implemented with welding stations and/or associated hardware, software, and/or firmware to control and/or monitor the welding stations. For example, the third discipline 3920 can be implemented using processor circuitry (e.g., a client compute node, an appliance, a CPU, a PLC or other type of controller, etc.) that controls and/or monitors the welding stations. Any other types and/or quantities of the disciplines 3916, 3918, 3920 are contemplated.

The disciplines 3916, 3918, 3920 include the contextual data translator 3902. In the illustrated example, the contextual data translator 3902 implements a first level or first tier translator (identified by TIER 1 TRANSLATOR), which is in communication with another instance of the contextual data translator 3902 implemented as a second level or second tier (identified by TIER 2 TRANSLATOR). The second level or second tier translator is in communication with yet another instance of the contextual data translator 3902 implemented as a third level or third tier translator (identified by TIER 3 TRANSLATOR). The third level or third tier translator is in communication with a third level or third tier translator of the second factory 3906 via the network 3908.

The second factory 3906 includes instances of the contextual data translator 3902, the functions 3910, 3912, 3914, and the disciplines 3916, 3918, 3920 of the first factory 3904. Additionally and/or alternatively, the second factory 3906 may include a different number and/or different types of the contextual data translator 3902, the functions 3910, 3912, 3914, the disciplines 3916, 3918, 3920, etc.

In some examples, the contextual data translator 3902 implements a hierarchical and tiered contextual translator that uses data generated by the disciplines 3916, 3918, 3920, and/or, more generally, the functions 3910, 3912, 3914, to recognize patterns and identify correlations to provide better context in and across different dialects/disciplines/functions/systems. For example, the contextual data translator 3902 at a first level or first tier of the first factory 3904 can obtain data generated by a controller associated with the first soldering station (identified by SOLDERING STATION 1) and/or the second soldering station (identified by SOLDERING STATION 2). In some examples, the contextual data translator 3902 can identify contextual chains of events across the first factory 3904 based on the data. For example, in response to completing the first discipline 3916 on a product, the product is to be processed with the second discipline 3918 and, thereby, first operation(s) executed by the first discipline 3916 and second operation(s) executed by the second discipline 3918 can implement a contextual chain of events (e.g., an event chain, a contextual event chain, etc.). In some examples, in response to completing the first function 3910 on a product, the product is to be provided to the second function 3912 for processing and, thereby, the first function 3910 and the second function 3912 can implement a contextual chain of events.

In the illustrated example, tiers of the contextual data translator 3902 exist in different control stations like the welding stations, the soldering stations, the screwdriving stations, etc., to expose patterns in each of the stations. For example, the contextual data translator 3902 of the first tier of the first function 3910 can provide the patterns, and/or, more generally, the data generated by the stations of the first tier of the first function 3910 (e.g., the soldering stations, the screwdriver stations, the welding stations, etc.), to the contextual data translator 3902 of the second tier (e.g., a higher tier) of the first function 3910 to surface patterns across the different control stations of the first tier of the first function 3910. In some examples, the contextual data translator 3902 of the second tier of the first function 3910 can provide the patterns, and/or, more generally, the data that produced the patterns, to the contextual data translator 3902 of the third tier (e.g., a higher tier) of the first factory 3904 to act on data across multiple one(s) of the functions 3910, 3912, 3914. For example, the contextual data translator 3902 of the third tier of the first factory 3904 can act on data generated by underlying tiers by generating alerts, transmitting commands to controller(s) of the functions 3910, 3912, 3914 (e.g., commands of halting or starting operations, processes, etc.), etc., and/or any combination(s) thereof.

In the illustrated example, the contextual data translator 3902 of the different tiers of the first factory 3904 (and/or the second factory 3906) can provide data, patterns, insights, and the like to an example translation server 3922. In some examples, the translation server 3922 can implement a white pages server that includes entries of metadata that can be utilized to assign meaning and/or context to data generated by disparate data sources, different disciplines, different functions, different systems (e.g., the first factory 3904 and the second factory 3906), etc. For example, the translation server 3922 can be implemented with a metadata datastore, a tag datastore, a look-up table, a hash table, etc., that can effectuate directory and/or dictionary-like functions.

Advantageously, deploying instances of the contextual data translator 3902 at different levels, tiers, etc., of the first factory 3904 (and/or the second factory 3906 can provide flexibility, modularity, and/or scalability to deploy the contextual data translator 3902 as and when necessary and to which ever one(s) of the disciplines 3916, 3918, 3920 and/or the functions 3910, 3912, 3914, as needed or requested. In some examples, if certain environments desire localized context and do not anticipate bigger environment-wide impact, the contextual data translator 3902 can be deployed to act on data and surface patterns locally. However, if future needs for expansion from local insights to environment-wide insights arise, the contextual data translator 3902 can be deployed to different tiers, levels, etc., of the environment 3900 because data generated by the environment 3900 is already tagged and ready to be deployed to next or subsequent tiers of the contextual data translator 3902.

Although the first factory 3904 and the second factory 3906 are depicted as having a hierarchy (e.g., a hierarchy of multiple tiers or layers), the contextual data translator 3902 can be instantiated in a non-hierarchical environment, such as a network. For example, a first instance of the contextual data translator 3902 can be instantiated and/or otherwise deployed at a first hop or node of a network, a second instance of the contextual data translator 3902 can be instantiated and/or otherwise deployed at a second hop or node of the network, and so on. Advantageously, the contextual data translator 3902 can identify patterns and correlations of data as the data is passed through the network and/or as the data is modified from hop-to-hop or node-to-node.

FIG. 40 is a block diagram of example contextual data translation circuitry 4000. In some examples, the contextual data translation circuitry 4000 can implement the contextual data translator 3902 of FIG. 39 and/or portion(s) of the ADM system 600 of FIG. 6. The contextual data translation circuitry 4000 of FIG. 40 may be instantiated (e.g., creating an instance of, bring into being for any length of time, materialize, implement, etc.) by processor circuitry such as a central processing unit executing instructions. Additionally or alternatively, the contextual data translation circuitry 4000 of FIG. 40 may be instantiated (e.g., creating an instance of, bring into being for any length of time, materialize, implement, etc.) by an ASIC or an FPGA structured to perform operations corresponding to the instructions. It should be understood that some or all of the contextual data translation circuitry 4000 of FIG. 40 may, thus, be instantiated at the same or different times. Some or all of the contextual data translation circuitry 4000 may be instantiated, for example, in one or more threads executing concurrently on hardware and/or in series on hardware. Moreover, in some examples, some or all of the contextual data translation circuitry 4000 of FIG. 40 may be implemented by one or more VMs and/or containers executing on the processor circuitry.

The contextual data translation circuitry 4000 of the illustrated example includes example data ingestion circuitry 4010, example machine learning circuitry 4020, example data query management circuitry 4030, example node management circuitry 4040, example data publishing circuitry 4050, an example datastore 4060, and an example bus 4080. The datastore 4060 of the illustrated example includes example raw data 4062, example metadata 4064, an example environment topology 4066, example contextual data graph models 4068, and an example machine learning model 4070. In the illustrated example, the data ingestion circuitry 4010, the machine learning circuitry 4020, the data query management circuitry 4030, the node management circuitry 4040, the data publishing circuitry 4050, and the example datastore 4060 are in communication with one(s) of each other by way of the bus 4080. For example, the bus 4080 can be implemented using at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 4080 can be implemented by any other type of computing or electrical bus. In some examples, the bus 4080 can implement the data plane 628, the control plane 630, and/or, more generally, the network plane 626 of FIG. 6, or portion(s) thereof.

The contextual data translation circuitry 4000 of the illustrated example includes the data ingestion circuitry 4010 to receive data (e.g., one or more data packets, one or more data messages, one or more data objects, metadata, etc.), determine whether new data is received and/or otherwise ready to be ingested, etc. In some examples, the data ingestion circuitry 4010 can implement the data ingestion manager 606 of FIG. 6, or portion(s) thereof. In some examples, the data ingestion circuitry 4010 extracts data object(s) from data, message(s), etc., and/or pre-processes the data object(s).

In some examples, a data object is implemented using a location or region of storage that contains a value or group of values. For example, the value or group of values can correspond to a collection of attributes or groups of values that define, act as, and/or are representative of an aspect, characteristic, descriptor, property, or quality of the data object. In some examples, each value of the data object can be accessed using an identifier that is associated with the value or a more complex expression that refers to the data object. In some examples, each data object can have a unique data type. For example, the data type of an object can determine the storage allocation for that data object and the interpretation of the values during subsequent access.

In some examples, the attributes of a data object can include a naming attribute, a descriptive attribute, a referential attribute, and the like. For example, the naming attribute can be implemented using a name to identify a data object. The descriptive attribute (also referred to as a relationship attribute) can be used to describe the characteristic(s) or feature(s) or the relationship of the data object. In some examples, the referential attribute can be used to formalize binary and associative relationships and in referring to (or making reference to) another instance in another data representation (e.g., a data graph model, a grid, a table, etc.). By way of example, a data object may correspond to a vehicle being manufactured in a factory. A naming attribute of the vehicle data object may be a make/model of the vehicle, a serial number of the vehicle, a vehicle identification number (VIN) of the vehicle, etc., and/or any combination(s) thereof. A descriptive attribute of the vehicle data object can be a color of the vehicle, a trim or feature package of the vehicle, etc., and/or any combination(s) thereof. A referential attribute of the vehicle data object may be the data object itself that refers to the vehicle. For example, the vehicle data object may be stored in a table of vehicles currently in production with the table including the vehicle data object and a plurality of other data objects. In some examples, the attributes of a data object are implemented using metadata. For example, a data object can be tagged with metadata to define the naming attribute(s), the descriptive attribute(s), the referential attribute(s), and the like. In some examples, the metadata that implements the referential attribute(s) of a data object can define relationship(s) between the data object and other data objects. For example, the referential attributes can include metadata that define a type of relationship such as a one-to-many relationship (e.g., a data object related to a plurality of other data objects), a many-to-many relationship (e.g., a plurality of data objects that include the data object is related to a different plurality of data objects), or a many-to-one relationship (e.g., a plurality of data objects that include the data object is related to a different data object).

In reference to the vehicle data object example above, the referential attributes can define the following relationships: (i) an inventory manager orders parts for the vehicle referenced by the vehicle data object; (ii) a warehouse manager receives the parts from a supplier and places the parts in inventory; (iii) the inventory manager allocates the parts to be assembled into the vehicle; (iv) a vehicle assembly worker removes the parts from inventory and assembles the parts into the vehicle; (v) a vehicle paint technician paints the vehicle after assembly is complete; (vi) a programming technician programs and/or otherwise configures vehicle control units of the vehicle after paint is complete; (vii) a truck driver is assigned to transport the completed vehicle to a dealership. For example, one(s) of the above-referenced relationships can be defined by metadata that is associated with other data. For example, first metadata associated with the inventory manager can include a pointer or reference to the vehicle data object. In some examples, in response to the inventory manager ordering the parts for the vehicle, second metadata associated with the warehouse manager can be updated to include the pointer or reference to the vehicle data object. In response to updating the second metadata with the vehicle data object, the first metadata and the second metadata become associated and/or linked with each other. Thusly, changes in updates in connection with the vehicle data object can be propagated to at least one of the inventory manager or the warehouse manager by identifying the vehicle data object in the first metadata and the second metadata.

In some examples, the data ingestion circuitry 4010 can ingest data at a node at a first hop or a first level/tier of a network environment, which may be implemented by the environment 3900 of FIG. 39. In some examples, the data ingestion circuitry 4010 translates data. For example, the data ingestion circuitry 4010 can convert portion(s) of the data from a first data format to a second data format, compress or decompress the data, decrypt or encrypt the data, etc., and/or any combination(s) thereof.

In some examples, the data ingestion circuitry 4010 receives an indication of an execution of a response or an adjustment in a process in response to an alert. For example, the data publishing circuitry 4050 can generate an alert based on data generated in the first discipline 3916 of the first function 3910. In some examples, the data publishing circuitry 4050 can transmit the alert to the first discipline 3916 of the second function 3912. In some examples, a controller of the first discipline 3916 of the second function 3912 can execute an action such as halting an operation in response to the alert. In some examples, the controller can generate and/or transmit data to the data ingestion circuitry 4010. For example, the data ingestion circuitry 4010 can determine that the data indicates that the controller carried out a response (e.g., the halting of the operation) or an adjustment in a process (e.g., the halting of the process) in response to the alert. In some examples, the data ingestion circuitry 4010 can provide the data, the indication, etc., to the machine learning model 4070 as model input(s) to generate model output(s). For example, the model output(s) can include a change, modification, update, etc., to a contextual data graph model associated with at least one of the first discipline 3916 of the first function 3910 or the first discipline 3916 of the second function 3912.

In some examples, the data ingestion circuitry 4010 collects data objects and metadata associated with user of application(s) and service(s) in a first system (e.g., the first factory 3904). For example, the data query management circuitry 4030 can reconcile use(s) of the application(s) and the service(s) by the first system and a second system (e.g., the second factory 3906).

The contextual data translation circuitry 4000 of the illustrated example includes the machine learning circuitry 4020 to execute a machine learning model (e.g., the machine learning model 4070) to generate output(s) (e.g., model output(s)), which can include contextual data graph model(s) and/or modification(s) thereof. In some examples, the machine learning circuitry 4020 can implement the algorithms 638, and/or, more generally, the analytics manager 636 of FIG. 6, or portion(s) thereof. In some examples, the machine learning circuitry 4020 instantiates and/or executes a machine learning microservice to train the machine learning model 4070, receive machine learning input(s), and/or generate machine learning output(s) based on the machine learning input(s).

In some examples, the machine learning circuitry 4020 instantiates and/or executes a machine learning microservice to generate the machine learning model 4070 based on data associated with an environment, such as the first factory 3904, the second factory 3906, and/or, more generally, the environment 3900. In some examples, the machine learning circuitry 4020 executes the machine learning model 4070 to generate data graphs (e.g., contextual data graphs, contextual data graph models, etc.), such as the contextual data graph models 4068, that correspond to respective portions of the environment.

In some examples, the machine learning circuitry 4020 identifies a contextual data graph model associated with metadata. For example, the machine learning circuitry 4020 can provide metadata associated with generated data (e.g., data generated by the disciplines 3916, 3918, 3920, the functions 3910, 3912, 3914, etc.) as model input(s) to the machine learning model 4070 to generate model output(s), which can include identification(s) of one(s) of the contextual data graph models 4068 that is/are associated with the metadata. In some examples, the machine learning circuitry 4020 can identify a first one of the contextual data graph models 4068 as associated with the metadata based on match(es) of portion(s) of the metadata and portion(s) of metadata of the first one of the contextual data graph models 4068.

In some examples, the machine learning circuitry 4020 determines a strength of association between a first data object and a second data object based on a contextual data graph model. For example, the second data object can be included in one of the contextual data graph models 4068, and the machine learning circuitry 4020 can connect the first data object to the second data object in the one of the contextual data graph models 4068 with a vector. The machine learning circuitry 4020 can determine an angle of the vector with respect to a reference axis (e.g., a horizontal axis, a vertical axis, etc.) based on a likelihood that the first data object causes the second data object. The machine learning circuitry 4020 can determine a length of the vector based on relatedness of the first and second data objects. For example, a relatively short length of the vector can be indicative that the first and second data objects are closely coupled while a relatively long length of the vector can be indicative that the first and second data objects are loosely related and/or relatively unrelated to each other. In some examples, the machine learning circuitry 4020 can determine the strength of the association based on at least one of the angle or the length of the vector.

In some examples, the machine learning circuitry 4020 determines whether the strength of the association satisfies a threshold. For example, the machine learning circuitry 4020 can determine (e.g., by executing the machine learning model 4070) whether the angle of the vector is less than and/or equal to an angle threshold and thereby can determine that the angle of the vector satisfies the angle threshold. In some examples, the machine learning circuitry 4020 can determine (e.g., by executing the machine learning model 4070) whether the length of the vector is less than and/or equal to a length threshold and thereby can determine that the length of the vector satisfies the length threshold.

In some examples, the machine learning circuitry 4020 generates the contextual data graph models 4068. For example, the machine learning circuitry 4020 can generate a first one of the contextual data graph models 4068 based on first data associated with a node. In some examples, the first data can be implemented using control data, monitoring data, sensor data, etc., collected by a controller of the first soldering station of the first discipline 3916 of the first function 3910. In some examples, the first data can be implemented using personnel data associated with a technician that manages the first soldering station, technical documents (e.g., user manuals for the first soldering station, specification sheets for the first soldering station, etc.), a make and/or model of a controller of the first soldering station, etc., and/or any combination(s) thereof.

In some examples, the machine learning circuitry 4020 can generate a second one of the contextual data graph models 4068 based on a sequence of events observed in a process. For example, the second one of the contextual data graph models 4068 can include first data representative of a first event carried out and/or otherwise executed by the first soldering station of the first discipline 3916 of the first function 3910, second data representative of a second event carried out and/or otherwise executed by the first screwdriver station of the second discipline 3918 of the first function 3910 (or the second function 3912), etc. For example, the machine learning circuitry 4020 can determine that the second event is observed to occur after the first event with a particular or specified likelihood or probability.

In some examples, the machine learning circuitry 4020 can generate a third one of the contextual data graph models 4068 based on second data associated with the first data. For example, the second data can be implemented using ancillary, auxiliary, and/or otherwise related data to the first data. In some examples, the first data can be representative of a completion of an operation on a vehicle, and the second data can be representative of inventory updates, marketing documents, etc., in connection with the vehicle.

In some examples, the machine learning circuitry 4020 identifies correlation(s) amongst one(s) of the contextual data graph models 4068. In some examples, the machine learning circuitry 4020 updates one(s) of the contextual data graph models 4068 based on the correlation(s). For example, the machine learning circuitry 4020 can adjust (e.g., lengthen or shorten) vector angles, adjust (e.g., lengthen or shorten) vector lengths, add or connect new nodes, remove or delete extraneous nodes, and/or any combination(s) thereof.

In some examples, the machine learning circuitry 4020 pushes updates to the contextual data graph models 4068 from hop-to-hop, node-to-node, and/or level/tier-to-level/tier. For example, the machine learning circuitry 4020 can update a first one of the contextual data graph models 4068 associated with a first node based on first data. The first node can be the first welding station of the third discipline 3920 of the first function 3910. The machine learning circuitry 4020 can instruct the data publishing circuitry 4050 to push the update (e.g., the entire first one of the contextual data graph models 4068 or portion(s) or indication(s) thereof) to a second node at a second hop or a second level of an environment. For example, the second node can be the contextual data translator 3902 at the second level/tier of the first factory 3904. The machine learning circuitry 4020 can identify a second one of the contextual data graph models 4068 associated with the first one of the contextual data graph models 4068. For example, the machine learning circuitry 4020 can identify a match of a first portion of first metadata of the first one of the contextual data graph models 4068 and a second portion of second metadata of the second one of the contextual data graph models 4068.

In some examples, the machine learning circuitry 4020 can identify correlation(s) between the first and second ones of the contextual data graph models 4068. For example, the machine learning circuitry 4020 can connect the first one of the contextual data graph models 4068 (or node(s) thereof) to the second one of the contextual data graph models 4068 (or node(s) thereof). In some examples, the machine learning circuitry 4020 can identify correlation(s) between the first and second ones of the contextual data graph models 4068 based on angles, lengths, etc., of vectors that connect the first and second ones of the contextual data graph models 4068. In some examples, the machine learning circuitry 4020 can update the second one of the contextual data graph models 4068 based on the correlation(s). For example, the machine learning circuitry 4020 can add, delete, etc., nodes of the second one of the contextual data graph models 4068, modify (e.g., increase/decrease a vector angle, increase/decrease a vector length, etc.) nodes of the second one of the contextual data graph models 4068, etc., and/or any combination(s) thereof based on the correlation(s).

In some examples, the machine learning circuitry 4020 determines whether portion(s) of data ingested at a node deviate from a baseline by a threshold. For example, the data can be sensor data, such as a temperature of an electric generator in connection with the first welding station of the third discipline 3920 of the first function 3910. In some examples, the machine learning circuitry 4020 can determine whether a temperature measurement of 150 degrees fahrenheit (F) deviates from a baseline temperature of the electric generator of 125° F. by a threshold (e.g., a temperature threshold) of 20° F. In some examples, the machine learning circuitry 4020 can determine that the deviation is to invoke the generation of an alert and the machine learning circuitry 4020 can identify subsequent process(es) that may be impacted by the abnormal behavior of the electric generator. For example, the machine learning circuitry 4020 can identify the subsequent process(es) by inspecting one(s) of the contextual data graph models 4068 including metadata that reference the electric generator.

In some examples, the machine learning circuitry 4020 improves contextual data translation in connection with use(s) of application(s) and service(s) across at least a first system and a second system. For example, the first system can be implemented with the first factory 3904 or a different type of the environment 3900 such as a corporate office, an IoT environment, an Edge network, etc. In some examples, the second system can be implemented with the second factory 3906 or a different type of the environment 3900 such as a corporate office, an IoT environment, an Edge network, etc. In some examples, the machine learning circuitry 4020 can generate the contextual data graph models 4068 to be representative of data objects and metadata associated with the use(s) of the application(s) and the service(s) in the system.

In some examples, the machine learning circuitry 4020 can identify (e.g., by executing the machine learning model 4070) relative strength(s) (e.g., strength(s) based on vector angle(s) and/or vector length(s)) and correlation(s) (e.g., correlation(s) based on type(s) and/or number(s) of connection(s) between nodes) among lexical terms in the first system. For example, the machine learning circuitry 4020 can identify lexical terms (e.g., words, keywords, etc.) in requests in the first factory 3904 for data such as data objects, files, and the like. In some examples, the machine learning circuitry 4020 can cross correlate first ones of the contextual data graph models 4068 associated with the first factory 3904 and second ones of the contextual data graph models 4068 associated with the second factory 3906.

In some examples, the machine learning circuitry 4020 generates (e.g., by executing the machine learning model 4070) weighted correlations based on connected data graph nodes of the cross correlated ones of the contextual data graph models 4068. In some examples, the machine learning circuitry 4020 rates a context and/or meaning of lexical terms between the first and second systems based on the weighted correlations. In some examples, the machine learning circuitry 4020 identifies event links or causality chains between the first and second systems based on the lexical terms. For example, the machine learning circuitry 4020 can determine a strength of association between a first data object (e.g., associated with a first portion of the first factory 3904) including a first lexical term and a second data object (e.g., associated with the second factory 3906 or a different portion of the first factory 3904) including a second lexical term. In some examples, the machine learning circuitry 4020 can determine whether the strength of the association satisfies a threshold (e.g., a strength threshold, a threshold based on a vector angle and/or vector length, etc.). In some examples, in response to determining that the strength of the association satisfies the threshold, the machine learning circuitry 4020 can determine that the first lexical term has a similar (e.g., a substantially similar) meaning or context to the second lexical term.

The contextual data translation circuitry 4000 of the illustrated example includes the data query management circuitry 4030 to tag a first data object generated at a first node with metadata based on an environment of the first node. For example, the data query management circuitry 4030 can tag data (e.g., process control data, sensor data, control data, etc.) generated by a controller of the first screwdriver station of the second discipline 3918 of the first function 3910 with metadata. For example, the data query management circuitry 4030 can tag the data with metadata that describes, references, and/or otherwise points to the controller (e.g., a name, an attribute, a relationship, etc., of the controller), the first screwdriver station (e.g., a name, an attribute, a relationship, etc., of the first screwdriver station), the second discipline 3918 (e.g., a name, an attribute, a relationship, etc., of the second discipline 3918), the first function 3910 (e.g., a name, an attribute, a relationship, etc., of the first function 3910), the first factory 3904 (e.g., a name, an attribute, a relationship, etc., of the first factory 3904), and/or, more generally, the environment 3900 (e.g., a name, an attribute, a relationship, etc., of the environment 3900).

In some examples, in response to one(s) of the contextual data graph models 4068 being generated, the data query management circuitry 4030 can store the one(s) of the contextual data graph models 4068 at a node. For example, the data query management circuitry 4030 can store the one(s) of the contextual data graph models 4068 at the first soldering station (e.g., a controller of the first soldering station) of the first discipline 3916 of the first function 3910, the contextual data translator 3902 at the first level/tier, the contextual data translator 3902 at the second level/tier, the contextual data translator 3902 at the third level/tier, etc.

In some examples, in response to the data ingestion circuitry 4010 collecting data objects and metadata associated with user of application(s) and service(s) in a first system (e.g., the first factory 3904), the data query management circuitry 4030 can reconcile use(s) of the application(s) and the service(s) by the first system and a second system (e.g., the second factory 3906). For example, the data query management circuitry 4030 can reconcile a first use of a first application based on a first lexical term used by a first user of the first application with a second use of a second application based on a second lexical term used by a second user of the second application. In some examples, the data query management circuitry 4030 can reconcile the first and second uses by determining that the first lexical term has a similar meaning to the second lexical term and thereby determine that the first and second uses are analogous and/or otherwise related to each other.

The contextual data translation circuitry 4000 of the illustrated example includes the node management circuitry 4040 to select a process in an environment to process for contextual data translation. For example, the node management circuitry 4040 can select a first process corresponding to the first discipline 3916 of the first function 3910, a second process corresponding to the second discipline 3918 of the first function 3910, a third process corresponding to the third discipline 3920 of the second function 3912, etc. In some examples, the node management circuitry 4040 can determine whether to select another process in the environment or if all of the processes in the environment have been selected.

In some examples, the node management circuitry 4040 selects a node associated with the process. For example, the node management circuitry 4040 can select a node such as the first soldering station, the second soldering station, etc., of the first discipline 3916. In some examples, the node management circuitry 4040 can determine whether to select another node in the process or if all nodes in the process have been selected.

The contextual data translation circuitry 4000 of the illustrated example includes the data publishing circuitry 4050 to publish data for access by node(s) in an environment. In some examples, the data publishing circuitry 4050 can persist and/or otherwise provide one(s) of the contextual data graph models 4068 in a shared datastore to be accessible by nodes of the environment 3900. For example, the translation server 3922 can implement the shared datastore. In some examples, the data publishing circuitry 4050 can push, deliver, and/or otherwise provide one(s) of the contextual data graph models 4068 to nodes of the environment 3900. For example, the data publishing circuitry 4050 can push the one(s) of the contextual data graph models 4068 to nodes at different tiers, levels, etc., of the environment 3900, to different hops or stops in a network, etc.

In some examples, the data publishing circuitry 4050 can generate alert(s) to one or more nodes in an environment based on update(s) to one(s) of the contextual data graph models 4068. For example, in response to a determination that a generation of data is associated with an emergency, a failure of equipment, a halting of a process, etc., the data publishing circuitry 4050 can deliver, transmit, and/or otherwise publish an alert to nodes associated with the data. For example, the nodes can be identified based on mapping first metadata descriptive of the data to second metadata in one(s) of the contextual data graph models 4068. In some examples, the data publishing circuitry 4050 can identify the nodes in response to determining that the nodes are associated with the one(s) of the contextual data graph models 4068.

The contextual data translation circuitry 4000 of the illustrated example includes the datastore 4060 to record data, such as the raw data 4062, the metadata 4064, the environment topology 4066, the contextual data graph models 4068, and the machine learning model 4070. In some examples, the datastore 4060 can implement the metadata datastore 646, the raw datastore 648, and/or, more generally, the distributed datastore 644 of FIG. 6, or portion(s) thereof.

In some examples, the raw data 4062 is raw and/or otherwise unprocessed data. In some examples, the raw data 4062 can be control data (e.g., generated by a controller monitoring the first soldering station, the first screwdriver station, the first welding station, etc., of FIG. 39), sensor data, location data, etc. In some examples, the metadata 4064 is data that provides information about one or more aspects of other data. For example, the metadata 4064 can include descriptive information (e.g., a naming attribute, a descriptive attribute, a referential attribute, etc.) associated with the raw data 4062, the environment topology 4066, the contextual data graph models 4068, etc., and/or any combination(s) thereof.

In some examples, the environment topology 4066 is implemented using data that describes, represents, and/or otherwise corresponds to environment 3900 of FIG. 39. For example, the environment topology 4066 can be implemented with data that describes an architecture, an order, an organization of levels or tiers, etc., of the first factory 3904, the second factory 3906, and/or, more generally, the environment 3900. In some examples, the environment topology 4066 can be implemented with data that describes that the soldering stations of the first discipline 3916 is/are topologically coupled to the first tier contextual data translator 3902, the first discipline 3916 is topologically coupled to the second discipline 3918 and the second tier contextual data translator 3902, etc. In some examples, the environment topology 4066 can be implemented with data that describes that the first factory 3904 is topologically coupled to the second factory 3906. In some examples, the environment topology 4066 can be implemented using data that describes, represents, and/or otherwise corresponds to the environment 3900. For example, the environment topology 4066 can be implemented using node data, which can include identification(s) of user(s) of the node, identification(s) of electronic device(s) of the node, electronic device information (e.g., an Internet Protocol (IP) address, a Media Access Control (MAC) number, quantity and/or type of hardware resource of an electronic device such as the first soldering station, a version of firmware and/or software of the electronic device, etc.), etc., and/or any combination(s) thereof. In some examples, the environment topology 4066 is implemented using data in any data format such as, for example, binary data, comma delimited data, tab delimited data, SQL structures, a table, a map, a graph (e.g., a data graph, a data graph structure, a contextual data graph model, etc.), a grid, a packet, a datagram, a frame, a file, an e-mail, a message, a document, a report, a list, etc.

In some examples, the contextual data graph models 4068 are models that represent relationships of data with respect to other related data. For example, the contextual data graph models 4068 can include a model with a plurality of nodes that are connected to one(s) of each other based on their affiliation, relatedness, and/or similarity with respect to each other. In some examples, a first node may be connected to a second node with a vector having an angle with respect to a reference axis and a length. The angle may be representative of a likelihood that the first node may cause an event that affects the second node. The length may be representative of a similarity of the first node and the second node. For example, if the first node is a first lexical term and the second node is a second lexical term, the length of a vector that connects the first node and the second node may be based on a cosine similarity (or any other natural language processing or text similarity measure or metric) between the first and second lexical terms.

In some examples, the machine learning model 4070 is a neural network. Additionally and/or alternatively, the machine learning model 4070 may be implemented using any other type of AI/ML model described herein. In some examples, the machine learning model 4070 can be implemented using more than one type and/or quantity of AI/ML models. For example, the machine learning model 4070 can include a neural network (or portion(s), layer(s), or slice(s) thereof) and a reinforcement learning network (or portion(s), layer(s), or slice(s) thereof). In some examples, output(s) of the neural network may be coupled and/or otherwise provided to input(s) of the reinforcement learning network.

The datastore 4060 of the illustrated example can be implemented by one or more volatile memories (e.g., an SDRAM), DRAM, RDRAM, etc.), one or more non-volatile memories (e.g., flash memory), and/or any combination(s) thereof. The datastore 4060 may additionally or alternatively be implemented by one or more DDR memories, such as DDR, DDR2, DDR3, DDR4, DDR5, mDDR, etc. The datastore 4060 may additionally or alternatively be implemented by one or more mass storage devices such as HDD(s), CD drive(s), DVD drive(s), SSD drive(s), etc. While in the illustrated example the datastore 4060 is illustrated as a single datastore, the datastore 4060 may be implemented by any number and/or type(s) of datastores. Furthermore, the data stored in the datastore 4060 may be in any data format such as, for example, binary data, comma delimited data, tab delimited data, SQL structures, a table, a map, a graph (e.g., a data graph, a graph data structure, etc.), a grid, a packet, a datagram, a frame, a file, an e-mail, a message, a document, a report, a list, etc. In some examples, the datastore 4060 can implement one or more databases.

While an example manner of implementing the contextual data translator 3902 of FIG. 39 is illustrated in FIG. 40, one or more of the elements, processes, and/or devices illustrated in FIG. 40 may be combined, divided, re-arranged, omitted, eliminated, and/or implemented in any other way. Further, the example data ingestion circuitry 4010, the example machine learning circuitry 4020, the example data query management circuitry 4030, the example node management circuitry 4040, the example data publishing circuitry 4050, the example datastore 4060, the example raw data 4062, the example metadata 4064, the example environment topology 4066, the example contextual data graph models 4068, the example machine learning model 4070, the example bus 4080, and/or, more generally, the example contextual data translator 3902 of FIG. 39, may be implemented by hardware alone or by hardware in combination with software and/or firmware. Thus, for example, any of the example data ingestion circuitry 4010, the example machine learning circuitry 4020, the example data query management circuitry 4030, the example node management circuitry 4040, the example data publishing circuitry 4050, the example datastore 4060, the example raw data 4062, the example metadata 4064, the example environment topology 4066, the example contextual data graph models 4068, the example machine learning model 4070, the example bus 4080, and/or, more generally, the example contextual data translator 3902, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example contextual data translator 3902 of FIG. 39 may include one or more elements, processes, and/or devices in addition to, or instead of, those illustrated in FIG. 40, and/or may include more than one of any or all of the illustrated elements, processes and devices.

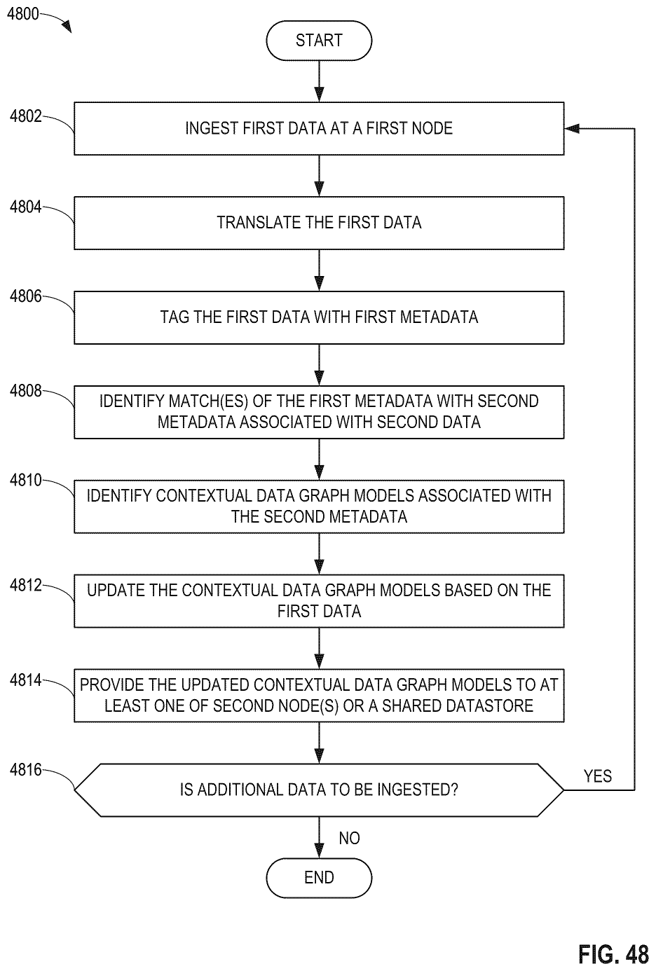

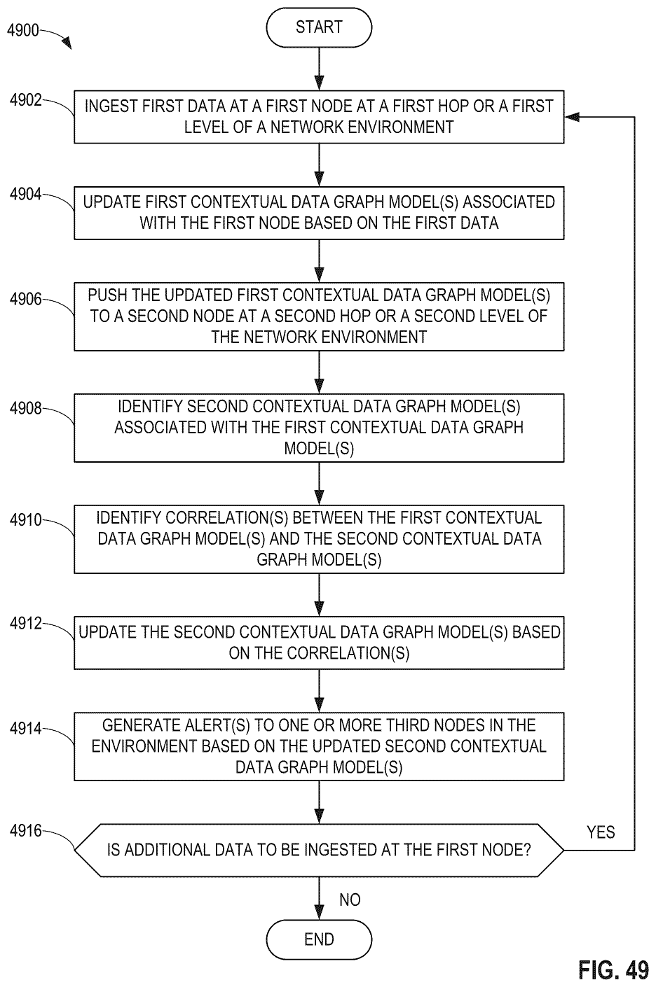

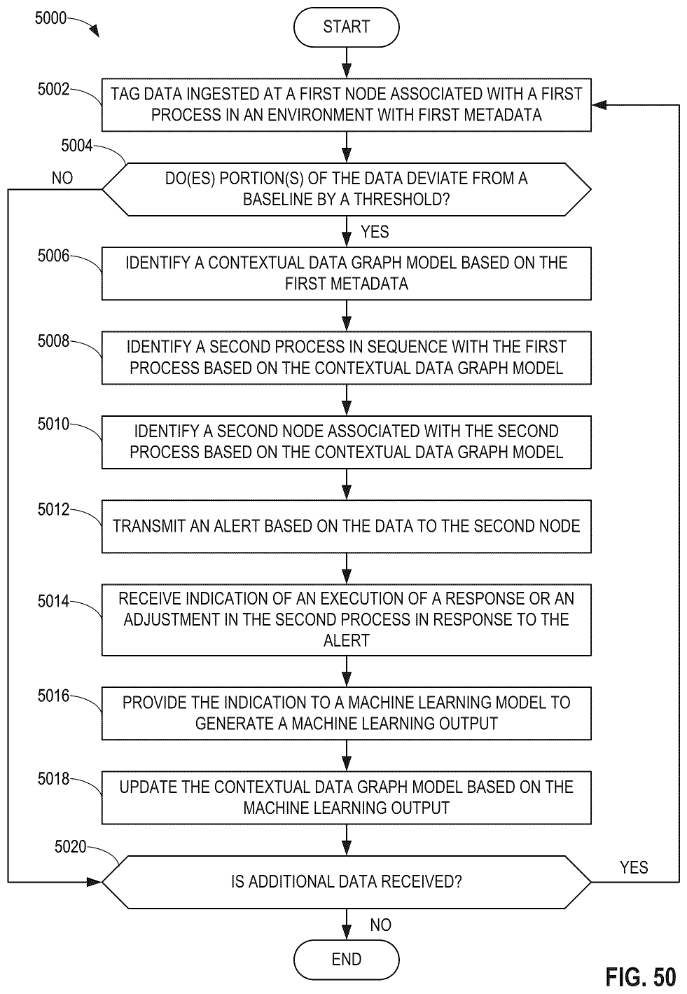

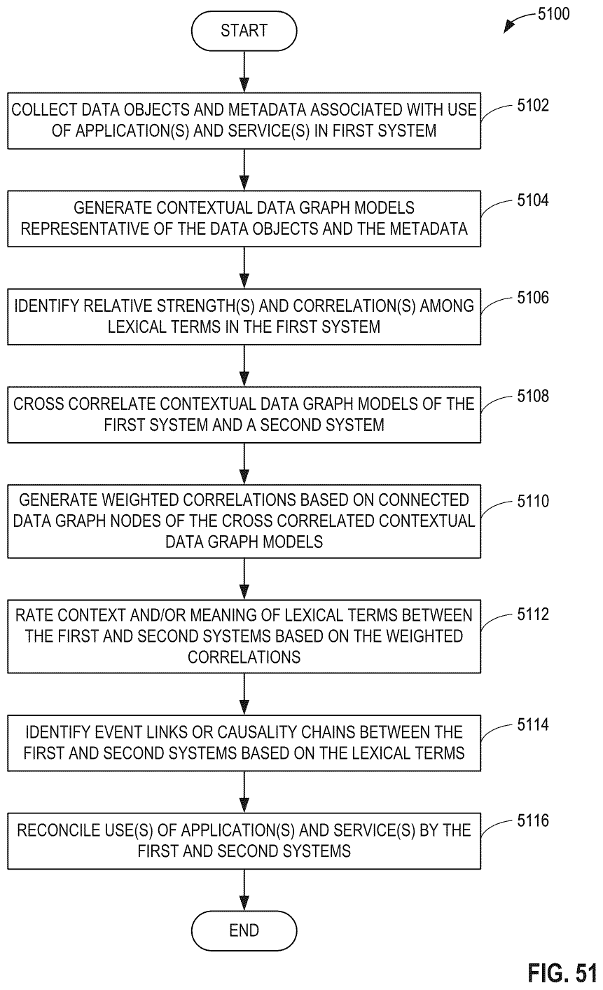

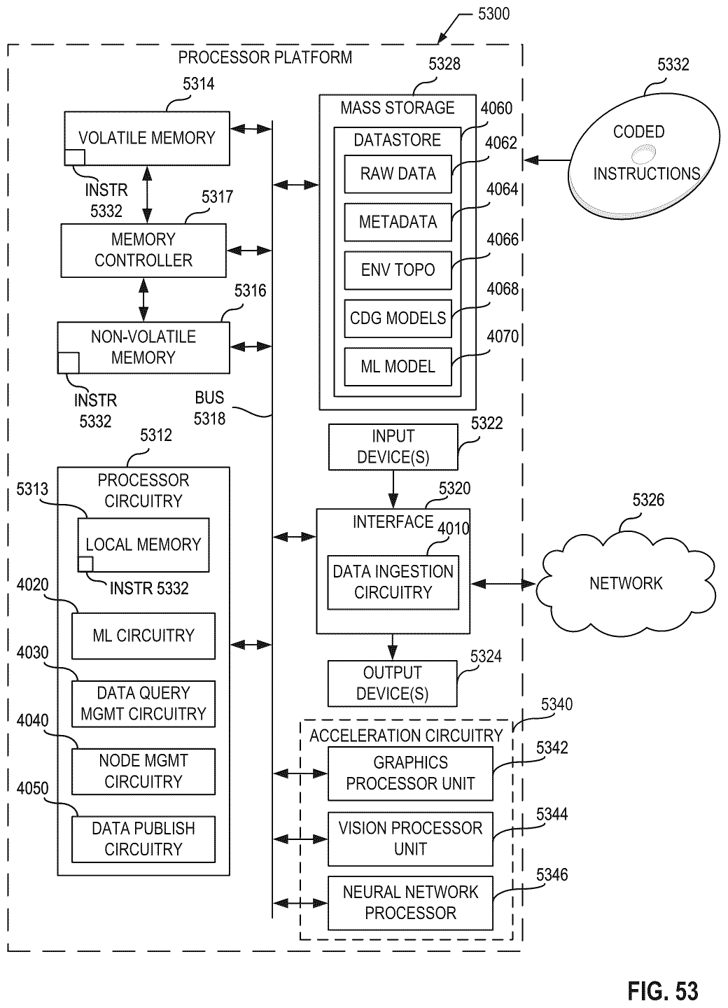

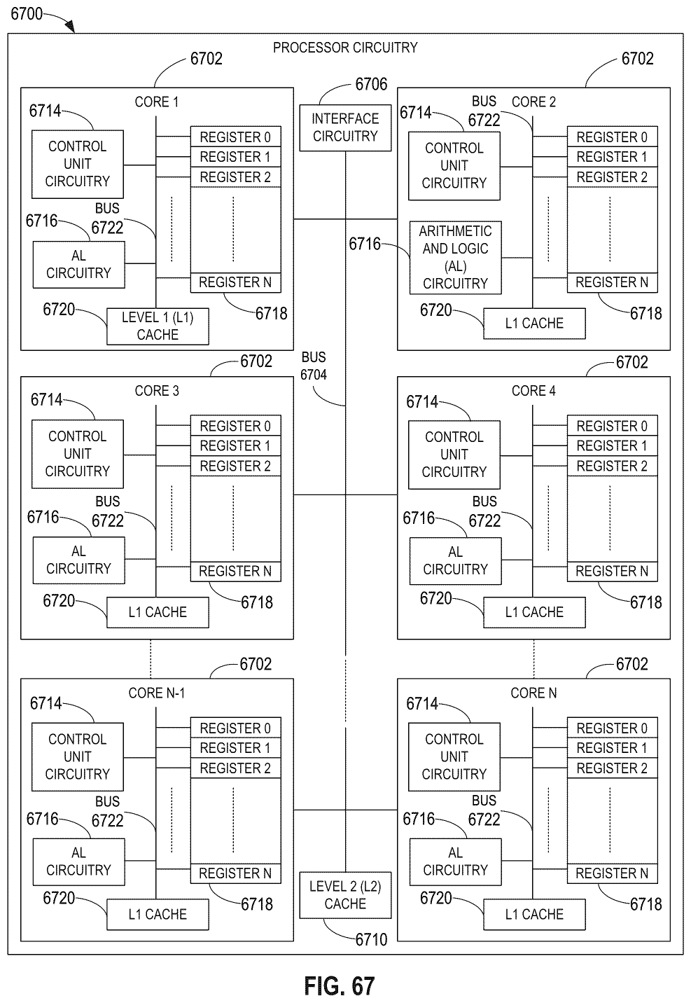

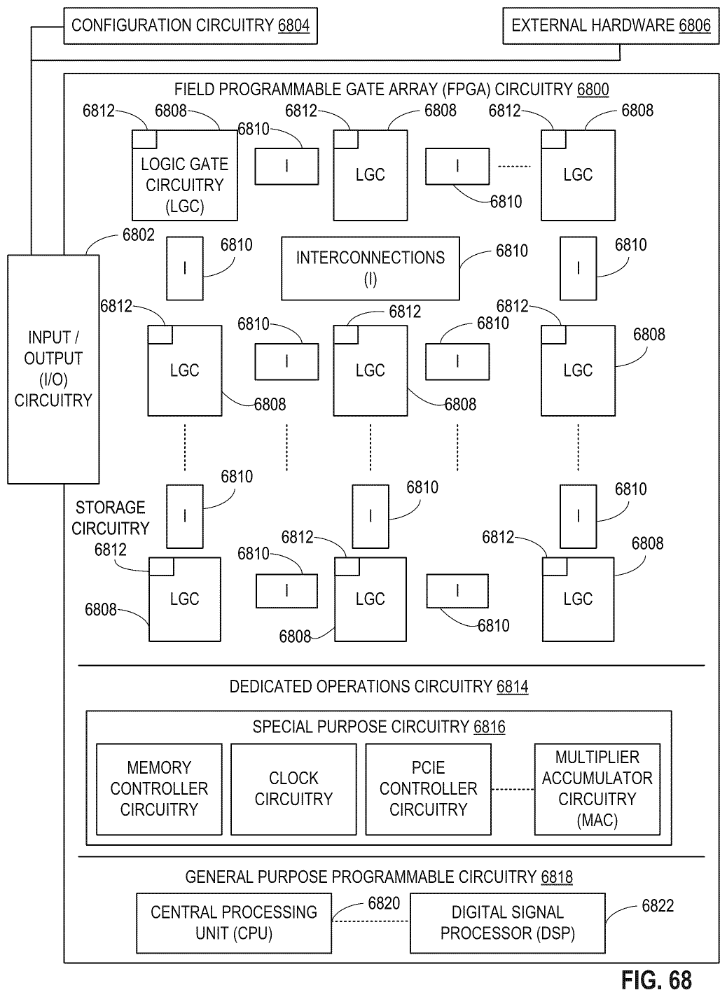

In some examples, the contextual data translation circuitry 4000 includes means for receiving data. For example, the means for receiving may be implemented by the data ingestion circuitry 4010. In some examples, the data ingestion circuitry 4010 may be instantiated by processor circuitry such as the example processor circuitry 5312 of FIG. 53. For instance, the data ingestion circuitry 4010 may be instantiated by the example general purpose processor circuitry 6700 of FIG. 67 executing machine executable instructions such as that implemented by at least blocks 4802, 4804, 4816 of FIG. 48, blocks 4902, 4916 of FIG. 49, blocks 5014, 5016, 5020 of FIG. 50, and block 5102 of FIG. 51. In some examples, the data ingestion circuitry 4010 may be instantiated by hardware logic circuitry, which may be implemented by an ASIC or the FPGA circuitry 6800 of FIG. 68 structured to perform operations corresponding to the machine readable instructions. Additionally or alternatively, the data ingestion circuitry 4010 may be instantiated by any other combination of hardware, software, and/or firmware. For example, the data ingestion circuitry 4010 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for receiving is to receive an indication of an execution of a response or an adjustment in a process (e.g., a second process or a different process) in response to an alert. In some examples, the means for receiving is to provide the indication to a machine learning model to generate a machine learning output.

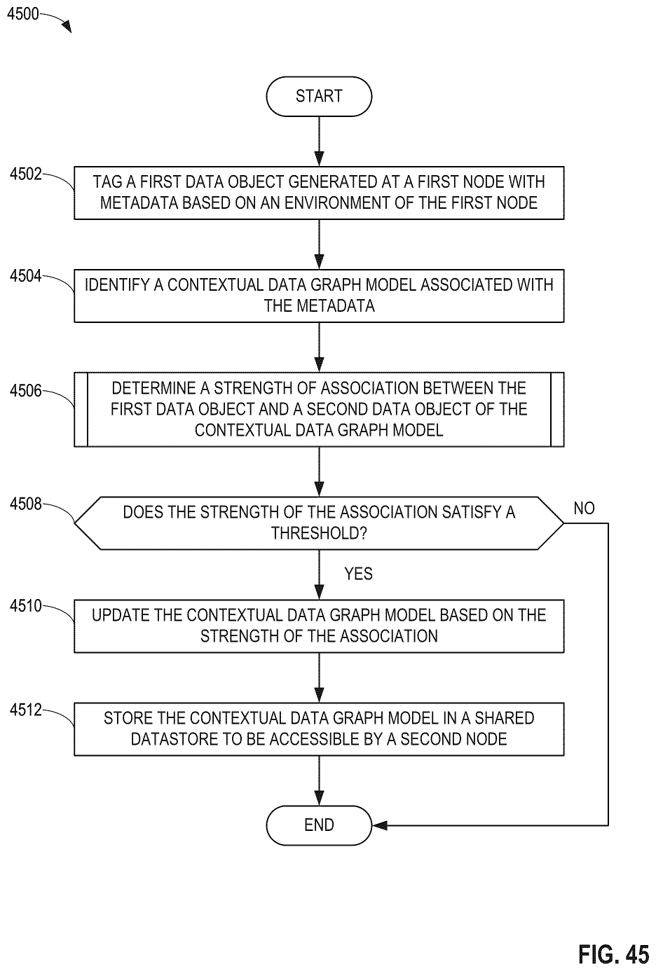

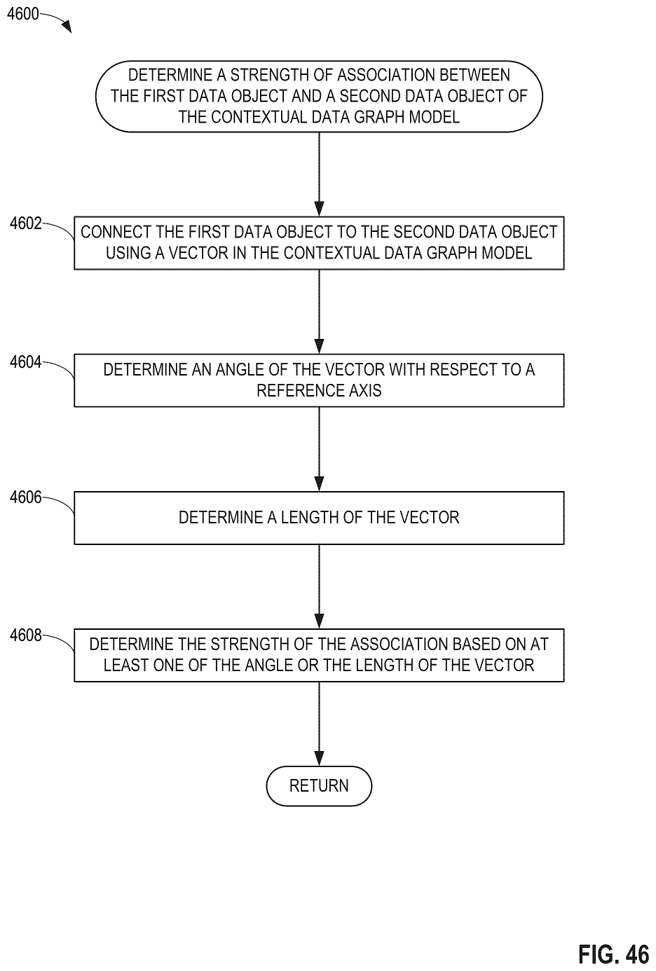

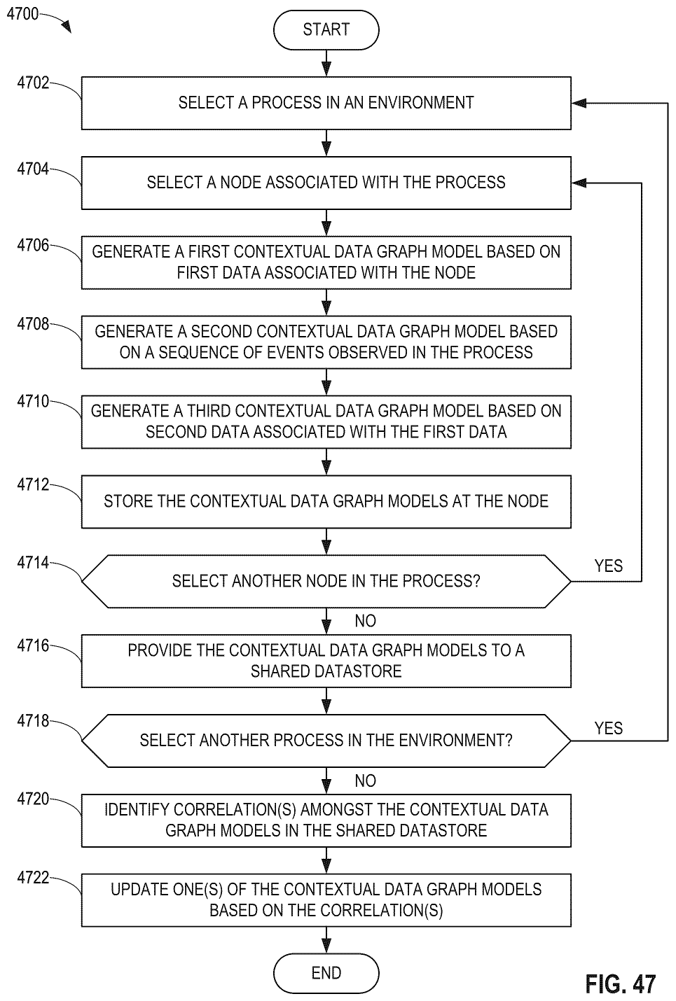

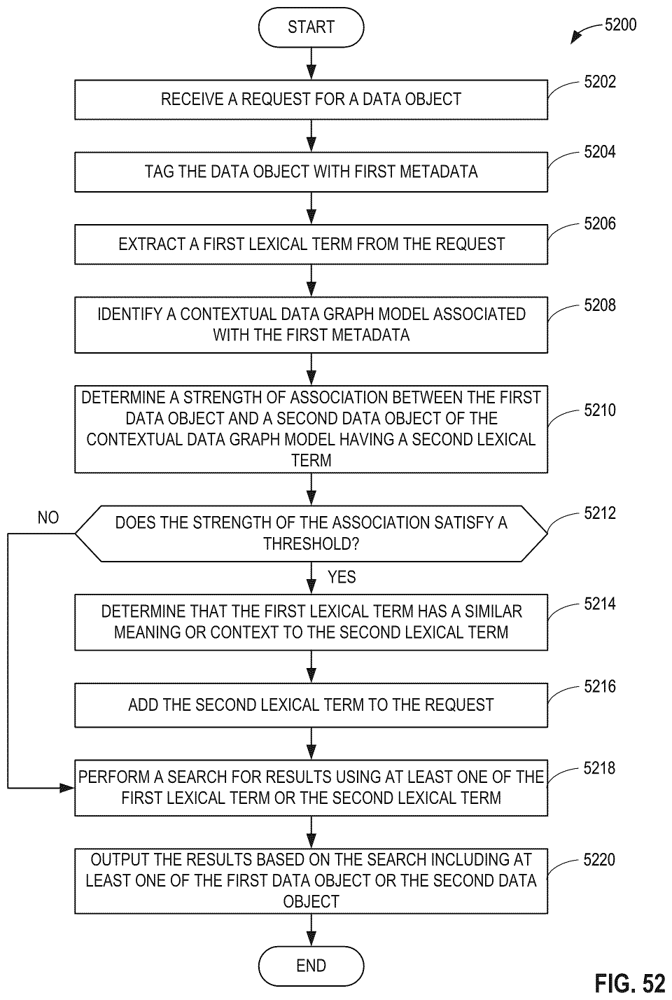

In some examples, the contextual data translation circuitry 4000 includes means for determining. For example, the means for determining may be implemented by the machine learning circuitry 4020. In some examples, the machine learning circuitry 4020 may be instantiated by processor circuitry such as the example processor circuitry 5312 of FIG. 53. For instance, the machine learning circuitry 4020 may be instantiated by the example general purpose processor circuitry 6700 of FIG. 67 executing machine executable instructions such as that implemented by at least blocks 4504, 4506, 4508, 4510 of FIG. 45, blocks 4602, 4604, 4606, 4608 of FIG. 46, blocks 4706, 4708, 4710, 4720, 4722 of FIG. 47, blocks 4808, 4810, 4812 of FIG. 48, blocks 4904, 4908, 4910, 4912 of FIG. 49, blocks 5004, 5006, 5008, 5018 of FIG. 50, blocks 5104, 5106, 5108, 5110, 5112, 5114 of FIG. 51, and blocks 5208, 5210, 5212, 5214 of FIG. 52. In some examples, the machine learning circuitry 4020 may be instantiated by hardware logic circuitry, which may be implemented by an ASIC or the FPGA circuitry 6800 of FIG. 68 structured to perform operations corresponding to the machine readable instructions. Additionally or alternatively, the machine learning circuitry 4020 may be instantiated by any other combination of hardware, software, and/or firmware. For example, the machine learning circuitry 4020 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for determining is to identify a contextual data graph model associated with the metadata. For example, the means for determining can include and/or otherwise implement means for identifying the contextual data graph model. In some examples, the means for determining is to determine a strength of association between the first data object and a second data object of the contextual data graph model. In some examples, the means for determining is to, in response to a determination that the strength of the association satisfies a threshold, update the contextual data graph model based on the strength of the association. For example, the means for determining can include and/or otherwise implement means for updating the contextual data graph model.

In some examples, the means for determining is to connect the first data object to the second data object with a vector in the contextual data graph model. For example, the means for determining can include and/or otherwise implement means for connecting the first data object to the second data object. In some examples, the means for determining is to determine an angle of the vector with respect to a reference axis. In some examples, the means for determining is to determine a length of the vector. In some examples, the means for determining is to determine the strength of the association based on at least one of the angle or the length.

In some examples in which a contextual data graph model is a first contextual data graph model, the means for determining is to generate the first contextual data graph model based on first data associated with the first node. In some examples, the means for determining is to generate a second contextual data graph model based on a sequence of events observed in a process of the environment, the process including a first operation to be executed by the first node. In some examples, the means for determining is to generate a third contextual data graph model based on second data associated with the first data. For example, the means for determining can include and/or otherwise implement means for generating at least one of the first contextual data graph model, the second contextual data graph model, or the third contextual data graph model.

In some examples, the means for determining is to identify one or more correlations between at least one of the first contextual data graph model, the second contextual data graph model, or the third contextual data graph model. For example, the means for determining can include and/or otherwise implement means for identifying the one or more correlations. In some examples, the means for determining is to update at least one of the first contextual data graph model, the second contextual data graph model, or the third contextual data graph model based on the one or more correlations. For example, the means for determining can include and/or otherwise implement means for updating at least one of the first contextual data graph model, the second contextual data graph model, or the third contextual data graph model based on the one or more correlations.

In some examples, in which metadata is first metadata, the means for determining is to identify a match of a first portion of the first metadata and a second portion of second metadata associated with the contextual data graph model. For example, the means for determining can include and/or otherwise implement means for identifying the match. In some examples, the means for determining is to identify the contextual data graph model based on the match. For example, the means for determining can include and/or otherwise implement means for identifying the contextual data graph model. In some examples, the means for determining is to, in response to the determination that the strength of the association satisfies the threshold, update the contextual data graph model by adding the first portion of the first metadata to the contextual data graph model. For example, the means for determining can include and/or otherwise implement means for updating the contextual data graph model.

In some examples in which the contextual data graph model is a first contextual data graph model associated with a first node, the first node is at a first hop or a first level of an environment, and a second node is at a second hop or a second level of the environment, the means for determining is to identify a second contextual data graph model associated with the second node based on the metadata. For example, the means for determining can include and/or otherwise implement means for identifying the second contextual data graph model. In some examples, the means for determining is to identify one or more correlations between the first contextual data graph model and the second contextual data graph model. For example, the means for determining can include and/or otherwise implement means for identifying the one or more correlations. In some examples, the means for determining is to update the second contextual data graph model based on the one or more correlations. For example, the means for determining can include and/or otherwise implement means for updating the second contextual data graph model based on the one or more correlations.

In some examples in which a first node is associated with a first process in an environment, and a determination is a first determination, the means for determining is to determine whether a portion of a first data object deviates from a baseline by a threshold. In some examples, the means for determining is to, in response to a second determination that a portion of a first data object deviates from the baseline by the threshold, identify a second process in sequence with the first process based on the contextual data graph model, and identify the second node associated with the second process based on the contextual data graph model. For example, the means for determining can include and/or otherwise implement means for identifying the second process and/or second node. In some examples, the means for determining is to update a contextual data graph model based on a machine learning output. For example, the means for determining can include and/or otherwise implement means for updating the contextual data graph model based on the machine learning output. In some examples in which a first data object includes a first lexical term, and second data object includes a second lexical term, the means for determining is to determine that the first lexical term has a similar meaning or context to the second lexical term based on the strength of the association satisfying the threshold.

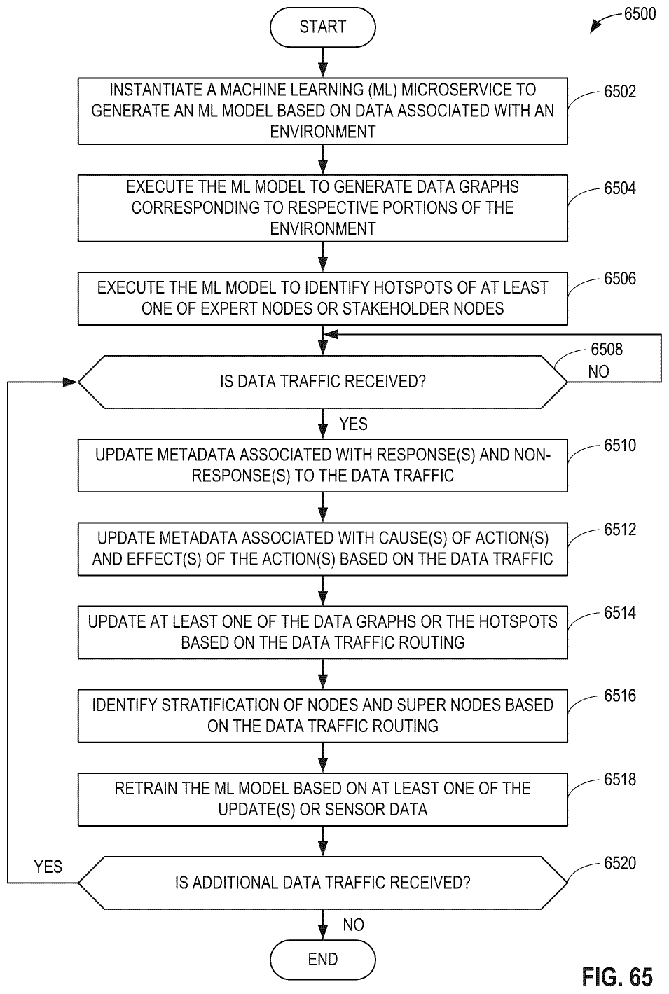

In some examples, the contextual data translation circuitry 4000 includes means for tagging data, a data object, etc. For example, the means for tagging can tag a first data object generated at a first node with metadata based on an environment of the first node. In some examples in which the first data object includes a first lexical term and a second data object includes a second lexical term, the means for tagging is to, in response to receiving a request for the first data object, add the second lexical term to the request, perform a search for results using at least one of the first lexical term or the second lexical term, and output the results based on the search, the results including at least one of the first data object or the second data object. For example, the means for tagging may be implemented by the data query management circuitry 4030. In some examples, the data query management circuitry 4030 may be instantiated by processor circuitry such as the example processor circuitry 5312 of FIG. 53. For instance, the data query management circuitry 4030 may be instantiated by the example general purpose processor circuitry 6700 of FIG. 67 executing machine executable instructions such as that implemented by at least block 4502 of FIG. 45, block 4712 of FIG. 47, block 4806 of FIG. 48, block 5002 of FIG. 65, block 5116 of FIG. 51, blocks 5202, 5204, 5206, 5216, 5218 of FIG. 52. In some examples, the data query management circuitry 4030 may be instantiated by hardware logic circuitry, which may be implemented by an ASIC or the FPGA circuitry 6800 of FIG. 68 structured to perform operations corresponding to the machine readable instructions. Additionally or alternatively, the data ingestion circuitry 4010 may be instantiated by any other combination of hardware, software, and/or firmware. For example, the data ingestion circuitry 4010 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the contextual data translation circuitry 4000 includes means for identifying a node in an environment. For example, the means for identifying can identify a node associated with a process based on a contextual data graph mode. In some examples, the means for identifying is to identify the node by querying, inspecting, and/or otherwise searching a node datastore (e.g., a node table, a preferred nodes table, etc.). In some examples, the means for identifying is to select a process in an environment. For example, the means for identifying can include and/or otherwise implement means for selecting the process. In some examples, the means for identifying is to select a node associated with a process. For example, the means for identifying can include and/or otherwise implement means for selecting the node. For example, the means for identifying may be implemented by the node management circuitry 4040. In some examples, the node management circuitry 4040 may be instantiated by processor circuitry such as the example processor circuitry 5312 of FIG. 53. For instance, the node management circuitry 4040 may be instantiated by the example general purpose processor circuitry 6700 of FIG. 67 executing machine executable instructions such as that implemented by at least blocks 4702, 4704, 4714, 4718 of FIG. 47 and block 5010 of FIG. 50. In some examples, the node management circuitry 4040 may be instantiated by hardware logic circuitry, which may be implemented by an ASIC or the FPGA circuitry 6800 of FIG. 68 structured to perform operations corresponding to the machine readable instructions. Additionally or alternatively, the node management circuitry 4040 may be instantiated by any other combination of hardware, software, and/or firmware. For example, the node management circuitry 4040 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the contextual data translation circuitry 4000 includes means for publishing a contextual data graph model in a shared datastore (e.g., a shared datastore to be accessible by a node of an environment). For example, the means for publishing may be implemented by the data publishing circuitry 4050. In some examples, the data publishing circuitry 4050 may be instantiated by processor circuitry such as the example processor circuitry 5312 of FIG. 53. For instance, the data publishing circuitry 4050 may be instantiated by the example general purpose processor circuitry 6700 of FIG. 67 executing machine executable instructions such as that implemented by at least block 4512 of FIG. 45, block 4716 of FIG. 47, block 4814 of FIG. 48, blocks 4906, 4914 of FIG. 49, block 5012 of FIG. 50, and block 5220 of FIG. 52. In some examples, the data publishing circuitry 4050 may be instantiated by hardware logic circuitry, which may be implemented by an ASIC or the FPGA circuitry 6800 of FIG. 68 structured to perform operations corresponding to the machine readable instructions. Additionally or alternatively, the data publishing circuitry 4050 may be instantiated by any other combination of hardware, software, and/or firmware. For example, the data publishing circuitry 4050 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which a contextual data graph model is a first contextual data graph model, the means for publishing is to store at least one of the first contextual data graph model, a second contextual data graph model, or a third contextual data graph model at a first node. In some examples, the means for publishing is to store at least one of the first contextual data graph model, the second contextual data graph model, or the third contextual data graph model in a shared datastore. In some examples in which a contextual data graph model is a first contextual data graph model associated with a first node, the first node is at a first hop or a first level of an environment, a second node is at a second hop or a second level of the environment, the means for publishing is to generate an alert to one or more third nodes in the environment in response to an update of a second contextual data graph model associated with the second node. In some examples in which a first node is associated with a first process in an environment, the means for publishing is to transmit an alert to a second node. In some examples, the alert can be based on a portion of a first data object.

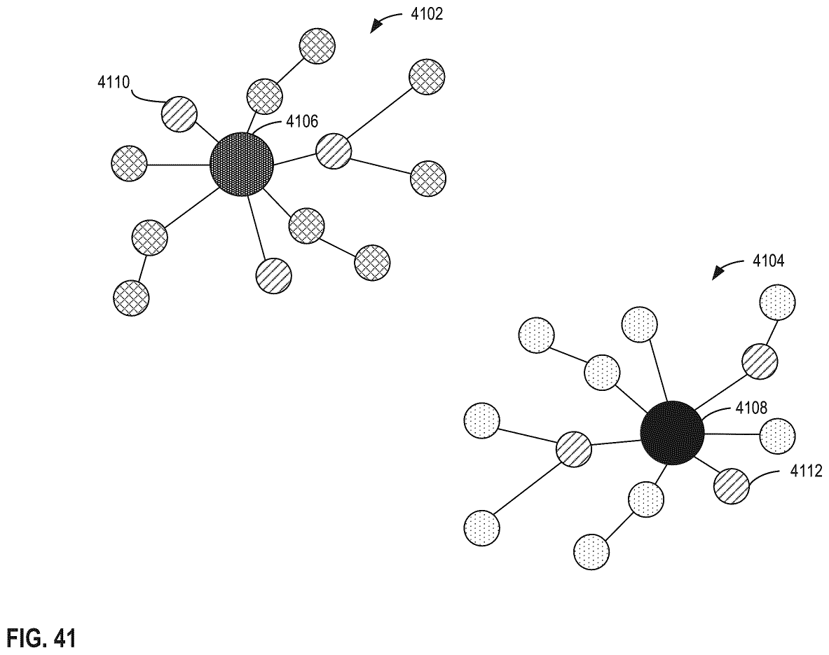

FIG. 41 is an illustration of example contextual data graph models 4102, 4104 including a first example contextual data graph model 4102 and a second example contextual data graph model 4104. In some examples, the first contextual data graph model 4102 and/or the second contextual data graph model 4104 can implement the contextual data graph models 4068 of FIG. 40. The first contextual data graph model 4102 has a first example primary or major node 4106 and the second contextual data graph model 4104 has a second example primary or major node 4108. The first contextual data graph model 4102 has a plurality of example adjacent nodes including a first example adjacent node 4110. For example, the first adjacent node 4110 is connected to the first primary node 4106 by a vector having an angle (relative to a reference axis), a length, an orientation, and a position with respect to the first primary node 4106. The second contextual data graph model 4104 has a plurality of example adjacent nodes including a second example adjacent node 4112. For example, the second adjacent node 4112 is connected to the second primary node 4108 by a vector having an angle (relative to a reference axis), a length, an orientation, and a position with respect to the second primary node 4108.

In some examples, if the primary nodes 4106, 4108 are the same, then the weighting of adjacent nodes 4110, 4112 may provide context and associated terms that may be customized and/or otherwise coopted for a particular department or discipline of an environment (e.g., an industrial, commercial, or office environment, etc.), such as the environment 3900 of FIG. 39. In some examples, if the primary nodes 4106, 4108 are different, but are connected to similar adjacent nodes 4110, 4112, then it would imply the primary nodes 4106, 4108 have the same contextual definition. In some examples, establishing the initial definitions (e.g., vector lengths, angles, orientations, spacings, etc.) may be done prescriptively by a person or inductively if it was an event, task, or object in common between the contextual data graph models 4102, 4104. In some examples, the machine learning circuitry 4020 of FIG. 40 can execute and/or otherwise cause the machine learning model 4070 to establish the initial definitions by analyzing, inspecting, and/or otherwise evaluating data passing through a network in an environment to identify causes/events, correlations, patterns, etc., observed in the data with respect to previously observed data.

In some examples, correlation of the primary nodes 4106, 4108 to one another may be calculated based on similarity in the depicted nodes (common adjacent terms) and strength of connection, which may be implemented by a vector length. In this example, cross hatched nodes and dotted nodes of the contextual data graphs models 4102, 4104 may constitute differentials that highlight differences between use/definition of same terms (e.g., lexical terms, data terms, etc.) in different disciplines, processes, departments, environments, etc.

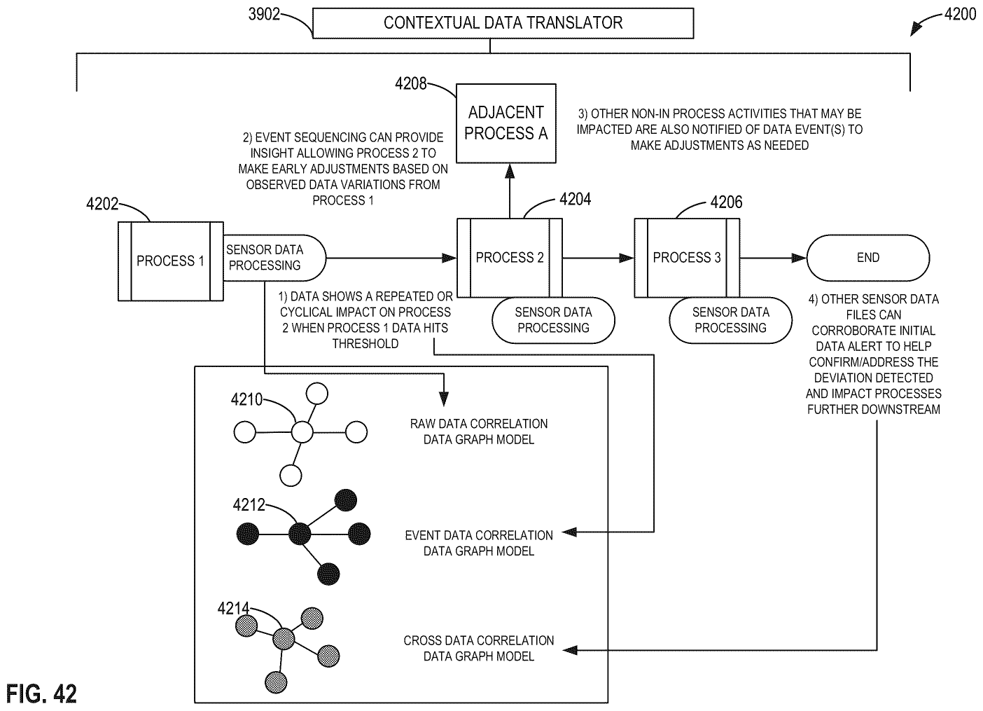

FIG. 42 is an illustration of an example event chain 4200. For example, the contextual data translator 3902 can obtain intervene in and/or otherwise monitor and/or control the event chain 4200. The event chain 4200 includes a first example process 4202 (identified by PROCESS 1), a second example process 4204 (identified by PROCESS 2), a third example process 4206 (identified by PROCESS 3), and an example adjacent process 4208 (identified by ADJACENT PROCESS A). In some examples, the event chain 4200 can be implemented by the disciplines 3916, 3918, 3920 of FIG. 39, the functions 3910, 3912, 3914 of FIG. 39, etc., and/or any combination(s) thereof. For example, the first process 4202 can be carried out and/or otherwise implemented by one(s) of the soldering stations of the first discipline 3916 of the first function 3910 performing one or more soldering actions, operations, procedures, workflows, etc. In some examples, the first process 4202 can be carried out and/or otherwise implemented by one(s) of the soldering stations of the first discipline 3916 of the first function 3910 performing one or more soldering actions, operations, procedures, workflows, etc., followed by (e.g., followed by in sequence) the screwdriver station of the second discipline 3918 of the first function 3910 performing one or more screwdriving actions, operations, procedures, workflows, etc. In some examples, the first process 4202 can be carried out and/or otherwise implemented by portion(s) of the first function 3910 performing one or more actions, operations, procedures, workflows, etc., followed by (e.g., followed by in sequence) the portion(s) of the second function 3912 performing one or more actions, operations, procedures, workflows, etc.

In some examples, the event chain 4200 implements a model (e.g., a contextual model) that is representative of an event-sequence dataset. Each of the processes 4202, 4204, 4206, 4208 can have a data model (e.g., a contextual data graph model) generated continuously from control and/or sensor data inputs which, ordinarily, show little change under nominal conditions. In some examples, a significant change from the normal model (e.g., detection of a deviation from a baseline or nominal condition or value(s)) may result in a response/adjustment in the subsequent process to address the change identified in the prior process. For example, recent correlated raw control and/or sensor data can provide indicators to which of the identified events has a high likelihood of occurrence based on which specific elements of the data have changed significantly. In some examples, the detection of the deviation can trigger a proposed adjustment and forwarding of supporting cross-data to increase confidence (or not) to assist autonomous and/or human supervised decision-making.

In example operation, the first process 4202 can execute a first operation and generate sensor data associated with the first operation. For example, the first process 4202 can include the first soldering station of the first discipline 3916 of the first function 3910 executing a first soldering action (e.g., soldering a first electrical component to a printed circuit board). In some examples, the data can show a repeated or cyclical impact on the second process 4204 when the first process 4202 satisfies a threshold (e.g., sensor data values of sensors monitoring the first soldering station have stabilized within a tolerance range). For example, the second process 4204 can include the screwdriving station of the second discipline 3918 of the first function 3910 executing a screwdriving action (e.g., screwing and/or otherwise coupling the printed circuit board into a support structure of an electrical assembly enclosure). In some examples, the data from the first process 4202 can have a cyclical impact on the second process 4204 because the second process 4204 can be initiated in response to a completion of the first process 4202.

Advantageously, the contextual data translator 3902 can monitor event sequencing of the event chain 4200 to identify insight allowing connected one(s) of the processes 4202, 4204, 4206, 4208 to make early adjustments based on data variation. For example, in response to detecting that an electrical power source powering the first soldering station has overheated and been turned off (e.g., turned off in response to a temperature sensor measurement exceeding a temperature threshold), the contextual data translator 3902 can generate an alert and transmit the alert to the second process 4204 to indicate the failure (or halting of the first process 4202) due to the detection of the failure of the electrical power source. In some examples, the contextual data translator 3902 can cause the second process 4204 (e.g., the screwdriving station of the second discipline 3918 of the first function 3910) to take mitigation measures (e.g., disable power to the screwdriving station to conserve power or other resources) and/or alert a subsequent process (e.g., the third process 4206) of the alert.

In some examples, the contextual data translator 3902 can also identify non-in process activities, such as the adjacent process 4208, that may be impacted of a data event (e.g., the disabling of the electrical power source of the first soldering station). In some examples, the adjacent process 4208 can be implemented using a marketing process, an inventory process, a warehouse process, a transportation process, or the like. For example, the contextual data translator 3902 can provide the alert to the adjacent process 4208 to make adjustments as needed, such as changes in materials (e.g., material ordering, procurement, storing, etc.), changes in availability of a product, etc., and/or any combination(s) thereof.

In the illustrated example, the contextual data translator 3902 can generate example contextual data graph models 4210, 4212, 4214 based on the event chain 4200. In some examples, the contextual data graph models 4210, 4212, 4214 can implement the contextual data graph models 4068 of FIG. 40. The contextual data graph models 4210, 4212, 4214 include a first example contextual data graph model 4210, a second example contextual data graph model 4212, and a third example contextual data graph model 4214. In some examples, the first contextual data graph model 4210 can be based on raw data correlations. For example, the first contextual data graph model 4210 can be generated, curated, etc., based on standalone data analysis of sensor input related directly to a corresponding inline process. For example, the first process 4202 can have a corresponding one of the first contextual data graph model 4210, which can be generated based on control and/or sensor data generated by the first process 4202. In some examples, the first contextual data graph model 4210 may not have correlation to other data sets, events, or processes.

In some examples, the second contextual data graph model 4212 can be based on event data correlations. For example, the second contextual data graph model 4212 can be generated, adapted, constructed, etc., based on captures of event sequences surrounding processes that the second contextual data graph model 4212 is associated with. For example, the second contextual data graph model 4212 can include data based on the second process 4204 and associated processes (e.g., the first process 4202, the third process 4206, the adjacent process 4208, etc.). In some examples, the second contextual data graph model 4212 can represent impact(s) of subsequent inline processes (e.g., an impact of an output of the second process 4204 to an input of the third process 4206). In some examples, a length of a vector connecting two nodes in the second contextual data graph model 4212 can define and/or otherwise be representative of a likelihood of event sequence (e.g., how probable, often, likely, etc., does the third process 4206 follows the second process 4204). In some examples, angles of deviation (e.g., an angle of a connecting vector with respect to a reference axis) can define and/or otherwise be representative of a degree of similarity of adjacent events that appear to be impacted (e.g., if not in a direct line of process events). For example, the third process 4206 is a direct inline process with respect to the second process 4204 while the adjacent process 4208 is an indirect or adjacent process with respect to the second process 4204.

In some examples, the third contextual data graph model 4214 can be based on cross data correlations. For example, the third contextual data graph model 4214 can be created, generated, modified, etc., based on a first data object. In some examples, the third contextual data graph model 4214 can be created, generated, modified, etc., based on captures or ingestions of other second data objects (e.g., documents, data files, etc.) that are frequently associated with or used in conjunction with the first data object. In some examples, a length of a vector of connecting nodes can define and/or otherwise be representative of a strength of association of the connected nodes. For example, the strength of association can be quantified based on a strength or high likelihood of connection and/or co-utilization (e.g., a frequency or likelihood that two data objects are used in tandem, combination, or sequence) of the first data object and one of the second data objects.

In some examples, the first contextual data graph model 4210 can be based on raw data correlations. For example, the first contextual data graph model 4210 can be generated, curated, etc., based on standalone data analysis of sensor input related directly to a corresponding inline process. For example, the first process 4202 can have a corresponding one of the first contextual data graph model 4210, which can be generated based on control and/or sensor data generated by the first process 4202. In some examples, the first contextual data graph model 4210 may not have correlation to other data sets, events, or processes.

In some examples, local contextual data graph models and associated data can be cached together, where analytics (e.g., execution of analytics by executing the machine learning model 4070 of FIG. 40) is performed to weigh the strength of various graph node combinations between datasets being correlated and over extended periods of time gaining additional insights based on event chaining from one dataset which influences/impacts another. In some examples, each of the contextual data graph models 4210, 4212, 4214 can be tagged with metadata such as system vendor, sensor type, unit, resolution, location zones (e.g., a zone or segment of the first factory 3904), alerts, past alerts, provenance, relevance to a fault, user access etc.

In some examples, the contextual data graph models 4210, 4212, 4214 and/or the event chain 4200 can be persisted to the translation server 3922 of FIG. 39, which can enable shared access to the contextually correlated datasets. Advantageously, the translation server 3922 can send the contextual data graph models 4210, 4212, 4214, the event chain 4200, and/or associated data to other parts of the environment 3900 (e.g., sent from the first factory 3904 to the translation server 3922 and from the translation server 3922 to the second factory 3906) to provide improved insights and correlation of cross-operations data and a means to quickly bootstrap information and data services operations. In some examples, security of data stored by the translation server 3922 can be ensured with access rights. In some examples, raw data can be hidden, while just surfacing the translated alert or context of the alert, which can then be used in a different zone on the floor of the first factory 3904, the second factory 3906, etc.

Advantageously, the deployment of the contextual data graph models 4210, 4212, 4214 and/or the event chain 4200 between different data managers of the environment 3900 can enable each data manager to learn, understand, and potentially align the vocabulary of other teams that may be requesting data (e.g., requesting an access of data, requesting a search for the data, etc.), the relationship between different data/information sources, and the importance of data and adjacent datasets when viewed from an end-to-end process standpoint, which is depicted by the event chain 4200.

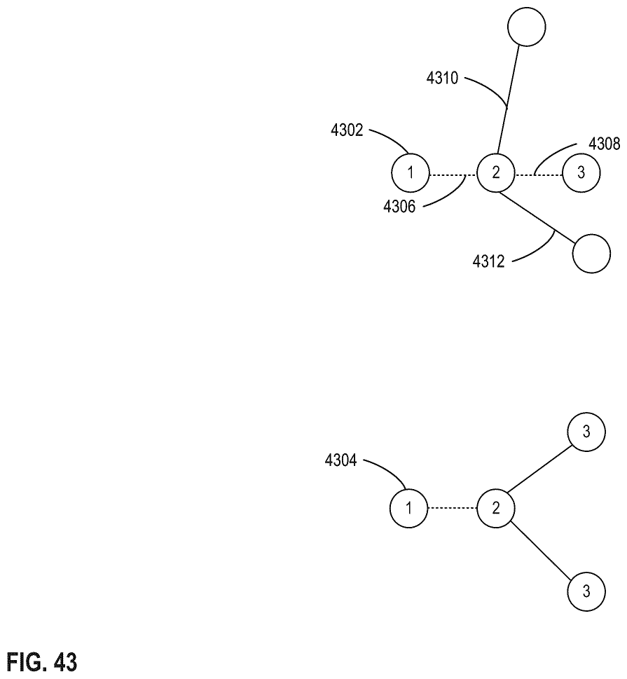

FIG. 43 is an illustration of a first example contextual data graph model 4302 and a second example contextual data graph model 4304. In some examples, the contextual data graph models 4302, 4304 can implement the contextual data graph models 4068 of FIG. 40 and/or the second contextual data graph model 4212 of FIG. 42. In some examples, the contextual data graph models 4302, 4304 can be implemented using data that defines, represents, and/or otherwise implements the event chain 4200 of FIG. 42. In some examples, the contextual data translator 3902 can generate the first contextual data graph model 4302 and/or the second contextual data graph model 4304.

In the illustrated example, the first contextual data graph model 4302 is an event sequence graph. Inline direct events of the first contextual data graph model 4302 are identified as nodes 1, 2, and 3. Such inline direct events represent events that are expected to be or have been observed in sequence, frequently. Example inline direct vectors 4306, 4308 have lengths (e.g., a length of the vector connecting node 1 and node 2, node 2 and node 3, etc.) that are relatively short, which can represent the events to be, apparently, closely coupled and/or otherwise tightly correlated. Example adjacent vectors 4310, 4312 are representative of connected events that have been observed to occur with lower frequency (as illustrated with longer vectors than the inline direct vectors 4306, 4308) with respect to the inline direct events. Although the adjacent vectors 4310, 4312 are representative of lower frequency events, the adjacent vectors 4310, 4312 may still represent connected events that are related in a statistically significant manner. Advantageously, the contextual data translator 3902 can dynamically generate, modify (e.g., add or remove a node, lengthen or shorten a vector, increase or decrease an angle of a vector, a change in location or connection of a vector, etc.), etc., the first contextual data graph model 4302 and/or the second contextual data graph model 4304 over time as events and associated data are recorded and observed.

In the illustrated example, the second contextual data graph model 4304 is another event sequence graph. In some examples, an event sequence can represent multiple coincidental events (e.g., events that may have an equal or substantially equal likelihood of occurrence) as depicted by two instances of node 3. For example, depending upon the adjacency of the outcomes of the two instances of node 3, these two instances can be two different events that can occur at the same time on two different process lines (e.g., two different manufacturing lines) or two equally or substantially equal possible events on a single process line.

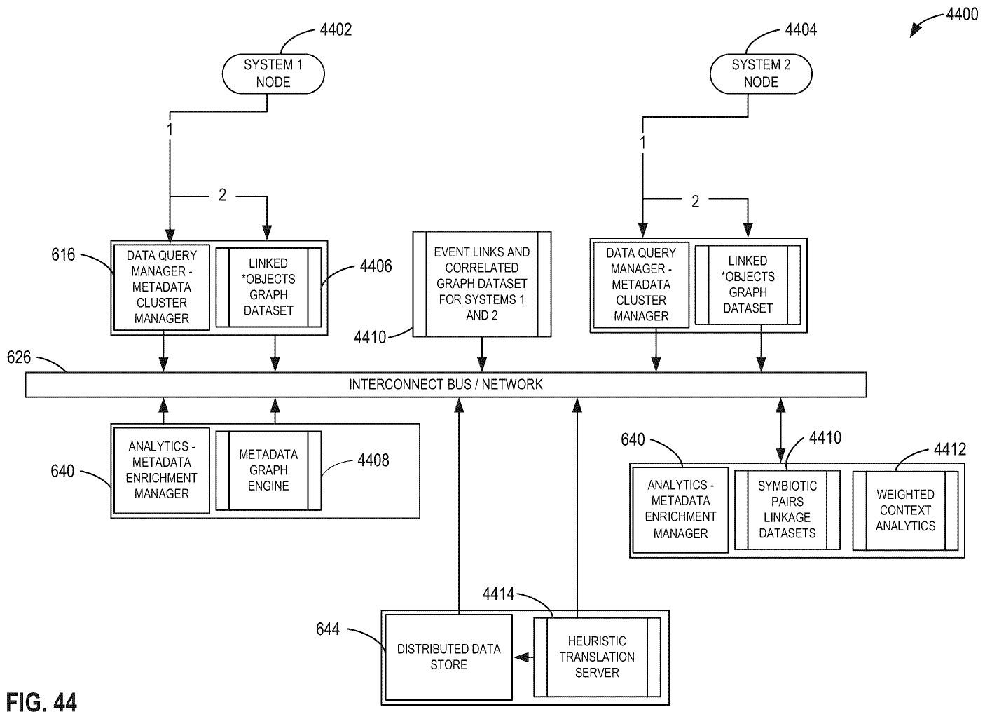

FIG. 44 is an illustration of an example contextual data translation system 4400 that may implement the contextual data translator 3902 as described herein. In some examples, the contextual data translation system 4400 can be implemented by the ADM system 600 of FIG. 6, or portion(s) thereof. The contextual data translation system 4400 includes a first example node 4402 (identified by SYSTEM 1 NODE) and a second example node 4404 (identified by SYSTEM 2 NODE).

In the illustrated example, the first node 4402 can execute applications, services, etc., under normal or typical use during a first operation. The data query manager 610 may collect metadata, data objects, etc., in connection with the normal or typical use. The data query manager 610 can update first example linked objects 4406 based on the collected metadata and data objects. In some examples, the first linked objects 4406 can be implemented using the contextual data graph models 4068 of FIG. 40. For example, during a second operation, the data query manager 610 can update the first linked objects 4406 to generate a graph representation of the collected metadata and the data objects. In some examples, the graph representation may indicate, show, etc., strengths of affinities and frequencies of cross-associations among terms, objects, etc., within a particular system and/or disciple associated with the first node 4402.

In the illustrated example, the metadata enrichment manager 640 may identify relative strengths and correlation among data objects, terms, etc., over time during a third operation. In some examples, over time, these correlations may have minor cyclical or event driven derivations of meaning and association. In some examples, the metadata enrichment manager 640 may identify the correlations independently for different systems (e.g., SYSTEM 1 and 2 independently). During the third operation, the metadata enrichment manager 640 may store a local dataset in an example metadata graph engine 4408 for in system requests and correlation of data for local users and applications, services, etc., that may require contextual resolution. In some examples, the metadata graph engine 4408 can be implemented by the machine learning circuitry 4020 of FIG. 40, and/or, more generally, the contextual data translation circuitry 4000 of FIG. 40.

In the illustrated example, copies from SYSTEM 1 and SYSTEM 2 may be cached in an example event links and correlated graph dataset 4410 during a fourth operation. In some examples, the event links and correlated graph dataset 4410 can be implemented by the contextual data graph models 4068, the event chain 4200, etc., and/or any combination(s) thereof. During a fifth operation, an example metadata comparator and analytics manager, which can be implemented by the analytics manager 636, use cached graph sets to generate weighed correlations based on connected graph nodes, “meanings” phrases, or keyword “pool” descriptions. For example, the metadata comparator and analytics manager may utilize example symbolic pairs linkage datasets 4410 and/or example weighted context analytics 4412 to generate the weighted correlations. In some examples, the symbolic pairs linkage datasets 4410 can be implemented using the metadata 4064, the environment topology 4066, the contextual data graph models 4068, the event chain 4200, etc., and/or any combination(s) thereof. In some examples, the weighted context analytics 4412 can be implemented by the machine learning circuitry 4020.

During the fifth operation, the weighted pools may be correlated to rate context, meaning, etc., between SYSTEM 1 and SYSTEM 2. In some examples, the metadata comparator and analytics manager may assign strong correlations to be similar in meaning and context between systems. In some examples, the metadata comparator and analytics manager may implement secondary confirmation by examining event links or causality chains that compare macro-level events within and then between systems to confirm similarity in use and effects of data, objects, etc., by users or programs (e.g., in process environments like manufacturing, where events tend to be linear and/or connected across systems). In some examples, confirmed correlations, which may include terminology and keyword “pools,” may be captured in an example heuristic white pages server 4414 to act as a resource for multiple teams with continuous reconciliation.

Flowcharts representative of example hardware logic circuitry, machine readable instructions, hardware implemented state machines, and/or any combination thereof for implementing the contextual data translation circuitry 4000 of FIG. 40 are shown in FIGS. 45-52. The machine readable instructions may be one or more executable programs or portion(s) of an executable program for execution by processor circuitry, such as the processor circuitry 5312 shown in the example processor platform 5300 discussed below in connection with FIG. 53. The program may be embodied in software stored on one or more non-transitory computer readable storage media such as a CD, a floppy disk, a hard disk drive (HDD), a solid-state drive (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 45-52, many other methods of implementing the example contextual data translation circuitry 4000 of FIG. 40 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 45 is a flowchart representative of example machine readable instructions and/or example operations 4500 that may be executed and/or instantiated by processor circuitry to persist a contextual data graph model in a shared datastore to be accessible by a node. The example machine readable instructions and/or the example operations 4500 of FIG. 45 begin at block 4502, at which the contextual data translation circuitry 4000 tags a first data object generated at a first node with metadata based on an environment of the first node. For example, the data query management circuitry 4030 can tag a first data object, which can be sensor data, generated by the first soldering station of the first discipline 3916 of the first function 3910. In some examples, the data query management circuitry 4030 can tag the first data object with the metadata 4064 (e.g., generate an association of the first data object with the metadata 4064), which can include a make, model, vendor, manufacturer, serial number, etc., of the first soldering station.

At block 4504, the contextual data translation circuitry 4000 identifies a contextual data graph model associated with the metadata. For example, the machine learning circuitry 4020 can identify (e.g., by executing the machine learning model 4070) a first one of the contextual data graph models 4068 that corresponds to the first soldering station. In some examples, the machine learning circuitry 4020 can identify at least one of the first contextual data graph model 4210, the second contextual data graph model 4212, or the third contextual data graph model 4214 associated with the first process 4202, which can include the first soldering station.

At block 4506, the contextual data translation circuitry 4000 determines a strength of association between the first data object and a second data object of the contextual data graph model. For example, the machine learning circuitry 4020 can determine (e.g., by executing the machine learning model 4070) a strength of association of the primary node 4106 of the first contextual data graph model 4102 and a first node connected to the primary node 4106 of the first contextual data graph model 4102. In some examples, the first node can be implemented with and/or otherwise representative of the first data object (and/or associated metadata) and the primary node 4106 can be implemented with and/or otherwise representative of a second data object, such as sensor data generated by the second soldering station of the first discipline 3916 of the first function 3910 that may be co-located (and/or communicatively coupled) with the first soldering station. Example machine readable instructions and/or the example operations that may be executed and/or instantiated by processor circuitry to implement block 4506 is described below in connection with FIG. 46.

At block 4508, the contextual data translation circuitry 4000 determines whether the strength of the association satisfies a threshold. For example, the machine learning circuitry 4020 can determine (e.g., by executing the machine learning model 4070) whether a vector angle, length, placement, location, etc., satisfies a threshold (e.g., a similarity threshold, a strength or strength of association threshold, etc.). If, at block 4508, the contextual data translation circuitry 4000 determines that the strength of the association does not satisfy a threshold, the example machine readable instructions and/or the example operations 4500 conclude, otherwise control proceeds to block 4510.

At block 4510, the contextual data translation circuitry 4000 updates the contextual data graph model based on the strength of the association. For example, the machine learning circuitry 4020 can modify or update (e.g., by executing the machine learning model 4070) an angle, a length, a placement, a location, etc., of a vector connecting the first data object and the second data object or a different vector connecting the first data object to the first contextual data graph model 4102 based on the strength of the association.

At block 4512, the contextual data translation circuitry 4000 stores the contextual data graph model in a shared datastore to be accessible by a second node. For example, the data publishing circuitry 4050 can push and/or otherwise publish update(s) to the first contextual data graph model 4102 to be stored in a shared datastore, such as the translation server 3922 of FIG. 39, to be accessible by another node of the environment 3900 such as a node associated with the second function 3912 of the first factory 3904 and/or a node associated with the second factory 3906. In response to persisting the contextual data graph model in a shared datastore to be accessible by a second node at block 4512, the example machine readable instructions and/or example operations 4500 of FIG. 45 conclude.

FIG. 46 is a flowchart representative of example machine readable instructions and/or example operations 4600 that may be executed and/or instantiated by processor circuitry to determine a strength of association between the first data object and a second data object of the contextual data graph model. The example machine readable instructions and/or the example operations 4600 of FIG. 46 begin at block 4602, at which the contextual data translation circuitry 4000 connects the first data object to the second data object using a vector in the contextual data graph model. For example, the machine learning circuitry 4020 can connect and/or otherwise identify a placement and/or orientation of a vector to be connected from a first data object to a second data object in the first contextual data graph model 4102. In some examples, the second data object can be implemented by the primary node 4106 and the first data object can be implemented by the first adjacent node 4110.

At block 4604, the contextual data translation circuitry 4000 determines an angle of the vector with respect to a reference axis. For example, the first contextual data graph model 4102 can have one or more axes, such as an x-axis, a y-axis, a z-axis (in the case of a three-dimensional implementation), etc. In some examples, the machine learning circuitry 4020 can determine an angle of the vector connecting the primary node 4106 and the first adjacent node 4110.

At block 4606, the contextual data translation circuitry 4000 determines a length of the vector. For example, the machine learning circuitry 4020 can determine a length of the vector connecting the primary node 4106 and the first adjacent node 4110.

At block 4608, the contextual data translation circuitry 4000 determines the strength of the association based on at least one of the angle or the length of the vector. For example, the machine learning circuitry 4020 can determine the strength of the association between the first and second data objects based on quantifications of their relationship to each other in the first contextual data graph model 4102, which can include at least one of the angle or the length of the vector connecting the primary node 4106 and the first adjacent node 4110. In response to determining the strength of the association based on at least one of the angle or the length of the vector at block 4608, the example machine readable instructions and/or the example operations 4600 of FIG. 46 conclude. For example, the machine readable instructions and/or the example operations 4600 of FIG. 46 can return to block 4508 of the machine readable instructions and/or the example operations 4500 of FIG. 45 to determine whether the strength of the association satisfies a threshold.

FIG. 47 is a flowchart representative of example machine readable instructions and/or example operations 4700 that may be executed and/or instantiated by processor circuitry to update one(s) of contextual data graph models based on correlation(s). The example machine readable instructions and/or the example operations 4700 of FIG. 47 begin at block 4702, at which the contextual data translation circuitry 4000 selects a process in an environment. For example, the node management circuitry 4040 can select the first process 4202 in an environment, such as the environment 3900.

At block 4704, the contextual data translation circuitry 4000 selects a node associated with the process. For example, the node management circuitry 4040 can select a node, such as the first soldering station of the first discipline 3916 of the first function 3910, that is associated with the first process 4202.

At block 4706, the contextual data translation circuitry 4000 generates a first contextual data graph model based on first data associated with the node. For example, the machine learning circuitry 4020 can generate (e.g., by executing the machine learning model 4070) the first contextual data graph model 4210 based on first data generated, ingested, and/or published by the first soldering station (e.g., a controller and/or sensor associated with the first soldering station).

At block 4708, the contextual data translation circuitry 4000 generates a second contextual data graph model based on a sequence of events observed in the process. For example, the machine learning circuitry 4020 can generate (e.g., by executing the machine learning model 4070) the second contextual data graph model 4212 based on a sequence of events observed in the first process 4202, the second process 4204, etc., and/or, more generally, the event chain 4200.

At block 4710, the contextual data translation circuitry 4000 generates a third contextual data graph model based on second data associated with the first data. For example, the machine learning circuitry 4020 can generate (e.g., by executing the machine learning model 4070) the third contextual data graph model 4214 based on associated data objects (e.g., ancillary, auxiliary, etc., types of data objects) that can be frequently associated with or used in conjunction with the first data associated with the first soldering station.

At block 4712, the contextual data translation circuitry 4000 stores the contextual data graph models at the node. For example, the data query management circuitry 4030 can store at least one of the first contextual data graph model 4210, the second contextual data graph model 4212, or the third contextual data graph model 4214 as one(s) of the contextual data graph models 4068 of the datastore 4060. In some examples, the datastore 4060 can be implemented using memory, one or more mass storage devices, etc., of the first soldering station (e.g., a controller and/or sensor associated with the first soldering station).

At block 4714, the contextual data translation circuitry 4000 determines whether to select another node in the process. For example, the node management circuitry 4040 can select the second soldering station of the first discipline 3916 of the first function 3910 to process. If, at block 4714, the contextual data translation circuitry 4000 determines to select another node in the process, control returns to block 4704, otherwise control proceeds to block 4716.

At block 4716, the contextual data translation circuitry 4000 provides the contextual data graph models to a shared datastore. For example, the data publishing circuitry 4050 can push and/or otherwise provide the at least one of the first contextual data graph model 4210, the second contextual data graph model 4212, or the third contextual data graph model 4214 to memory, one or more mass storage devices, etc., of the translation server 3922, which can be accessed by different nodes of the environment 3900.

At block 4718, the contextual data translation circuitry 4000 determines whether to select another process in the environment. For example, the node management circuitry 4040 can select the second process 4204 to analyze and/or otherwise process for generation of one(s) of the contextual data graph models 4068. If, at block 4718, the contextual data translation circuitry 4000 determines to select another process in the environment, control returns to block 4702, otherwise control proceeds to block 4720.

At block 4720, the contextual data translation circuitry 4000 identifies correlation(s) amongst the contextual data graph models in the shared datastore. For example, the machine learning circuitry 4020 can identify correlation(s), association(s), relationship(s), etc., amongst at least one of the first contextual data graph model 4210, the second contextual data graph model 4212, or the third contextual data graph model 4214, and/or, more generally, the contextual data graph models 4068, based on placements, locations, positions, angles, lengths, etc., of node connecting vectors. In some examples, the machine learning circuitry 4020 can couple the first contextual data graph model 4210 to the second contextual data graph model 4212 to identify whether first node(s) of the first contextual data graph model 4210 can be coupled to second node(s) of the second contextual data graph model 4212 based on relatedness between the first node(s) and the second node(s). In some examples, the machine learning circuitry 4020 can identify correlation(s) between the first contextual data graph model 4210 and the second contextual data graph model 4212 based on the coupling(s) of the first node(s) and the second node(s).

At block 4722, the contextual data translation circuitry 4000 updates one(s) of the contextual data graph models based on the correlation(s). For example, the machine learning circuitry 4020 can update at least one of the one of the first contextual data graph model 4210, the second contextual data graph model 4212, or the third contextual data graph model 4214, and/or, more generally, the contextual data graph models 4068, based on placements, locations, positions, angles, lengths, etc., of node connecting vectors indicative of correlation(s) amongst them. In response to updating one(s) of the contextual data graph models based on the correlation(s) at block 4722, the example machine readable instructions and/or example operations 4700 of FIG. 47 conclude.

FIG. 48 is a flowchart representative of example machine readable instructions and/or example operations 4800 that may be executed and/or instantiated by processor circuitry to provide updated contextual data graph models to at least one of node(s) or a shared datastore. The example machine readable instructions and/or the example operations 4800 of FIG. 48 begin at block 4802, at which the contextual data translation circuitry 4000 ingests first data at a first node. For example, the data ingestion circuitry 4010 can receive and/or otherwise ingest first data generated by a node, such as the first welding station of the third discipline 3920 of the first function 3910.

At block 4804, the contextual data translation circuitry 4000 translates the first data. For example, the data ingestion circuitry 4010 can convert, reformat, decrypt/encrypt, etc., the first data from a first data format to a second data format.

At block 4806, the contextual data translation circuitry 4000 tags the first data with first metadata. For example, the first data can be an operating amperage measurement of the first welding station, and the data query management circuitry 4030 can tag the amperage measurement with first metadata, such as a user, make, model, vendor, manufacturer, serial number, etc., of the first welding station.

At block 4808, the contextual data translation circuitry 4000 identifies match(es) of the first metadata with second metadata associated with second data. For example, the machine learning circuitry 4020 can determine whether a first portion of the first metadata matches a second portion of second metadata associated with second data, such as an operating amperage measurement of the first screwdriving station of the second discipline 3918 of the first function 3910.

At block 4810, the contextual data translation circuitry 4000 identifies contextual data graph models associated with the second metadata. For example, the machine learning circuitry 4020 can identify one(s) of the contextual data graph models 4068 that includes the second metadata.

At block 4812, the contextual data translation circuitry 4000 updates the contextual data graph models based on the first data. For example, the machine learning circuitry 4020 can update the one(s) of the contextual data graph models 4068 by adding and/or removing the first portion of the first metadata to node(s) of the one(s) of the contextual data graph models 4068.

At block 4814, the contextual data translation circuitry 4000 provides the updated contextual data graph models to at least one of second node(s) or a shared datastore. For example, the data publishing circuitry 4050 can push and/or otherwise provide the one(s) of the contextual data graph models 4068 to memory, one or more mass storage devices, etc., of the translation server 3922, which can be accessed by different nodes of the environment 3900. In some examples, the data publishing circuitry 4050 can provide the one(s) of the contextual data graph models 4068 to the different nodes of the environment 3900.

At block 4816, the contextual data translation circuitry 4000 determines whether additional data is to be ingested. For example, the data ingestion circuitry 4010 can determine whether another measurement is available from the first welding station to be ingested for updating the contextual data graph models 4068. If, at block 4816, the contextual data translation circuitry 4000 determines that additional data is to be ingested, control returns to block 4802, otherwise the example machine readable instructions and/or the example operations 4800 of FIG. 48 conclude.

FIG. 49 is a flowchart representative of example machine readable instructions and/or example operations 4900 that may be executed and/or instantiated by processor circuitry to generate alert(s) to node(s) in an environment based on updated contextual data graph model(s). The example machine readable instructions and/or the example operations 4900 of FIG. 49 begin at block 4902, at which the contextual data translation circuitry 4000 ingests first data at a first node at a first hop or a first level of a network environment. For example, the data ingestion circuitry 4010 can ingest first data from the first welding station of the third discipline 3920 of the first function 3910 at a first level of the first factory 3904. In some examples, the data ingestion circuitry 4010 can ingest first data at a first hop in a network (e.g., the Internet, a private network, an Edge network, etc.).

At block 4904, the contextual data translation circuitry 4000 updates first contextual data graph model(s) associated with the first node based on the first data. For example, the machine learning circuitry 4020 can identify first one(s) of the contextual data graph models 4068 based on match(es) of first metadata tagged to the first data to second metadata tagged to the first one(s) of the contextual data graph models 4068.

At block 4906, the contextual data translation circuitry 4000 pushes the updated first contextual data graph model(s) to a second node at a second hop or a second level of the network environment. For example, the data publishing circuitry 4050 can transfer update(s) to the first one(s) of the contextual data graph models 4068 to the contextual data translator 3902 at the second level of the first factory 3904.

At block 4908, the contextual data translation circuitry 4000 identifies second contextual data graph model(s) associated with the first contextual data graph model(s). For example, the machine learning circuitry 4020 can identify second one(s) of the contextual data graph models 4068 corresponding to the second level of the first factory 3904. In some examples, the second one(s) of the contextual data graph models 4068 can match portion(s) of metadata included in the first one(s) of the contextual data graph models 4068.

At block 4910, the contextual data translation circuitry 4000 identifies correlation(s) between the first contextual data graph model(s) and the second contextual data graph model(s). For example, the machine learning circuitry 4020 can identify correlation(s) between and/or otherwise amongst the first and second one(s) of the contextual data graph models 4068.

At block 4912, the contextual data translation circuitry 4000 updates the second contextual data graph model(s) based on the correlation(s). For example, the machine learning circuitry 4020 can update the second one(s) of the contextual data graph models 4068 based on the correlation(s). In some examples, the machine learning circuitry 4020 can update the second one(s) of the contextual data graph models 4068 by adding/deleting nodes, increasing/decreasing vector lengths, increasing/decreasing vector angles, etc., and/or any combination(s) thereof.

At block 4914, the contextual data translation circuitry 4000 generates alert(s) to one or more third nodes in the environment based on the updated second contextual data graph model(s). For example, the data publishing circuitry 4050 can generate and/or propagate an alert to other nodes of the first factory 3904 and/or the second factory 3906 based on the correlation(s). For example, the data publishing circuitry 4050 can detect that the correlation(s) is/are indicative of a first failure occurring at the first welding station, which can impact operation of a different welding station, a different function, a different discipline etc. In some examples, the data publishing circuitry 4050 can generate the alert to the different welding station, the different function, the different discipline, etc., in response to the detections of the correlation(s) having unfavorable outcome(s).

At block 4916, the contextual data translation circuitry 4000 determines whether additional data is to be ingested at the first node. For example, the data ingestion circuitry 4010 can determine whether additional data has been generated by the first welding station of the third discipline 3920 of the first function 3910 at the first level of the first factory 3904. If, at block 4916, the contextual data translation circuitry 4000 determines that additional data is to be ingested at the first node, control returns to block 4902, otherwise the example machine readable instructions and/or the example operations 4900 of FIG. 49 conclude.

FIG. 50 is a flowchart representative of example machine readable instructions and/or example operations 5000 that may be executed and/or instantiated by processor circuitry to update a contextual data graph model based on a machine learning output. The example machine readable instructions and/or the example operations 5000 of FIG. 50 begin at block 5002, at which the contextual data translation circuitry 4000 tags data ingested at a first node associated with a first process in an environment with first metadata. For example, the data query management circuitry 4030 can tag first data, which can be sensor data, generated by the first soldering station of the first discipline 3916 of the first function 3910. In some examples, the data query management circuitry 4030 can tag the first data with the metadata 4064 (e.g., generate an association of the first data with the metadata 4064), which can include a make, model, vendor, manufacturer, serial number, etc., of the first soldering station. In some examples, the first soldering station can be included in and/or otherwise part of the first process 4202 of FIG. 42.

At block 5004, the contextual data translation circuitry 4000 determines whether portion(s) of the data deviate from a baseline by a threshold. For example, the machine learning circuitry 4020 can determine whether a value of the sensor data is different from an average value of the sensor data by more than a threshold value, which can be indicative of an abnormal, anomalous, or irregular event in connection with the first soldering station.

If, at block 5004, the contextual data translation circuitry 4000 determines that portion(s) of the data do not deviate from a baseline by a threshold, control proceeds to block 5020, otherwise control proceeds to block 5006. At block 5006, the contextual data translation circuitry 4000 identifies a contextual data graph model based on the first metadata. For example, the machine learning circuitry 4020 can search the contextual data graph models 4068 for one(s) that include portion(s) of the first metadata, and/or, more generally, the first metadata. In some examples, the search can result in the second contextual data graph model 4212 of FIG. 42.

At block 5008, the contextual data translation circuitry 4000 identifies a second process in sequence with the first process based on the contextual data graph model. For example, the machine learning circuitry 4020 can identify that the second process 4204 is in sequence with the first process 4202 based on connections of the second contextual data graph model 4212.

At block 5010, the contextual data translation circuitry 4000 identifies a second node associated with the second process based on the contextual data graph model. For example, the node management circuitry 4040 can identify the first screwdriver station of the second discipline 3918 of the first function 3910 as a part of the second process 4204. In some examples, the identification of the first screwdriver station is based on connections of the second contextual data graph model 4212.

At block 5012, the contextual data translation circuitry 4000 transmits an alert based on the data to the second node. For example, the data publishing circuitry 4050 can transmit an alert based on the sensor data from the first soldering station to the first screwdriver station in response to a determination that output(s) from the first soldering station can affect input(s) of the first screwdriver station.

At block 5014, the contextual data translation circuitry 4000 receives an indication of an execution of a response or an adjustment in the second process in response to the alert. For example, the first screwdriver station can be halted and/or otherwise cease operation in response to the alert. In some examples, a user may carry out an activity in connection with the first screwdriver station in response to the alert. In some examples, the data ingestion circuitry 4010 can receive data indicative of the halting/ceasing operation of the first screwdriver station, the carrying out of the activity, etc., and/or any combination(s) thereof.

At block 5016, the contextual data translation circuitry 4000 provides the indication to a machine learning model to generate a machine learning output. For example, the data ingestion circuitry 4010 can provide the data to the machine learning model 4070 as model input(s) to generate model output(s). In some examples, the model output(s) can include change(s) to one(s) of the contextual data graph models 4068, such as one of the contextual data graph models 4068 that is associated with the first screwdriving station and/or another one of the contextual data graph models 4068 that is associated with the first soldering station.

At block 5018, the contextual data translation circuitry 4000 updates the contextual data graph model based on the machine learning output. For example, the machine learning circuitry 4020 can update the one of the contextual data graph models 4068 that is associated with the first screwdriving station and/or the one of the contextual data graph models 4068 that is associated with the first soldering station based on the model output(s) from the machine learning model 4070.

At block 5020, the contextual data translation circuitry 4000 determines whether additional data is received. For example, the data ingestion circuitry 4010 can determine whether additional data is received from the first soldering station (and/or the first screwdriving station). If, at block 5020, the contextual data translation circuitry 4000 determines that additional data is received, control returns to block 5002, otherwise the example machine readable instructions and/or the example operations 5000 of FIG. 50 conclude.

FIG. 51 is a flowchart representative of example machine readable instructions and/or example operations 5100 that may be executed and/or instantiated by processor circuitry to reconcile use(s) of application(s) and service(s) by first and second systems. The example machine readable instructions and/or the example operations 5100 of FIG. 51 begin at block 5102, at which the contextual data translation circuitry 4000 collects data objects and metadata associated with use of application(s) and service(s) in a first system. For example, the data ingestion circuitry 4010 can collect the metadata and the data objects associated with a system, such as the first factory 3904, and/or, more generally, the environment 3900.

At block 5104, the contextual data translation circuitry 4000 generates contextual data graph models representative of the data objects and the metadata. For example, the machine learning circuitry 4020 can generate (e.g., by executing and/or otherwise invoking an execution of the machine learning model 4070) the contextual data graph models 4068 in connection with the first factory 3904 based on the collected metadata and the data objects.

At block 5106, the contextual data translation circuitry 4000 identifies relative strength(s) and correlation(s) among lexical terms in the first system. For example, the machine learning circuitry 4020 can identify relative strengths and correlations amongst different one(s) of lexical terms associated with the applications, services, etc., in the first factory 3904.

At block 5108, the contextual data translation circuitry 4000 cross-correlates contextual data graph models of the first system and a second system. For example, the For example, the machine learning circuitry 4020 can cross correlate first one(s) of the contextual data graph models 4068 associated with the first factory 3904 and second one(s) of the contextual data graph models 4068 associated with the second factory 3906.

At block 5110, the contextual data translation circuitry 4000 generates weighted correlations based on connected graph nodes of the cross correlated contextual data graph models. For example, the machine learning circuitry 4020 can generate weighted correlations based on the cross-correlations of the contextual data graph models 4068 of the first factory 3904 and the second factory 3906.

At block 5112, the contextual data translation circuitry 4000 rates context and/or meaning of lexical terms between the first and second systems based on the weighted correlations. For example, the machine learning circuitry 4020 can rank, rate, review, etc., the context and/or meaning of different lexical terms used by the first factory 3904 (and/or user(s) thereof) and the second factory 3906 (and/or user(s) thereof) to determine whether the different lexical terms are substantially similar, have the same connotation, etc., and/or any combination(s) thereof.

At block 5114, the contextual data translation circuitry 4000 identifies event links or causality chains between the first and second systems based on the lexical terms. For example, the machine learning circuitry 4020 can identify event links or causality chains between the first factory 3904 and the second factory 3906 based on the lexical terms. In some examples, the event links or causality chains can be implemented using the event chain 4200 of FIG. 42 and/or associated contextual data graph models. In some examples, the machine learning circuitry 4020 can identify a link, a correlation, etc., between a first event associated with the first factory 3904 and a second event associated with the second factory 3906 in response to a determination that a first lexical term associated with the first event has a similar context and/or meaning as a second lexical term associated with the second event.

At block 5116, the contextual data translation circuitry 4000 reconciles use(s) of application(s) and service(s) by the first and second systems. For example, the machine learning circuitry 4020 can align, link, and/or otherwise associate first use(s) of first application(s), first service(s), etc., of the first factory 3904 and second use(s) of the first application(s) or second application(s), the first service(s) or second service(s), etc., of the second factory 3906. In response to reconciling the use(s) of the application(s) and service(s) by the different systems at block 5116, the example machine readable instructions and/or the example operations 5100 of FIG. 51 conclude.

FIG. 52 is a flowchart representative of example machine readable instructions and/or example operations 5200 that may be executed and/or instantiated by processor circuitry to output results based on a search including at least one of a first data object or a second data object. The example machine readable instructions and/or the example operations 5200 of FIG. 52 begin at block 5202, at which the contextual data translation circuitry 4000 receives a request for a data object. For example, the data query management circuitry 4030 can receive a request from a user, a node, etc., for a data object associated with the third discipline 3920 of the first function 3910 to determine whether a product has been completely processed by the third discipline 3920 (e.g., determine whether all welding operations on the product are complete).

At block 5204, the contextual data translation circuitry 4000 tags the data object with first metadata. For example, the data query management circuitry 4030 can tag the first data object with first metadata associated with the requester, such as a type of application and/or service used to generate the request, personnel information associated with the user such as a job role, job title, or expertise, type(s) of data objects previously requested by the requester, etc., and/or any combination(s) thereof to facilitate the search for the first data object.

At block 5206, the contextual data translation circuitry 4000 extracts a first lexical term from the request. For example, the request for the data object can include a keyword of “welding”. In some examples, the data query management circuitry 4030 can extract the lexical term of “welding” from the request for the first data object.

At block 5208, the contextual data translation circuitry 4000 identifies a contextual data graph model associated with the first metadata. For example, the machine learning circuitry 4020 can identify one(s) of the contextual data graph models 4068 that include portion(s) of the first metadata tagged by the data query management circuitry 4030.

At block 5210, the contextual data translation circuitry 4000 determines a strength of association between the first data object and a second data object of the contextual data graph model having a second lexical term. For example, the machine learning circuitry 4020 can determine a strength of association, relatedness, relevancy, etc., between the first data object and a second data object of the identified one(s) of the contextual data graph models 4068.

At block 5212, the contextual data translation circuitry 4000 determines whether the strength of the association satisfies a threshold. For example, the machine learning circuitry 4020 can determine whether the strength of the association between the first data object and the second data object satisfies a threshold based on an angle, a length, etc., of a vector that connects the first data object and the second data object.

If, at block 5212, the contextual data translation circuitry 4000 determines that the strength of the association does not satisfy a threshold, control proceeds to block 5218, otherwise control proceeds to block 5214. At block 5214, the contextual data translation circuitry 4000 determines that the first lexical term has a similar meaning or context to the second lexical term. For example, the machine learning circuitry 4020 can determine that the second data object is associated with keywords of “welding station”.

At block 5216, the contextual data translation circuitry 4000 adds the second lexical term to the request. For example, the data query management circuitry 4030 can add the keyword of station, and/or, more generally, welding station, to the request for the first data object.

At block 5218, the contextual data translation circuitry 4000 performs a search for results using at least one of the first lexical term or the second lexical term. For example, the data query management circuitry 4030 can search the datastore 4060 or a shared datastore, such as the translation server 3922, for the first data object using the keywords of “welding” and “station”.

At block 5220, the contextual data translation circuitry 4000 outputs the results based on the search including at least one of the first data object or the second data object. For example, the data publishing circuitry 4050 can output search results to the requester that include the first data object or the second data object. In some examples, the data publishing circuitry 4050 can output search results that include operational statuses of the first and second welding stations of the third discipline 3920 of the first function 3910, a serial number of products in process at the first and second welding stations, etc., and/or any combination(s) thereof. In some examples, the requester can determine whether a product having a particular serial number is currently in process at the first and second welding stations in response to an improved search that added keywords to the request based on metadata associated with the requester. In response to outputting the results based on the search including at least one of the first data object or the second data object at block 5220, the example machine readable instructions and/or the example operations 5200 of FIG. 52 conclude.

FIG. 53 is a block diagram of an example processor platform 5300 structured to execute and/or instantiate the machine readable instructions and/or the operations of FIGS. 45-52 to implement the contextual data translation circuitry 4000 of FIG. 40. The processor platform 5300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 5300 of the illustrated example includes processor circuitry 5312. The processor circuitry 5312 of the illustrated example is hardware. For example, the processor circuitry 5312 can be implemented by one or more integrated circuits, logic circuits, FPGAs, microprocessors, CPUs, GPUs, DSPs, and/or microcontrollers from any desired family or manufacturer. The processor circuitry 5312 may be implemented by one or more semiconductor based (e.g., silicon based) devices. In this example, the processor circuitry 5312 implements the example machine learning circuitry 4020 (identified by ML CIRCUITRY), the example data query management circuitry 4030 (identified by DATA QUERY MGMT CIRCUITRY), the example node management circuitry 4040 (identified by NODE MGMT CIRCUITRY), and the example data publishing circuitry 4050 (identified by DATA PUBLISH CIRCUITRY) of FIG. 40.

The processor circuitry 5312 of the illustrated example includes a local memory 5313 (e.g., a cache, registers, etc.). The processor circuitry 5312 of the illustrated example is in communication with a main memory including a volatile memory 5314 and a non-volatile memory 5316 by a bus 5318. In some examples, the bus 5318 implements the bus 4080 of FIG. 40. The volatile memory 5314 may be implemented by SDRAM, DRAM, RDRAM®, and/or any other type of RAM device. The non-volatile memory 5316 may be implemented by flash memory and/or any other desired type of memory device. Access to the main memory 5314, 5316 of the illustrated example is controlled by a memory controller 5317.

The processor platform 5300 of the illustrated example also includes interface circuitry 5320. The interface circuitry 5320 may be implemented by hardware in accordance with any type of interface standard, such as an Ethernet interface, a USB interface, a Bluetooth® interface, an NFC interface, a PCI interface, and/or a PCIe interface. In this example, the interface circuitry 5320 implements the example data ingestion circuitry 4010 of FIG. 40.

In the illustrated example, one or more input devices 5322 are connected to the interface circuitry 5320. The input device(s) 5322 permit(s) a user to enter data and/or commands into the processor circuitry 5312. The input device(s) 5322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 5324 are also connected to the interface circuitry 5320 of the illustrated example. The output device(s) 5324 can be implemented, for example, by display devices (e.g., an LED, an OLED, an LCD, a CRT display, an IPS display, a touchscreen, etc.), a tactile output device, a printer, and/or speaker. The interface circuitry 5320 of the illustrated example, thus, typically includes a graphics driver card, a graphics driver chip, and/or graphics processor circuitry such as a GPU.

The interface circuitry 5320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 5326. The communication can be by, for example, an Ethernet connection, a DSL connection, a telephone line connection, a coaxial cable system, a satellite system, a line-of-site wireless system, a cellular telephone system, an optical connection, etc.

The processor platform 5300 of the illustrated example also includes one or more mass storage devices 5328 to store software and/or data. Examples of such mass storage devices 5328 include magnetic storage devices, optical storage devices, floppy disk drives, HDDs, CDs, Blu-ray disk drives, RAID systems, solid state storage devices such as flash memory devices and/or SSDs, and DVD drives. In this example, the one or more mass storage devices 5328 implement the example datastore 4060, the example raw data 4062, the example metadata 4064, the example environment topology 4066 (identified by ENV TOPO), the example contextual data graph models 4068 (identified by CDG MODELS), and the example machine learning model 4070 (identified by ML MODEL) of FIG. 40.

The machine executable instructions 5332, which may be implemented by the machine readable instructions of FIGS. 45-52, may be stored in the mass storage device 5328, in the volatile memory 5314, in the non-volatile memory 5316, and/or on a removable non-transitory computer readable storage medium such as a CD or DVD.

The processor platform 5300 of the illustrated example of FIG. 53 includes example acceleration circuitry 5340, which includes an example GPU 5342, an example vision processing unit (VPU) 5344, and an example neural network processor 5346. In this example, the GPU 5342, the VPU 5344, the neural network processor 5346, and/or, more generally, the acceleration circuitry 5340, are in communication with different hardware of the processor platform 5300, such as the volatile memory 5314, the non-volatile memory 5316, etc., via the bus 5318. In this example, the neural network processor 5346 may be implemented by one or more integrated circuits, logic circuits, microprocessors, GPUs, DSPs, or controllers from any desired family or manufacturer that can be used to execute an AI/ML model, such as a neural network, which may be implemented by the machine learning model 4070. In some examples, one or more of the example data ingestion circuitry 4010, the example machine learning circuitry 4020, the example data query management circuitry 4030, the example node management circuitry 4040, and/or the example data publishing circuitry 4050 can be implemented in or with at least one of the GPU 5342, the VPU 5344, the neural network processor 5346, and/or, more generally, the acceleration circuitry 5340, instead of or in addition to the processor circuitry 5312 and/or the interface circuitry 5320.

From the foregoing, it will be appreciated that example systems, methods, apparatus, and articles of manufacture have been disclosed for contextual translation of data for improved data management. Disclosed systems, methods, apparatus, and articles of manufacture improve the efficiency of using a computing device by aligning different terminology used by different teams and/or processes to improve data access, management, and/or storage, which can reduce the computational, memory, and network resources needed to describe an environment (e.g., a network environment). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for contextual translation of data for improved data management are disclosed herein. Further examples and combinations thereof include the following:

Example 122 includes an apparatus to identify data correlations in a network environment, the apparatus comprising at least one memory, instructions, and processor circuitry to at least one of execute or instantiate the instructions to tag a first data object generated at a first node with metadata based on an environment of the first node, identify a contextual data graph model associated with the metadata, determine a strength of association between the first data object and a second data object of the contextual data graph model, in response to a determination that the strength of the association satisfies a threshold, update the contextual data graph model based on the strength of the association, and store the contextual data graph model in a shared datastore, the shared datastore to be accessible by a second node of the environment.

In Example 123, the subject matter of Example 122 can optionally include that the processor circuitry is to connect the first data object to the second data object with a vector in the contextual data graph model, determine an angle of the vector with respect to a reference axis, determine a length of the vector, and determine the strength of the association based on at least one of the angle or the length.

In Example 124, the subject matter of Examples 122-123 can optionally include that the contextual data graph model is a first contextual data graph model, and the processor circuitry is to generate the first contextual data graph model based on first data associated with the first node, generate a second contextual data graph model based on a sequence of events observed in a process of the environment, the process including a first operation to be executed by the first node, generate a third contextual data graph model based on second data associated with the first data, and store at least one of the first contextual data graph model, the second contextual data graph model, or the third contextual data graph model at the first node.

In Example 125, the subject matter of Examples 122-124 can optionally include that the processor circuitry is to identify one or more correlations between at least one of the first contextual data graph model, the second contextual data graph model, or the third contextual data graph model, and update at least one of the first contextual data graph model, the second contextual data graph model, or the third contextual data graph model based on the one or more correlations.

In Example 126, the subject matter of Examples 122-125 can optionally include that the metadata is first metadata, and the processor circuitry is to identify a match of a first portion of the first metadata and a second portion of second metadata associated with the contextual data graph model, identify the contextual data graph model based on the match, and in response to the determination that the strength of the association satisfies the threshold, add the first portion of the first metadata to the contextual data graph model to update the contextual data graph model.

In Example 127, the subject matter of Examples 122-126 can optionally include that the contextual data graph model is a first contextual data graph model associated with the first node, the first node is at a first hop or a first level of the environment, the second node is at a second hop or a second level of the environment, and the processor circuitry is to identify a second contextual data graph model associated with the second node based on the metadata, identify one or more correlations between the first contextual data graph model and the second contextual data graph model, update the second contextual data graph model based on the one or more correlations, and generate an alert to one or more third nodes in the environment in response to the update of the second contextual data graph model.

In Example 128, the subject matter of Examples 122-127 can optionally include that the first node is associated with a first process in the environment, the determination is a first determination, and the processor circuitry is to determine whether a portion of the first data object deviates from a baseline by a threshold, and in response to a second determination that the portion of the first data object deviates from the baseline by the threshold identify a second process in sequence with the first process based on the contextual data graph model, identify the second node is associated with the second process based on the contextual data graph model, and transmit an alert to the second node, the alert based on the portion of the first data object.

In Example 129, the subject matter of Examples 122-128 can optionally include that the processor circuitry is to receive an indication of an execution of a response or an adjustment in the second process in response to the alert, provide the indication to a machine learning model to generate a machine learning output, and update the contextual data graph model based on the machine learning output.

In Example 130, the subject matter of Examples 122-129 can optionally include that the first data object includes a first lexical term, the second data object includes a second lexical term, and the processor circuitry is to determine that the first lexical term has a similar meaning or context to the second lexical term based on the strength of the association satisfying the threshold, and in response to receiving a request for the first data object add the second lexical term to the request, perform a search of the shared datastore using at least one of the first lexical term or the second lexical term, and output a result of the search, the result including at least one of the first data object or the second data object.

Example 131 includes an apparatus to identify data correlations in a network environment, the apparatus comprising means for tagging a first data object generated at a first node with metadata based on an environment of the first node, means for determining, the means for determining to identify a contextual data graph model associated with the metadata, determine a strength of association between the first data object and a second data object of the contextual data graph model, and in response to a determination that the strength of the association satisfies a threshold, update the contextual data graph model based on the strength of the association, and means for publishing the contextual data graph model in a shared datastore, the shared datastore to be accessible by a second node of the environment.

In Example 132, the subject matter of Example 131 can optionally include that the means for determining is to connect the first data object to the second data object with a vector in the contextual data graph model, determine an angle of the vector with respect to a reference axis, determine a length of the vector, and determine the strength of the association based on at least one of the angle or the length.

In Example 133, the subject matter of Examples 131-132 can optionally include that the contextual data graph model is a first contextual data graph model, and the means for determining is to generate the first contextual data graph model based on first data associated with the first node, generate a second contextual data graph model based on a sequence of events observed in a process of the environment, the process including a first operation to be executed by the first node, and generate a third contextual data graph model based on second data associated with the first data, and the means for publishing is to store at least one of the first contextual data graph model, the second contextual data graph model, or the third contextual data graph model at the first node.

In Example 134, the subject matter of Examples 131-133 can optionally include that the means for determining is to identify one or more correlations between at least one of the first contextual data graph model, the second contextual data graph model, or the third contextual data graph model, and update at least one of the first contextual data graph model, the second contextual data graph model, or the third contextual data graph model based on the one or more correlations.

In Example 135, the subject matter of Examples 131-134 can optionally include that the metadata is first metadata, and the means for determining is to identify a match of a first portion of the first metadata and a second portion of second metadata associated with the contextual data graph model, identify the contextual data graph model based on the match, and in response to the determination that the strength of the association satisfies the threshold, add the first portion of the first metadata to the contextual data graph model to update the contextual data graph model.

In Example 136, the subject matter of Examples 131-135 can optionally include that the contextual data graph model is a first contextual data graph model associated with the first node, the first node is at a first hop or a first level of the environment, the second node is at a second hop or a second level of the environment, and the means for determining is to identify a second contextual data graph model associated with the second node based on the metadata, identify one or more correlations between the first contextual data graph model and the second contextual data graph model, and update the second contextual data graph model based on the one or more correlations, and the means for publishing is to generate an alert to one or more third nodes in the environment in response to the update of the second contextual data graph model.

In Example 137, the subject matter of Examples 131-136 can optionally include that the first node is associated with a first process in the environment, the determination is a first determination, and the means for determining is to determine whether a portion of the first data object deviates from a baseline by a threshold, and in response to a second determination that the portion of the first data object deviates from the baseline by the threshold identify a second process in sequence with the first process based on the contextual data graph model, and identify the second node is associated with the second process based on the contextual data graph model, and the means for publishing to transmit an alert to the second node, the alert based on the portion of the first data object.

In Example 138, the subject matter of Examples 131-137 can optionally include means for receiving to receive an indication of an execution of a response or an adjustment in the second process in response to the alert, and provide the indication to a machine learning model to generate a machine learning output, and the means for determining is to update the contextual data graph model based on the machine learning output.

In Example 139, the subject matter of Examples 131-138 can optionally include that the first data object includes a first lexical term, the second data object includes a second lexical term, and wherein the means for determining to determine that the first lexical term has a similar meaning or context to the second lexical term based on the strength of the association satisfying the threshold, and the means for tagging is to, in response to receiving a request for the first data object add the second lexical term to the request, perform a search of the shared datastore using at least one of the first lexical term or the second lexical term, and output a result of the search, the result including at least one of the first data object or the second data object.

Example 140 includes a computer readable storage medium comprising instructions that, when executed, cause processor circuitry to at least tag a first data object at a first node with metadata based on an environment of the first node, identify a contextual data graph model associated with the metadata, determine a strength of association between the first data object and a second data object of the contextual data graph model, in response to a determination that the strength of the association satisfies a threshold, update the contextual data graph model based on the strength of the association, and persist the contextual data graph model in a shared datastore, the shared datastore to be accessible by a second node of the environment.

In Example 141, the subject matter of Example 140 can optionally include that the instructions, when executed, cause the processor circuitry to connect the first data object to the second data object with a vector in the contextual data graph model, determine an angle of the vector with respect to a reference axis, determine a length of the vector, and determine the strength of the association based on at least one of the angle or the length.

In Example 142, the subject matter of Examples 140-141 can optionally include that the contextual data graph model is a first contextual data graph model, and the instructions, when executed, cause the processor circuitry to generate the first contextual data graph model based on first data associated with the first node, generate a second contextual data graph model based on a sequence of events observed in a process of the environment, the process including a first operation to be executed by the first node, generate a third contextual data graph model based on second data associated with the first data, and store at least one of the first contextual data graph model, the second contextual data graph model, or the third contextual data graph model at the first node.

In Example 143, the subject matter of Examples 140-142 can optionally include that the instructions, when executed, cause the processor circuitry to identify one or more correlations between at least one of the first contextual data graph model, the second contextual data graph model, or the third contextual data graph model, and update at least one of the first contextual data graph model, the second contextual data graph model, or the third contextual data graph model based on the one or more correlations.

In Example 144, the subject matter of Examples 140-143 can optionally include that the metadata is first metadata, and the instructions, when executed, cause the processor circuitry to identify a match of a first portion of the first metadata and a second portion of second metadata associated with the contextual data graph model, identify the contextual data graph model based on the match, and in response to the determination that the strength of the association satisfies the threshold, add the first portion of the first metadata to the contextual data graph model to update the contextual data graph model.

In Example 145, the subject matter of Examples 140-144 can optionally include that the contextual data graph model is a first contextual data graph model associated with the first node, the first node is at a first hop or a first level of the environment, the second node is at a second hop or a second level of the environment, and the instructions, when executed, cause the processor circuitry to identify a second contextual data graph model associated with the second node based on the metadata, identify one or more correlations between the first contextual data graph model and the second contextual data graph model, update the second contextual data graph model based on the one or more correlations, and generate an alert to one or more third nodes in the environment in response to the update of the second contextual data graph model.

In Example 146, the subject matter of Examples 140-145 can optionally include that the first node is associated with a first process in the environment, the determination is a first determination, and the instructions, when executed, cause the processor circuitry to determine whether a portion of the first data object deviates from a baseline by a threshold, and in response to a second determination that the portion of the first data object deviates from the baseline by the threshold identify a second process in sequence with the first process based on the contextual data graph model, identify the second node is associated with the second process based on the contextual data graph model, and transmit an alert to the second node, the alert based on the portion of the first data object.

In Example 147, the subject matter of Examples 140-146 can optionally include that the instructions, when executed, cause the processor circuitry to receive an indication of an execution of a response or an adjustment in the second process in response to the alert, provide the indication to a machine learning model to generate a machine learning output, and update the contextual data graph model based on the machine learning output.

In Example 148, the subject matter of Examples 140-147 can optionally include that the first data object includes a first lexical term, the second data object includes a second lexical term, and the instructions, when executed, cause the processor circuitry to determine that the first lexical term has a similar meaning or context to the second lexical term based on the strength of the association satisfying the threshold, and in response to receiving a request for the first data object add the second lexical term to the request, perform a search of the shared datastore using at least one of the first lexical term or the second lexical term, and output a result of the search, the result including at least one of the first data object or the second data object.

Example 149 includes a method to identify data correlations in a network environment, the method comprising tagging a first data object generated at a first node with metadata based on an environment of the first node, identifying a contextual data graph model associated with the metadata, determining a strength of association between the first data object and a second data object of the contextual data graph model, in response to determining that the strength of the association satisfies a threshold, updating the contextual data graph model based on the strength of the association, and storing the contextual data graph model in a shared datastore, the shared datastore to be accessible by a second node of the environment.

In Example 150, the subject matter of Example 149 can optionally include connecting the first data object to the second data object with a vector in the contextual data graph model, determining an angle of the vector with respect to a reference axis, determining a length of the vector, and determining the strength of the association based on at least one of the angle or the length.

In Example 151, the subject matter of Examples 149-150 can optionally include that the contextual data graph model is a first contextual data graph model, and further include generating the first contextual data graph model based on first data associated with the first node, generating a second contextual data graph model based on a sequence of events observed in a process of the environment, the process including a first operation to be executed by the first node, generating a third contextual data graph model based on second data associated with the first data, and storing at least one of the first contextual data graph model, the second contextual data graph model, or the third contextual data graph model at the first node.

In Example 152, the subject matter of Examples 149-151 can optionally include identifying one or more correlations between at least one of the first contextual data graph model, the second contextual data graph model, or the third contextual data graph model, and updating at least one of the first contextual data graph model, the second contextual data graph model, or the third contextual data graph model based on the one or more correlations.

In Example 153, the subject matter of Examples 149-152 can optionally include that the metadata is first metadata, and further include identifying a match of a first portion of the first metadata and a second portion of second metadata associated with the contextual data graph model, identifying the contextual data graph model based on the match, and in response to the determination that the strength of the association satisfies the threshold, adding the first portion of the first metadata to the contextual data graph model to update the contextual data graph model.

In Example 154, the subject matter of Examples 149-153 can optionally include that the contextual data graph model is a first contextual data graph model associated with the first node, the first node is at a first hop or a first level of the environment, the second node is at a second hop or a second level of the environment, and further include identifying a second contextual data graph model associated with the second node based on the metadata, identifying one or more correlations between the first contextual data graph model and the second contextual data graph model, updating the second contextual data graph model based on the one or more correlations, and generating an alert to one or more third nodes in the environment in response to the update of the second contextual data graph model.

In Example 155, the subject matter of Examples 149-154 can optionally include that the first node is associated with a first process in the environment, and further include determining whether a portion of the first data object deviates from a baseline by a threshold, and in response to determining that the portion of the first data object deviates from the baseline by the threshold identifying a second process in sequence with the first process based on the contextual data graph model, identifying the second node is associated with the second process based on the contextual data graph model, and transmitting an alert to the second node, the alert based on the portion of the first data object.

In Example 156, the subject matter of Examples 149-155 can optionally include receiving an indication of an execution of a response or an adjustment in the second process in response to the alert, providing the indication to a machine learning model to generate a machine learning output, and updating the contextual data graph model based on the machine learning output.

In Example 157, the subject matter of Examples 149-156 can optionally include that the first data object includes a first lexical term, the second data object includes a second lexical term, and further include determining that the first lexical term has a similar meaning or context to the second lexical term based on the strength of the association satisfying the threshold, and in response to receiving a request for the first data object adding the second lexical term to the request, performing a search of the shared datastore using at least one of the first lexical term or the second lexical term, and outputting a result of the search, the result including at least one of the first data object or the second data object.

Example 158 is edge server processor circuitry to perform the method of any of Examples 149-157.

Example 159 is edge cloud processor circuitry to perform the method of any of Examples 149-157.

Example 160 is edge node processor circuitry to perform the method of any of Examples 149-157.

Example 161 is edge gateway processor circuitry to perform the method of any of Examples 149-157.

Example 162 is edge switch circuitry to perform the method of any of Examples 149-157.

Example 163 is an XPU to perform the method of any of Examples 149-157.

Example 164 is an Infrastructure Processing Unit to perform the method of any of Examples 149-157.

Example 165 is an apparatus comprising at least one of acceleration circuitry, one or more graphics processor units, one or more vision processor units, Artificial Intelligence processor circuitry, machine learning processor circuitry, neural network processor circuitry, one or more digital signal processors, one or more general purpose processors, or network interface circuitry to perform the method of any of Examples 149-157.

Example 166 is at least one computer readable medium comprising instructions to perform the method of any of Examples 149-157.

### Section F—Systems, Apparatus, Articles of Manufacture, and Methods for Data Routing Based on User Engagement

In some autonomous systems, different devices may act automatically and independently. However, it is sometimes imperative to surface some of the data to a user prior to acting. For example, which group of users to interrupt, when to interrupt a user, how to customize the urgency of the event to maximize response, whether other users should be disclosed the data, etc., are not trivial decisions. Some cases may be obvious such as when a failure has been detected, but in some cases, such as a prediction of a failure yet to occur or if the autonomous system has identified a chain of events that may lead to a failure based on prior history, are technically challenging. In addition, other cases might be increasingly challenging to resolve especially when the autonomous system is in a training phase (e.g., an Artificial Intelligence/Machine Learning (AI/ML) training phase) and a topic or domain expert could provide supervision that could improve the overall accuracy. Some prior recommender systems may contact users with data based on previous behavior of the users. However, some prior recommender systems may not contact the users based on a context of the data, the physicality of the data, or the escalation needed in a physical environment such as a smart city, a factory, a medical facility (e.g., a hospital), etc.

Examples disclosed herein can provide an infrastructure based on the ADM system 600 of FIG. 6 to determine an improved and/or otherwise optimal representation of data for a user. For example, a data routing manager can determine the improved and/or otherwise optimal representation through customization and creation of a network of subject matter experts and stakeholders to whom the data could be sent to for supervisory inputs, timeliness, addition of relevant information. In some examples, the data routing manager can determine that the data provides guidance on who or what (e.g., an application or service) the data should be routed based on a context and an urgency of the data itself.

In some examples, the data routing manager can create a data trail for each node containing which user is contacted and their response/relevance. In some examples, the data routing manager can use metadata to identify users to contact. In some examples, the data routing manager can use federated learning to exchange information and generation of topical users map highlighting experts/stakeholders connected to their metadata graph of contextual topics of relevance.

In some examples, as different nodes analyze data, a node may obtain some feedback if: the data it found needs action (e.g., a failure is predicted) or can benefit from expert input (e.g., potential anomalies in the data or previous history for similar data configuration that can be learned from the distributed data store). In some examples, the data routing manager can effectuate message scheduling for experts and sometimes users with authority to provide additional insights or take action. For example, interrupting users at the wrong time may result in them not paying attention, while waiting for too long would be problematic with time-sensitive information.

Examples disclosed herein utilize distributed/federated AI/ML techniques to determine an improved and/or otherwise best or optimal time and users to target with an item or piece of information. For example, presenting an alert to a user while the user is in the middle of a time-sensitive task can distract the task processing and lead to inaccurate results or can be completely ignored and the alert can lose its impact. An example of this may be a manufacturing process where an imminent failure alert would go to the appropriate supervisor and technician(s) to ensure that, if a shutdown is needed, it is executed at an optimal time with minimum cascade impact to adjacent processes and ensure safety of nearby humans. In some examples, on the flip side, even if the immediate failure on a single node is trivial but if multiple nodes are seeing a similar failure, the failures may have a bigger cascading impact. In some examples, the data routing manager can surface this alert from multiple nodes with urgency to bring the desired attention to avert the failure.

In some examples, as a message is generated, the data routing manager can assign the message a set of metadata such as which algorithm and/or analytics generated the message, node(s) associated with the metadata, type (e.g., an alarm, action, event, warning, etc.), physical location, priority, etc., and so on. In some examples, the data routing manager can use the metadata to create a potential ranked list of relevant users with a confidence score, a relevance score, and an authorization score for each user. In some examples, the data routing manager can effectuate the running of a federated search across multiple nodes for a match or substantial association to the metadata and available users. For example, going through a list, the data routing manager can attempt to interrupt a user with data. In some examples, if the user responds, then this user gets an updated relevancy score for the metadata. In some examples, if the user does not respond (or acknowledges that the data is not relevant to the user), then based on the priority of the message, the data routing manager may either wait and try again or target a different user. In some examples, the data routing manager can also collect data on the user responsiveness to be able to adapt the metadata accordingly to help the user's outreach leading to action. In some examples, the data routing manager can execute a clustering algorithm to rank a responsiveness of a user. In some examples, a user and their response(s) (positive, negative, or none) may be logged as part of the data provenance.

In some examples, such as autonomous factories or industrial environments, the data routing manager can use an authorization score to refine a user list so an interrupt can be crafted for specific authorized personnel or group of users for maximum attention. In some examples, in case a user is unresponsive or unavailable despite the authority ranking, the data routing manager can surface alerts to users with similar or relatively high authorization scores. By way of example, imagine out-of-pocket (OOP) coverage in an organization or environment. In some examples, the data routing manager can forward (e.g., automatically or proactively forward) an alert to the coverage or, if unavailable, use info from the past (e.g., historical data, actions, events, etc.) to forward the alert to other users. In some examples, the data routing manager can invoke AI/ML techniques to continuously learn and update a relevance score and an authorization score for respective users to automatically and/or otherwise proactively craft these alerts for specific users and route these alerts to the appropriate users.

In some examples, the data routing manager instantiated by and/or otherwise executing on a first node (N1) may generate a message with a set of metadata <Ml, . . . Mx>. The example data routing manager of N1 can query its own resources to identify user(s) as well as query neighboring nodes by requesting a list of user(s) based on the set of metadata. In some examples, each node may give back N1 a ranked list of users. In some examples, N1 may aggregate the lists to create a primary list (e.g., a main list, a controlling list, etc.). As used herein, the term “primary list” is a collected list of everything that falls into a particular category, spectrum, etc. For example, the primary list may be a list of all lists. In some examples, the primary list may be consulted as a ground truth or baseline from which other lists may be generated. In some examples, the primary list may be compilation of everything that falls into the particular category, spectrum, etc., or may form an index of everything that falls into the particular category, spectrum, etc. In some examples, as the data routing manager of N1 contacts the users, N1 may update its own relevance scores for each of the user(s) based on continuous AI/ML learning. In some examples, the data routing manager of N1 may use in an AI/ML model any information N1 knows on the current status of the user (e.g., based on sensor data from a sensor such as a video camera or from login credentials at an electronic terminal), when the user was last pinged successfully, and/or previous behavior of the user, which can include expertise or subject domain knowledge.

In some examples, as other nodes contact N1 in the future (e.g., by providing metadata), the data routing manager of N1 may use that information to rank the relevance and availability of a user associated with N1 (or a different node). In some examples, the data trail may stay at Node N1, but a data routing manager on a different node may use the information in a federated learning fashion to provide other nodes with a list of recommended users.

In some examples, the data routing manager can transform a data object as the data object moves from node to node (e.g., from user-to-user, application-to-application, service-to-service, etc.). For example, the data routing manager can transform the data object to generate an augmented data object, which can be used to improve the impact and prioritization of key points and/or facets of that data based on a user to whom the augmented data object is being presented. As the data object moves from one node to another, the data routing manager of the receiving node can apply local node customization data to the data object to effect augmentation or change to the data object and to improve a contextual relevance of the data object and add information to convey urgency or impact (e.g., adverse impact to downstream processes if this data object is ignored).

In some examples, the data routing manager as described herein may continually train a machine learning model (e.g., an AI/ML model) in various ways. One such way can include the data routing manager applying cause/effect and actions/reactions associated with data routing in a network environment to AI/ML models (e.g., neural networks or other AI/ML models), refining data graphs, identifying hotspots of experts and/or stakeholders (e.g., environment or organizational stakeholders), improving context of data to individual users/applications, and/or storing the AI/ML models in the local node customization datasets. In some examples, the data routing manager can continually train the machine learning model by tracking data object traffic on a macro level to create a map of the larger network and hotspots of “expert nodes”—people or applications that may directly address data object issues and typically are creators of content—and/or “stakeholder nodes”—people or applications that may be directly or indirectly impacted by the data object with respect to action or inaction taken and consume the data as a trigger to initiating a different event.

In some examples, the data routing manager can consider various parameters for the AI/ML model training such as why other users and/or teams dismissed the data (e.g., resource constraint, charter and ownership, context, etc.). In some examples, the data routing manager can execute the AI/ML models with model inputs to generate model outputs, which can include a reorganization and/or restatement of information to increase relevancy to the users and/or teams who otherwise ignored the information they subscribed to. For example, the data routing manager can execute the AI/ML models to implement an intelligent gossip protocol/filter to “see” how data objects are moved from one group of nodes to another in an effort to identify additional relevant experts and stakeholders.

In some examples, the data routing manager can execute the AI/ML models to determine a user/team/etc., having a specified priority (e.g., a first priority, a second priority, etc.) by watching, intercepting, inspecting, etc., traffic of the data object. In some examples, the data routing manager can determine if there is a nexus or central node which other nodes, uniformly, communicate these types of data object to—presumably to have the nexus take action or make a decision—to determine the priority. In some examples, the data routing manager can determine and/or otherwise identify an existence of a stratification of nodes and super nodes that points to a hierarchy of how information and decisions may be made in a network and, also, potentially highlighting how and where improvements may be made to improve efficiency of data routing in the network.

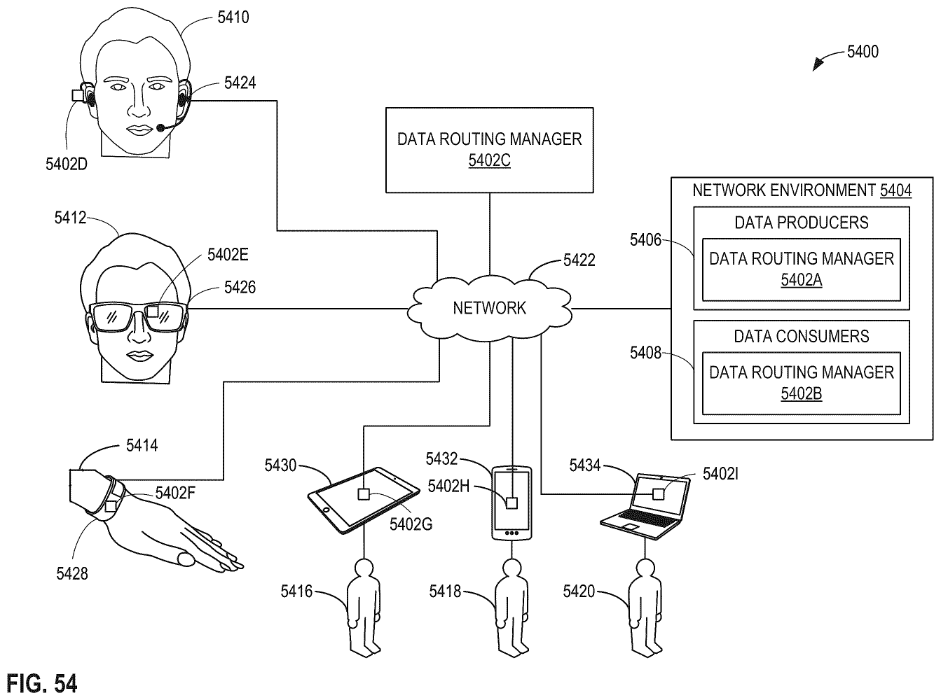

Turning to the figures, the illustrated example of FIG. 54 is a block diagram of an example data routing management system 5400 including an example data routing manager 5402A-I to implement proactive and/or otherwise adaptive data routing in a network environment, which can be implemented by an example network environment 5404. In some examples, the network environment 5404 can be implemented by one of the computational use cases 205 of FIG. 2. For example, the network environment 5404 can be implemented by a manufacturing plant, a healthcare facility (e.g., a hospital), a smart building, a smart city, a transportation logistics system, a retail store, etc. The network environment 5404 of the illustrated example includes example data producers 5406 and example data consumers 5408. In some examples, the data producers 5406 can be implemented using one(s) of the data sources 160 of FIG. 1. For example, the data producers 5406 can be implemented using a sensor, a vehicle, a mobile or handheld electronic device (e.g., a smartphone, a tablet computer, etc.), an IoT device, etc. In some examples, the data consumers 5408 can be implemented using one(s) of the central office 120, the cloud data center 130, the access point or base station 140, the local processing hub 150, etc., of FIG. 1, the nodes 215, the local network equipment 225, the core network data center 235, the cloud data center 245, etc., or any other type of electronic device such as a server, an IPU, etc.

The data producers 5406 include a first example data routing manager 5402A and the data consumers 5408 include a second example data routing manager 5402B. A third example data routing manager 5402C, a fourth example data routing manager 5402D, a fifth example data routing manager 5402E, a sixth example data routing manager 5402F, a seventh example data routing manager 5402G, an eighth example data routing manager 5402H, and a ninth example data routing manager 5402I are also depicted in the illustrated example. The first through ninth data routing managers 5402A-I are collectively referred to as the data routing manager 5402A-I. For example, each of the data routing managers 5402A-I can have the same functionality. In some examples, one(s) of the data routing managers 5402A-I can have first functionality that is the same across the data routing managers 5402A-I and second functionality that is different from other one(s) of the data routing managers 5402A-I.

In example operation, the data producers 5406 can generate and/or otherwise produce data for consumption by the data consumers 5408. For example, the data producers 5406 can generate data, which can include one or more data objects and/or associated metadata. As used herein, data is information in any form that may be ingested, processed, interpreted and/or otherwise manipulated by processor circuitry to produce a result. The produced result may itself be data. In some examples, the data producers 5406 can generate data formatted as an Internet message (e.g., a HyperText Transfer Protocol (HTTP) message. However, the data producers 5406 can generate data based on any other message format and/or protocol such as, for example, a file transfer protocol (FTP), a simple message transfer protocol (SMTP), an HTTP secure (HTTPS) protocol, an Information-centric networking protocol/format/scheme, etc.

In example operation, the data routing manager 5402A-I can route data generated by the data producers 5406 to example users 5410, 5412, 5414, 5416, 5418, 5420 by way of an example network 5422. The network 5422 of the illustrated example is the Internet. However, the network 5422 may be implemented using any suitable wired and/or wireless network(s) including, for example, one or more data buses, one or more Local Area Networks (LANs), one or more wireless LANs (WLANs), one or more cellular networks, one or more satellite networks, one or more private networks, one or more public networks, etc. In some examples, one(s) of the users 5410, 5412, 5414, 5416, 5418, 5420 can be associated with a node (e.g., a logical node or entity) of the data routing management system 5400.

The network 5422 enables the data routing manager 5402A-I to be in communication with one(s) of the users 5410, 5412, 5414, 5416, 5418, 5420 by way of a respective example electronic device 5424, 5426, 5428, 5430, 5432, 5434. The users 5410, 5412, 5414, 5416, 5418, 5420 are associated with the network environment 5404. For example, the users 5410, 5412, 5414, 5416, 5418, 5420 can be supervisors and/or technicians in a manufacturing plant of factory, medical personnel (e.g., a doctor, nurse, orderly, administrator, maintenance personnel, etc.) in a healthcare facility, office workers (e.g., engineers and/or project managers in a technology company, accountants and/or lawyers in an accounting or consulting firm, etc.) in an office or commercial building, etc. The users 5410, 5412, 5414, 5416, 5418, 5420 include a first example user 5410, a second example user 5412, a third example user 5414, a fourth example user 5416, a fifth example user 5418, and a sixth example user 5420.

The electronic devices 5424, 5426, 5428, 5430, 5432, 5434 include a first example electronic device 5424, a second example electronic device 5426, a third example electronic device 5428, a fourth example electronic device 5430, a fifth example electronic device 5432, and a sixth example electronic device 5434. In this example, the first electronic device 5424 is a headset electronic device associated with the first user 5410. The second electronic device 5426 are smart glasses (or a headset or headset display, an augmented reality (AR) headset, a virtual reality (VR) headset, etc.) associated with the second user 5412. The third electronic device 5428 is a smartwatch (or other type of wearable device such as a smart band or smart wristband, a fitness tracker, etc.) associated with the third user 5414. The fourth electronic device 5430 is a tablet computer associated with the fourth user 5416. The fifth electronic device 5432 is a handheld mobile device (e.g., a smartphone) associated with the fifth user 5418. The sixth electronic device 5434 is a laptop computer (or a desktop computer) associated with the sixth user 5420. A different quantity and/or different type(s) of electronic device(s) may additionally and/or alternatively be included in the data routing management system 5400.

In the illustrated example, the data routing manager 5402A-I can be executed and/or instantiated by respective ones of the data producers 5406, the data consumers 5408, and the electronic devices 5424, 5426, 5428, 5430, 5432, 5434. For example, the fourth electronic device 5430 can execute and/or instantiate the seventh data routing manager 5402G on the fourth electronic device 5430. In some examples, one(s) of the electronic devices 5424, 5426, 5428, 5430, 5432, 5434 can execute and/or instantiate portion(s) of the data routing manager 5402A-I. In some examples, the data routing manager 5402A-I can be implemented using hardware, software (e.g., one or more software applications, one or more services, etc.), and/or firmware. The third data routing manager 5402C can be executed and/or instantiated by a central node. For example, the third data routing manager 5402C can be executed and/or instantiated by processor circuitry separate from the data producers 5406, the data consumers 5408, and the electronic devices 5424, 5426, 5428, 5430, 5432, 5434.

In example operation, the data producers 5406 and/or one(s) of the electronic devices 5424, 5426, 5428, 5430, 5432, 5434 can generate data associated with the network environment 5404. For example, one(s) of the data producers 5406 can generate data associated with a completion and/or operation of a vehicle manufacturing stage (e.g., assembling a vehicle door, painting a vehicle body, etc.). In some examples, the one(s) of the data producers 5406 can transmit the data to one(s) of the electronic devices 5424, 5426, 5428, 5430, 5432, 5434. For example, the first data routing manager 5402A can transmit the data to the second electronic device 5426 by way of the network 5422. The following description is in connection with the first data routing manager 5402A of the data producers 5406 (e.g., one or more of the data producers 5406), but is applicable to any other one(s) of the data routing manager 5402A-I.

In example operation, the first data routing manager 5402A can determine that the data is to be published and/or propagated to other one(s) of the users 5410, 5412, 5414, 5416, 5418, 5420. In some examples, the first data routing manager 5402A can generate a list of the users 5410, 5412, 5414, 5416, 5418, 5420 associated with a first node of the data routing management system 5400. In some examples, the first data routing manager 5402A can query one or more second nodes (e.g., neighboring nodes) for their respective lists of users. In some examples, the first data routing manager 5402A can generate a list (e.g., a primary list) of first user(s) (e.g., one(s) of the users 5410, 5412, 5414, 5416, 5418, 5420 associated with the first node) and/or second user(s) (e.g., users associated with the one or more neighboring nodes).

In example operation, the first data routing manager 5402A can execute an AI/ML model (e.g., a classification model, a neural network model, etc.) with the data as model input(s) to generate model output(s), which can include a relevancy score for respective one(s) of the first user(s) and/or the second user(s). For example, the relevancy score can refer to a representation of a relevancy or strength of association of data, or portion(s) thereof, with a user and/or metadata associated with the user. In some examples, the first data routing manager 5402A can identify one(s) of the first user(s) and/or the second user(s) whose relevancy score satisfies a threshold (e.g., a relevancy score threshold). In some examples, the first data routing manager 5402A can deliver, provide, and/or otherwise transmit a data message including the data (or portion(s) thereof) and associated metadata to the one(s) of the first user(s) and/or the second user(s) whose relevancy score satisfies the threshold.

Advantageously, the first data routing manager 5402A can surface the data message, which can implement an alert or urgent notification, to appropriate one(s) of the users 5410, 5412, 5414, 5416, 5418, 5420 to ensure an appropriate action is executed to address and/or otherwise mitigate the alert or the urgent notification. Advantageously, the first data routing manager 5402A can continuously learn (e.g., by retraining the AI/ML model) which one(s) of the users 5410, 5412, 5414, 5416, 5418, 5420 is/are associated with different types of data. For example, the first data routing manager 5402A can update (e.g., add, remove, modify, etc.) metadata associated with user(s) who respond and/or user(s) who do not respond to the data message to improve future routing of data to the appropriate and/or necessary user. In some examples, the first data routing manager 5402A can propagate the metadata to one(s) of the data consumers 5408, one(s) of the electronic devices 5424, 5426, 5428, 5430, 5432, 5434, etc., to improve their respective learning associated with future routing of data in the data routing management system 5400.

FIG. 55 is a block diagram of example data routing management circuitry 5500. In some examples, the data routing management circuitry 5500 can implement the data routing manager 5402 of FIG. 54 and/or portion(s) of the ADM system 600 of FIG. 6. The data routing management circuitry 5500 of FIG. 55 may be instantiated (e.g., creating an instance of, bring into being for any length of time, materialize, implement, etc.) by processor circuitry such as a central processing unit executing instructions. Additionally or alternatively, the data routing management circuitry 5500 of FIG. 55 may be instantiated (e.g., creating an instance of, bring into being for any length of time, materialize, implement, etc.) by an ASIC or an FPGA structured to perform operations corresponding to the instructions. It should be understood that some or all of the data routing management circuitry 5500 of FIG. 55 may, thus, be instantiated at the same or different times. Some or all of the data routing management circuitry 5500 may be instantiated, for example, in one or more threads executing concurrently on hardware and/or in series on hardware. Moreover, in some examples, some or all of the data routing management circuitry 5500 of FIG. 55 may be implemented by one or more VMs and/or containers executing on the processor circuitry.

The data routing management circuitry 5500 of the illustrated example includes example data ingestion circuitry 5510, example machine learning circuitry 5520, example data query management circuitry 5530, example node management circuitry 5540, example data publishing circuitry 5550, an example datastore 5560, and an example bus 5580. The datastore 5560 of the illustrated example includes example raw data 5562, example metadata 5564, example users 5566, example nodes 5568, and an example machine learning model 5570. In the illustrated example, the data ingestion circuitry 5510, the machine learning circuitry 5520, the data query management circuitry 5530, the node management circuitry 5540, the data publishing circuitry 5550, and the example datastore 5560 are in communication with one(s) of each other by way of the bus 5580. For example, the bus 5580 can be implemented using at least one of an I2C bus, a SPI bus, a PCI bus, or a PCIe or PCIE bus. Additionally or alternatively, the bus 5580 can be implemented by any other type of computing or electrical bus. In some examples, the bus 5580 can implement the data plane 628, the control plane 630, and/or, more generally, the network plane 626 of FIG. 6, or portion(s) thereof.

The data routing management circuitry 5500 of the illustrated example includes the data ingestion circuitry 5510 to receive data (e.g., one or more messages), determine whether new data is received and/or otherwise ready to be ingested, etc. In some examples, the data ingestion circuitry 5510 can implement the data ingestion manager 606 of FIG. 6, or portion(s) thereof. In some examples, the data ingestion circuitry 5510 extracts data object(s) from data, message(s), etc., and/or pre-processes the data object(s). For example, the data ingestion circuitry 5510 can determine whether a message is associated with a user. In some examples, the data ingestion circuitry 5510 can determine whether the message indicates that the user initiated an action in response to receiving a different message. In some examples, the data ingestion circuitry 5510 can determine whether a user acknowledged that a portion of a data object (e.g., an augmented data object) is relevant to a user. For example, the second user 5412 can receive a message, which includes an augmented and/or otherwise modified data object. In some examples, the second user 5412 can generate a message (e.g., by using the second electronic device 5426) that indicates that one or more portions of the augmented data object is relevant to the user 5412 and/or one or more portions of the augmented data object are not relevant to the user 5412. In some examples, the data ingestion circuitry 5510 can determine whether a received message is indicative of a user affirming a relevancy, an association, etc., of a message that was presented to the user.

In some examples, the data ingestion circuitry 5510 can receive and/or otherwise ingest sensor and/or location data. For example, the data ingestion circuitry 5510 can receive video data from a video camera, a beacon signal from a radio frequency identification device (RFID) terminal, a use of login credentials at an electronic terminal (e.g., a laptop computer, a desktop computer, a control station, etc.), etc. In some examples, the data ingestion circuitry 5510 can determine whether a location of a user changed based on the ingested sensor and/or location data. For example, the data ingestion circuitry 5510 can receive first sensor data that locates the first user 5410 in a first location at a first time and receive second sensor data that locates the first user 5410 in a second location at a second time after the first time.

The data routing management circuitry 5500 of the illustrated example includes the machine learning circuitry 5520 to execute a machine learning model (e.g., the machine learning model 5570) to generate output(s) (e.g., model output(s)), which can include an authorization score, a confidence score, and/or a relevancy score associated with a user. In some examples, the machine learning circuitry 5520 can implement the algorithms 638, and/or, more generally, the analytics manager 636 of FIG. 6, or portion(s) thereof. In some examples, the machine learning circuitry 5520 instantiates and/or executes a machine learning microservice to generate machine learning output(s) based on machine learning input(s).

In some examples, the machine learning circuitry 5520 instantiates and/or executes a machine learning microservice to generate the machine learning model 5570 based on data associated with an environment, such as the network environment 5404. In some examples, the machine learning circuitry 5520 executes the machine learning model 5570 to generate data graphs corresponding to respective portions of the environment. In some examples, the machine learning circuitry 5520 executes the machine learning model 5570 to identify hotspots of at least one of expert nodes or stakeholder nodes.

In some examples, the machine learning model 5570 updates metadata associated with response(s) and/or non-response(s) by user(s) to data traffic (e.g., one or more messages). In some examples, the machine learning model 5570 updates metadata associated with cause(s) of action(s) and effect(s) of the action(s) based on the data traffic. In some examples, the machine learning model 5570 updates at least one of the data graphs or the hotspots based on a routing of the data traffic. In some examples, the machine learning model 5570 identifies a stratification of nodes and super nodes based on the routing of the data traffic. In some examples, the machine learning model 5570 retrains the machine learning model 5570 based on at least one of the update(s) or other data, which can include activity information, sensor data, etc.

As used herein, the term “authorization score” refers to a value that represents a likelihood or probability that a user has access (e.g., is authorized to access) to specific data. For example, an authorization score for a user can be based on an organization structure to which the user belongs. In some examples, the authorization score can be based on organizational data associated with the user, which can include a name, a job description or role, technical expertise or knowledge, a level of organizational seniority, a level of an organization hierarchy to which the user belongs (e.g., a manager that the user reports to, direct report(s) of the user or those that report to the user, etc.), security credentials, and the like.

As used herein, the term “confidence score” refers to a likelihood or probability that an output from the machine learning model 5570 is accurate, appropriate, and/or otherwise useful. In some examples, the confidence score can refer to a representation of accuracy or a level of error of the machine learning model 5570. For example, the machine learning model 5570 can generate an output, which can be an identification of the first user 5410 as being associated with data, and a corresponding confidence score. In some examples, the machine learning model 5570 can generate a confidence score of 0.8, which can be representative of an 80% likelihood that the data is relevant to the first user 5410.

As used herein, the term “relevancy score” refers to a value that represents a likelihood or probability that data, or portion(s) thereof, is relevant to a user. In some examples, the relevancy score can refer to a representation of a relevancy or strength of association of data, or portion(s) thereof, with a user and/or metadata associated with the user.

In some examples, the machine learning circuitry 5520 can determine whether the authorizations score, the confidence score, and/or the relevancy score satisfies a respective one of a first threshold (e.g., an authorization score threshold), a second threshold (e.g., a confidence score threshold), or a third threshold (e.g., a relevancy score threshold). In some examples, the machine learning circuitry 5520 can update metadata associated with a user, such as the first user 5410, in response to a determination whether the user responded to a message or did not respond to the message. For example, the machine learning circuitry 5520 can determine that the first user 5410 may find a message relevant because first metadata associated with the first user 5410 can be associated with second metadata associated with the message. In some examples, in response to the first user 5410 ignoring and/or otherwise not responding to the message, the machine learning circuitry 5520 can penalize the first metadata by reducing a relevancy score corresponding to the first metadata, removing portion(s) of the first metadata that matched and/or otherwise corresponded to the second metadata, and/or any combination(s) thereof. In some examples, the machine learning circuitry 5520 can penalize the first metadata in response to the first user 5410 responding to the message by acknowledging that one or more portions of the message are not relevant to the first user 5410. In some examples, in response to the first user 5410 responding to the message by performing an action in connection with the message, acknowledging that the message is relevant to the first user 5410, etc., the machine learning circuitry 5520 can reward the first metadata. For example, the machine learning circuitry 5520 can reward the first metadata by increasing a relevancy score corresponding to the first metadata. In some examples, by increasing the relevancy score of the first metadata, future or subsequent messages that have metadata corresponding to the first metadata may be prioritized to be routed to the first user 5410.

In some examples, the machine learning circuitry 5520 penalizes metadata associated with a non-responsive user based on a level of busyness or lack of availability of the non-responsive user based on activity information (e.g., electronic activity information), sensor data, etc. For example, the fourth user 5416 can receive a message associated with an event (e.g., a manufacturing operation has been completed, halted due to a failure or fault, etc.) in the network environment 5404 and the fourth user 5416 may ignore the message. In some examples, the machine learning circuitry 5520 can analyze sensor data associated with the first user 5410. For example, the machine learning circuitry 5520 can determine, based on video data that includes the fourth user 5416, that the fourth user 5416 picked up the fourth electronic device 5430 at approximately the time the message is transmitted to the fourth electronic device 5430, but the fourth user 5416 did not acknowledge the message or respond to the message. In some examples, the machine learning circuitry 5520 can penalize the metadata associated with the fourth user 5416 because the fourth user 5416 appeared to not find the message relevant. By way of another example, the machine learning circuitry 5520 can determine, based on utilization data of the fourth electronic device 5430, that the fourth user 5416 ignored the message because the fourth user 5416 is executing a time-sensitive task (e.g., a time-sensitive task indicated by increased levels of applications or services in operation, increased levels of computational, storage, or memory resources indicative of heavy utilization, etc.). In some examples, the machine learning circuitry 5520 may not penalize the metadata associated with the fourth user 5416 because the fourth user 5416 is identified as busy or not available to respond to the message. In some examples, the machine learning circuitry 5520 can determine that the message is to be presented to the fourth user 5416 again in response to determining that the fourth user 5416 completed the time-sensitive task.

By way of example, if a user dismisses a message, then the machine learning circuitry 5520 can generate an updated relevancy score that penalizes the metadata that matched this user to the message. The machine learning circuitry 5520 can determine how much to penalize by attempting to quantify how busy is this user at that point in time. The machine learning circuitry 5520 can determine a level of busyness using sensors (e.g., a video camera) in the network environment 5404, behavior on all electronic devices that the user can engage with, and, if approved, biometric sensors that are embedded in wearable devices that the user can engage with such as smartwatches, smart glasses, etc. Examples of collected data can include gaze (e.g., using a laptop camera), heart rate from a smartwatch, and emotional status from a video camera in the network environment 5404. In some examples, the machine learning circuitry 5520 can generate and maintain a baseline for each user to determine a deviation from the baseline. For example, the deviation can be interpreted as an increase in busyness of the user, a distraction level of the user, a level of engagement of the user with an electronic device or other type of machinery or equipment in the network environment 5404, etc.

In some examples, the machine learning circuitry 5520 determines to update a relevancy score of a location associated with a user based on sensor data. For example, the machine learning circuitry 5520 can increase a relevancy score of a location for a user in response to determining that the user is at the location. In some examples, the machine learning circuitry 5520 can decrease a relevancy score of a location for a user in response to determining that the user is not at the location or has not been at the location longer than a specified time duration.

In some examples, the machine learning circuitry 5520 determines that data received at a node indicates that an action is required by a user. For example, the machine learning circuitry 5520 can determine that data indicates a message is to be provided to a user based on the context and/or content of the data. In some examples, the machine learning circuitry 5520 can determine that the message is to be an alert that requires immediate attention (e.g., to avert, avoid, and/or mitigate a potential or predicted failure).

In some examples, the machine learning circuitry 5520 determines that data received at a node indicates that feedback is requested from one or more users (e.g., technical or subject matter experts, management personnel, technicians, financial or other administrative personnel, etc.). In some examples, the machine learning circuitry 5520 can update metadata associated with the one or more users based on received feedback.

In some examples, the machine learning circuitry 5520 can determine that a user acknowledged that a first portion of a data object (e.g., an augmented data object) is relevant to a user and a second portion of the data object is not relevant to the user. In some examples, the machine learning circuitry 5520 can modify metadata associated with the user to associate the first portion with the user and disassociate the second portion from the user.

In some examples, the machine learning circuitry 5520 can determine to increase a relevancy score of a topic associated with a user in response to the user responding to a message having the topic. In some examples, the machine learning circuitry 5520 can determine to decrease a relevancy score of a topic associated with a user in response to the user ignoring a message having the topic. In some examples, the machine learning circuitry 5520 can determine whether a relevancy score of a topic associated with a user satisfies a threshold. For example, in response to determining that the topic relevancy score is greater than the threshold, the user may be identified as an expert, a stakeholder, etc., in connection with the topic.

The data routing management circuitry 5500 of the illustrated example includes the data query management circuitry 5530 to generate a message with metadata based on data received at a first node. For example, in response to an ingestion of data, the data query management circuitry 5530 can determine to generate a message based on the data. In some examples, the data query management circuitry 5530 can generate the message by embedding and/or otherwise including the metadata 5564 in the message. In some examples, the data query management circuitry 5530 can implement the data query handler 612, the data cache cluster manager 614, the metadata cluster manager 616, and/or, more generally, the data query manager 610 of FIG. 6, or portion(s) thereof.

In some examples, the data query management circuitry 5530 generates the message to solicit feedback from a user. In some examples, the data query management circuitry 5530 generates the message to solicit an action from a user. In some examples, the data query management circuitry 5530 determines whether another message is to be generated.

In some examples, the data query management circuitry 5530 requests data to process, such as sensor data from a data producer, activity information associated with one(s) of the electronic devices 5424, 5426, 5428, 5430, 5432, 5434, etc. For example, the data query management circuitry 5530 can request and/or otherwise retrieve the raw data 5562, or portion(s) thereof, to process.

In some examples, the data query management circuitry 5530 applies local node customization data to a data object to generate an augmented data object. For example, the local node customization data can be based on the metadata 5564 associated with a user. In some examples, the local node customization data can include a technique of data presentation (e.g., a text-based message, a graphic based message, an auditory or verbal message via a speaker, etc.), an amount of data to convey (e.g., present a portion of data rather than an entirety of the data), a time at which to present data to a user and/or interrupt the user, etc., and/or any combination(s) thereof.

In some examples, the data query management circuitry 5530 determines whether to age ingested data. For example, the data query management circuitry 5530 can determine whether there is a difference between first data to be included in a message and second data stored in the raw data 5562. In some examples, the data query management circuitry 5530 can determine to age the second data in response to determining that the difference does not satisfy a threshold because the first data and the second data are the same or substantially similar. For example, the data query management circuitry 5530 can age the second data by deleting or removing the second data from the raw data 5562, moving the second data to a lower level of storage (e.g., from cache storage to mass storage), reducing a level of redundancy of the second data (e.g., remove the second data from one or more storage discs or devices), etc., and/or any combination(s) thereof.

The data routing management circuitry 5500 of the illustrated example includes the node management circuitry 5540 to generate a list of users of which to provide a message based on relevancy of the data to one(s) of the list. In some examples, the node management circuitry 5540 can implement the node manager 622 of FIG. 6, or portion(s) thereof.

In some examples, the node management circuitry 5540 can generate the list of users based on user(s) associated with a first node or one or more second nodes. For example, the node management circuitry 5540 can compile a list of users based on first user(s) associated with a first one of the data producers 5406 (and/or a first one of the data consumers 5408) and second user(s) associated with a second one of the data producers 5406 (and/or a second one of the data consumers 5408). In some examples, the node management circuitry 5540 ranks the list based on a relevancy score of respective ones of the list. In some examples, the node management circuitry 5540 identifies a set of users of the list as having a relevancy score that satisfies a threshold. For example, the node management circuitry 5540 can select a user in the list to process. The node management circuitry 5540 can determine whether a relevancy score associated with the user for a particular data item is greater than a threshold. In response to determining that the relevancy score is greater than the threshold (and thereby satisfies the threshold in this example), the node management circuitry 5540 can identify the user as likely finding the specific data item relevant to the user. In some examples, the node management circuitry 5540 identifies a user as an expert associated with a topic in response to determining that a relevancy score for the user in connection with the topic satisfies a threshold (e.g., a relevancy score threshold, a topic relevancy score threshold, etc.).

The data routing management circuitry 5500 of the illustrated example includes the data publishing circuitry 5550 to publish a message for presentation to a user. In some examples, the data publishing circuitry 5550 can publish the message to one or more data subscribers, consumers, etc. In some examples, the data publishing circuitry 5550 can implement the scheduler 620, and/or, more generally, the data publishing manager 618 of FIG. 6, or portion(s) thereof.

In some examples, the data publishing circuitry 5550 queries neighboring nodes to a local node for user(s) associated with metadata. For example, a neighboring node can inform the data ingestion circuitry 5510 that the first user 5410 is associated with the metadata. In some examples, the data publishing circuitry 5550 can deliver the message to the first user 5410 via the network 5422. In some examples, the data publishing circuitry 5550 can publish a message that references or points to portion(s) of the raw data 5562 to the network 5422. In some examples, the message, when received by the fourth data routing manager 5402D, can cause the fourth data routing manager 5402D to determine that the raw data 5562 is relevant to the first user 5410. In response to the determination, the fourth data routing manager 5402D can retrieve (or request to retrieve) the referenced portion(s) of the raw data 5562 for presentation to the first user 5410.

In some examples, the data publishing circuitry 5550 delivers a message, which includes portion(s) of the metadata 5564, to a set of users. In some examples, the data publishing circuitry 5550 delivers the message, which can include an augmented data object, to a user to cause a presentation of the augmented data object to the user. In some examples, the data publishing circuitry 5550 provides updated portion(s) of the metadata 5564 to one or more neighboring or associated nodes.

The data routing management circuitry 5500 of the illustrated example includes the datastore 5560 to record data, such as the raw data 5562, the metadata 5564, the users 5566, the nodes 5568, and the machine learning model 5570. In some examples, the datastore 5560 can implement the metadata datastore 646, the raw datastore 648, and/or, more generally, the distributed datastore 644 of FIG. 6, or portion(s) thereof.

In some examples, the raw data 5562 is raw and/or otherwise unprocessed data. In some examples, the raw data 5562 can be sensor data, location data, activity information, electronic device utilization data, etc. In some examples, the metadata 5564 is data that provides information about one or more aspects of other data. For example, the metadata 5564 can include descriptive information associated with the raw data 5562, the users 5566, the nodes 5568, etc., and/or any combination(s) thereof. In some examples, the users 5566 are implemented using data that describes, represents, and/or otherwise corresponds to the users 5410, 5412, 5414, 5416, 5418, 5420 of FIG. 54. For example, the users 5566 can be implemented with user data, such as user data corresponding to the first user 5410, which can include a name, a job description or role, technical expertise or knowledge, a level of organizational seniority, a level of an organization hierarchy to which the user belongs (e.g., a manager that the user reports to, direct report(s) of the user or those that report to the user, etc.), security credentials, and the like. In some examples, the nodes 5568 are implemented using data that describes, represents, and/or otherwise corresponds to nodes of the network environment 5404. For example, the nodes 5568 can be implemented using node data, which can include identification(s) of user(s) of the node, identification(s) of electronic device(s) of the node, electronic device information (e.g., an Internet Protocol (IP) address, a Media Access Control (MAC) number, quantity and/or type of hardware resource of the electronic device, a version of firmware and/or software of the electronic device, etc.), etc., and/or any combination(s) thereof. In some examples, the machine learning model 5570 is a neural network. Additionally and/or alternatively, the machine learning model 5570 may be implemented using any other type of AI/ML model described herein.

The datastore 5560 of the illustrated example can be implemented by one or more volatile memories (e.g., an SDRAM), DRAM, RDRAM, etc.), one or more non-volatile memories (e.g., flash memory), and/or any combination(s) thereof. The datastore 5560 may additionally or alternatively be implemented by one or more DDR memories, such as DDR, DDR2, DDR3, DDR4, DDR5, mDDR, etc. The datastore 5560 may additionally or alternatively be implemented by one or more mass storage devices such as HDD(s), CD drive(s), DVD drive(s), SSD drive(s), etc. While in the illustrated example the datastore 5560 is illustrated as a single datastore, the datastore 5560 may be implemented by any number and/or type(s) of datastores. Furthermore, the data stored in the datastore 5560 may be in any data format such as, for example, binary data, comma delimited data, tab delimited data, SQL structures, a table, a map, a graph (e.g., a data graph, a graph data structure, etc.), a grid, a packet, a datagram, a frame, a file, an e-mail, a message, a document, a report, a list, etc. In some examples, the datastore 5560 can implement one or more databases.

While an example manner of implementing the data routing manager 5402A-I of FIG. 54 is illustrated in FIG. 55, one or more of the elements, processes, and/or devices illustrated in FIG. 55 may be combined, divided, re-arranged, omitted, eliminated, and/or implemented in any other way. Further, the example data ingestion circuitry 5510, the example machine learning circuitry 5520, the example data query management circuitry 5530, the example node management circuitry 5540, the example data publishing circuitry 5550, the example datastore 5560, the example raw data 5562, the example metadata 5564, the example users 5566, the example nodes 5568, the example machine learning model 5570, the example bus 5580, and/or, more generally, the example data routing manager 5402A-I of FIG. 54, may be implemented by hardware alone or by hardware in combination with software and/or firmware. Thus, for example, any of the example data ingestion circuitry 5510, the example machine learning circuitry 5520, the example data query management circuitry 5530, the example node management circuitry 5540, the example data publishing circuitry 5550, the example datastore 5560, the example raw data 5562, the example metadata 5564, the example users 5566, the example nodes 5568, the example machine learning model 5570, the example bus 5580, and/or, more generally, the example data routing manager 5402A-I, could be implemented by processor circuitry, analog circuit(s), digital circuit(s), logic circuit(s), programmable processor(s), programmable microcontroller(s), GPU(s), DSP(s), ASIC(s), PLD(s), and/or FPLD(s) such as FPGAs. Further still, the example data routing manager 5402A-I of FIG. 54 may include one or more elements, processes, and/or devices in addition to, or instead of, those illustrated in FIG. 55, and/or may include more than one of any or all of the illustrated elements, processes and devices.

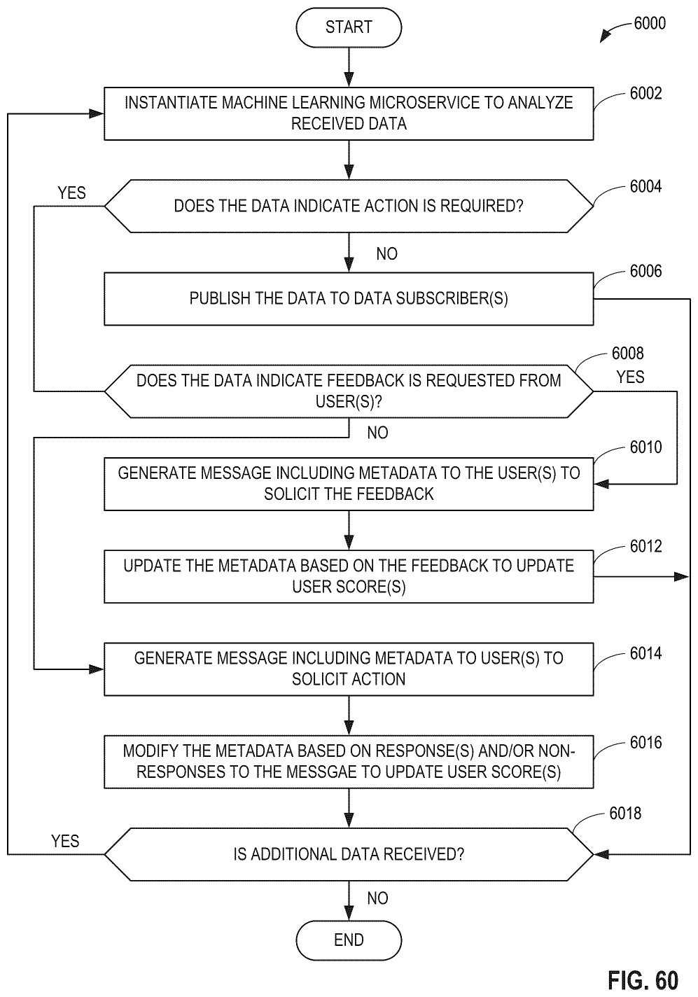

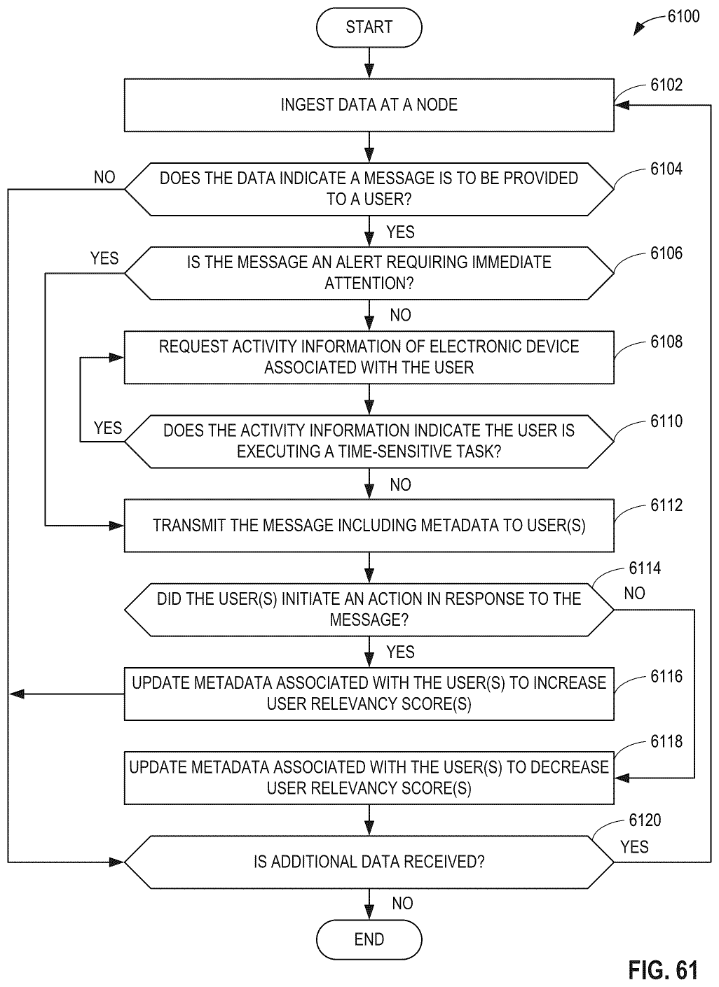

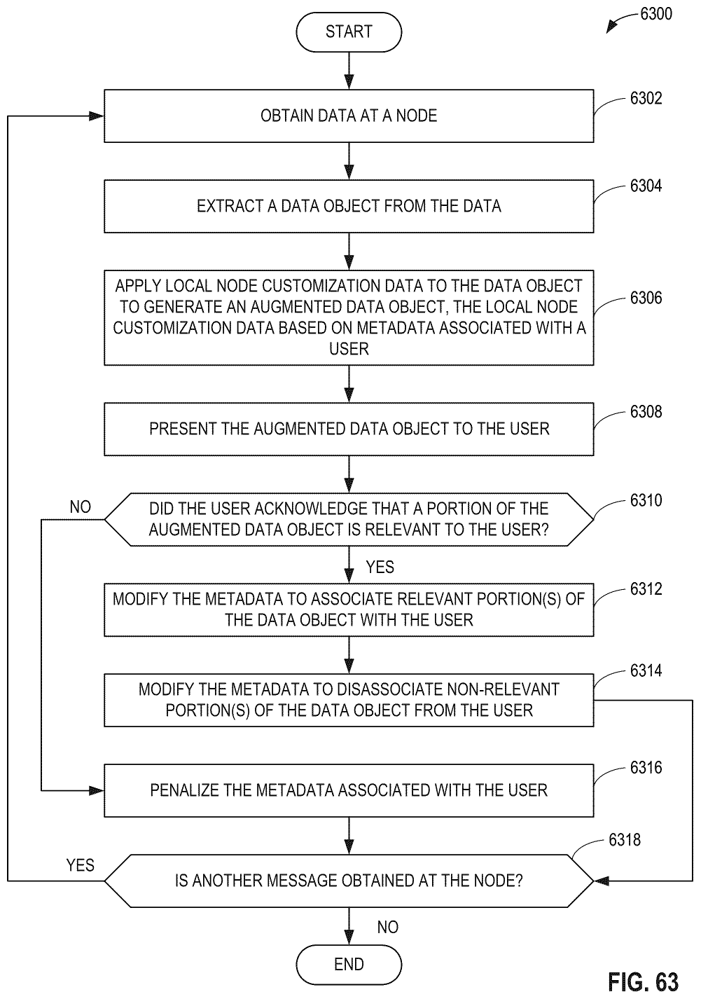

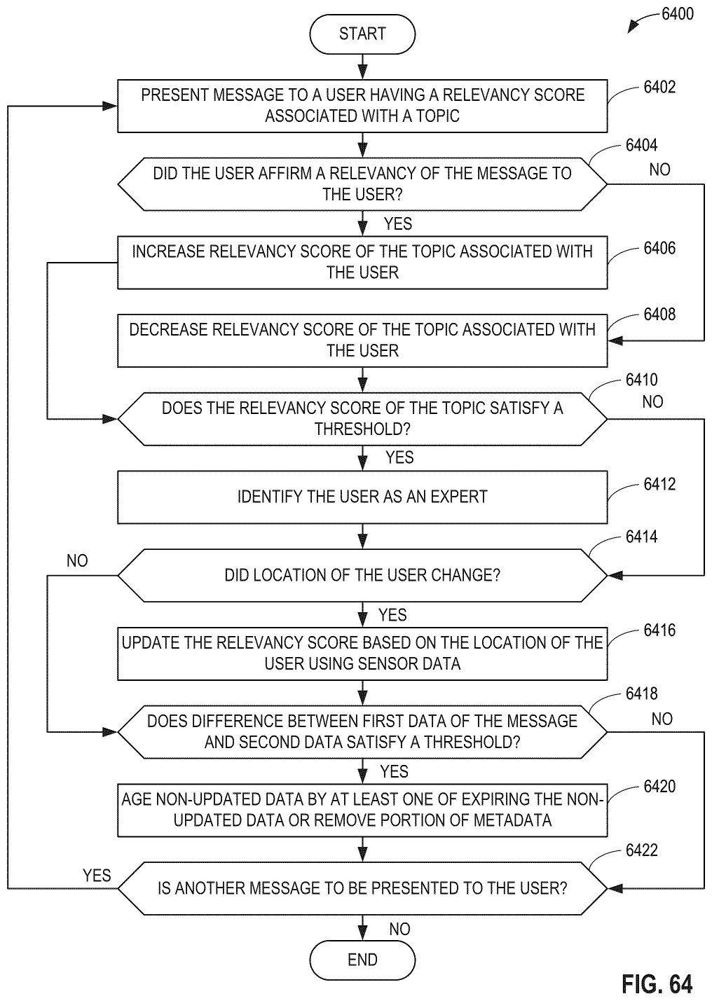

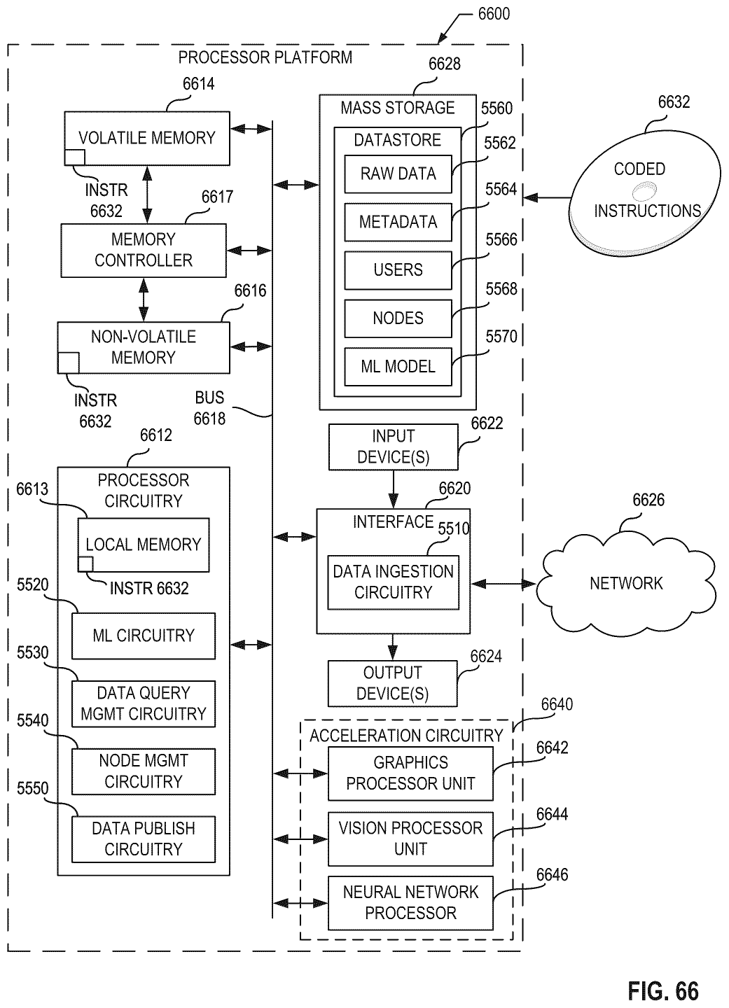

In some examples, the data routing management circuitry 5500 includes means for receiving data. For example, the means for receiving may be implemented by the data ingestion circuitry 5510. In some examples, the data ingestion circuitry 5510 may be instantiated by processor circuitry such as the example processor circuitry 6612 of FIG. 66. For instance, the data ingestion circuitry 5510 may be instantiated by the example general purpose processor circuitry 6700 of FIG. 67 executing machine executable instructions such as that implemented by at least block 6018 of FIG. 60, blocks 6102, 6114, 6120 of FIG. 61, blocks 6302, 6304, 6310, 6318 of FIG. 63, blocks 6404, 6414 of FIG. 64, and blocks 6508, 6520 of FIG. 65. In some examples, the data ingestion circuitry 5510 may be instantiated by hardware logic circuitry, which may be implemented by an ASIC or the FPGA circuitry 6800 of FIG. 68 structured to perform operations corresponding to the machine readable instructions. Additionally or alternatively, the data ingestion circuitry 5510 may be instantiated by any other combination of hardware, software, and/or firmware. For example, the data ingestion circuitry 5510 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate. In some examples, the means for receiving is to extract a data object from data. For example, the means for receiving can include and/or otherwise implement means for extracting the data object. In some examples, the means for receiving includes and/or otherwise implements means for ascertaining whether a second user is in a location based on sensor data.

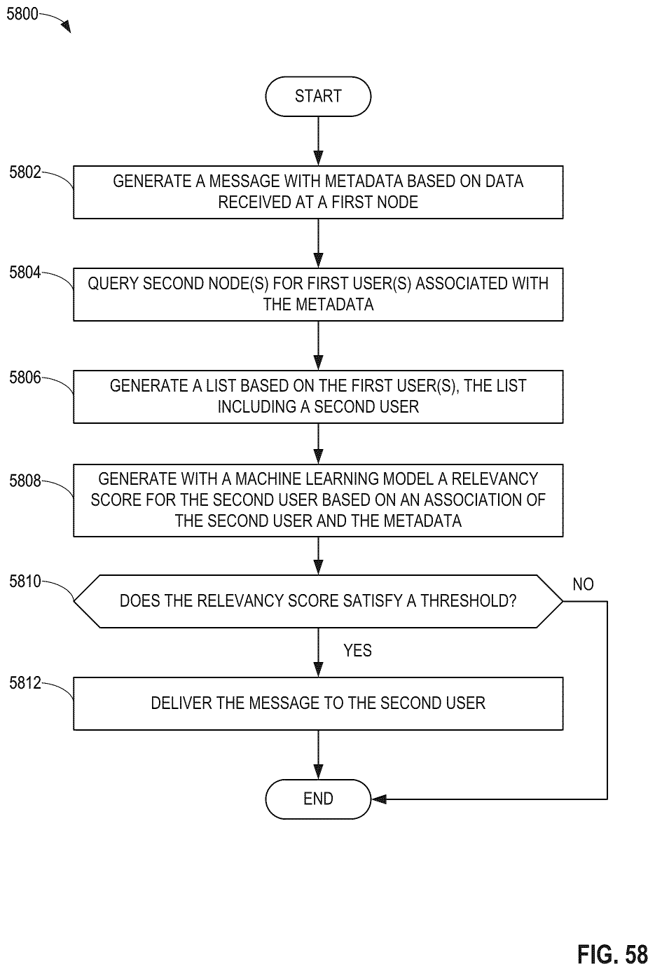

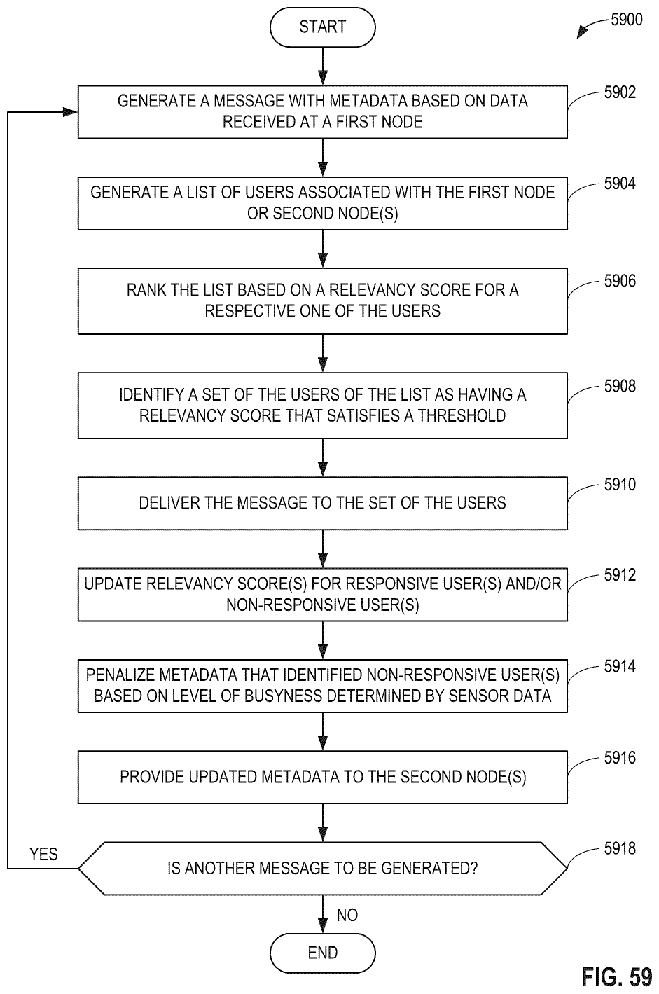

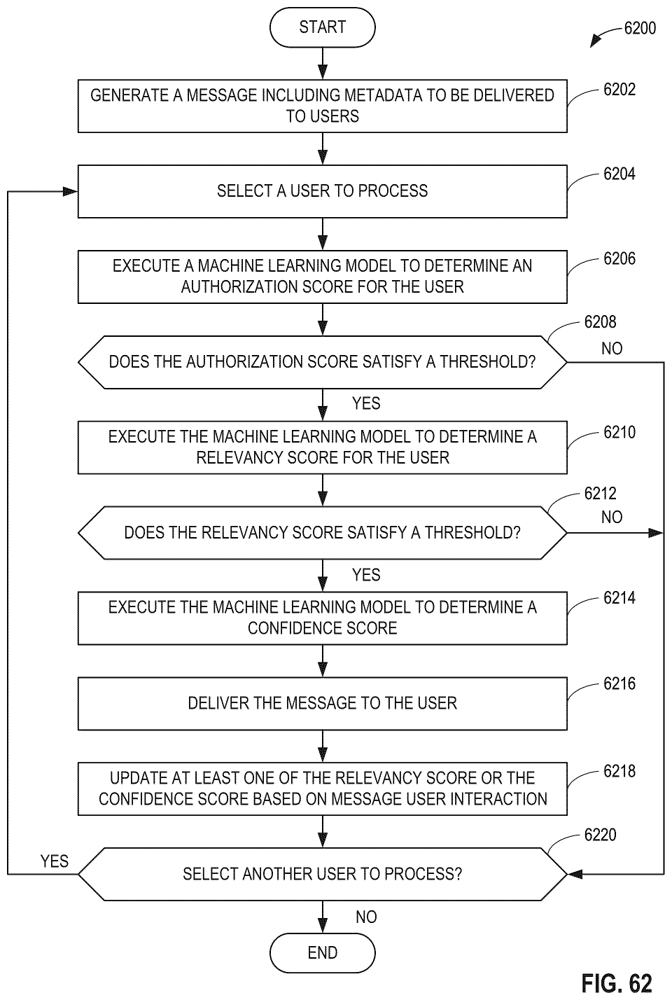

In some examples, the data routing management circuitry 5500 includes means for determining. For example, the means for determining may be implemented by the machine learning circuitry 5520. In some examples, the machine learning circuitry 5520 may be instantiated by processor circuitry such as the example processor circuitry 6612 of FIG. 66. For instance, the machine learning circuitry 5520 may be instantiated by the example general purpose processor circuitry 6700 of FIG. 67 executing machine executable instructions such as that implemented by at least blocks 5808, 5810 of FIG. 58, blocks 5912, 5914 of FIG. 59, blocks 6002, 6004, 6008, 6012, 6016 of FIG. 60, blocks 6104, 6106, 6110, 6116, 6118 of FIG. 61, blocks 6206, 6208, 6210, 6212, 6214, 6218 of FIG. 62, blocks 6312, 6314, 6316 of FIG. 63, blocks 6406, 6408, 6410, 6416 of FIG. 64, and blocks 6502, 6504, 6506, 6510, 6512, 6514, 6516, 6518 of FIG. 65. In some examples, the machine learning circuitry 5520 may be instantiated by hardware logic circuitry, which may be implemented by an ASIC or the FPGA circuitry 6800 of FIG. 68 structured to perform operations corresponding to the machine readable instructions. Additionally or alternatively, the machine learning circuitry 5520 may be instantiated by any other combination of hardware, software, and/or firmware. For example, the machine learning circuitry 5520 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for determining is to determine, with a machine learning model, a relevancy score for the second user based on an association of a user and metadata. In some examples in which a set of first users include a second user with a first relevancy score and a third user with a third relevancy score, the means for determining is to increase a first relevancy score of the second user in response to the second user responding to a message. For example, the means for determining can include and/or otherwise implement means for increasing the first relevancy score. In some examples, the means for determining is to decrease a third relevancy score of the third user in response to the third user ignoring the message or acknowledging that the message is not relevant to the third user. For example, the means for determining can include and/or otherwise implement means for decreasing the third relevancy score.

In some examples in which metadata is first metadata, the means for determining is to, in response to the third user not responding to the message, determine activity information associated with the third user. In some examples, the means for determining is to, in response to determining that the activity information indicates that the third user is available, remove the first metadata from second metadata associated with the third user. For example, the means for determining can include and/or otherwise implement means for removing the first metadata from the second metadata. In some examples, the means for determining is to, in response to the third user acknowledging that the message is not relevant to the third user, remove the first metadata from second metadata associated with the third user. In some examples, the means for determining is to determine whether data indicates an action is to be performed.

In some examples in which a threshold is a relevancy score threshold, the means for determining is to execute a machine learning model to determine an authorization score for the second user with the authorization score representative of whether the second user is granted access to the data. For example, the means for determining can include and/or otherwise implement means for executing the machine learning model. In some examples, the means for determining is to, in response to determining that the authorization score satisfies an authorization score threshold, execute the machine learning model to determine the relevancy score for the second user, the relevancy score representative of a first likelihood that the data is relevant to the second user. In some examples, the means for determining is to execute the machine learning model to determine a confidence score representative of a second likelihood that the second user is to response to the message.

In some examples, the means for determining is to, in response to a second user acknowledging that a first portion of a data object is not relevant to the second user and a second portion of the data object is relevant to the second user, remove a second portion of a local node customization data corresponding to the first portion. In some examples, the means for determining is to add a third portion to the local node customization data corresponding to the second portion. For example, the means for determining can include and/or otherwise implement means for removing the second portion and/or means for adding the third portion.

In some examples in which data is associated with a first location, the means for determining is to, in response to determining that a second user is in the first location, increase a relevancy score, and in response to determining that the second user is not in the first location, decrease the relevancy score. For example, the means for determining can include and/or otherwise implement means for increasing the relevancy score and/or means for decreasing the relevancy score.

In some examples in which data is first data, the means for determining is to instantiate a machine learning microservice to generate a machine learning model based on second data associated with an environment. For example, the means for determining can include and/or otherwise implement means for instantiating the machine learning microservice. In some examples, the means for determining is to execute the machine learning model to generate a data graph corresponding to a portion of the environment. For example, the means for determining can include and/or otherwise implement means for generating the data graph. In some examples, the means for determining is to identify a hotspot of at least one of expert nodes or stakeholder nodes. For example, the means for determining can include and/or otherwise implement means for identifying the hotspot. In some examples, the means for determining is to update at least one of the data graph or the hotspot based on a routing of the message to the second user or one or more third users. For example, the means for determining can include and/or otherwise implement means for updating the at least one of the data graph or the hotspot.

In some examples, the data routing management circuitry 5500 includes means for generating a message with metadata based on data received at a first node. For example, the means for generating may be implemented by the data query management circuitry 5530. In some examples, the data query management circuitry 5530 may be instantiated by processor circuitry such as the example processor circuitry 6612 of FIG. 66. For instance, the data query management circuitry 5530 may be instantiated by the example general purpose processor circuitry 6700 of FIG. 67 executing machine executable instructions such as that implemented by at least block 5802 of FIG. 58, blocks 5902, 5918 of FIG. 59, blocks 6010, 6014 of FIG. 60, block 6108 of FIG. 61, block 6202 of FIG. 62, block 6306 of FIG. 63, and blocks 6418, 6420 of FIG. 64. In some examples, the data query management circuitry 5530 may be instantiated by hardware logic circuitry, which may be implemented by an ASIC or the FPGA circuitry 6800 of FIG. 68 structured to perform operations corresponding to the machine readable instructions. Additionally or alternatively, the data query management circuitry 5530 may be instantiated by any other combination of hardware, software, and/or firmware. For example, the data query management circuitry 5530 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the data routing management circuitry 5500 includes means for compiling a list based on first users. In some examples, the list includes a second user. For example, the means for compiling may be implemented by the node management circuitry 5540. In some examples, the node management circuitry 5540 may be instantiated by processor circuitry such as the example processor circuitry 6612 of FIG. 66. For instance, the node management circuitry 5540 may be instantiated by the example general purpose processor circuitry 6700 of FIG. 67 executing machine executable instructions such as that implemented by at least block 5806 of FIG. 58, blocks 5904, 5906, 5908 of FIG. 59, blocks 6204, 6220 of FIG. 62, and block 6412 of FIG. 64. In some examples, the node management circuitry 5540 may be instantiated by hardware logic circuitry, which may be implemented by an ASIC or the FPGA circuitry 6800 of FIG. 68 structured to perform operations corresponding to the machine readable instructions. Additionally or alternatively, the node management circuitry 5540 may be instantiated by any other combination of hardware, software, and/or firmware. For example, the node management circuitry 5540 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which a relevancy score is a first relevancy score, the means for compiling is to rank a list based on second relevancy scores, a respective one of the second relevancy scores corresponding to a respective one of the first users. For example, the means for compiling can include and/or otherwise implement means for ranking the list. In some examples, the means for compiling is to identify a set of the first users of the list as having a respective one of the second relevancy scores that satisfies the threshold. For example, the means for compiling can include and/or otherwise implement means for identifying the set of the first users.

In some examples, the data routing management circuitry 5500 includes means for querying one or more second nodes for first users associated with metadata. For example, the means for querying may be implemented by the data publishing circuitry 5550. In some examples, the data publishing circuitry 5550 may be instantiated by processor circuitry such as the example processor circuitry 6612 of FIG. 66. For instance, the data publishing circuitry 5550 may be instantiated by the example general purpose processor circuitry 6700 of FIG. 67 executing machine executable instructions such as that implemented by at least blocks 5804, 5812 of FIG. 58, blocks 5910, 5916 of FIG. 59, block 6006 of FIG. 60, block 6112 of FIG. 61, block 6216 of FIG. 62, block 6308 of FIG. 63, and blocks 6402, 6422 of FIG. 64. In some examples, the data publishing circuitry 5550 may be instantiated by hardware logic circuitry, which may be implemented by an ASIC or the FPGA circuitry 6800 of FIG. 68 structured to perform operations corresponding to the machine readable instructions. Additionally or alternatively, the data publishing circuitry 5550 may be instantiated by any other combination of hardware, software, and/or firmware. For example, the data publishing circuitry 5550 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for querying is to, in response to determining that data indicates that an action is to be performed, generate a message to solicit the action from a user. For example, the means for querying can include and/or otherwise implement means for generating the message. In some examples, the means for querying is to apply local node customization data to a data object to generate an augmented data object. For example, the means for querying can include and/or otherwise implement means for applying the local node customization data. In some examples, the local node customization data is based on second metadata associated with the second user.

In some examples in which data is first data associated with second data, the means for querying is to determine whether a difference between the first data and the second data satisfies a threshold. For example, the means for querying can include and/or otherwise implement means for determining whether the difference between the first data and the second data satisfies a threshold. In some examples, the means for querying is to, in response to determining that the difference satisfies the threshold, age the second data by at least one of expiring the second data or removing a portion of second metadata associated with the second user that corresponds to the second data. For example, the means for querying can include and/or otherwise implement means for aging the second data.

In some examples, the data routing management circuitry 5500 includes means for transmitting the message to a user in response to determining that a relevancy score satisfies a threshold. For example, the means for transmitting may be implemented by the data publishing circuitry 5550. In some examples, the data publishing circuitry 5550 may be instantiated by processor circuitry such as the example processor circuitry 6612 of FIG. 66. For instance, the data publishing circuitry 5550 may be instantiated by the example general purpose processor circuitry 6700 of FIG. 67 executing machine executable instructions such as that implemented by at least blocks 5804, 5812 of FIG. 58, blocks 5910, 5916 of FIG. 59, block 6006 of FIG. 60, block 6112 of FIG. 61, block 6216 of FIG. 62, block 6308 of FIG. 63, and blocks 6402, 6422 of FIG. 64. In some examples, the data publishing circuitry 5550 may be instantiated by hardware logic circuitry, which may be implemented by an ASIC or the FPGA circuitry 6800 of FIG. 68 structured to perform operations corresponding to the machine readable instructions. Additionally or alternatively, the data publishing circuitry 5550 may be instantiated by any other combination of hardware, software, and/or firmware. For example, the data publishing circuitry 5550 may be implemented by at least one or more hardware circuits (e.g., processor circuitry, discrete and/or integrated analog and/or digital circuitry, an FPGA, an ASIC, an IPU, network interface circuitry, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for transmitting is to, in response to determining that data does not indicate that an action is to be performed, transmit the data to one or more data subscribers. In some examples, the means for transmitting is to present an augmented data object to a user. For example, the means for transmitting can include and/or otherwise implement means for presenting the augmented data object to the user.

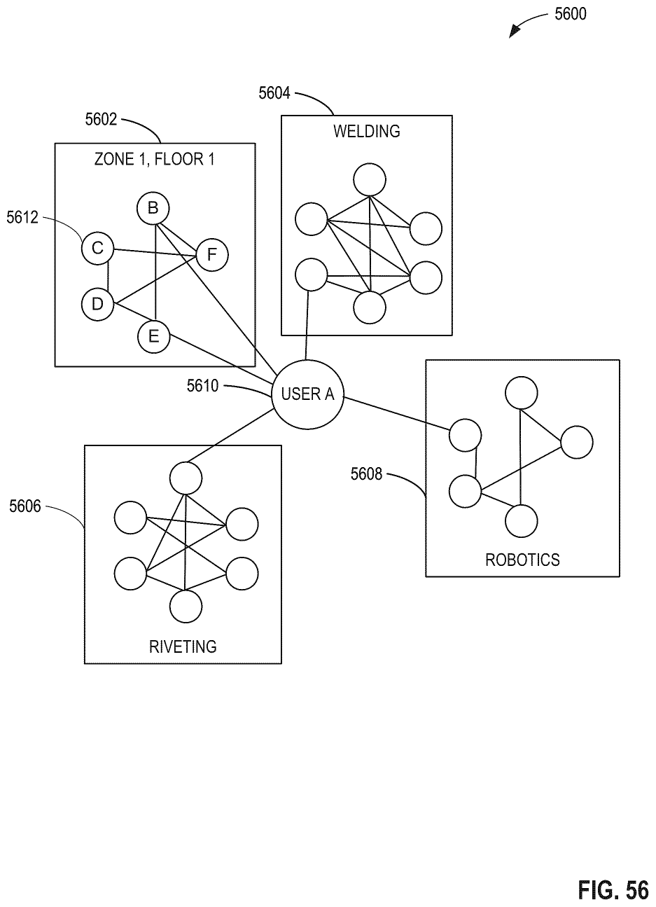

FIG. 56 is an illustration of an example user graph 5600, which includes example data graphs 5602, 5604, 5606, 5608 associated with an example user 5610 (identified by USER A) to facilitate adaptive data routing in an example network environment (e.g., the network environment 5404 of FIG. 54). In some examples, the machine learning circuitry 5520 can execute the machine learning model 5570 to generate one(s) of the data graphs 5602, 5604, 5606, 5608, and/or, more generally, the user graph 5600. In some examples, the user 5610 can be one of the users 5410, 5412, 5414, 5416, 5418, 5420 of FIG. 54, the users 5566 of FIG. 55, etc. For example, the user 5610 can be a physical person, such as one of the users 5410, 5412, 5414, 5416, 5418, 5420. In some examples, the user 5610 can be user data, such as user data stored in the users 5566 of the datastore 5560.

The data graphs 5602, 5604, 5606, 5608 include a first example data graph 5602 (identified by ZONE 1, FLOOR 1), a second example data graph 5604 (identified by WELDING), a third example data graph 5606 (identified by RIVETING), and a fourth example data graph 5608 (identified by ROBOTICS). The illustrated example depicts the user graph 5600 and how the user graph 5600 is connected to multiple metadata (and communities). For example, the first data graph 5602 includes a plurality of example nodes (e.g., data graph nodes) 5612. Each of the plurality of the nodes 5612 represent and/or otherwise correspond to a user (e.g., one of the users 5566 of FIG. 55). For example, each of the plurality of the nodes 5612 can be implemented using metadata corresponding to a respective user. For example, the first graph node 5602 is depicted as having 5 data graph nodes, or 5 sets of metadata corresponding to a respective one of 5 users (e.g., USER B, USER C, USER D, USER E, USER F). In this example, the user 5610 is connected by way of metadata to USER B and USER D. For example, a first portion of first metadata associated with the user 5610 can match, point to, reference, etc., a second portion of second metadata associated with USER B, a third portion of third metadata associated with USER D, etc. By way of another example, USER B is connected by way of metadata to USER E and USER F.

In the illustrated example, the first data graph 5602 is representative of users in Zone 1, Location 1 of an environment (e.g., a factory, a warehouse, an office building, etc.). For example, the plurality of the data graph nodes 5612 are coupled to one(s) of each other based on matching (or substantially matching) portion(s) of metadata (e.g., first metadata of a first user matching second metadata of a second user). In some examples, the data graph nodes 5612 are included in the first data graph 5602 because they share the same location. The data graph nodes 5612 can be connected to one(s) of each other based on metadata relationships. For example, USER B may be a manager that supervises USER E and USER F.

In the illustrated example, the second data graph 5604 is representative of users that are associated with a topic of welding. For example, data graph nodes of the second data graph 5604 are likely to find data associated with welding relevant. In the illustrated example, the third data graph 5606 is representative of users that are associated with a topic of riveting. For example, data graph nodes of the third data graph 5606 are likely to find data associated with riveting relevant. In the illustrated example, the fourth data graph 5608 is representative of users that are associated with a topic of robotics. For example, data graph nodes of the fourth data graph 5608 are likely to find data associated with riveting relevant.

In the illustrated example, the user 5610 represents a person and the metadata associated with the person (e.g., portion(s) of the metadata 5564 corresponding to the user 5610) based on the communities the person belongs to. In some examples, these communities could be based on expertise/knowledge/tasks (e.g., welding, riveting, robotics, etc.) or context (e.g., a location of Zone 1, Floor 1). In some examples, this metadata is collected based on activity of users as reported by sensors in the network environment (e.g., reported by video cameras on a factory floor). Additionally and/or alternatively, this metadata can be collected using passive sensing such as a wireless access point receiving a login in a particular location, a user scanning security credentials by way of RFID at a terminal, etc. In some examples, a context of a user can be collected using which applications the user uses, a role of the user in their organization, access rights of the user as determined by Information Technology (IT) personnel, internal groups (e.g., knowledge boards, message groups, special interest groups, etc.) the user is signed up to, etc. In some examples, the data routing manager 5402A-I can execute natural language processing (NLP) techniques to group words into context in the form of metadata.

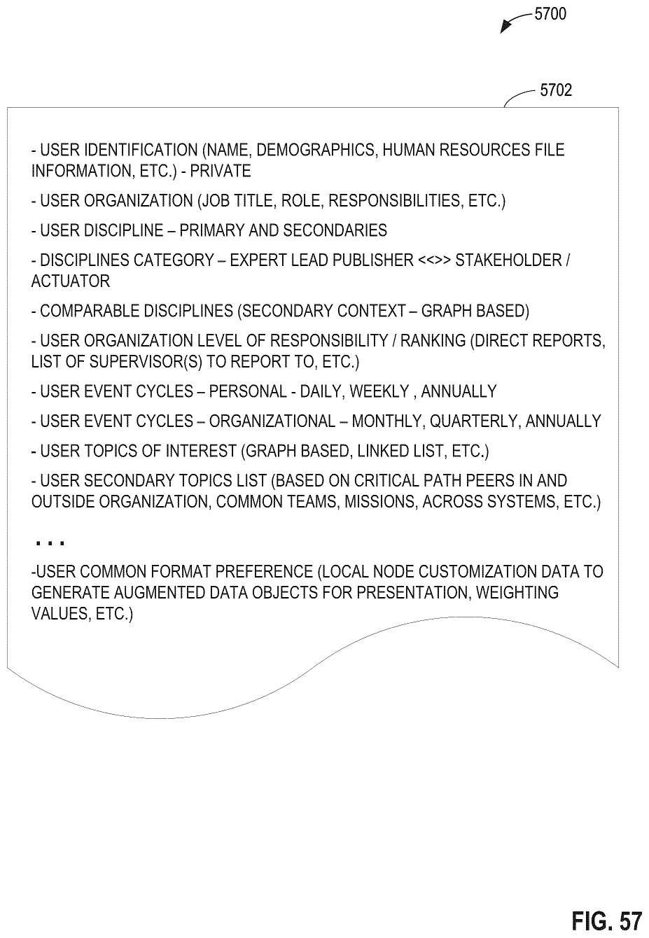

FIG. 57 depicts an example dataset 5700, which includes example metadata 5702. In some examples, the metadata 5702, and/or, more generally, the dataset 5700, can implement the metadata 5564, or portion(s) thereof. In some examples, the data routing manager 5402A-I can effectuate adaptive data routing in the network environment 5404 of FIG. 54 based on the metadata 5702. For example, the machine learning circuitry 5520 can execute the machine learning model 5570 to carry out time based and/or content type analysis of the metadata 5702. For example, the machine learning model 5570 can generate model output(s), which can include individual user data traffic and content selection/preference. In some examples, the machine learning model 5520 can identify preference(s) for each user in private node dataset to be stored in the datastore 5560.

In the illustrated example, the dataset 5700 includes data associated with a network environment, such as a user organization, user discipline(s), discipline categories, comparable disciplines, user organization level of responsibility and/or ranking, and the like. For example, the data included in the dataset 5700 can be associated with and/or otherwise correspond to a user, such as one of the users 5566. In the illustrated example, the dataset 5700 can include user event cycles, which can be used to identify user(s) of interest to whom to deliver alerts. In the illustrated example, the dataset 5700 can include user topics of interest, user secondary topics, user common format preference(s), etc., from which alert(s) may be generated and/or a routing of which may be determined.

Flowcharts representative of example hardware logic circuitry, machine readable instructions, hardware implemented state machines, and/or any combination thereof for implementing the example data routing management circuitry 5500 of FIG. 55 are shown in FIGS. 58-65. The machine readable instructions may be one or more executable programs or portion(s) of an executable program for execution by processor circuitry, such as the processor circuitry 6612 shown in the example processor platform 6600 discussed below in connection with FIG. 66. The program may be embodied in software stored on one or more non-transitory computer readable storage media such as a CD, a floppy disk, a hard disk drive (HDD), a solid-state drive (SSD), a DVD, a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 58-65, many other methods of implementing the example data routing management circuitry 5500 of FIG. 55 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

FIG. 58 is a flowchart representative of example machine readable instructions and/or example operations 5800 that may be executed and/or instantiated by processor circuitry to route a message to user(s). The example machine readable instructions and/or the example operations 5800 of FIG. 58 begin at block 5802, at which the data routing management circuitry 5500 generates a message with metadata based on data received at a first node. For example, the data query management circuitry 5530 can generate a message including the metadata 5564 that describes data received (or generated) at a first node, such as the first data routing manager 5402A. In some examples, the data can be patient data (e.g., in a medical facility) such as a medical test result (e.g., an X-ray scan, a blood test, etc.), vehicle data (e.g., in an automotive manufacturing factory) such as a completion of a vehicle part, etc. In some examples, the metadata 5564 can be a patient name, a doctor, a wing of a hospital in which the patient is being treated, etc. In some examples, the metadata 5564 can be a serial number of a vehicle being manufactured, a location of the vehicle, etc.

At block 5804, the data routing management circuitry 5500 queries second node(s) for first user(s) associated with the metadata. For example, the data publishing circuitry 5550 can query one(s) of the data routing managers 5402A-I for one(s) of the users 5410, 5412, 5414, 5416, 5418, 5420 associated with the metadata.

At block 5806, the data routing management circuitry 5500 generates a list based on the first user(s), the list including a second user. For example, the node management circuitry 5540 can generate a list of users including the first user 5410 and the second user 5412 that are associated with the metadata. For example, the first user 5410 can be the nurse, doctor, surgeon, etc., treating the patient. In some examples, the second user 5412 can be an oncologist, an X-ray technician, etc., treating the patient. In some examples, the first user 5410 can be a supervisor on a factory floor, a technician on the factory floor, etc. In some examples, the second user 5412 can be a supply chain engineer, a sales representative, etc., associated with the vehicle.

At block 5808, the data routing management circuitry 5500 generates with a machine learning model a relevancy score for the second user based on an association of the second user and the metadata. For example, the machine learning circuitry 5520 can execute the machine learning model 5570 using the list of the users as model inputs to generate model outputs. In some examples, the model outputs can include a relevancy score for a respective one of the first user 5410 and the second user 5412. For example, the relevancy score for the first user 5410 and the second user 5412 can be correlated to a strength of association of the metadata with respective metadata of the first user 5410 and the second user 5412.

At block 5810, the data routing management circuitry 5500 determines whether the relevancy score satisfies a threshold. For example, the machine learning circuitry 5520 can determine that a first relevancy score of 0.9 (e.g., a probability of 0.9, a 90% likelihood, etc.) for the first user 5410 satisfies a relevancy score threshold of 0.8 because the first relevancy score of 0.9 is greater than or equal to 0.8. In some examples, the machine learning circuitry 5520 can determine that a second relevancy score of 0.4 (e.g., a probability of 0.4, a 40% likelihood, etc.) for the second user 5412 does not satisfy the relevancy score threshold of 0.8 because the second relevancy score of 0.4 is less than 0.8.

If, at block 5810, the data routing management circuitry 5500 determines that the relevancy score does not satisfy the threshold, the example machine readable instructions and/or the operations 5800 of FIG. 58 conclude. If, at block 5810, the data routing management circuitry 5500 determines that the relevancy score satisfies the threshold, then, at block 5812, the data routing management circuitry 5500 delivers the message to the second user. For example, the data publishing circuitry 5550 can transmit the message to the first user 5410 by way of the network 5422. In some examples, the first electronic device 5424 can present the message to the first user 5410 by speaking the message through a speaker of the first electronic device 5424. In some examples, the data routing management circuitry 5500 can publish the message to a server from which data subscribers, such as the fourth data routing manager 5402D, can identify the message as being addressed to the first user 5410 and thereby retrieving the message for presenting to the first user 5410 by way of the first electronic device 5424. In response to delivering the message to the second user at block 5812, the example machine readable instructions and/or the operations 5800 of FIG. 58 conclude.

FIG. 59 is another flowchart representative of example machine readable instructions and/or example operations 5900 that may be executed and/or instantiated by processor circuitry to route a message to user(s). The example machine readable instructions and/or the example operations 5900 of FIG. 59 begin at block 5902, at which the data routing management circuitry 5500 generates a message with metadata based on data received at a first node. For example, the data query management circuitry 5530 can generate a message including the metadata 5564 that describes data received (or generated) at a first node, such as the ninth data routing manager 5402I. In some examples, the metadata included in or with the message can be first metadata. In some examples, the data can be financial data (e.g., the network environment 5404 is a corporate or commercial office) such as invoices (e.g., sale invoices, service invoices, expense receipts, etc.), inventory data (e.g., the network environment 5404 is a warehouse) such as shipping manifests, bills of lading, etc. In some examples, the metadata 5564 can describe and/or include an identifier of a corporate officer, an accountant, a floor of an office building in which the financial data is generated, etc. In some examples, the metadata 5564 can reference and/or include a license plate of a truck to transport a pallet of goods, a location of the pallet of goods, a truck driver associated with the license plate or the truck, etc.

At block 5904, the data routing management circuitry 5500 generates a list of users associated with the first node or second node(s). For example, the node management circuitry 5540 can generate a list of users including the third user 5414, the fourth user 5416, and the fifth user 5418 that are associated with the metadata. For example, the third user 5414 can be the corporate officer associated with the financial data, the fourth user 5416 can be an accountant associated with the financial data, and the fifth user 5418 can be an IT professional on the floor of the corporate office on which the financial data is generated. In some examples, the corporate officer can be associated with second metadata, the accountant can be associated with third metadata, and/or the IT professional can be associated with fourth metadata. In some examples, the third user 5414 can be a warehouse supervisor, the fourth user 5416 can be a forklift operator, and the fifth user 5418 can be a truck driver associated with the warehouse. For example, the warehouse supervisor can be associated with fifth metadata, the forklift operator can be associated with sixth metadata, and/or the truck driver can be associated with seventh metadata. In some examples, one(s) of the second through seventh metadata can be implemented using the metadata 5720.

At block 5906, the data routing management circuitry 5500 ranks the list based on a relevancy score for a respective one of the users. For the node management circuitry 5540 can rank the third user 5414, the fourth user 5416, and the fifth user 5418 based on their respective relevancy score for the metadata. In some examples, a first relevancy score of the third user 5414 can be based on matching portion(s) of the first metadata and the second metadata (or the fifth metadata). In some examples, a second relevancy score of the fourth user 5416 can be based on matching portion(s) of the first metadata and the third metadata (or the sixth metadata). In some examples, a third relevancy score of the fifth user 5418 can be based on matching portion(s) of the first metadata and the fourth metadata (or the seventh metadata).

At block 5908, the data routing management circuitry 5500 identifies a set of the users of the list as having a relevancy score that satisfies a threshold. For example, the node management circuitry 5540 can determine that the third user 5414 has a relevancy score of 0.85, the fourth user 5416 has a relevancy score of 0.92, and the fifth user 5418 has a relevancy score of 0.18. In some examples, the node management circuitry 5540 can identify the third user 5414 and the fourth user 5416 as having a relevancy score that satisfies a threshold of 0.75 because 0.85 and 0.92 are greater than or equal to the threshold.

At block 5910, the data routing management circuitry 5500 delivers the message to the set of the users. For example, the data publishing circuitry 5550 can deliver, transmit, and/or otherwise provide the message to the third user 5414 and the fourth user 5416 by way of the network 5422. In some examples, the sixth data routing manager 5402F and the seventh data routing manager 5402G can apply local node customization data to the message to improve and/or otherwise optimize the presentation of the message. For example, the sixth data routing manager 5402F can apply local node customization data by removing graphics from the message to emphasize text-based data on the third electronic device 5428. In some examples, the seventh data routing manager 5402G can resize and/or reorient graphics of the message to surround a current application window that the fourth user 5416 is using on the fourth electronic device 5430. In some examples, the local node customization data can be implemented using portion(s) of one(s) of the second through seventh metadata.

At block 5912, the data routing management circuitry 5500 updates relevancy score(s) for responsive user(s) and/or non-responsive user(s). For example, the third user 5414 may ignore the message while the fourth user 5416 responds to the message (e.g., the fourth user 5416 taps the message on the fourth electronic device 5430 to increase the size of the message, electronically engaging with the message by editing the message, copying the message, saving the message, responding with a reply message, etc.). In some examples, the machine learning circuitry 5520 can decrease the relevancy score of the third user 5414. For example, the machine learning circuitry 5520 can decrease the relevancy score associated with portion(s) of the second metadata (or the fifth metadata) that matched portion(s) of the first metadata because the third user 5414 ignored the message. In some examples, the machine learning circuitry 5520 can increase or maintain the relevancy score of the fourth user 5416 because the fourth user 5416 engaged with and/or responded to the message. For example, the machine learning circuitry 5520 can increase the relevancy score associated with portion(s) of the third metadata (or the sixth metadata) that matched portion(s) of the first metadata because the fourth user 5416 acknowledged in some manner that the message is relevant to the fourth user 5416 (e.g., relevant to interest(s) of the fourth user 5416.

At block 5914, the data routing management circuitry 5500 penalizes metadata that identified non-responsive user(s) based on a level of busyness determined by sensor data. For example, the machine learning circuitry 5520 can analyze sensor data (e.g., video data from a video camera that has the third user 5414 in a field of view of the video camera), activity information (e.g., hardware, software, and/or firmware utilization of the third electronic device 5428), etc., and/or any combination(s) thereof. In some examples, in response to determining that the third user 5414 is not busy based on the sensor data and/or the activity information, the machine learning circuitry 5520 can penalize (e.g., remove, modify, alter, change, etc.) the second metadata (or the fifth metadata) associated with the third user 5414 that matched a portion of the first metadata of the message. In some examples, in response to determining that the third user 5414 is busy based on the sensor data and/or the activity information, the machine learning circuitry 5520 may not penalize the second metadata (or the fifth metadata) associated with the third user 5414 that matched a portion of the first metadata of the message.

At block 5916, the data routing management circuitry 5500 provides updated metadata to the second node(s). For example, the data publishing circuitry 5550 can provide updated metadata (e.g., updated version(s) of the second (or fifth) metadata that has been penalized) associated with the third user 5414 to neighboring nodes of the ninth data routing manager 5402I, such as one(s) of the other data routing managers 5402A-I. In some examples, the data publishing circuitry 5550 provides the updated metadata to the neighboring nodes to synchronize the updated metadata with metadata associated with the third user 5414 that is stored at the neighboring nodes (e.g., to improve AI/ML learning capabilities at the neighboring nodes by using updated metadata).

At block 5918, the data routing management circuitry 5500 determines whether there is another message to be generated. If, at block 5918, the data routing management circuitry 5500 determines that another message is to be generated, control returns to block 5902, otherwise the example machine readable instructions and/or the operations 5900 of FIG. 59 conclude.

FIG. 60 is a flowchart representative of example machine readable instructions and/or example operations 6000 that may be executed and/or instantiated by processor circuitry to present a message to user(s). The example machine readable instructions and/or the example operations 6000 of FIG. 60 begin at block 6102, at which the data routing management circuitry 5500 ingests data at a node. For example, the data ingestion circuitry 5510 can ingest data generated by one(s) of the data producers 5406.

At block 6104, the data routing management circuitry 5500 determines whether the data indicates a message is to be provided to a user. For example, the machine learning circuitry 5520 can determine, based on one or more data objects, portions, etc., included in the message, that the one or more data objects, portions, etc., is/are to be presented and/or otherwise provided to a user, such as the second user 5412. In some examples, the machine learning circuitry 5520 can determine to present the one or more data objects, portions, etc., to the second user 5412 based on first metadata associated with the one or more data objects, portions, etc., that correlate with second metadata associated with the second user 5412.

If, at block 6104, the data routing management circuitry 5500 determines that the data does not indicate that a message is to be provided to a user, control proceeds to block 6120, otherwise, control proceeds to block 6106. At block 6106, the data routing management circuitry 5500 determines whether the message is an alert requiring immediate attention. For example, the machine learning circuitry 5520 can determine that the message is an alert generated by a programmable logic controller (PLC) controlling and/or otherwise monitoring heavy machinery (e.g., a robotic arm, a crane, an electric motor drive, etc.) in the network environment 5404. In some examples, the heavy machinery can be associated with the second user 5414 (e.g., the second user 5414 is a technician whose job function is to maintain the heavy machinery that caused the alarm).

If, at block 6106, data routing management circuitry 5500 determines that the message is an alert requiring immediate attention control proceeds to block 6112, otherwise control proceeds to block 6108. At block 6108, the data routing management circuitry 5500 requests activity information of an electronic device associated with the user. For example, the data query management circuitry 5530 can ping the fifth data routing manager 5402E for activity information of the second electronic device 5426, which can include resource utilization data, an identification of application(s) and/or service(s) in operation on the second electronic device 5426, etc.

At block 6110, the data routing management circuitry 5500 determines whether the activity information indicates that the user is executing a time-sensitive task. For example, the machine learning circuitry 5520 can provide the activity information to the machine learning model 5570 to generate model output(s), which can include a determination of whether the second user 5412 is busy executing a time-sensitive task (e.g., mitigating an alarm from different heavy machinery).

If, at block 6110, the data routing management circuitry 5500 determines that the activity information indicates that the user is executing a time-sensitive task, control returns to block 6108 to request (e.g., periodically or iteratively request) activity information of the electronic device associated with the user in an effort to determine when the second user 5412 is no longer busy and/or otherwise available to be presented with the message.

If, at block 6110, the data routing management circuitry 5500 determines that the activity information indicates that the user is not executing a time-sensitive task, control proceeds to block 6112. At block 6112, the data routing management circuitry 5500 transmits the message including metadata to user(s). For example, the data publishing circuitry 5550 can deliver, via the network 5422, the message including metadata associated with the message.

At block 6114, the data routing management circuitry 5500 determines whether the user(s) initiated an action in response to the message. For example, the data ingestion circuitry 5510 can receive an acknowledgement that the message is relevant to the second user 5412, a response message indicating that an action is being carried out (or has been carried out) by the second user 5412. In some examples, the response message can be generated by the PLC indicating that a fault of the heavy machinery that caused the alarm has been resolved, mitigated, fixed, etc.

If, at block 6114, the data routing management circuitry 5500 determines that the user(s) initiated an action in response to the message, control proceeds to block 6116. At block 6116, the data routing management circuitry 5500 updates metadata associated with the user(s) to increase user relevancy score(s). For example, the machine learning circuitry 5520 can provide the acknowledgment, the response message, etc., to the machine learning model 5570 to generate model output(s), which can include an increase in a relevancy score representative of the relevancy of the metadata of the message with metadata associated with the second user 5412. In response to updating the metadata associated with the user(s) to increase user relevancy score(s) at block 6116, control proceeds to block 6120.

If, at block 6114, the data routing management circuitry 5500 determines that the user(s) did not initiate an action in response to the message, control proceeds to block 6118. At block 6118, the data routing management circuitry 5500 updates metadata associated with the user(s) to decrease user relevancy score(s). For example, the machine learning circuitry 5520 can provide data to the machine learning model 5570 indicative of the second user 5412 ignoring the message, acknowledging that the message is not relevant to the second user 5412 (e.g., the heavy machinery is in a different department than the department the second user 5412 belongs to, etc.) to generate model output(s), which can include a decrease in a relevancy score representative of the relevancy of the metadata of the message with metadata associated with the second user 5412. In response to updating the metadata associated with the user(s) to decrease user relevancy score(s) at block 6118, control proceeds to block 6120.

At block 6120, the data routing management circuitry 5500 determines whether additional data is received. For example, the data ingestion circuitry 5510 can determine that there is additional data to ingest from one(s) of the data producers 5406. If, at block 6120, the data routing management circuitry 5500 determines that additional data is received, control returns to block 6102, otherwise the example machine readable instructions and/or the example operations 6100 of FIG. 61 conclude.

FIG. 62 is a flowchart representative of example machine readable instructions and/or example operations 6200 that may be executed and/or instantiated by processor circuitry to escalate presentation of a message to user(s). The example machine readable instructions and/or the example operations 6200 begin at block 6200, at which the data routing management circuitry 5500 generates a message including metadata to be delivered to users. For example, the data query management circuitry 5530 generates a message (e.g., one or more data packets) associated with a medical patient in a medical facility (e.g., a hospital). In some examples, the message includes and/or otherwise is representative of medical test results (e.g., a magnetic resonance imaging (MRI) scan, a blood test result, etc.) associated with the medical patient. In some examples, the message is intended to be delivered to a medical doctor treating the medical patient.

At block 6204, the data routing management circuitry 5500 selects a user to process. For example, the node management circuitry 5540 can select the first user 5410 to process. In some examples, the first user 5410 is a medical doctor treating the medical patient.

At block 6206, the data routing management circuitry 5500 executes a machine learning model to determine an authorization score for the user. For example, the machine learning circuitry 5520 can instantiate the machine learning model 5570 to determine an authorization score for the first user 5410. In some examples, the machine learning circuitry 5520 can provide portion(s) of the message to the machine learning model 5570 as model input(s) to generate model output(s), which can include an authorization score of 0.9 for the first user 5410. For example, the first user 5410 can have an authorization score of 0.9 because the message is highly likely (e.g., a 90% likelihood) to be relevant to the medical doctor treating the medical patient.

At block 6208, the data routing management circuitry 5500 determines whether the authorization score satisfies a threshold. For example, the machine learning circuitry 5520 can determine that the authorization score of 0.9 for the first user 5410 satisfies an authorization score threshold of 0.85 because the authorization score of 0.9 is greater than or equal to the authorization score threshold of 0.85.

If, at block 6208, the data routing management circuitry 5500 determines that the authorization score does not satisfy a threshold, control proceeds to block 6220. For example, the first user 5410 may not be authorized based on the authorization score of the first user 5410 to access the message (e.g., the medical patient is not being treated by the first user 5410).

If, at block 6208, the data routing management circuitry 5500 determines that the authorization score satisfies a threshold, control proceeds to block 6210. At block 6210, the data routing management circuitry 5500 executes the machine learning model to determine a relevancy score for the user. For example, the machine learning circuitry 5520 can execute the machine learning model 5570 to determine a relevancy score associated with the first user 5410 for the message. In some examples, the machine learning model 5570 can output a relevancy score of 0.95 associated with the first user 5410 for the message because the first user 5410 is substantially likely to find the medical test result for the medical patient being treated by the first user 5410 as substantially or materially relevant.

At block 6212, the data routing management circuitry 5500 determines whether the relevancy score satisfies a threshold. For example, the machine learning circuitry 5520 can determine that the relevancy score of 0.95 for the first user 5410 for the message satisfies a relevancy score threshold of 0.80 because the relevancy score of 0.95 is greater than or equal to the relevancy score threshold of 0.80.

If, at block 6212, the data routing management circuitry 5500 determines that the relevancy score does not satisfy a threshold, control proceeds to block 6220. For example, the machine learning circuitry 5520 can determine that the first user 5410 may not find the medical test result relevant (e.g., the medical patient is not being treated by the first user 5410).

If, at block 6212, the data routing management circuitry 5500 determines that the relevancy score satisfies a threshold, control proceeds to block 6214. At block 6214, the data routing management circuitry 5500 executes the machine learning model to determine a confidence score. For example, the machine learning circuitry 5520 can invoke the machine learning model 5570 to generate model output(s) based on at least one of the authorization score or the relevancy score as model input(s). In some examples, the model output(s) can include a confidence score representative of a likelihood, probability, etc., that at least one of the authorization score or the relevancy score are accurate or are likely to cause a satisfactory result.

At block 6216, the data routing management circuitry 5500 delivers the message to the user. For example, the data publishing circuitry 5550 can provide, deliver, and/or otherwise cause transmission of the message to the first user 5410 by way of the network 5422.

At block 6218, the data routing management circuitry 5500 updates at least one of the relevancy score or the confidence score based on message user interaction. For example, in response to the first user 5410 engaging with the message (e.g., by reviewing the medical test result, executing an action such as scheduling another medical test or discharging the patient in response to the message, etc.), the machine learning circuitry 5520 can provide feedback to the machine learning model 5570 to affirm the confidence score (or increase the confidence score). In some examples, in response to the first user 5410 engaging with the message, the machine learning circuitry 5520 can provide feedback from the first user 5410 to the machine learning model 5570 to increase (or maintain) the relevancy score associated with the first user 5410 for the message (or portion(s) thereof). In some examples, in response to the first user 5410 ignoring the message, the machine learning circuitry 5520 can provide feedback (e.g., the ignoring of the message) to the machine learning model 5570 to decrease at least one of the authorization score or the relevancy score because the first user 5410 ignored the message.

At block 6220, the data routing management circuitry 5500 determines whether to select another user to process. For example, the node management circuitry 5540 can determine to select the second user 5412 (or a different user) to process. If, at block 6220, the data routing management circuitry 5500 determines to select another user to process, control returns to block 6204, otherwise the example machine readable instructions and/or the example operations 6200 of FIG. 62 conclude.

FIG. 63 is a flowchart representative of example machine readable instructions and/or example operations 6300 that may be executed and/or instantiated by processor circuitry to augment a data object to present to a user based on metadata associated with the user. The example machine readable instructions and/or example operations 6300 of FIG. 63 begin at block 6302, at which the data routing management circuitry 5500 obtains data at a node. For example, the data ingestion circuitry 5510 can obtain a data packet, a message (e.g., a data message), or any other implementation of data generation from one(s) of the data producers 5406. In some examples, the data ingestion circuitry 5510 can be part of the fifth data routing manager 5402E.

At block 6304, the data routing management circuitry 5500 extracts a data object from the data. For example, the data ingestion circuitry 5510 can determine that an obtained data packet includes a header (e.g., a data header, a packet header, a data packet header, etc.) and a payload (e.g., a data payload, a packet payload, a data packet payload, etc.), which can include one or more portions of data. In some examples, the data ingestion circuitry 5510 can extract a portion of data from the payload as a data object.

At block 6306, the data routing management circuitry 5500 applies local node customization data to the data object to generate an augmented data object, and the local node customization data based on metadata associated with a user. For example, the data query management circuitry 5530 can identify the data object as data to be used to render and/or otherwise generate a graphic (e.g., a graph, a plot, an image, etc.). In some examples, the data query management circuitry 5530 can be part of the fifth data routing manager 5402E. For example, the data query management circuitry 5530 can optimize display of the graphic on the second electronic device 5426 based on metadata associated with the second user 5412. In some examples, the metadata associated with the second user 5412 can indicate that the second user 5412 prefers to view bar graphs rather than scatter plots. For example, the data query management circuitry 5530 can instantiate the graphic as a bar graph to increase a likelihood that the second user 5412 will engage with the graphic and/or otherwise find the graphic relevant.

At block 6308, the data routing management circuitry 5500 presents the augmented data object to the user. For example, the data publishing circuitry 5550 can present the data object as a bar graph to the second user 5412 on the second electronic device 5426.

At block 6310, the data routing management circuitry 5500 determines whether the user acknowledged that a portion of the augmented data object is relevant to the user. For example, the data ingestion circuitry 5510 can determine whether the second user 5412 identified one or more portions of the data object as relevant. In some examples, the data ingestion circuitry 5510 can receive data indicative that the second user 5412 identified a first portion of the data object as relevant, a second portion of the data object as not relevant, etc., and/or any combination(s) thereof.

If, at block 6310, the data routing management circuitry 5500 determines that the user did acknowledge that a portion of the augmented data object is relevant to the user, control proceeds to block 6312. At block 6312, the data routing management circuitry 5500 modifies the metadata to associate relevant portion(s) of the data object with the user. For example, the machine learning circuitry 5520 can provide an acknowledgement from the second user 5412 that the first portion of the data object is relevant to the machine learning model 5570 as model input(s) to generate model output(s). In some examples, the model output(s) can include an increased relevancy score associated with the second user 5412 for the first portion of the data object.

At block 6314, the data routing management circuitry 5500 modifies the metadata to disassociate non-relevant portion(s) of the data object with the user. For example, the machine learning circuitry 5520 can provide an acknowledgement from the second user 5412 that the second portion of the data object is not relevant to the machine learning model 5570 as model input(s) to generate model output(s). In some examples, the model output(s) can include a decreased relevancy score associated with the second user 5412 for the second portion of the data object. For example, the machine learning model 5570 can output modified metadata for the second user 5412 that removes a portion of the metadata that correlated with the second portion of the data object. In response to modifying the metadata to disassociate non-relevant portion(s) of the data object from the user at block 6314, control proceeds to block 6318.

If, at block 6310, the data routing management circuitry 5500 determines that the user did not acknowledge that a portion of the augmented data object is relevant to the user, control proceeds to block 6316. At block 6316, the data routing management circuitry 5500 penalizes the metadata associated with the user. For example, the machine learning circuitry 5520 can obtain an acknowledgement from the second user 5412 that portion(s) of the data object is/are not relevant. In some examples, the machine learning circuitry 5520 can provide the acknowledgment (or an indicia of a lack of acknowledgment because the second user 5412 may have ignored the data object) to the machine learning model 5570 as model input(s) to generate model output(s). In some examples, the model output(s) can include revised or updated metadata for the second user 5412 that removes a portion of the metadata that correlated with the portion(s) of the data object. In response to penalizing the metadata associated with the user at block 6316, control proceeds to block 6318.

At block 6318, the data routing management circuitry 5500 determines whether another message is obtained at the node. For example, the data ingestion circuitry 5510 can determine whether another data packet, message, or any other implementation of data generation is obtained from one(s) of the data producers 5406. If, at block 6318, the data routing management circuitry 5500 determines that another message is obtained at the node, control returns to block 6302, otherwise the example machine readable instructions and/or the example operations 6300 of FIG. 63 conclude.

FIG. 64 is a flowchart representative of example machine readable instructions and/or example operations 6400 that may be executed and/or instantiated by processor circuitry to adjust metadata associated with a user. The example machine readable instructions and/or example operations 6400 begin at block 6402, at which the data routing management circuitry 5500 presents a message to a user having a relevancy score associated with a topic. For example, the data publishing circuitry 5550 can present a message, which can include audio, visual, and/or text data, to the fourth user 5416 using the fourth electronic device 5430. In some examples, the fourth user 5416 is a supervisor for an automobile manufacturing assembly line and, more specifically, an engine assembly line. For example, the message can be associated with a topic of engine assembly.

At block 6404, the data routing management circuitry 5500 determines whether the user affirmed a relevancy of the message to the user. For example, the fourth user 5416 can acknowledge receipt of the message and/or acknowledge that the message includes data that the fourth user 5416 finds relevant. In some examples, the data ingestion circuitry 5510 can receive the acknowledgment(s) and provide the acknowledgement(s) (and/or associated data) to the machine learning circuitry 5520.

If, at block 6404, the data routing management circuitry 5500 determines that the user did not affirm a relevancy of the message to the user, control proceeds to block 6408. At block 6408, the data routing management circuitry 5500 decreases a relevancy score of the topic associated with the user. For example, if the message has a topic of automobile infotainment system and the fourth user 5416 ignored the message, then the machine learning circuitry 5520 can determine that the relevancy score for the message having the topic of automobile infotainment system is to be reduced and/or otherwise decreased. Advantageously, by reducing the relevancy score for the message having the topic of automobile infotainment system, the fourth user 5416 can receive subsequent messages that are more relevant to the fourth user 5416, such as messages having the topic of engine assembly. In response to decreasing the relevancy score of the topic associated with the user at block 6408, control proceeds to block 6410.

If, at block 6404, the data routing management circuitry 5500 determines that the user did affirm a relevancy of the message to the user, control proceeds to block 6406. At block 6406, the data routing management circuitry 5500 increases a relevancy score of the topic associated with the user. For example, if the message has a topic of engine assembly and the fourth user 5416 engaged with and/or otherwise acknowledged a relevancy of the message, then the machine learning circuitry 5520 can determine that the relevancy score for the message having the topic of engine assembly is to be increased (or maintained). Advantageously, by increasing the relevancy score for the message having the topic of engine assembly, the fourth user 5416 can receive subsequent messages that are more relevant to the fourth user 5416, such as messages having the topic of engine assembly, or related topics such as transmission assembly, radiator assembly, etc. In response to increasing the relevancy score of the topic associated with the user at block 6406, control proceeds to block 6410.

At block 6410, the data routing management circuitry 5500 determines whether the relevancy score of the topic satisfies a threshold. For example, the machine learning circuitry 5520 can determine whether the fourth user 5416 is an expert, such as a stakeholder, a technical lead or expert, a subject matter expert, etc., based on a relevancy score of the topic for the fourth user 5416. In some examples, the machine learning circuitry 5520 can determine that a relevancy score of 0.92 of the topic of engine assembly for the fourth user 5416 is greater than a threshold (e.g., a relevancy score threshold) of 0.8, which can be indicative of the fourth user 5416 being an expert on the topic of engine assembly.

If, at block 6410, the data routing management circuitry 5500 determines that the relevancy score of the topic does not satisfy a threshold, control proceeds to block 6414. If, at block 6410, the data routing management circuitry 5500 determines that the relevancy score of the topic satisfies a threshold, control proceeds to block 6412. At block 6412, the data routing management circuitry 5500 identifies the user as an expert. For example, the node management circuitry 5540 can identify the fourth user 5416 as an expert on the topic of engine assembly based on the relevancy score of 0.92 satisfying the threshold of 0.8. Advantageously, the node management circuitry 5540 can identify the fourth user 5416 to be part of a list of users whom messages having the topic of engine assembly are to be routed for presentation. Advantageously, the node management circuitry 5540 can identify the fourth user 5416 to be part of the list of users in response to a determination the fourth user 5416 is an expert in connection with the topic of engine assembly.

At block 6414, the data routing management circuitry 5500 determines whether a location of the user changed. For example, the data ingestion circuitry 5510 can ingest video data from a video camera. In some examples, the data ingestion circuitry 5510 can invoke the machine learning circuitry 5520 to execute the machine learning model 5570 to identify users in a location (e.g., Zone 1, Floor 1 of a factory). For example, the data ingestion circuitry 5510 can determine whether the fourth user 5416 is in the location, has left the location, or has not been in the location longer than a specified time duration (e.g., a day, a week, a month, etc.) based on output(s) from the machine learning model 5570.

If, at block 6414, the data routing management circuitry 5500 determines that the location of the user did not change, control proceeds to block 6418. If, at block 6414, the data routing management circuitry 5500 determines that the location of the user did change, control proceeds to block 6416. At block 6416, the data routing management circuitry 5500 updates the relevancy score based on the location of the user using sensor data. For example, the machine learning circuitry 5520 can determine that the location of Zone 1, Floor 1 of the factory is for engine assembly. In some examples, the machine learning circuitry 5520 can increase a relevancy score of the topic of engine assembly for the fourth user 5416 in response to determining that the fourth user 5416 is identified (e.g., based on sensor data such as video data from a video camera) as being in the location proximate the engine assembly area. In response to updating the relevancy score based on the location of the user using sensor data at block 6416, control proceeds to block 6418.

At block 6418, the data routing management circuitry 5500 determines whether a difference between first data of the message and second data satisfies a threshold. For example, the data query management circuitry 5530 can determine whether first data of the message is different from second data, which may be stored on the fourth electronic device 5430 or elsewhere (e.g., different one(s) of the electronic devices 5424, 5426, 5428, 5430, 5432, 5434, one(s) of the data producers 5406, one(s) of the data consumers 5408, a datastore associated with the network environment 5404, etc., and/or any combination(s) thereof). In some examples, the data query management circuitry 5530 can proceed with the determination in an effort to determine whether the first data of the message is cumulative, repetitive, redundant, etc., with respect to the second data.

If, at block 6418, the data routing management circuitry 5500 determines that a difference between first data of the message and second data does not satisfy a threshold, control proceeds to block 6422. If, at block 6418, the data routing management circuitry 5500 determines that a difference between first data of the message and second data satisfies a threshold, control proceeds to block 6420. At block 6420, the data routing management circuitry 5500 ages non-updated data by at least one of expiring the non-updated data or remove portion of metadata. For example, the data query management circuitry 5530 can age the second data by expiring the second data (e.g., delete the second data from one or more datastores, reduce an availability or storage redundancy of the second data, etc.). In some examples, the data query management circuitry 5530 can age the second data by removing portion(s) of metadata of the second data that correlate to, correspond to, match etc., portion(s) of metadata associated with the fourth user 5416.

At block 6422, the data routing management circuitry 5500 determines whether another message is to be presented to the user. For example, the data publishing circuitry 5550 can determine that another message is to be presented to the fourth user 5416. If, at block 6422, the data routing management circuitry 5500 determines that another message is to be presented to the user, control returns to block 6402, otherwise the example machine readable instructions and/or the example operations 6400 of FIG. 64 conclude.

FIG. 65 is a flowchart representative of example machine readable instructions and/or example operations 6500 that may be executed and/or instantiated by processor circuitry to train and/or retrain a machine learning model. The example machine readable instructions and/or example operations 6500 begin at block 6502, at which the data routing management circuitry 5500 instantiates a machine learning microservice to generate a machine learning model based on data associated with an environment. For example, the machine learning circuitry 5520 can instantiate a microservice to generate the machine learning model 5570, which can be a neural network or any other type of AI/ML model, based on data associated with the network environment 5404.

At block 6504, the data routing management circuitry 5500 executes the machine learning model to generate data graphs corresponding to respective portions of the environment. For example, the machine learning circuitry 5520 can cause the machine learning model 5570 to generate one(s) of the data graphs 5602, 5604, 5606, 5608, which may correspond to portions of the network environment 5404.

At block 6506, the data routing management circuitry 5500 executes the machine learning model to identify hotspots of at least one of expert nodes or stakeholder nodes. For example, the machine learning circuitry 5520 can cause the machine learning model 5570 to identify hotspot(s) of at least one of expert nodes (e.g., expert data graph nodes) or stakeholder nodes (e.g., stakeholder data graph nodes) of the data graphs 5602, 5604, 5606, 5608.

At block 6508, the data routing management circuitry 5500 determines whether data traffic is received. For example, the data ingestion circuitry 5510 can determine whether one or more messages is received at a node, which may be implemented using the first data routing manager 5402A, and/or, more generally, one(s) of the data producers 5406. If, at block 6508, the data routing management circuitry 5500 determines that data traffic is not received, control waits at block 6508 to make another determination whether data traffic is received.

If, at block 6508, the data routing management circuitry 5500 determines that data traffic is received, control proceeds to block 6510. At block 6510, the data routing management circuitry 5500 updates metadata associated with response(s) and non-response(s) to the data traffic. For example, the machine learning circuitry 5520 can update (e.g., add, delete, modify, etc.) metadata associated with the first user 5410 in response to whether the first user 5410 responded, ignored, and/or acknowledged the data traffic.

At block 6512, the data routing management circuitry 5500 updates metadata associated with cause(s) of action(s) and effect(s) of the action(s) based on the data traffic. For example, the data ingestion circuitry 5510 can receive data representative of one or more actions carried out by the first user 5410 after the first user 5410 received the data traffic. In some examples, the machine learning circuitry 5520 can provide the data representative of the one or more actions to the machine learning model 5570 as model input(s) to determine model output(s). For example, the model output(s) can include update(s) (e.g., addition(s), deletion(s), modification(s), etc.) to metadata associated with the first user 5410 in response to whether the first user 5410 performed one or more actions in response to being presented with the data traffic.

At block 6514, the data routing management circuitry 5500 updates at least one of the data graphs or the hotspots based on the data traffic routing. For example, the machine learning circuitry 5520 can update one(s) of the data graphs 5602, 5604, 5606, 5608, hotspot(s) associated thereof, etc., and/or any combination(s) thereof, based on a routing of the data traffic. In some examples in which the user 5610 of FIG. 56 is presented with data, the routing of the data traffic can include the user 5610 forwarding and/or otherwise providing the data to USER B, who then may forward the data to USER E. In some examples, the machine learning circuitry 5520 can receive indications of the data forwarding and correspondingly update metadata associated with USER B and USER E to increase an association and/or relevancy of the data with USER B and USER E. Advantageously, in response to new data being generated that is related to the previous data, the machine learning circuitry 5520 can cause the new data to be delivered to USER B and/or USER E in addition to and/or alternatively to the user 5610.

At block 6516, the data routing management circuitry 5500 identifies a stratification of nodes and super nodes based on the data traffic routing. For example, the machine learning circuitry 5520 can identify USER B as a node and USER F as a super node because USER F receives an increasing number of data forwards with respect to USER B and/or other one(s) of the users of FIG. 56. Advantageously, in some examples, the node management circuitry 5540 can identify super node(s), such as USER F, to receive a higher priority when determining who to present data to with respect to non-super nodes.

At block 6518, the data routing management circuitry 5500 retrains the machine learning model based on at least one of the update(s) or sensor data. For example, the machine learning circuitry 5520 can retrain and/or otherwise cause a retraining of the machine learning model 5570 based on the update(s) in connection with at least one of block 6510, 6512, 6514, 6516. In some examples, the machine learning circuitry 5520 can retrain and/or otherwise cause a retraining of the machine learning model 5570 based on sensor data associated with the first user 5410, such as video camera data, RFID pings, electronic terminal logins, etc., and/or any combination(s) thereof.

At block 6520, the data routing management circuitry 5500 determines whether additional data traffic is received. For example, the data ingestion circuitry 5510 can determine whether additional data traffic is received. If, at block 6520, the data routing management circuitry 5500 determines that additional data traffic is received, control returns to block 6508, otherwise the example machine readable instructions and/or the example operations 6500 conclude.

FIG. 66 is a block diagram of an example processor platform 6600 structured to execute and/or instantiate the machine readable instructions and/or the operations of FIGS. 58-65 to implement the data routing management circuitry 5500 of FIG. 55. The processor platform 6600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 6600 of the illustrated example includes processor circuitry 6612. The processor circuitry 6612 of the illustrated example is hardware. For example, the processor circuitry 6612 can be implemented by one or more integrated circuits, logic circuits, FPGAs, microprocessors, CPUs, GPUs, DSPs, and/or microcontrollers from any desired family or manufacturer. The processor circuitry 6612 may be implemented by one or more semiconductor based (e.g., silicon based) devices. In this example, the processor circuitry 6612 implements the example machine learning circuitry 5520 (identified by ML CIRCUITRY), the example data query management circuitry 5530 (identified by DATA QUERY MGMT CIRCUITRY), the example node management circuitry 5540 (identified by NODE MGMT CIRCUITRY), and the example data publishing circuitry 5550 (identified by DATA PUBLISH CIRCUITRY) of FIG. 55.

The processor circuitry 6612 of the illustrated example includes a local memory 6613 (e.g., a cache, registers, etc.). The processor circuitry 6612 of the illustrated example is in communication with a main memory including a volatile memory 6614 and a non-volatile memory 6616 by a bus 6618. In some examples, the bus 6618 implements the bus 5580 of FIG. 55. The volatile memory 6614 may be implemented by SDRAM, DRAM, RDRAM®, and/or any other type of RAM device. The non-volatile memory 6616 may be implemented by flash memory and/or any other desired type of memory device. Access to the main memory 6614, 6616 of the illustrated example is controlled by a memory controller 6617.

The processor platform 6600 of the illustrated example also includes interface circuitry 6620. The interface circuitry 6620 may be implemented by hardware in accordance with any type of interface standard, such as an Ethernet interface, a USB interface, a Bluetooth® interface, an NFC interface, a PCI interface, and/or a PCIe interface. In this example, the interface circuitry 6620 implements the example data ingestion circuitry 5510 of FIG. 55.

In the illustrated example, one or more input devices 6622 are connected to the interface circuitry 6620. The input device(s) 6622 permit(s) a user to enter data and/or commands into the processor circuitry 6612. The input device(s) 6622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 6624 are also connected to the interface circuitry 6620 of the illustrated example. The output device(s) 6624 can be implemented, for example, by display devices (e.g., an LED, an OLED, an LCD, a CRT display, an IPS display, a touchscreen, etc.), a tactile output device, a printer, and/or speaker. The interface circuitry 6620 of the illustrated example, thus, typically includes a graphics driver card, a graphics driver chip, and/or graphics processor circuitry such as a GPU.

The interface circuitry 6620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 6626. The communication can be by, for example, an Ethernet connection, a DSL connection, a telephone line connection, a coaxial cable system, a satellite system, a line-of-site wireless system, a cellular telephone system, an optical connection, etc.

The processor platform 6600 of the illustrated example also includes one or more mass storage devices 6628 to store software and/or data. Examples of such mass storage devices 6628 include magnetic storage devices, optical storage devices, floppy disk drives, HDDs, CDs, Blu-ray disk drives, RAID systems, solid state storage devices such as flash memory devices and/or SSDs, and DVD drives. In this example, the one or more mass storage devices 6628 implement the example datastore 5560, the example raw data 5562, the example metadata 5564, the example users 5566, the example nodes 5568, and the example machine learning model 5570 (identified by ML MODEL) of FIG. 55.

The machine executable instructions 6632, which may be implemented by the machine readable instructions of FIGS. 58-65, may be stored in the mass storage device 54328, in the volatile memory 6614, in the non-volatile memory 6616, and/or on a removable non-transitory computer readable storage medium such as a CD or DVD.

The processor platform 6600 of the illustrated example of FIG. 66 includes example acceleration circuitry 6640, which includes an example GPU 6642, an example VPU 6644, and an example neural network processor 6646. In this example, the GPU 6642, the VPU 6644, the neural network processor 6646, and/or, more generally, the acceleration circuitry 6640, are in communication with different hardware of the processor platform 6600, such as the volatile memory 6614, the non-volatile memory 6616, etc., via the bus 6618. In this example, the neural network processor 6646 may be implemented by one or more integrated circuits, logic circuits, microprocessors, GPUs, DSPs, or controllers from any desired family or manufacturer that can be used to execute an AI/ML model, such as a neural network, which may be implemented by the machine learning model 5570. In some examples, one or more of the example data ingestion circuitry 5510, the example machine learning circuitry 5520, the example data query management circuitry 5530, the example node management circuitry 5540, and/or the example data publishing circuitry 5550 can be implemented in or with at least one of the GPU 6642, the VPU 6644, the neural network processor 6646, and/or, more generally, the acceleration circuitry 6640, instead of or in addition to the processor circuitry 6612 and/or the interface circuitry 5320.

From the foregoing, it will be appreciated that example systems, methods, apparatus, and articles of manufacture have been disclosed for data routing based on user engagement. Disclosed systems, methods, apparatus, and articles of manufacture improve the efficiency of using a computing device by routing data, messages, alerts, and the like to pertinent users rather than broadcasting to an entire network, which can reduce the computational, memory, and network resources needed to convey data to the pertinent users. Disclosed systems, methods, apparatus, and articles of manufacture are accordingly directed to one or more improvement(s) in the operation of a machine such as a computer or other electronic and/or mechanical device.

Example systems, apparatus, articles of manufacture, and methods for data routing based on user engagement are disclosed herein. Further examples and combinations thereof include the following:

Example 167 includes an apparatus for data routing in a network environment, the apparatus comprising at least one memory, instructions, and processor circuitry to at least one of execute or instantiate the instructions to generate a message with metadata based on data received at a first node, query one or more second nodes for first users associated with the metadata, generate a list based on the first users, the list including a second user, generate, with a machine learning model, a relevancy score for the second user based on an association of the second user and the metadata, and in response to determining that the relevancy score satisfies a threshold, deliver the message to the second user.

In Example 168, the subject matter of Example 167 can optionally include that the relevancy score is a first relevancy score, and the processor circuitry is to rank the list based on second relevancy scores, respective ones of the second relevancy scores corresponding to respective ones of the first users, identify a set of the first users of the list that have corresponding ones of the second relevancy scores that satisfy the threshold, and deliver the message to the set of the first users.

In Example 169, the subject matter of Examples 167-168 can optionally include that the set of the first users includes the second user and a third user with a third relevancy score, and the processor circuitry is to increase the first relevancy score of the second user in response to the second user responding to the message, and decrease the third relevancy score of the third user in response to the third user at least one of ignoring the message or acknowledging that the message is not relevant to the third user.

In Example 170, the subject matter of Examples 167-169 can optionally include that the metadata is first metadata, and the processor circuitry is to deliver the message to a third user in the list, in response to the third user not responding to the message, determine activity information associated with the third user, and in response to determining that the activity information indicates that the third user is available, remove the first metadata from second metadata associated with the third user.

In Example 171, the subject matter of Examples 167-170 can optionally include that the activity information includes at least one of electronic device activity data or sensor data, the electronic device activity data is associated with an application executing on an electronic device, and the sensor data is from at least one of a video camera or a wearable device.

In Example 172, the subject matter of Examples 167-171 can optionally include that the metadata is first metadata, and the processor circuitry is to deliver the message to a third user in the list, and in response to the third user acknowledging that the message is not relevant to the third user, remove the first metadata from second metadata associated with the third user.

In Example 173, the subject matter of Examples 167-172 can optionally include that the processor circuitry is to determine whether the data indicates an action is to be performed, in response to determining that the data does not indicate the action is to be performed, publish the data to one or more data subscribers, and in response to determining that the data does indicate the action is to be performed, generate the message to solicit the action from the second user.

In Example 174, the subject matter of Examples 167-173 can optionally include that the threshold is a relevancy score threshold, and the processor circuitry is to at least one of execute or instantiate the instructions to execute the machine learning model to determine an authorization score for the second user, the authorization score representative of whether the second user is granted access to the data, in response to determining that the authorization score satisfies an authorization score threshold, execute the machine learning model to determine the relevancy score for the second user, the relevancy score representative of a first likelihood that the data is relevant to the second user, and execute the machine learning model to determine a confidence score representative of a second likelihood that the second user is to respond to the message.

In Example 175, the subject matter of Examples 167-174 can optionally include that the metadata is first metadata, and the processor circuitry is to extract a data object from the data, apply local node customization data to the data object to generate an augmented data object, the local node customization data based on second metadata associated with the second user, and present the augmented data object to the second user.

In Example 176, the subject matter of Examples 167-175 can optionally include that the processor circuitry is to, in response to the second user acknowledging that a first portion of the data object is not relevant to the second user and a second portion of the data object is relevant to the second user remove a second portion of the local node customization data corresponding to the first portion, and add a third portion to the local node customization data corresponding to the second portion.

In Example 177, the subject matter of Examples 167-176 can optionally include that the data is associated with a first location, and the processor circuitry is to determine whether the second user is in the first location based on sensor data, increase the relevancy score in response to a determination that the second user is in the first location, and decrease the relevancy score in response to a determination that the second user is not in the first location.

In Example 178, the subject matter of Examples 167-177 can optionally include that the data is first data associated with second data, and the processor circuitry is to determine whether a difference between the first data and the second data satisfies a threshold, and in response to a determination that the difference satisfies the threshold, at least one of expire the second data or remove a portion of second metadata associated with the second user and that corresponds to the second data.

In Example 179, the subject matter of Examples 167-178 can optionally include that the data is first data, and the processor circuitry is to instantiate a machine learning microservice to generate the machine learning model based on second data associated with an environment, and execute the machine learning model to generate a data graph corresponding to a portion of the environment, identify a hotspot of at least one of expert nodes or stakeholder nodes, and update at least one of the data graph or the hotspot based on a routing of the message to the second user or one or more third users.

In Example 180, the subject matter of Examples 167-179 can optionally include that the message is a first message, the metadata is first metadata, and the relevancy score for the second user is based on a previous response of the second user to a second message, the second message having second metadata associated with the first metadata.

In Example 181, the subject matter of Examples 167-180 can optionally include that the message is a first message, and the relevancy score is based on at least one of a frequency or a time of day at which the second user responded to one or more second messages prior to the first message.

Example 182 includes an apparatus for data routing in a network environment, the apparatus comprising means for generating a message with metadata based on data received at a first node, means for querying one or more second nodes for first users associated with the metadata, means for compiling a list based on the first users, the list including a second user, means for determining, with a machine learning model, a relevancy score for the second user based on an association of the second user and the metadata, and means for transmitting the message to the second user in response to determining that the relevancy score satisfies a threshold.

In Example 183, the subject matter of Example 182 can optionally include that the relevancy score is a first relevancy score, and wherein the means for compiling is to rank the list based on second relevancy scores, respective ones of the second relevancy scores corresponding to respective ones of the first users, and identify a set of the first users of the list that have corresponding ones of the second relevancy scores that satisfy the threshold, and the means for transmitting is to transmit the message to the set of the first users.

In Example 184, the subject matter of Examples 182-183 can optionally include that the set of the first users includes the second user and a third user with a third relevancy score, and the means for determining is to increase the first relevancy score of the second user in response to the second user responding to the message, and decrease the third relevancy score of the third user in response to the third user at least one of ignoring the message or acknowledging that the message is not relevant to the third user.

In Example 185, the subject matter of Examples 182-184 can optionally include that the metadata is first metadata, and wherein the means for transmitting is to transmit the message to a third user in the list, and the means for determining is to in response to the third user not responding to the message, determine activity information associated with the third user, and in response to determining that the activity information indicates that the third user is available, remove the first metadata from second metadata associated with the third user.

In Example 186, the subject matter of Examples 182-185 can optionally include that the activity information includes at least one of electronic device activity data or sensor data, the electronic device activity data is associated with an application executing on an electronic device, and the sensor data is from at least one of a video camera or a wearable device.

In Example 187, the subject matter of Examples 182-186 can optionally include that the metadata is first metadata, and wherein the means for transmitting is to transmit the message to a third user in the list, and the means for determining is to, in response to the third user acknowledging that the message is not relevant to the third user, remove the first metadata from second metadata associated with the third user.

In Example 188, the subject matter of Examples 182-187 can optionally include that the means for determining is to determine whether the data indicates an action is to be performed, the means for transmitting is to, in response to determining that the data does not indicate the action is to be performed, transmit the data to one or more data subscribers, and the means for querying is to, in response to determining that the data does indicate the action is to be performed, generate the message to solicit the action from the second user.

In Example 189, the subject matter of Examples 182-188 can optionally include that the threshold is a relevancy score threshold, and the means for determining is to execute the machine learning model to determine an authorization score for the second user, the authorization score representative of whether the second user is granted access to the data, in response to determining that the authorization score satisfies an authorization score threshold, execute the machine learning model to determine the relevancy score for the second user, the relevancy score representative of a first likelihood that the data is relevant to the second user, and execute the machine learning model to determine a confidence score representative of a second likelihood that the second user is to respond to the message.

In Example 190, the subject matter of Examples 182-189 can optionally include that the metadata is first metadata, and further including means for extracting to extract a data object from the data, the means for querying to apply local node customization data to the data object to generate an augmented data object, the local node customization data based on second metadata associated with the second user, and the means for transmitting present the augmented data object to the second user.

In Example 191, the subject matter of Examples 182-190 can optionally include that the means for determining is to, in response to the second user acknowledging that a first portion of the data object is not relevant to the second user and a second portion of the data object is relevant to the second user remove a second portion of the local node customization data corresponding to the first portion, and add a third portion to the local node customization data corresponding to the second portion.

In Example 192, the subject matter of Examples 182-191 can optionally include that the data is associated with a first location, and further including means for ascertaining whether the second user is in the first location based on sensor data, and the means for determining to increase the relevancy score in response to a first determination that the second user is in the first location, and decrease the relevancy score in response to a second determination that the second user is not in the first location.

In Example 193, the subject matter of Examples 182-192 can optionally include that the data is first data associated with second data, and the means for querying is to determine whether a difference between the first data and the second data satisfies a threshold, and in response to a determination that the difference satisfies the threshold, at least one of expire the second data or remove a portion of second metadata associated with the second user and that corresponds to the second data.

In Example 194, the subject matter of Examples 182-193 can optionally include that the data is first data, the means for determining is to instantiate a machine learning microservice to generate the machine learning model based on second data associated with an environment, and execute the machine learning model to generate a data graph corresponding to a portion of the environment, identify a hotspot of at least one of expert nodes or stakeholder nodes, and update at least one of the data graph or the hotspot based on a routing of the message to the second user or one or more third users.

In Example 195, the subject matter of Examples 182-194 can optionally include that the message is a first message, the metadata is first metadata, and the relevancy score for the second user is based on a previous response of the second user to a second message, the second message having second metadata associated with the first metadata.

In Example 196, the subject matter of Examples 182-195 can optionally include that the message is a first message, and the relevancy score is based on a frequency or a time of day at which the second user responded to one or more second messages prior to the first message.

Example 197 includes at least one computer readable medium comprising instructions that, when executed, cause processor circuitry to at least generate a message with metadata based on data received at a first node, query one or more second nodes for first users associated with the metadata, generate a list based on the first users, the list including a second user, generate, with a machine learning model, a relevancy score for the second user based on an association of the second user and the metadata, and in response to determining that the relevancy score satisfies a threshold, deliver the message to the second user.

In Example 198, the subject matter of Example 197 can optionally include that the relevancy score is a first relevancy score, and the instructions, when executed, cause the processor circuitry to rank the list based on second relevancy scores, respective ones of the second relevancy scores corresponding to respective ones of the first users, identify a set of the first users of the list that have corresponding ones of the second relevancy scores that satisfy the threshold, and deliver the message to the set of the first users.

In Example 199, the subject matter of Examples 197-198 can optionally include that the set of the first users includes the second user and a third user with a third relevancy score, and the instructions, when executed, cause the processor circuitry to increase the first relevancy score of the second user in response to the second user responding to the message, and decrease the third relevancy score of the third user in response to the third user at least one of ignoring the message or acknowledging that the message is not relevant to the third user.

In Example 200, the subject matter of Examples 197-199 can optionally include that the metadata is first metadata, and the instructions, when executed, cause the processor circuitry to deliver the message to a third user in the list, in response to the third user not responding to the message, determine activity information associated with the third user, and in response to determining that the activity information indicates that the third user is available, remove the first metadata from second metadata associated with the third user.

In Example 201, the subject matter of Examples 197-200 can optionally include that the activity information includes at least one of electronic device activity data or sensor data, the electronic device activity data is associated with an application executing on an electronic device, and the sensor data is from at least one of a video camera or a wearable device.

In Example 202, the subject matter of Examples 197-201 can optionally include that the metadata is first metadata, and the instructions, when executed, cause the processor circuitry to deliver the message to a third user in the list, and in response to the third user acknowledging that the message is not relevant to the third user, remove the first metadata from second metadata associated with the third user.

In Example 203, the subject matter of Examples 197-202 can optionally include that the instructions, when executed, cause the processor circuitry to determine whether the data indicates an action is to be performed, in response to determining that the data does not indicate the action is to be performed, publish the data to one or more data subscribers, and in response to determining that the data does indicate the action is to be performed, generate the message to solicit the action from the second user.

In Example 204, the subject matter of Examples 197-203 can optionally include that the threshold is a relevancy score threshold, and the instructions, when executed, cause the processor circuitry to execute the machine learning model to determine an authorization score for the second user, the authorization score representative of whether the second user is granted access to the data, in response to determining that the authorization score satisfies an authorization score threshold, execute the machine learning model to determine the relevancy score for the second user, the relevancy score representative of a first likelihood that the data is relevant to the second user, and execute the machine learning model to determine a confidence score representative of a second likelihood that the second user is to respond to the message.

In Example 205, the subject matter of Examples 197-204 can optionally include that the metadata is first metadata, and the instructions, when executed, cause the processor circuitry to extract a data object from the data, apply local node customization data to the data object to generate an augmented data object, the local node customization data based on second metadata associated with the second user, and present the augmented data object to the second user.

In Example 206, the subject matter of Examples 197-205 can optionally include that the instructions, when executed, cause the processor circuitry to, in response to the second user acknowledging that a first portion of the data object is not relevant to the second user and a second portion of the data object is relevant to the second user remove a second portion of the local node customization data corresponding to the first portion, and add a third portion to the local node customization data corresponding to the second portion.

In Example 207, the subject matter of Examples 197-206 can optionally include that the data is associated with a first location, and the instructions, when executed, cause the processor circuitry to increase the relevancy score in response to a first determination that the second user is in the first location, and decrease the relevancy score in response to a second determination that the second user is not in the first location.

In Example 208, the subject matter of Examples 197-207 can optionally include that the data is first data associated with second data, and the instructions, when executed, cause the processor circuitry to determine whether a difference between the first data and the second data satisfies a threshold, and in response to a determination that the difference satisfies the threshold, at least one of expire the second data or remove a portion of second metadata associated with the second user and that corresponds to the second data.

In Example 209, the subject matter of Examples 197-208 can optionally include that the data is first data, and the instructions, when executed, cause the processor circuitry to instantiate a machine learning microservice to generate the machine learning model based on second data associated with an environment, and execute the machine learning model to generate a data graph corresponding to a portion of the environment, identify a hotspot of at least one of expert nodes or stakeholder nodes, and update at least one of the data graph or the hotspot based on a routing of the message to the second user or one or more third users.

In Example 210, the subject matter of Examples 197-209 can optionally include that the message is a first message, the metadata is first metadata, and the relevancy score for the second user is based on a previous response of the second user to a second message, the second message having second metadata associated with the first metadata.

In Example 211, the subject matter of Examples 197-210 can optionally include that the message is a first message, and the relevancy score is based on a frequency or a time of day at which the second user responded to one or more second messages prior to the first message.

Example 212 includes a method for data routing in a network environment, the method comprising generating a message with metadata based on data received at a first node, querying one or more second nodes for first users associated with the metadata, generating a list based on the first users, the list including a second user, generating, with a machine learning model, a relevancy score for the second user based on an association of the second user and the metadata, and in response to determining that the relevancy score satisfies a threshold, delivering the message to the second user.

In Example 213, the subject matter of Example 212 can optionally include that the relevancy score is a first relevancy score, and further include ranking the list based on second relevancy scores, respective ones of the second relevancy scores corresponding to respective ones of the first users, identifying a set of the first users of the list that have corresponding ones of the second relevancy scores that satisfy the threshold, and delivering the message to the set of the first users.

In Example 214, the subject matter of Examples 212-213 can optionally include that the set of the first users includes the second user and a third user with a third relevancy score, and further include increasing the first relevancy score of the second user in response to the second user responding to the message, and decreasing the third relevancy score of the third user in response to the third user at least one of ignoring the message or acknowledging that the message is not relevant to the third user.

In Example 215, the subject matter of Examples 212-214 can optionally include that the metadata is first metadata, and further include delivering the message to a third user in the list, in response to the third user not responding to the message, determining activity information associated with the third user, and in response to determining that the activity information indicates that the third user is available, removing the first metadata from second metadata associated with the third user.

In Example 216, the subject matter of Examples 212-215 can optionally include that the activity information includes at least one of electronic device activity data or sensor data, the electronic device activity data is associated with an application executing on an electronic device, and the sensor data is from at least one of a video camera or a wearable device.

In Example 217, the subject matter of Examples 212-216 can optionally include that the metadata is first metadata, and further include delivering the message to a third user in the list, and in response to the third user acknowledging that the message is not relevant to the third user, removing the first metadata from second metadata associated with the third user.

In Example 218, the subject matter of Examples 212-217 can optionally include determining whether the data indicates an action is to be performed, in response to determining that the data does not indicate the action is to be performed, publishing the data to one or more data subscribers, and in response to determining that the data does indicate the action is to be performed, generating the message to solicit the action from the second user.

In Example 219, the subject matter of Examples 212-218 can optionally include that the threshold is a relevancy score threshold, and further include executing the machine learning model to determine an authorization score for the second user, the authorization score representative of whether the second user is granted access to the data, in response to determining that the authorization score satisfies an authorization score threshold, executing the machine learning model to determine the relevancy score for the second user, the relevancy score representative of a first likelihood that the data is relevant to the second user, and executing the machine learning model to determine a confidence score representative of a second likelihood that the second user is to respond to the message.

In Example 220, the subject matter of Examples 212-219 can optionally include that the metadata is first metadata, and further include extracting a data object from the data, applying local node customization data to the data object to generate an augmented data object, the local node customization data based on second metadata associated with the second user, and presenting the augmented data object to the second user.

In Example 221, the subject matter of Examples 212-220 can optionally include, in response to the second user acknowledging that a first portion of the data object is not relevant to the second user and a second portion of the data object is relevant to the second user removing a second portion of the local node customization data corresponding to the first portion, and adding a third portion to the local node customization data corresponding to the second portion.

In Example 222, the subject matter of Examples 212-221 can optionally include that the data is associated with a first location, and further including increasing the relevancy score in response to determining that the second user is in the first location, and decreasing the relevancy score in response to determining that the second user is not in the first location.

In Example 223, the subject matter of Examples 212-222 can optionally include that the data is first data associated with second data, and further include determining whether a difference between the first data and the second data satisfies a threshold, and in response to determining that the difference satisfies the threshold, at least one of expiring the second data or removing a portion of second metadata associated with the second user and that corresponds to the second data.

In Example 224, the subject matter of Examples 212-223 can optionally include that the data is first data, and further include instantiating a machine learning microservice to generate the machine learning model based on second data associated with an environment, and executing the machine learning model to generate a data graph corresponding to a portion of the environment, identify a hotspot of at least one of expert nodes or stakeholder nodes, and update at least one of the data graph or the hotspot based on a routing of the message to the second user or one or more third users.

In Example 225, the subject matter of Examples 212-224 can optionally include that the message is a first message, the metadata is first metadata, and the relevancy score for the second user is based on a previous response of the second user to a second message, the second message having second metadata associated with the first metadata.

In Example 226, the subject matter of Examples 212-225 can optionally include that the message is a first message, and the relevancy score is based on a frequency or a time of day at which the second user responded to one or more second messages prior to the first message.

Example 227 is edge server processor circuitry to perform the method of any of Examples 212-226.

Example 228 is edge cloud processor circuitry to perform the method of any of Examples 212-226.

Example 229 is edge node processor circuitry to perform the method of any of Examples 212-226.

Example 230 is edge gateway processor circuitry to perform the method of any of Examples 212-226.

Example 231 is edge switch circuitry to perform the method of any of Examples 212-226.

Example 232 is an XPU to perform the method of any of Examples 212-226.

Example 233 is an Infrastructure Processing Unit to perform the method of any of Examples 212-226.

Example 234 is an apparatus comprising at least one of acceleration circuitry, one or more graphics processor units, one or more vision processor units, Artificial Intelligence processor circuitry, machine learning processor circuitry, neural network processor circuitry, one or more digital signal processors, one or more general purpose processors, or network interface circuitry to perform the method of any of Examples 212-226.

Example 235 is at least one computer readable medium comprising instructions to perform the method of any of Examples 212-226.

### Section G—Example Hardware and/or Software Distribution Platform Implementations that May Implement the Examples Disclosed Herein

FIG. 67 is a block diagram of an example implementation of the processor circuitry 1112, 2112, 3812, 5312, 6612 of FIGS. 11, 21, 38, 53, and/or 66. In this example, the processor circuitry 1112, 2112, 3812, 5312, 6612 of FIGS. 11, 21, 38, 53, and/or 66 is implemented by a general purpose microprocessor 6700. The general purpose microprocessor circuitry 6700 execute some or all of the machine readable instructions of the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 to effectively instantiate the ADM system 600 of FIG. 6 as logic circuits to perform the operations corresponding to those machine readable instructions. For example, the microprocessor 6700 may implement multi-core hardware circuitry such as a CPU, a DSP, a GPU, an XPU, etc. Although it may include any number of example cores 6702 (e.g., 1 core), the microprocessor 6700 of this example is a multi-core semiconductor device including N cores. The cores 6702 of the microprocessor 6700 may operate independently or may cooperate to execute machine readable instructions. For example, machine code corresponding to a firmware program, an embedded software program, or a software program may be executed by one of the cores 6702 or may be executed by multiple ones of the cores 6702 at the same or different times. In some examples, the machine code corresponding to the firmware program, the embedded software program, or the software program is split into threads and executed in parallel by two or more of the cores 6702. The software program may correspond to a portion or all of the machine readable instructions and/or operations represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65.

The cores 6702 may communicate by a first example bus 6704. In some examples, the first bus 6704 may implement a communication bus to effectuate communication associated with one(s) of the cores 6702. For example, the first bus 6704 may implement at least one of an Inter-Integrated Circuit (I2C) bus, a Serial Peripheral Interface (SPI) bus, a PCI bus, or a PCIe bus. Additionally or alternatively, the first bus 6704 may implement any other type of computing or electrical bus. The cores 6702 may obtain data, instructions, and/or signals from one or more external devices by example interface circuitry 6706. The cores 6702 may output data, instructions, and/or signals to the one or more external devices by the interface circuitry 6706. Although the cores 6702 of this example include example local memory 6720 (e.g., Level 1 (L1) cache that may be split into an L1 data cache and an L1 instruction cache), the microprocessor 6700 also includes example shared memory 6710 that may be shared by the cores (e.g., Level 2 (L2) cache)) for high-speed access to data and/or instructions. Data and/or instructions may be transferred (e.g., shared) by writing to and/or reading from the shared memory 6710. The local memory 6720 of each of the cores 6702 and the shared memory 6710 may be part of a hierarchy of storage devices including multiple levels of cache memory and the main memory (e.g., the main memory 2114, 2116 of FIG. 21, the main memory 3814, 3816 of FIG. 38, the main memory 5314, 5316 of FIG. 53, the main memory 6614, 6616 of FIG. 66, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 6702 may be referred to as a CPU, DSP, GPU, etc., or any other type of hardware circuitry. Each core 6702 includes control unit circuitry 6714, arithmetic and logic (AL) circuitry (sometimes referred to as an ALU) 6716, a plurality of registers 6718, the L1 cache 6720, and a second example bus 6722. Other structures may be present. For example, each core 6702 may include vector unit circuitry, single instruction multiple data (SIMD) unit circuitry, load/store unit (LSU) circuitry, branch/jump unit circuitry, floating-point unit (FPU) circuitry, etc. The control unit circuitry 6714 includes semiconductor-based circuits structured to control (e.g., coordinate) data movement within the corresponding core 6702. The AL circuitry 6716 includes semiconductor-based circuits structured to perform one or more mathematic and/or logic operations on the data within the corresponding core 6702. The AL circuitry 6716 of some examples performs integer based operations. In other examples, the AL circuitry 6716 also performs floating point operations. In yet other examples, the AL circuitry 6716 may include first AL circuitry that performs integer based operations and second AL circuitry that performs floating point operations. In some examples, the AL circuitry 6716 may be referred to as an Arithmetic Logic Unit (ALU). The registers 6718 are semiconductor-based structures to store data and/or instructions such as results of one or more of the operations performed by the AL circuitry 6716 of the corresponding core 6702. For example, the registers 6718 may include vector register(s), SIMD register(s), general purpose register(s), flag register(s), segment register(s), machine specific register(s), instruction pointer register(s), control register(s), debug register(s), memory management register(s), machine check register(s), etc. The registers 6718 may be arranged in a bank as shown in FIG. 67. Alternatively, the registers 6718 may be organized in any other arrangement, format, or structure including distributed throughout the core 6702 to shorten access time. The second bus 6722 may implement at least one of an I2C bus, a SPI bus, a PCI bus, or a PCIe bus

Each core 6702 and/or, more generally, the microprocessor 6700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 6700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 68 is a block diagram of another example implementation of the processor circuitry 1112, 2112, 3812, 5312, 6612 of FIGS. 11, 21, 38, 53, and/or 66. In this example, the processor circuitry 1112, 2112, 3812, 5312, 6612 of FIGS. 11, 21, 38, 53, and/or 66 is implemented by FPGA circuitry 6800. The FPGA circuitry 6800 can be used, for example, to perform operations that could otherwise be performed by the example microprocessor 6700 of FIG. 67 executing corresponding machine readable instructions. However, once configured, the FPGA circuitry 6800 instantiates the machine readable instructions in hardware and, thus, can often execute the operations faster than they could be performed by a general purpose microprocessor executing the corresponding software.

More specifically, in contrast to the microprocessor 6700 of FIG. 67 described above (which is a general purpose device that may be programmed to execute some or all of the machine readable instructions represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 but whose interconnections and logic circuitry are fixed once fabricated), the FPGA circuitry 6800 of the example of FIG. 68 includes interconnections and logic circuitry that may be configured and/or interconnected in different ways after fabrication to instantiate, for example, some or all of the machine readable instructions represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65. In particular, the FPGA 6800 may be thought of as an array of logic gates, interconnections, and switches. The switches can be programmed to change how the logic gates are interconnected by the interconnections, effectively forming one or more dedicated logic circuits (unless and until the FPGA circuitry 6800 is reprogrammed). The configured logic circuits enable the logic gates to cooperate in different ways to perform different operations on data received by input circuitry. Those operations may correspond to some or all of the software represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65. As such, the FPGA circuitry 6800 may be structured to effectively instantiate some or all of the machine readable instructions of the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 as dedicated logic circuits to perform the operations corresponding to those software instructions in a dedicated manner analogous to an ASIC. Therefore, the FPGA circuitry 6800 may perform the operations corresponding to the some or all of the machine readable instructions of FIGS. FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 faster than the general purpose microprocessor can execute the same.

In the example of FIG. 68, the FPGA circuitry 6800 is structured to be programmed (and/or reprogrammed one or more times) by an end user by a hardware description language (HDL) such as Verilog. The FPGA circuitry 6800 of FIG. 68, includes example input/output (I/O) circuitry 6802 to obtain and/or output data to/from example configuration circuitry 6804 and/or external hardware (e.g., external hardware circuitry) 6806. For example, the configuration circuitry 6804 may implement interface circuitry that may obtain machine readable instructions to configure the FPGA circuitry 6800, or portion(s) thereof. In some examples, the configuration circuitry 6804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 6806 may implement the microprocessor 6700 of FIG. 67. The FPGA circuitry 6800 also includes an array of example logic gate circuitry 6808, a plurality of example configurable interconnections 6810, and example storage circuitry 6812. The logic gate circuitry 6808 and interconnections 6810 are configurable to instantiate one or more operations that may correspond to at least some of the machine readable instructions of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 and/or other desired operations. The logic gate circuitry 6808 shown in FIG. 68 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 6808 to enable configuration of the electrical structures and/or the logic gates to form circuits to perform desired operations. The logic gate circuitry 6808 may include other electrical structures such as look-up tables (LUTs), registers (e.g., flip-flops or latches), multiplexers, etc.

The interconnections 6810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 6808 to program desired logic circuits.

The storage circuitry 6812 of the illustrated example is structured to store result(s) of the one or more of the operations performed by corresponding logic gates. The storage circuitry 6812 may be implemented by registers or the like. In the illustrated example, the storage circuitry 6812 is distributed amongst the logic gate circuitry 6808 to facilitate access and increase execution speed.

The example FPGA circuitry 6800 of FIG. 68 also includes example Dedicated Operations Circuitry 6814. In this example, the Dedicated Operations Circuitry 6814 includes special purpose circuitry 6816 that may be invoked to implement commonly used functions to avoid the need to program those functions in the field. Examples of such special purpose circuitry 6816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 6800 may also include example general purpose programmable circuitry 6818 such as an example CPU 6820 and/or an example DSP 6822. Other general purpose programmable circuitry 6818 may additionally or alternatively be present such as a GPU, an XPU, etc., that can be programmed to perform other operations.

Although FIGS. 67 and 68 illustrate two example implementations of the processor circuitry 1112, 2112, 3812, 5312, 6612 of FIGS. 11, 21, 38, 53, and/or 66, many other approaches are contemplated. For example, as mentioned above, modern FPGA circuitry may include an on-board CPU, such as one or more of the example CPU 6820 of FIG. 68. Therefore, the processor circuitry 1112, 2112, 3812, 5312, 6612 of FIGS. 11, 21, 38, 53, and/or 66 may additionally be implemented by combining the example microprocessor 6700 of FIG. 67 and the example FPGA circuitry 6800 of FIG. 68. In some hybrid examples, a first portion of the machine readable instructions represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 may be executed by one or more of the cores 6702 of FIG. 67 and a second portion of the machine readable instructions represented by the flowcharts of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 may be executed by the FPGA circuitry 6800 of FIG. 68.

In some examples, the processor circuitry 1112, 2112, 3812, 5312, 6612 of FIGS. 11, 21, 38, 53, and/or 66 may be in one or more packages. For example, the processor circuitry 6700 of FIG. 67 and/or the FPGA circuitry 6800 of FIG. 68 may be in one or more packages. In some examples, an XPU may be implemented by the processor circuitry 1112, 2112, 3812, 5312, 6612 of FIGS. 11, 21, 38, 53, and/or 66, which may be in one or more packages. For example, the XPU may include a CPU in one package, a DSP in another package, a GPU in yet another package, and an FPGA in still yet another package.

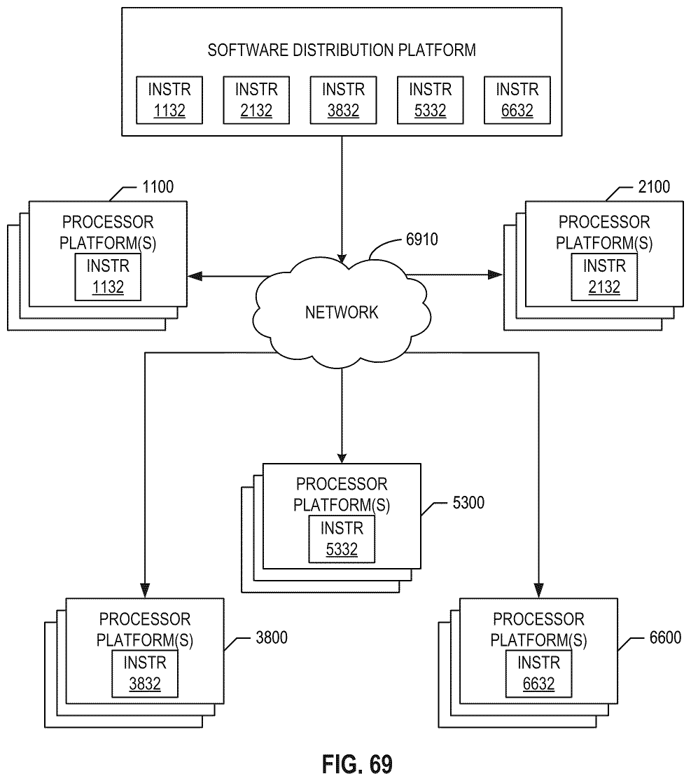

A block diagram illustrating an example software distribution platform 6905 to distribute software such as the example machine readable instructions 1132, 2132, 3832, 5332, 6632 of FIGS. 11, 21, 38, 53, and/or 66 to hardware devices owned and/or operated by third parties is illustrated in FIG. 69. The example software distribution platform 6905 may be implemented by any computer server, data facility, cloud service, etc., capable of storing and transmitting software to other computing devices. The third parties may be customers of the entity owning and/or operating the software distribution platform 6905. For example, the entity that owns and/or operates the software distribution platform 6905 may be a developer, a seller, and/or a licensor of software such as the example machine readable instructions 1132, 2132, 3832, 5332, 6632 of FIGS. 11, 21, 38, 53, and/or 66. The third parties may be consumers, users, retailers, OEMs, etc., who purchase and/or license the software for use and/or re-sale and/or sub-licensing. In the illustrated example, the software distribution platform 6905 includes one or more servers and one or more storage devices. The storage devices store the machine readable instructions 1132, 2132, 3832, 5332, 6632 of FIGS. 11, 21, 38, 53, and/or 66, which may correspond to the example machine readable instructions of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65, as described above. The one or more servers of the example software distribution platform 6905 are in communication with a network 6910, which may correspond to any one or more of the Internet and/or any of the example networks 1126, 2126, 3826, 5326, 6626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132, 2132, 3832, 5332, 6632 of FIGS. 11, 21, 38, 53, and/or 66 from the software distribution platform 6905. For example, the software, which may correspond to the example machine readable instructions of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65, may be downloaded to the example processor platform 1100, 2100, 3800, 5300, 6600, which is/are to execute the machine readable instructions 1132, 2132, 3832, 5332, 6632 of FIGS. 11, 21, 38, 53, and/or 66 to implement the example ADM system 600 of FIG. 6, the ADM systems 1200, 1300 of FIGS. 12 and/or 13, the data value scoring circuitry 2400 of FIG. 24, the contextual data translation circuitry 4000 of FIG. 40, the data routing management circuitry 5500 of FIG. 55, and/or portion(s) thereof. In some examples, one or more servers of the software distribution platform 6905 periodically offer, transmit, and/or force updates to the software (e.g., the example machine readable instructions 1132, 2132, 3832, 5332, 6632 of FIGS. 11, 21, 38, 53, and/or 66) to ensure improvements, patches, updates, etc., are distributed and applied to the software at the end user devices.

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7, 9, 10, 15, 16, 17, 18, 19, 20, 26, 27, 28, 29, 30, 31, 32, 33, 34, 35, 36, 37, 45, 46, 47, 48, 49, 50, 51, 52, 58, 59, 60, 61, 62, 63, 64, and/or 65 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, methods, apparatus, and articles of manufacture have been disclosed for proactive data management and analytics. Disclosed systems, methods, apparatus, and articles of manufacture achieve and/or otherwise implement improved data ingestion, bus, analytics, storage, data publishing, privacy, security, and trust techniques over conventional data management systems. Disclosed systems, methods, apparatus, and articles of manufacture improve the efficiency of using a computing device by implementing examples disclosed herein. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A system for proactive data management, the system comprising:
a data ingestion manager to extract a first data object from ingested data, the ingested data to be generated by one or more data sources in an environment, the one or more data sources including at least one of autonomous equipment, a sensor, or a first electronic device associated with a first user;
a data query manager to tag a first portion of the first data object with first metadata, the first metadata based on at least one of the environment or a type of a first one of the one or more data sources that generated the first data object;
a distributed datastore to store a second data object and second metadata, the second data object linked to the second metadata in a data graph;
an analytics manager to:
identify the second data object based on at least a partial match of the first metadata to the second metadata; and
augment one or more second portions of the second metadata based on one or more first portions of the first metadata to output enriched second metadata in the data graph;
a node manager to identify a second electronic device in the environment, the second electronic device represented by a node in a preferred nodes table, the node to be identified based on the enriched second metadata; and
a data publishing manager to publish at least one of the first data object or the second data object for access by the second electronic device, the second electronic device associated with the first user or a second user in the environment.

2. The system of claim 1, wherein the analytics manager is to at least one of identify the second data object or enrich the second data object in response to execution of one or more machine learning models with the first data object as a data input to the one or more machine learning models.

3. The system of claim 1, further including a data security manager to:
identify a data access policy corresponding to the second metadata;
determine whether the second user has access to the first data object based on the data access policy; and
in response to a determination that the second user does not have access to the first data object based on the data access policy, deny the second electronic device access to the first data object.

4. The system of claim 3, wherein the data security manager is to, in response to a determination that the second user has access to the first data object based on the data access policy, permit the data publishing manager to publish the first data object for access by the second electronic device.

5. The system of claim 1, wherein the distributed datastore includes a metadata datastore and a raw datastore, and the analytics manager is to:
obtain the second metadata and third metadata from the metadata datastore via a data plane, the third metadata including at least one of the one or more second portions of the second metadata;
obtain the second data object from the raw datastore via the data plane;
generate a primary data graph node based on the second data object;
generate a first strength vector to connect the primary data graph node to the at least one of the one or more second portions of the second metadata;
generate a second strength vector to connect the primary data graph node to one of one or more third portions of the third metadata;
generate the data graph based on at least one of the primary data graph node, the first strength vector, and the second strength vector; and
store the data graph in the distributed datastore.

6. The system of claim 5, wherein the first strength vector has a vector length and an angle with respect to a reference axis, the vector length represented by a strength of association between the at least one of the one or more second portions of the second metadata and the second data object, the angle represented by a first probability that a first event associated with the at least one of the one or more second portions of the second metadata is to precede or follow a second event associated with the second data object.

7. The system of claim 1, wherein the analytics manager is to instantiate a machine learning microservice to:
predict at least one of an access frequency or a use frequency of the first data object by at least one of the first user or the second user based on a data retention policy; and
store the first data object in hot storage, warm storage, or cold storage based on the data retention policy.

8. The system of claim 1, wherein the first data object is a first instance of the first data object with one or more first values, and the analytics manager is to:
locate a second instance of the first data object in a raw datastore of the distributed datastore, the second instance to have one or more second values;
determine whether a correlation error based on a comparison of the one or more first values and the one or more second values satisfies a threshold; and
in response to a determination that the correlation error satisfies the threshold:
apply an error correction value to the first instance to reduce the correlation error; and
expire the second instance.

9. The system of claim 1, wherein the environment is a first environment, the first data object includes a first lexical term, the second data object includes a second lexical term, and the analytics manager is to:
generate an association of the first lexical term and the second lexical term in response to a determination that a strength of a vector in the data graph satisfies a threshold, the vector to connect a first portion of the first metadata to a second portion of the second metadata; and
store the association in the distributed datastore, the association to be accessible by the second electronic device in the first environment or a third electronic device in a second environment.

10. The system of claim 1, wherein:
the analytics manager is to identify, based on the data graph, one or more nodes in the preferred nodes table, the one or more nodes to be represented by logical entities in the environment, the one or more nodes to be identified based on a relevancy score associated with the one or more nodes and the first data object;
the node manager is to determine whether the one or more nodes are included in the preferred nodes table; and
the data publishing manager is to publish the first data object for access by the one or more nodes in response to a determination that the one or more nodes are in the preferred nodes table.

11.-42. (canceled)

43. An apparatus for data routing in a network environment, the apparatus comprising:
machine readable instructions; and
programmable circuitry to utilize the
machine readable instructions to:
generate a message with metadata based on data received at a first node;
query one or more second nodes for first users associated with the metadata;
compile a list based on the first users, the list including a second user;
determine, with a machine learning model, a relevancy score for the second user based on an association of the second user and the metadata; and
interface circuitry to transmit the message to the second user in response to determining that the relevancy score satisfies a threshold.

44. The apparatus of claim 43, wherein:
the relevancy score is a first relevancy score;
the programmable circuitry is to:
rank the list based on second relevancy scores, respective ones of the second relevancy scores corresponding to respective ones of the first users; and
identify a set of the first users of the list that have corresponding ones of the second relevancy scores that satisfy the threshold; and
the interface circuitry is to transmit the message to the set of the first users.

45. The apparatus of claim 44, wherein the set of the first users includes the second user and a third user with a third relevancy score, and the programmable circuitry is to:
increase the first relevancy score of the second user in response to the second user responding to the message; and
decrease the third relevancy score of the third user in response to the third user at least one of ignoring the message or acknowledging that the message is not relevant to the third user.

46.-49. (canceled)

50. The apparatus of claim 43, wherein the threshold is a relevancy score threshold, and the programmable circuitry is to:
execute the machine learning model to determine an authorization score for the second user, the authorization score representative of whether the second user is granted access to the data;
in response to determining that the authorization score satisfies an authorization score threshold, execute the machine learning model to determine the relevancy score for the second user, the relevancy score representative of a first likelihood that the data is relevant to the second user; and
execute the machine learning model to determine a confidence score representative of a second likelihood that the second user is to respond to the message.

51.-54. (canceled)

55. The apparatus of claim 43, wherein the data is first data, and the programmable circuitry is to:
instantiate a machine learning microservice to generate the machine learning model based on second data associated with an environment; and
execute the machine learning model to:
generate a data graph corresponding to a portion of the environment;
identify a hotspot of at least one of expert nodes or stakeholder nodes; and
update at least one of the data graph or the hotspot based on a routing of the message to the second user or one or more third users.

56.-107. (canceled)

108. At least one computer readable medium comprising instructions that, when executed, cause programmable circuitry to at least:
generate metadata for at least one of ingested data or stored data;
determine at least one of a first strength vector for the ingested data within a first graph model or a second strength vector for the stored data within a second graph model, the first strength vector to link the ingested data to one or more first adjacent nodes in the first graph model, the second strength vector to link the stored data to one or more second adjacent nodes in the second graph model; and
store at least one of the ingested data or the stored data based on respective ones of the first graph model or the second graph model.

109.-110. (canceled)

111. The at least one computer readable medium of claim 108, wherein the instructions, when executed, cause the programmable circuitry to:
connect the ingested data to the first adjacent nodes within the first graph model based on a first portion of metadata of the ingested data matching a second portion of metadata of the first adjacent nodes; and
connect the stored data to the second adjacent nodes within the second graph model based on a third portion of metadata of the stored data matching a fourth portion of metadata of the second adjacent nodes.

112. The at least one computer readable medium of claim 108, wherein the instructions, when executed, cause the programmable circuitry to:
determine a consumption status of the stored data, the consumption status including at least one of a frequency of use of the stored data, a consumption form of the stored data in use, or a validity time of the stored data;
calculate a retention cost of the stored data, the retention cost representative of a quantification of at least one of storage space used to store the stored data, first power consumption to store the stored data, or second power consumption to at least one of write or read the stored data; and
retain the stored data in response to at least one of the consumption status or the retention cost satisfying a first threshold.

113. The at least one computer readable medium of claim 108, wherein the instructions, when executed, cause the programmable circuitry to:
predict a frequency at which the stored data is to be used based on at least one of a consumption status of the stored data, a validity time of the stored data, or a data coverage of the first adjacent nodes in the first graph model; and
select a storage retention for the stored data based on at least one of the consumption status, the validity time, the data coverage, or a contextual data association, the storage retention including a promotion or a demotion of the stored data, the promotion to cause the stored data to have a first level of accessibility, the demotion to cause the stored data to have a second level of accessibility, the second level of accessibility to be less than the first level of accessibility.

114. (canceled)

115. The at least one computer readable medium of claim 108, wherein the instructions, when executed, cause the programmable circuitry to:
assess a first uniqueness of the stored data, the first uniqueness including a first comparison of one or more characteristics similar to the stored data and the second adjacent nodes; and
associate a cyclical trend of critical events with at least one of a first pattern of use of the stored data, a second pattern of use of the second adjacent nodes, first nominal traffic of the stored data, or second nominal traffic of the second adjacent nodes, wherein the instructions, when executed, further cause the programmable circuitry to retain the stored data in response to at least one of the first uniqueness or the cyclical trend satisfying a second threshold.

116.-234. (canceled)
